(19) United States
(12) Patent Application Publication
(10) Pub. No.: US 2015/0324400 A1
(43) Pub. Date: Nov. 12, 2015

(54) Interest Collection and Tracking System and Method of Use

(71) Applicant: Access Event Solutions, Sparks, NV (US)

(72) Inventors: SETH SHECK, RENO, NV (US); KAREN YOUNG, Reno, NV (US); PHILLIP WRIGHT, Reno, NV (US)

(21) Appl. No.: 14/706,800

(22) Filed: May 7, 2015

Related U.S. Application Data
(60) Provisional application No. 61/989,581, filed on May 7, 2014.

(51) Int. Cl. G06F 17/30; H04B 5/00; H04W 4/00

(52) U.S. Cl. CPC G06F 17/30321; G06F 17/30882; H04W 4/008; H04B 5/0062

(57) ABSTRACT

An interest collection system includes one or more wireless communication technologies such as Radio Frequency Identification (RFID) tags, Near Field Communication (NFC) tags, Bluetooth communication signals, and other one-way or two-way technologies. These technologies can be used to wirelessly interact with reader devices at event locations such that certain types of interactions are interpreted as one or more of participant interest, preference, and participation. Interactions may be recoded and information related thereto may be provided to event participants, organizers, service providers, and/or others for later retrieval and/or analysis. In some examples participant interest, preference, and participation across multiple events may be collected.

### CROSS REFERENCE TO RELATED APPLICATIONS

This application claims priority to U.S. Provisional Patent Application Ser. No. 61/989,581, filed on May 7, 2014, and entitled “Interest Collection And Tracking System And Method Of Use,” the entire disclosure of which is incorporated herein by reference.

### COPYRIGHT

A portion of the disclosure of this patent document contains or may contain material subject to copyright protection. The copyright owner has no objection to the photocopy reproduction of the patent document or the patent disclosure in exactly the form it appears in the Patent and Trademark Office patent file or records, but otherwise reserves all copyrights.

### TECHNICAL FIELD

The present invention relates to systems and methods for the collection, tracking, analysis, and reporting of activities of persons at an event or location, and more particularly to automated systems and methods for collecting and analyzing interest-indicating activities, and generating a persistent event stream reflecting individual interests.

### BACKGROUND

Events such as, for example conference events, entertainment events, and merchandising events, generally involve participants and staff interacting with event areas and assets, such as entry points, exit points, merchandise, vendor booths, activities, seminars, and the like. Participants generally have a limited amount of time to interact with a vendor or activity provider, and the vendor or activity provider generally have a small window in which to generate a lasting impression on the participant. The participant's failure to acquire information of interest, or the vendor or activity provider's failure to generate, in the participant, a lasting impression can result in a significant barrier to post-event interactions.

After the conclusion of an event, participants have traditionally been left to rely on their own memory to recall details of participation and matters of interest. Vendor materials or collateral collected during an event has been used as method for reminding participants where they have been and some of what they might have been interested in while in attendance, but the usefulness of such materials and collateral in this respect is generally limited to their availability to the participant, the participant's retaining the materials and collateral during and after the event, and the participant's ability to remember from where they acquired the materials and collateral and why. In addition, this materials and collateral often do not represent any sort of intelligent connection between the participant and their level of interest such that the materials and collateral facilitates the participant's ability to obtain or receive additional information of interest. This can result in a disincentive for former participants to engage with vendors and activity providers, and in some cases can serve as a complete barrier to any sort of post-event interaction and engagement, resulting in a loss of revenue to vendors and activity providers, and lessening the overall experience for the participant.

In an effort to ensure post-event engagement, vendors and activity providers have traditionally relied on cumbersome methods for collecting information from interested participants. For example, the collection of business cards and email signup sheets require participants to queue at card collection repositories and locations for writing their contact information. Participants may have to repeat this activity for each vendor of interest, resulting in their being dissuaded from taking the time to complete the process, potentially denying the vendor valuable contact data and leaving the participant to rely on their memory after the fact to pursue further engagement. Even where information is collected, the vendor or event organizer may be left with a tedious data entry task to be done after the close of the event. Manual data entry of participant information can be dependent on the quality of the handwriting of the participant, as well as the accuracy of the data entry specialists reading of the participant's information. These sorts of cumbersome and error-prone methods between the vendor or activity provider and the participant can result in a temporary delay in establishing or permanent failure to establish an association with the participants, again potentially impacting subsequent engagement that would otherwise benefit vendors, activity providers, and participants.

In the competition for the attention of participants, vendors and activity providers have often relied on the offering of complimentary goods, such as hats, mugs, and the like in attempt to both lure participants and potentially remind them of where they have been, what they may have been interested in, in the hope that the participant might make an effort to communicate with the provider after the event. Such methods generally do not provide the vendor any way to push information to former participants, nor to these goods generally allow the vendor or activity provider a method for easily tracking activity of a former participant that is directly attributable to their participation in the event. In some cases, vendors and activity providers have tried to address this shortcoming, in part, by providing smart materials, such as USB memory sticks that include information about the vendor or activity provider. Such an approach continues to rely on the participant retaining the USB stick and making the effort to use the device with the participant's computer after the conclusion of the event. In addition, this approach is not conducive to working with mobile devices, which generally lack USB interfaces.

A recent strategy used to try to address the proliferation of mobile smart devices is the Quick Response Code (QR Code). A QR code is a type of matrix barcode containing information about the item to which it is attached. A QR code consists of black modules (square dots) arranged in a square grid on a white background, which can be read by an imaging device (such as a camera) and processed using Reed-Solomon error correction until the image can be appropriately interpreted. The data is then extracted from patterns present in both horizontal and vertical components of the image. QR codes have been used to display text to users, open Uniform Resource Locators (URL), and compose e-mails and text messages.

For a participant to engage with a QR code, the participant generally needs to retrieve their mobile device, bring up the image capture interface, get close enough to the QR code to take a picture, position the camera in a still position, then take the picture of the QR code. In addition, this will generally do little more than direct their mobile device to do something, such as forwarding the participant to a web site or sending an email to the vendor or activity provider. Such an approach generally fails to provide an easily accessible history to the participant of vendors and activities where the participant interacted with a QR code. In addition, this tends to be a one-way transient engagement, such as the sending of an email or the spawning of web locations. This technology generally fails to provide a persistent, trackable interface for participants to interact with vendors and activity providers after the conclusion of the event, and the reliance on mobile device operation is a disincentive for the participant to collect QR codes. As such, subsequent engagement may be significantly limited.

### SUMMARY OF SOME ASPECTS OF THE APPLICATION

The applicants believe that they have discovered the at least some of the problems with existing interest collection and analysis systems and methods explained above. The applicants have therefore invented improved interest collection and analysis systems and methods, and aspects of them, disclosed in this specification interest collection and analysis.

In some embodiments, the interest collection system includes one or more wireless communication technologies such as Radio Frequency Identification (RFID) tags, Near Field Communication (NFC) tags, Bluetooth communication signals, and other one-way or two-way technologies. These technologies can be used to wirelessly interact with reader devices at event locations such that certain types of interactions are interpreted as one or more of participant interest, preference, and participation.

In some embodiments, participants can indicate their interest in a particular location, activity, or physical asset by engaging with receiving devices such as, for example, an NFC reader kiosk or an NFC-enabled mobile device. Engagement activities can include actions such as tapping a wireless communication technology tag (also referred to as a wireless interest indication device) one or more times on or near one or more tag readers to indicate interest, a degree of interest, or both, detecting a specific interaction with a site device, detecting the exceeding of a threshold time period in a given location or area, and the like. In some implementations, an increase in the number of taps is associated with an increased level of participant interest. In some implementations, interest indication can be accomplished by detection of a participant's tag and receiving subsequent participant selections through an external interface such as a touch screen display.

In certain instances a tap event at, a location, activity, or physical asset is associated with a pre-defined URL or with a placeholder for a later-defined URL. At the time a participant engages with the reader associated with the location, activity, or physical asset in a manner defined as indicative of participant interest, the associated URL at the time of interest indication can be added to the participants personal portal. In some cases, the URL includes tracking information to identify that the participant has clicked on the URL generated by an interest indication event. In other cases, the participant portal implements one or more tracking technologies to capture when a participants clicks on a URL. The tracking of post-event activity associated with URL's generated by interest indication events can be used, at least in part, to generate interest and activity reports. In some implementations, reports and other information for one or more events are made available to vendors or activity providers at a secure vendor portal. The availability of such reports can provide vendors and activity providers with information relating to the timing and amount of subsequent participant activity directly associated with attendance at the event long after the conclusion of the event itself. For example, a participant at a rare book convention that expressed a high level of interest in a particular collector of a particular author could, months or years later, return to their portal and look for the collector's URL, without having to remember the specific name or location of the collector during the interim between the event and the subsequent time of follow up.

In some embodiments, a participant portal unique to a participant provides real-time and historical event information, interest indication information, or both. The unique participant portals can, for example, be implemented as unique URL specific to the participant and requiring access authentication. The portal can be implemented as a series of event-associated tabs, as an aggregated view, or both. Certain implementations present the participant's portal to the participant when the participant taps a wireless tag associated with the participant to enabled mobile devices, such as, for example, an NFC-enabled phone. In some instances, the tap will spawn a browser instance on the mobile device displaying the participant's portal. In other instances, a native device app instance will be initiated and the participant's portal displayed. In certain cases, tapping the tag to the wireless enabled device presents the participant with the option to include the event, subsequent event activities, or both to the participant's event stream. The event stream can be designated as publicly accessible, accessible to authorized individuals, or private. Attendees may choose to link together some or all of the events they have attended, making the information of interest persistently available to the attendee at a single online location. Such a portal can provide persistent information access to attendees, can allow one or more of vendors, activity providers, and attendees continued engagement after the conclusion of an event, thus allowing for tracking of event attendee behaviors across multiple attendees and multiple events.

In some embodiments, one or more gamification features are used to entice engagement activities. For example, a participant can accumulate points for tap events where points are redeemable for vouchers. In another example, an interest tap event at a particular event or location can submit a stamp to the participant's profile or event stream. In some instances, participant virtual assets may include a passport where the occurrence of certain interest indication events generates a stamp in the participant's passport. In certain cases, a passport may be associated with a particular event. These event passports may be offered for sale in advance or at the time of the event. An event passport can include, for example, offers that encourage engagement activities. For example, a passport may include a pre-defined offer such as a “buy 4, get one free” offer where the participant taps the reader associated with the purchase in a manner that indicates a purchase event occurred. Upon detection of the required number of purchase events, a voucher can be associated with the participant's wireless tag such that the participant may redeem the voucher at a vendor or location.

The participant, in certain cases, may engage with a vendor or location by interacting with external devices, such as a touch screen displays. A participant can, for example, tap their wireless tag to a wireless tag reader device communicatively coupled to a computing device. The computing device can include an interactive display, such as a touch screen display, where the participant may identify items of interest shown on the display. These selection events can be included in the participant's event stream, stored in a database, or both.

In certain implementations, the purchase of the event passport is initiated by a tap event at a passport associated wireless reader device. Upon detection of the tap event, an email, SMS message, or the like can be sent to the participant's wireless mobile device that includes an activation link. Upon detection of a click event associated with the activation link, the system can activate the passport, and in some instances, can associate rewards, vouchers, or both with the activated passport.

In some instances, the interest collection and analysis system may include a continuing education module for tracking attendance and collecting participant interest. A tap event, wireless tag reading event, Bluetooth detection event, or the like can occur at a reader device, such as a kiosk, upon entering a course event. All entrance and exit events can be logged and transmitted to the education module. Continuing education credit based on, for example, attendance time, can be allocated based on calculations of participant's time in the course. In some instances, tap events at the culmination of an event can indicate interest in obtaining follow-up information or materials from the course provider, whether a participant liked a the course, or both. The participant's portal can include a log of attended courses, along with credits obtained, instructor information, the participant's level of satisfaction with the course, and the like. Participants can use this information to report course attendance, plan future course registration, and the like.

In some embodiments, the system includes a staff module, an equipment management module, or both. Event staffs are generally tasked with roles and responsibilities. These roles and responsibilities, in part, determine applicable system privileges. Theses system privileges may be augmented or limited based on a location or station check in within the event. For example, when a staff person is assigned a role as an event entry worker, they may have certain privileges assigned that are applicable to all event entry workers. If that worker then takes a position at a main entrance gate, the system can detect that they are at a main location where limited system privileges are available, such as, for example, no voucher redemption. The device used by the staff person may then dynamically alter available features and function such that the staff person can no longer redeem participant vouchers.

In addition, in some implementations, the staff and equipment modules track when a staff member arrives at, is active at, or leaves a location or station. Having a record of who is using a device and at what station a device is presently in use can provide the event coordinator with a real time and historical record of equipment possession, location, and level of use. In some instances, one or more of a tap event, location services detection, RFID detection, and Bluetooth communication inform the system of device location in relation to an event location or station.

In some embodiments, upon detection of a tap event associated with a participant's tag, the mobile device displays authorized areas the participant may enter. Other features and functions that can be made available to staff person include, for example, the ability to upgrade access level, add vouchers, replace and activate credentials, and deactivate lost or damaged credentials.

In some implementations, the interest collection and tracking system is integrated with a CRM system, such as for example, Salesforce.com®. An attendee can initiate an interest event at an exhibitor that then populates the participant's portal with a tracked exhibitor-related URL for the event. When the attendee visits the destination of the tracked link, the depth and detail of the attendee navigation can be collected, and the information can be provided to the exhibitor. In certain instances, the information is provided to the exhibitor indirectly through publication to the exhibitor portal, through an exhibitor report, or both. In other instances, the information is used to directly create a ranked lead and/or opportunity record in the vendor's CRM system.

There are other problem solutions and other novel aspects of embodiments disclosed in this application. They will become apparent as the specification proceeds. In this regard, this disclosure is not to be limited to subject matter that addresses one or more issues identified in the Background or includes a feature or aspect of this Brief Summary.

### BRIEF DESCRIPTION OF THE DRAWINGS

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label. The applicants' preferred and other embodiments are disclosed in conjunction with the following Figures in which:

FIG. 1A is a is a computer network or similar digital processing environment in which a portion of the interest collection and tracking system can be implemented;

FIG. 1B is a block diagram of an application architecture of the interest collection and tracking system of FIG. 1A;

FIG. 2 is a schematic floor plan diagram for deployment and operation of the interest collection and tracking system of FIG. 1A;

FIG. 3 is a schematic block diagram of one embodiment of an electronic configuration for one or more of the computer devices of FIG. 1A;

FIG. 4 is a schematic block diagram of one embodiment of an electronic configuration for one or more of the mobile devices of FIG. 1A;

FIG. 5 is an application layer diagram of the interest collection and tracking system of FIG. 1A;

FIG. 6 is an entity relationship diagram based on an underlying relational data model of the databases of FIG. 5;

FIG. 7 is a block diagram of one example of component architecture for a credential reader device and a interest collection and tracking system server device in the networked environment of FIG. 1A;

FIG. 8A and FIG. 8B are a flow diagram of a computer-implemented interest collection process of the interest collection and tracking system of FIG. 1A;

FIG. 9A and FIG. 9B are a flow diagram of a computer-implemented presentation attendance process of the interest collection and tracking system of FIG. 1A;

FIG. 10A and FIG. 10B are a flow diagram of a computer-implemented access control process of the interest collection and tracking system of FIG. 1A;

FIG. 11A and FIG. 11B are a flow diagram of a computer-implemented equipment management process of the interest collection and tracking system of FIG. 1A;

FIG. 12A and FIG. 12B are a flow diagram of a computer-implemented pre-registration activation process of the interest collection and tracking system of FIG. 1A;

FIG. 13A and FIG. 13B are a flow diagram of a computer-implemented registration activation process of the interest collection and tracking system of FIG. 1A;

FIG. 14 is a flow diagram of a computer-implemented credential pickup process of the interest collection and tracking system of FIG. 1A;

FIG. 15A and FIG. 15B are a flow diagram of a computer-implemented ticket holder credential activation process of the interest collection and tracking system of FIG. 1A;

FIG. 16 is a flow diagram of a computer-implemented voucher redemption process of the interest collection and tracking system of FIG. 1A;

FIG. 17 is a flow diagram of a computer-implemented interest detection process of the interest collection and tracking system of FIG. 1A;

FIG. 18 is a flow diagram of a computer-implemented interest publication process of the interest collection and tracking system of FIG. 1A;

FIG. 19 is a flow diagram of a computer-implemented event stream privacy configuration process of the interest collection and tracking system of FIG. 1A;

FIG. 20 is a flow diagram of a computer-implemented passport configuration and update process of the interest collection and tracking system of FIG. 1A;

FIG. 21 is a flow diagram of a computer-implemented continuing education configuration process of the interest collection and tracking system of FIG. 1A;

FIG. 22 is a screen capture of a login interface displayed by the administration application of the interest collection and tracking system of FIG. 1A;

FIG. 23 is a screen capture of a main interface displayed by the administration application of the interest collection and tracking system of FIG. 1A;

FIG. 24 is a screen capture of an event configuration selection menu interface displayed by the administration application on the main interface of FIG. 23;

FIG. 25 is a screen capture of a registration selection menu interface displayed by the administration application on the main interface of FIG. 23;

FIG. 26 is a screen capture of a user settings selection menu interface displayed by the administration application on the main interface of FIG. 23;

FIG. 27 is a screen capture of a statistics selection menu interface displayed by the administration application on the main interface of FIG. 23;

FIG. 28 is a screen capture of a settings selection menu interface displayed by the administration application on the main interface of FIG. 23;

FIG. 29 is a screen capture of an area details interface displayed by the administration application of the interest collection and tracking system of FIG. 1A;

FIG. 30A and FIG. 30B are screen captures of an area functions interface displayed by the administration application of the interest collection and tracking system of FIG. 1A;

FIG. 31 is a screen capture of an area access points interface displayed by the administration application of the interest collection and tracking system of FIG. 1A;

FIG. 32 is a screen capture of an area schedules interface displayed by the administration application of the interest collection and tracking system of FIG. 1A;

FIG. 33 is a screen capture of an area captions interface displayed by the administration application of the interest collection and tracking system of FIG. 1A;

FIG. 34 is a screen capture of a credentials configuration interface displayed by the administration application of the interest collection and tracking system of FIG. 1A;

FIG. 35 is a screen capture of a voucher configuration interface displayed by the administration application of the interest collection and tracking system of FIG. 1A;

FIG. 36 is a screen capture of an equipment configuration interface displayed by the administration application of the interest collection and tracking system of FIG. 1A;

FIG. 37 is a screen capture of data load interface displayed by the administration application of the interest collection and tracking system of FIG. 1A;

FIG. 38 is a screen capture of a shop data load interface displayed by the administration application of the interest collection and tracking system of FIG. 1A;

FIG. 39 is a screen capture of a main summary interface displayed by the administration application of the interest collection and tracking system of FIG. 1A;

FIG. 40 is a screen capture of an area and schedules summary view displayed by the administration application of the interest collection and tracking system of FIG. 1A;

FIG. 41 is a screen capture of a credentials summary view displayed by the administration application of the interest collection and tracking system of FIG. 1A;

FIG. 42 is a screen capture of a vouchers summary view displayed by the administration application of the interest collection and tracking system of FIG. 1A;

FIG. 43 is a screen capture of an equipment summary view displayed by the administration application of the interest collection and tracking system of FIG. 1A;

FIG. 44 is a screen capture of a branding summary view displayed by the administration application of the interest collection and tracking system of FIG. 1A;

FIG. 45 is a screen capture of a social media settings summary view displayed by the administration application of the interest collection and tracking system of FIG. 1A;

FIG. 46 is a screen capture of a check in settings summary view displayed by the administration application of the interest collection and tracking system of FIG. 1A;

FIG. 47 is a screen capture of a branding configuration interface displayed by the administration application of the interest collection and tracking system of FIG. 1A;

FIG. 48 is a screen capture of an organizations configuration interface displayed by the administration application of the interest collection and tracking system of FIG. 1A;

FIG. 49 is a screen capture of a crew configuration interface displayed by the administration application of the interest collection and tracking system of FIG. 1A;

FIG. 50 is a screen capture of an attendee configuration interface displayed by the administration application of the interest collection and tracking system of FIG. 1A;

FIG. 51 is a screen capture of a maintenance configuration interface displayed by the administration application of the interest collection and tracking system of FIG. 1A;

FIG. 52 is a screen capture of a password configuration interface displayed by the administration application of the interest collection and tracking system of FIG. 1A;

FIG. 53A, 53B, and FIG. 53C are screen captures of a statistical dashboard interface displayed by the administration application of the interest collection and tracking system of FIG. 1A;

FIG. 54 is a screen capture of a gallery displayed by the administration application of the interest collection and tracking system of FIG. 1A;

FIG. 55A, 55B, and FIG. 55C are screen captures of a snapshot view displayed by the administration application of the interest collection and tracking system of FIG. 1A;

FIG. 56 is a screen capture of a social media participation incentive configuration interface displayed by the administration application of the interest collection and tracking system of FIG. 1A;

FIG. 57 is a screen capture of a check in notification configuration interface displayed by the administration application of the interest collection and tracking system of FIG. 1A;

FIG. 58A and FIG. 58B are screen captures of example voucher status views displayed on the event dashboard of the interest collection and tracking system of FIG. 1A;

FIG. 59A and FIG. 59B are screen captures of example voting status views displayed on the event dashboard of the interest collection and tracking system of FIG. 1A;

FIGS. 60A and 60B are screen captures of example photo share statistics views displayed on the event dashboard of the interest collection and tracking system of FIG. 1A;

FIG. 61 is a screen capture of an access control status view displayed on the event dashboard of the interest collection and tracking system of FIG. 1A;

FIG. 62 is a screen capture of check in status view displayed on the event dashboard of the interest collection and tracking system of FIG. 1A;

FIG. 63 is a screen capture of home view displayed on user portal of the interest collection and tracking system of FIG. 1A;

FIG. 64 is a screen capture of photo menu selection interface displayed on the home view of FIG. 63;

FIG. 65 is a screen capture of a my event photos view displayed on user portal of the interest collection and tracking system of FIG. 1A;

FIG. 66 is a screen capture of an all event photos view displayed on user portal of the interest collection and tracking system of FIG. 1A;

FIG. 67 is a screen capture of a Login View of a site device of FIG. 2;

FIG. 68 is a screen capture of an unlocked Home View of a site device of FIG. 2;

FIG. 69 is a screen capture of an Attendee Credential Activation Start View of a site device of FIG. 2;

FIG. 70 is a screen capture of an Attendee Credential Activation Organization Search View of a site device of FIG. 2;

FIG. 71A is a screen capture of an Attendee Credential Activation Organization Search Results View of a site device of FIG. 2;

FIG. 71B is a screen capture of another Attendee Credential Activation Organization Search Results View of a site device of FIG. 2;

FIG. 71C is a screen capture of another Attendee Credential Activation Organization Search Results View of a site device of FIG. 2;

FIG. 72 is a screen capture of a Credential Activation View of a site device of FIG. 2;

FIG. 73 is a screen capture of a Manual Credential Activation Prompt of a site device of FIG. 2;

FIG. 74 is a screen capture of a Credential Activation Tap View of a site device of FIG. 2;

FIG. 75 is a screen capture of a Credential Test Start View of a site device of FIG. 2;

FIG. 76 is a screen capture of a Credential Test Results View of an activated site device of FIG. 2;

FIG. 77 is a screen capture of a Credential Activation Activated View of a site device of FIG. 2;

FIG. 78 is a screen capture of another Credential Activation Activated View of a site device of FIG. 2;

FIG. 79 is a screen capture of a Credential Test Results View of a damaged site device of FIG. 2;

FIG. 80 is a screen capture of a Feature Exit View of a site device of FIG. 2;

FIG. 81 is a screen capture of a Worker Credential Activation Start View of a site device of FIG. 2;

FIG. 82 is a screen capture of a Worker Credential Activation Organization Search View of a site device of FIG. 2;

FIG. 83 is a screen capture of another Worker Credential Activation Organization Search Results View of a site device of FIG. 2;

FIG. 84 is a screen capture of another Worker Credential Activation Organization Search Results View of a site device of FIG. 2;

FIG. 85 is a screen capture of another Worker Credential Activation Organization Search Results View of a site device of FIG. 2;

FIG. 86 is a screen capture of a Credential Activation Selection View of a site device of FIG. 2;

FIG. 87 is a screen capture of a Check In Start View of a site device of FIG. 2;

FIG. 88 is a screen capture of a Check In Tap View of a site device of FIG. 2;

FIG. 89 is a screen capture of a Check In Welcome View of a site device of FIG. 2;

FIG. 90 is a screen capture of an Access Control Start View of a site device of FIG. 2;

FIG. 91 is a screen capture of an Unauthorized Message View of a site device of FIG. 2;

FIG. 92 is a screen capture of an Access Control Tap Credential View of a site device of FIG. 2;

FIG. 93 is a screen capture of an Access Control Access Denied View of a site device of FIG. 2;

FIG. 94 is a screen capture of an Access Control Authorized Areas Listing View of a site device of FIG. 2;

FIG. 95 is a screen capture of an Access Control Lost Credential View of a site device of FIG. 2;

FIG. 96 is a screen capture of an Access Control Access Allowed View of a site device of FIG. 2;

FIG. 97 is a screen capture of another Access Control Authorized Areas Listing View of a site device of FIG. 2;

FIG. 98 is a screen capture of another Access Control Tap View of a site device of FIG. 2;

FIG. 99 is a screen capture of an Access Control Tap Credential View of a site device of FIG. 2;

FIG. 100 is a screen capture of another Access Control Access Allowed View of a site device of FIG. 2;

FIG. 101 is a screen capture of another Access Control Authorized Areas Listing View of a site device of FIG. 2;

FIG. 102 is a screen capture of another Credential Test Start View of a site device of FIG. 2;

FIG. 103 is a screen capture of another Credential Test Results View of a site device of FIG. 2 for an activated credential;

FIG. 104 is a screen capture of a Credential Test Results View of a site device of FIG. 2 for a damaged credential;

FIG. 105 is a screen capture of a Credential Test Results View of a site device of FIG. 2 for an inactivated credential;

FIG. 106 is a screen capture of a Credential Test Results View of a site device of FIG. 2 for an unactivated credential;

FIG. 107 is a screen capture of a Voucher Redemption Start View of a site device of FIG. 2;

FIG. 108 is a screen capture of a Voucher Redemption Available Vouchers Selection View of a site device of FIG. 2;

FIG. 109 is a screen capture of a Voucher Redemption Selected Vouchers View of a site device of FIG. 2;

FIG. 110 is a screen capture of a Voucher Redemption Redeemed Voucher View of a site device of FIG. 2;

FIG. 111 is a screen capture of a Voucher Redemption Voucher History View of a site device of FIG. 2;

FIG. 112 is a screen capture of a Voucher Redemption No Vouchers Available View of a site device of FIG. 2;

FIG. 113 is a screen capture of another Voucher Redemption Voucher History View of a site device of FIG. 2;

FIG. 114 is a screen capture of a Voucher Redemption No Voucher Type Available View of a site device of FIG. 2;

FIG. 115 is a screen capture of a Voucher Redemption Voucher Type List View of a site device of FIG. 2;

FIG. 116 is a screen capture of a Voucher Redemption View of a site device of FIG. 2 for a damaged credential;

FIG. 117 is a screen capture of a Photo Gallery View of a site device of FIG. 2;

FIG. 118 is a screen capture of a Selected Photo View of a site device of FIG. 2;

FIG. 119 is a screen capture of a Selected Photo Menu Options View of a site device of FIG. 2;

FIG. 120 is a screen capture of an Edited Photo View of a site device of FIG. 2;

FIG. 121 is a screen capture of a Saved Photo View of a site device of FIG. 2;

FIG. 122 is a screen capture of an Area Specific Photo Caption Selection View of a site device of FIG. 2;

FIG. 123 is a screen capture of an Area Specific Selected Photo Caption View of a site device of FIG. 2;

FIG. 124 is a screen capture of a Photo Capture View of a site device of FIG. 2;

FIG. 125 is a screen capture of a Save/Discard Photo View of a site device of FIG. 2;

FIG. 126 is a screen capture of a Captioned Photo View of a site device of FIG. 2;

FIG. 127 is a screen capture of another Edited Photo View of a site device of FIG. 2;

FIG. 128 is a screen capture of a Model Release Acceptance Prompt of a site device of FIG. 2;

FIG. 129 is a screen capture of a Model Release Refused Acceptance Message of a site device of FIG. 2;

FIG. 130 is a screen capture of a Pre-Posting Credential Tap Prompt Message of a site device of FIG. 2;

FIG. 131 is a screen capture of a Pre-Posting Multi-Destination View of a site device of FIG. 2;

FIG. 132 is a screen capture of a Forgot To Upload Prompt of a site device of FIG. 2;

FIG. 133 is a screen capture of a Post-Posting Confirmation View of a site device of FIG. 2;

FIG. 134 is a screen capture of an Attendee Registration Organization Selection View of a site device of FIG. 2;

FIG. 135 is a screen capture of an Attendee Registration Attendee Selection View of a site device of FIG. 2;

FIG. 136 is a screen capture of an Attendee Registration Manual Data Entry View of a site device of FIG. 2;

FIG. 137 is a screen capture of another Attendee Registration Manual Data Entry View of a site device of FIG. 2;

FIG. 138 is a screen capture of another Attendee Registration Manual Data Entry View of a site device of FIG. 2;

FIG. 139 is a screen capture of another Attendee Registration Manual Data Entry View of a site device of FIG. 2;

FIG. 140 is a screen capture of an Attendee Registration Credential Issuance View of a site device of FIG. 2;

FIG. 141 is a screen capture of another Attendee Registration Credential Issuance View of a site device of FIG. 2;

FIG. 142 is a screen capture of another Attendee Registration Credential Upgrade Prompt of a site device of FIG. 2;

FIG. 143 is a screen capture of a Post-Upgrade Attendee Registration View of a site device of FIG. 2;

FIG. 144 is a screen capture of a Saved Post-Upgrade Attendee Registration View of a site device of FIG. 2;

FIG. 145 is a screen capture of an Attendee Registration Upgrade Prompt of a site device of FIG. 2;

FIG. 146 is a screen capture of another Manual Credential Activation Prompt of a site device of FIG. 2;

FIG. 147 is a screen capture of an In-Process Credential Activation Upgrade View of a site device of FIG. 2;

FIG. 148 is a screen capture of a Credential Test Start View of a site device of FIG. 2;

FIG. 149 is a screen capture of a Credential Test Results View of a site device of FIG. 2 for an issued credential;

FIG. 150 is a screen capture of an Attendee Registration Voucher and Reward Edit View of a site device of FIG. 2;

FIG. 151 is a screen capture of a Worker Registration Organization Selection View of a site device of FIG. 2;

FIG. 152 is a screen capture of a Worker Registration Manual Data Entry View of a site device of FIG. 2;

FIG. 153 is a screen capture of another Worker Registration Manual Data Entry View of a site device of FIG. 2;

FIG. 154 is a screen capture of another Worker Registration Manual Data Entry View of a site device of FIG. 2;

FIG. 155 is a screen capture of a Worker Registration Credential Issuance View of a site device of FIG. 2;

FIG. 156 is a screen capture of a Worker Registration Voucher and Reward Edit View of a site device of FIG. 2;

FIG. 157 is a screen capture of a Worker Credential Activation Access Level Selection View of a site device of FIG. 2;

FIG. 158 is a screen capture of a Worker Credential Activation Access Level Tap Credential View of a site device of FIG. 2;

FIG. 159 is a screen capture of a Utilities Start View of a site device of FIG. 2;

FIG. 160 is a screen capture of an Access Points Selection View of a site device of FIG. 2;

FIG. 161 is a screen capture of an Access Points Site View of a site device of FIG. 2;

FIG. 162 is a screen capture of another Access Points Site View of a site device of FIG. 2;

FIG. 163 is a screen capture of an Access Points Overwrite Prompt of a site device of FIG. 2;

FIG. 164 is a screen capture of an Access Points Tap Sign View of a site device of FIG. 2;

FIG. 165 is a screen capture of an Access Points Invalid Sign View of a site device of FIG. 2;

FIG. 166 is a screen capture of an Access Points Sign Registration Confirmation View of a site device of FIG. 2;

FIG. 167 is a screen capture of a Voucher Reset Selection View of a site device of FIG. 2;

FIG. 168 is a screen capture of another Voucher Reset Selection View of a site device of FIG. 2;

FIG. 169 is a screen capture of a Voucher Reset Tap Credential View of a site device of FIG. 2;

FIG. 170 is a screen capture of a Voucher Reset Confirmation Prompt of a site device of FIG. 2;

FIG. 171 is a screen capture of a Voucher Not Reset Confirmation of a site device of FIG. 2;

FIG. 172 is a screen capture of a Voucher Reset Confirmation Prompt of a site device of FIG. 2;

FIG. 173 is a screen capture of a Credential Test Start View of a site device of FIG. 2;

FIG. 174 is a screen capture of a Credential Test Result View of a site device of FIG. 2;

FIG. 175 is a screen capture of a Credential Reset Tap Credential View of a site device of FIG. 2;

FIG. 176 is a screen capture of a Credential Reset Confirmation Message of a site device of FIG. 2;

FIG. 177 is a screen capture of a Photo Tracker Gallery View of a site device of FIG. 2;

FIG. 178 is a screen capture of a Photo Tracker View of a site device of FIG. 2 for a selected photo;

FIG. 179 is a screen capture of another Photo Tracker View of a site device of FIG. 2 for a selected photo;

FIG. 180 is a screen capture of a Photo Share Reset Tap Credential View of a site device of FIG. 2;

FIG. 181 is a screen capture of a Photo Share Reset Selection View of a site device of FIG. 2;

FIG. 182 is a screen capture of a Photo Share Reset Confirmation View of a site device of FIG. 2;

FIG. 183 is a screen capture of another Photo Share Reset Confirmation View of a site device of FIG. 2;

FIG. 184 is a screen capture of the Home View of a site device of FIG. 2 configured as a voucher redemption device;

FIG. 185 is a screen capture of the Home View of a site device of FIG. 2 configured as a check in and access control device;

FIG. 186 is a screen capture of the Home View of a site device of FIG. 2 configured as an attendee activation and registration device;

FIG. 187 is a screen capture of the Home View of a site device of FIG. 2 configured as photo capture and photo share device;

FIG. 188 is a screen capture of the Home View of a site device of FIG. 2 configured as a check in device;

FIG. 189 is a screen capture of the Home View of a site device of FIG. 2 configured as an all functions device;

FIG. 190 is a screen capture of the Home View of a site device of FIG. 2 configured as an worker activation and registration device;

FIG. 191 is a screen capture of the Home View of a site device of FIG. 2 configured as an attendee and worker registration device;

### DETAILED DESCRIPTION

This disclosure is directed to interest collection and tracking systems and methods of use of such systems. Changes may be made in the function and arrangement of elements discussed without departing from the spirit and scope of the disclosure. Various embodiments may omit, substitute, or add various procedures or components as appropriate. For instance, the methods disclosed may be performed in an order different from that described, and various steps may be added, omitted, or combined. Also, features disclosed with respect to certain embodiments may be combined in or with other embodiments as well as features of other embodiments.

Certain embodiments of the interest collection and tracking systems and methods are described with reference to methods, apparatus (systems), and computer programs that can be implemented by computer program instructions. These computer program instructions can be provided to a processor of a general purpose computer, special purpose computer, mobile computing device, or other programmable data processing apparatus to produce a machine, such that the instructions, which execute via the processor of the computer or other programmable data processing apparatus, create means for implementing the acts specified herein to transform data from a first state to a second state.

These computer program instructions can be stored in a computer-readable memory that can direct a computer or other programmable data processing apparatus to operate in a particular manner, such that the instructions stored in the computer-readable memory produce an article of manufacture including instruction means which implement the acts specified herein. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the acts specified herein.

The various illustrative logical blocks, modules, and algorithm steps described in connection with the embodiments disclosed herein can be implemented as electronic hardware, computer software, or combinations of both. To illustrate this interchangeability of hardware and software, various illustrative components, blocks, modules, and steps have been described generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices such as, for example, a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a computer terminal In the alternative, the processor and the storage medium can reside as discrete components in a computer terminal.

Depending on the embodiment, certain acts, events, or functions of any of the methods described herein can be performed in a different sequence, can be added, merged, or left out altogether (e.g., not all described acts or events are necessary for the practice of the method). Moreover, in certain embodiments, acts or events can be performed concurrently such as, for example, through multi-threaded processing, interrupt processing, or multiple processors or processor cores, rather than sequentially. Moreover, in certain embodiments, acts or events can be performed on alternate tiers within the architecture.

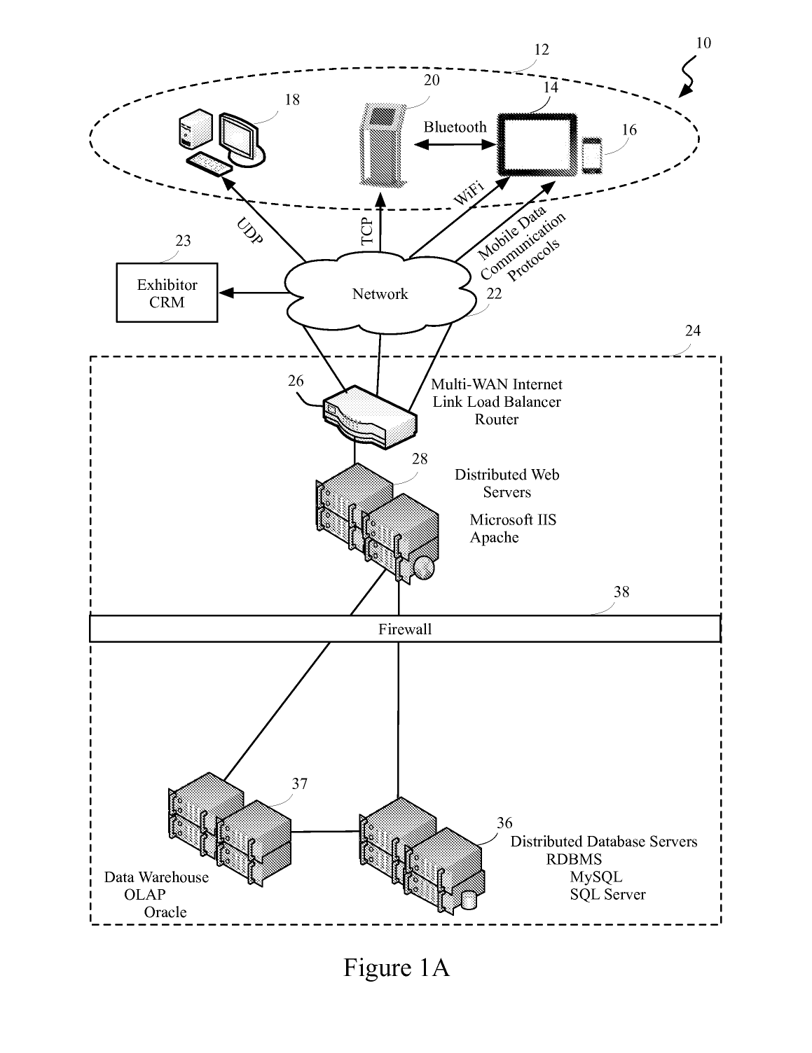

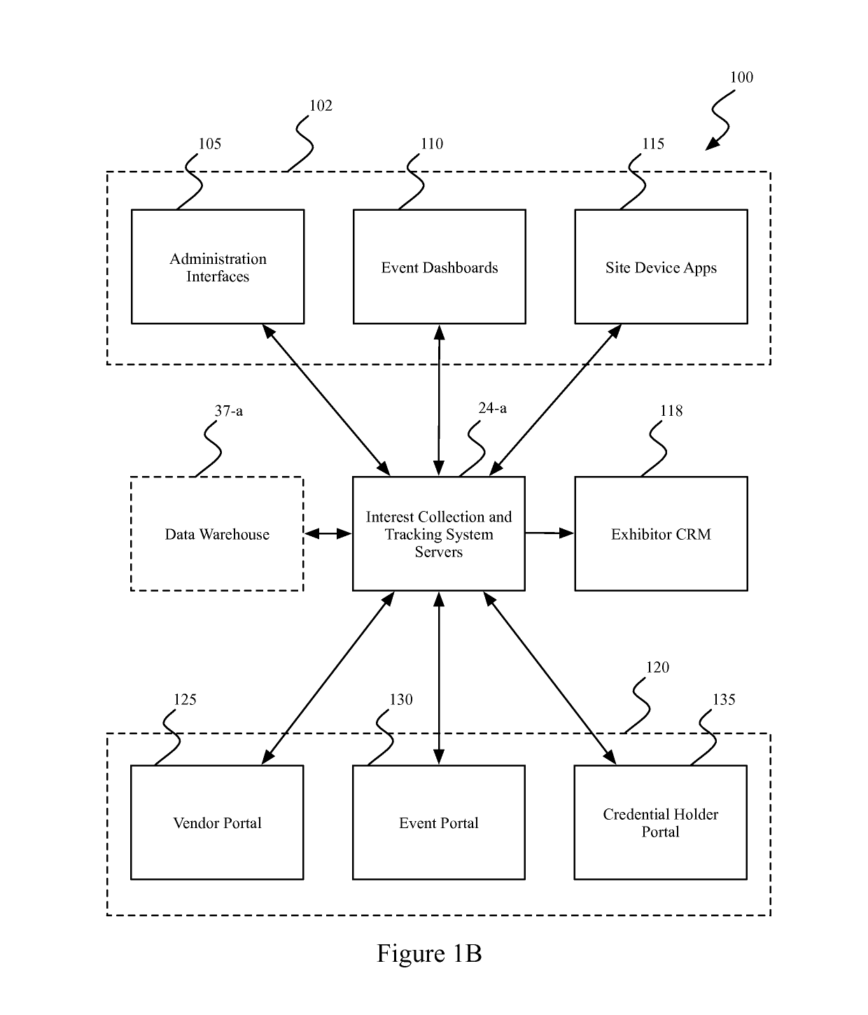

FIG. 1A is representative of many specific computing arrangements that can support the system and method disclosed. In one embodiment, the software implementing the interest collection and tracking system runs in the Windows® environment. In another embodiment, the software is implemented to run in other environments, such as Linux®, UNIX®, or in any hardware having enough power to support timely operation of software such as that identified in FIG. 1A. In some implementations of the interest collection and tracking system, the Windows® Server 2008 R2 server operating system is deployed on one or more server computers 24. In an alternate embodiment, one or more computers are deployed as virtual instances rather than physical computers.

A load balancing router 26, such as for example, the Peplink® Multi Wan Router can distribute traffic inside a firewall 38 to and from web server computers 28. In some deployments, these webservers 28 are distributed instances of a Windows® IIS web server. A data warehouse server 37 may be communicatively coupled to one or more of the web servers 28, database servers 36, or both. In some deployments, the web servers 32 are running instances of an application servers such as, or example, Windows® IIS web server, the Windows®.NET framework, or both. The web servers 28 are communicatively coupled to computers 36 hosting one or more persistent data stores. These data stores can be distributed databases such as, for example, Microsoft SQL Server® or MySQL® or the native operating system's file/folder structure.

Client computing devices of various types 12 can connect to a remote server infrastructure 24 via a network 22 over one or more communication protocols. All computers can pass information as unstructured data, structured files, structured data streams such as, for example, XML, structured data objects, such as JSON, and/or structured messages. Client computers and devices 14, 16, 18, 20 may communicate over various protocols such as, for example, UDP, TCP/IP and/or HTTP over TCP/IP. In some embodiments, web servers 28 communicate with third party systems, such as Exhibitor CRM systems 23, in some instances creating and or updating records or objects in the third party system.

Client computers and devices 14, 16, 18, 20 and server computers 24 provide processing, storage, and input/output devices executing application programs. Client computers and devices 12 can also be linked through communications network 22 to other computing devices, including other client devices/processes 12 and server computers 24. In some embodiments, server computers 37, 36 run software to implement centralized persistent data storage and retrieval. The network 22 can be a local area network and/or a wide area network that is part of a remote access network, a global network (e.g., the Internet), a worldwide collection of computers, and/or gateways that currently use respective protocols (TCP/IP, UDP, etc.) to communicate with one another. Multiple client computer devices 12 may each execute and operate instances of the applications accessing the interest collection and tacking system servers.

On reading this disclosure, those of skill in the art will recognize that many of the components discussed as separate units may be combined into one unit and an individual unit may be split into several different units. Further, the various functions could be contained in and/or performed on one computer or spread over several networked computers and/or devices. The identified components may be upgraded and replaced as associated technology improves and advances are made in computing technology.

Referring now to FIG. 1B, in some embodiments, the interest collection tracking system servers 24-a provide data to and application services for event-related applications 102, such as system and event administration interfaces 105, event dashboards 110, and site device apps 115. The interest collection tracking system servers 24-a can also serve user interfaces, data, and logic services for one or more portals, such as a vendor portal 125 targeted to event vendors, an event portal 130 targeted to event attendees, staff, and participants, and a user portal 135 targeted to credentialed attendee or worker. In some implementations, a data warehouse 37-a provides one or more of data services, analytical services, and reporting services to the interest collection tracking system servers 24-a. These services may provide processed information for presentation in on-demand reports, event dashboards 110, or one or more portals 125, 130, 135.

In some implementations, the interest collection tracking system servers 24-a can push leads to a third party system, such as an exhibitor CRM system 118. The following C# sample code is an example of how to create an opportunity in the Salesforce.com® CRM system and relate it to an existing account (e.g. a lead) using a custom external ID field named MyExtId_c. This creates an opportunity, sets the required fields, and then sets the opportunity external ID field to the account object that has only the external ID field specified. The code then creates the opportunity. Once the opportunity is created, the account (lead) will be its parent.

```
public void createLead( )
{
  try
  {
    Opportunity newOpportunity = new Opportunity( );
    newOpportunity.Name = “Opportunity”;
    newOpportunity.StageName = “Prospecting”;
    DateTime dt = (DateTime)binding.getServerTimestamp( ).timestamp;
    newOpportunity.CloseDate = dt.AddDays(7);
    newOpportunity.CloseDateSpecified = true;
    // Create the parent reference.
    // Used only for foreign key reference
    // and doesn't contain any other fields
    Account accountReference = new Account( );
    accountReference.MyExtId_c = “Access Event System”;
    newOpportunity.Account = accountReference;
    // Create the account and the opportunity
    SaveResult[ ] results = binding.create(new sObject[ ] {
                newOpportunity });
  }
  catch (SoapException e)
  {
    Console.WriteLine(“An unexpected error has occurred: ” +
                e.Message + “\n” + e.StackTrace);
  }
}
```

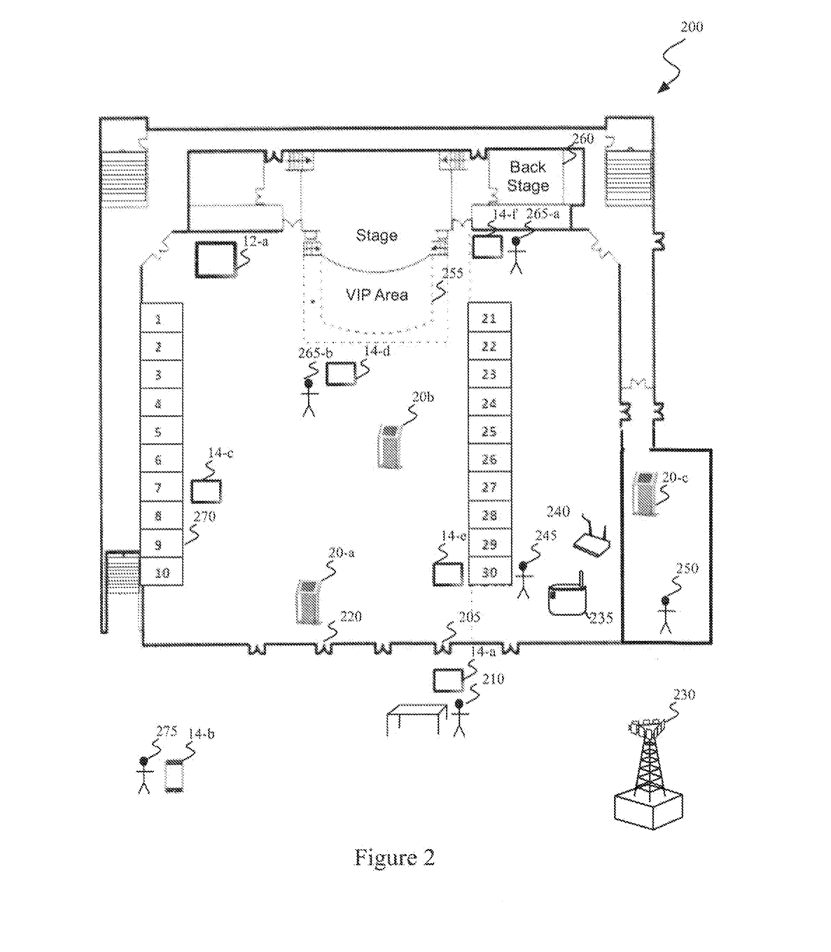

Referring now to FIG. 2, various mobile site devices, fixed location site devices, or both can be deployed at multiple locations at an event venue. These devices can control and track event participation, as well as collect and track participant interest in various event activities, vendors, assets, and the like, communicating the collected and tracked information to interest collection and tracking system servers 24. Event venues 200 often have a variety of activities, areas, vendors, and the like. In this example, individuals arrive at the event, approaching an entrance 205. An access control worker 210 may be controlling access to the event at the entrance 205 through various functions such as, for example, verifying credentials, checking in attendees, upgrading access levels, registering unregistered attendees, granting vouchers, awarding incentives, stamping virtual passports, and the like. A site device operated by the access control worker 14-a may be configured to specifically support one or more of these functions. Entrance times and other information related to the attendee may be transmitted to the interest collection and tracking system servers by the site device 14-a over one or more wireless networks, such as by connecting to a cellular network base station 230, a microcell 235, or a WiFi access point 240.

In some embodiments, a site device, such as a self-service kiosk 20-a, is located at one or more venue exits 220. An attendee may check out by, for example, tapping their credential to the kiosk 20-a, and in some instances, interacting with the kiosk prompts that are initiated by the tap event. The tap event and kiosk interactions can collect, for example, the time the attendee leaves the event, the attendee's level of enjoyment, the attendee's voting preference for one or more event elements, and the like. The attendee's time at the event can be calculated by, for example, calculating the difference between the arrival and departure time. The time at the event can be compared to a threshold time period and a level of interest in the event can be determined based on whether the time at the event exceeds the threshold time period value. This collected and calculated data can be transferred to the interest collection and tracking system servers, then subsequently used to populate one or more portals with data of interest to the portal user. For example, time at an event and enjoyment level can be made available on the exhibitor portal. Further, particular items, exhibits, or activities that received a high voting preference or other interest indications by an attendee can be used to generate tracked links of interest on the attendee's user portal.

While in the venue, an attendee or worker may interact with various aspects of the event. For example, and exhibitor 245 may be maintaining a booth with certain merchandise or materials of interest to attendees. A site device 14-c can be configured such that that an attendee, worker, or any valid credential holder can tap their credential to the site device 14-c and register their interest in the vendor. In addition, the site device 14-c can be configured to detect such things as multiple taps, duration of proximity to the device, or other pre-configured events indicative of interest. Further, the device can be configured to allow the credential holder to interact with the interface and indicate interest in particular materials or merchandise directly. This interest information can be stored on the site device 14-c, transmitted to the interest collection and tracking system servers 24, or both. In certain implementations, interest information and associated credential holder information is made available to the vendor at the vendor portal during the event, after the event, or both. In some instances, the interest indication information is used by the interest collection and tracking system servers 24 to automatically populate the attendee portal with associated vendor information. This information can include, for example, trackable links allowing the attendee and the vendor to interact after the conclusion of the event.

At some events, speaker involved activities, such as continuing education courses, may be offered. In some instances, a site device 20-c is deployed for attendees to check into and check out of an event. This can log attendance, as well as the time the attendee is physically in the activity. In some embodiments, upon detection of an interaction event such as a credential tap, the site device 20-c further engages the attendee with one or more survey questions, voting prompts, or the like. This information can be transmitted to the interest collection and tracking system servers 24, which can then update continuing education logs, transmit attendee information to the speaker 250, or the like.

At certain events, some areas are controlled as restricted access areas. For example, there may be VIP areas and back stage areas 260 that require special access credentials to be allowed in these areas. Access to restricted access areas may be monitored and controlled by workers 265-a, 265-b using site devices 14-f, 14-d. Attendees can tap their credentials to the devices 14-f, 14-d to determine if they have sufficient access to enter the area. In some implementations, an access upgrade function of an authorized site device can upgrade the access level associated with the active attendee's credential. In some instances, the upgrading of access is associated with the payment of a fee, indicating possible willingness and interest in premium services or areas. This interest information can be transmitted to the interest collection and tracking system servers 24, which can then populate one or more portals, such as the vendor portal, with upgrade statistics, area access statistics, specific attendee upgrades, and the like. Event providers may use this information to make future decisions and offers relating to access level areas and upgrade options.

At some events, vendors may offer vouchers for merchandise, services, or both. For example, a food vendor may offer a dinner voucher. This voucher may have been assigned to credential at the time of activation, during the event, as a reward or incentive, or by the vendor. The vendor location at the event, such as a vendor booth 270, may be issued a site device 14-c for the issuing, tracking, auditing, and redemption of vouchers associated with credentials. Further, in some instances, the site device 14-c can award vouchers for the vendor or other vendors based on the type and frequency of engagement with one or more vendors or activities at the event. Information related to the issuance and redemption of vouchers can be transmitted to the interest collection and tracking system servers 24, which can then populate one or more portals, such as the vendor portal, with voucher-related statistics and derived attendee interest information.

Interactive interest indication devices 12-a can be positioned at one or more locations at an event venue to collect interest information from attendees. For example, a large interactive display can allow attendees to vote on displayed items, such as posters, bands, and the like. In some implementations, the attendee taps their credentials before submitting interest selections. Information about the attendee and their associated interest selections can be transmitted to the interest collection and tracking system servers 24. This information can be used to populate, for example, an at-event public dashboard, private event organizer dashboard, or both.

Upon leaving an event, attendees can access information relating to their activities and interests at the event via an event portal, a attendee portal, or both. The attendee portal can maintain information associated with the various interest indicating activities and make this information available to the attendee persistently. In some instances, a browser-based portal, a portal app, or both are delivered to the mobile device 14-b of the attendee 275. In certain instances, tapping the attendee's credential to a tap-enabled mobile device, such as an NFC-enabled phone, will automatically initiate the portal app and take the user to the event associated with the credential.

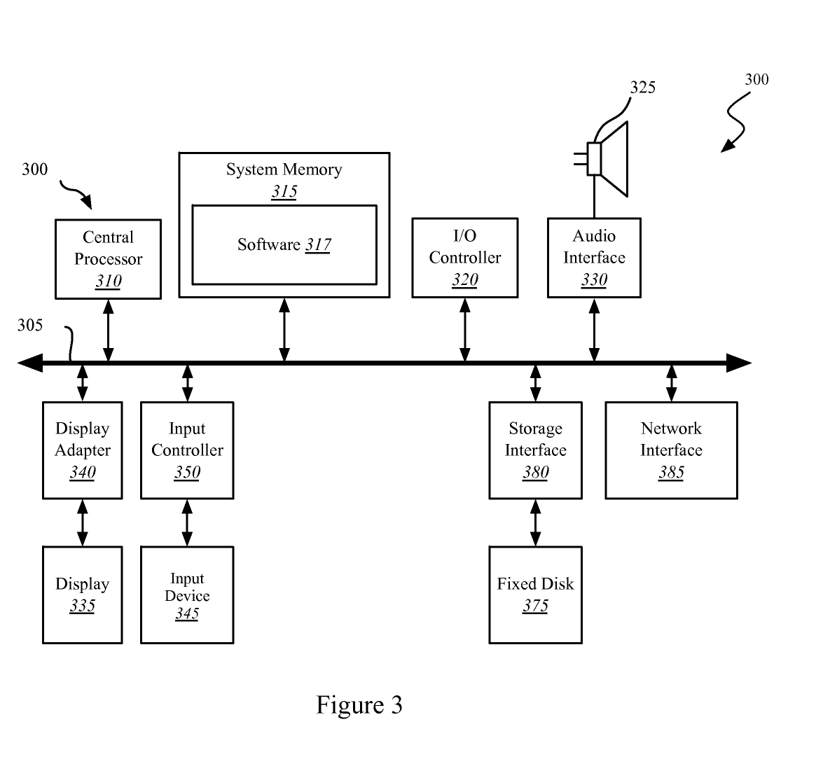

Referring now to FIG. 3, server device 300 is an example of a server 28, 36 37, or both (e.g., see FIG. 1). In one configuration, server 300 includes a bus 305 which interconnects major subsystems of the server 300, such as a central processor 310, a system memory 315 (typically RAM, but which may also include ROM, flash RAM, or the like), an input/output controller 350, an external audio device, such as a speaker system 325 via an audio output interface 330, an external device, such as a display screen 335 via display adapter 340, an input device 345 (e.g., remote control device interfaced with an input controller 350), a storage interface 380 to a fixed disk 375. Also included is a network interface 385 which can be coupled directly to bus 305. The server 300 may further include a plurality of communication ports for enabling communication of the processor with external peripherals, such as external video sources, expansion buses, or other displays, a SCSI port or a key pad.

Bus 305 allows data communication between central processor 310 and system memory 315, which may include read-only memory (ROM) or flash memory (neither shown), and random access memory (RAM) (not shown), as previously noted. The RAM is generally the main memory into which the operating system and game application programs are loaded. The ROM or flash memory may contain, among other code, the Basic Input-Output system (BIOS), which controls basic hardware operation such as the interaction with peripheral components or devices.

Storage interface 380, as with the other storage interfaces server 200, can connect to a standard computer readable medium for storage and/or retrieval of information, such as a fixed disk drive. Fixed disk 375 can be a part of server 300 or can be separate and accessed through other interface systems. Network interface 385 may provide a direct connection to a remote server via a direct network link. Network interface 385 may provide such connection using wireless techniques, including WiFi, digital cellular telephone connection, digital satellite data connection, or the like.

Many other devices or subsystems (not shown) may be connected in a similar manner (e.g., a display, computing device, keypad, camera, authentication device, and so on). Conversely, all of the devices shown in FIG. 3 need not be present to practice the present systems and methods. The devices and subsystems therefore may be interconnected in different ways from that shown in FIG. 3. The aspect of some operations of a system such as that shown in FIG. 3 are readily known in the art and are not discussed in detail in this application. Computer instructions to implement the present disclosure may be stored in a non-transitory computer-readable medium such as one or more of system memory 315 or fixed disk 375.

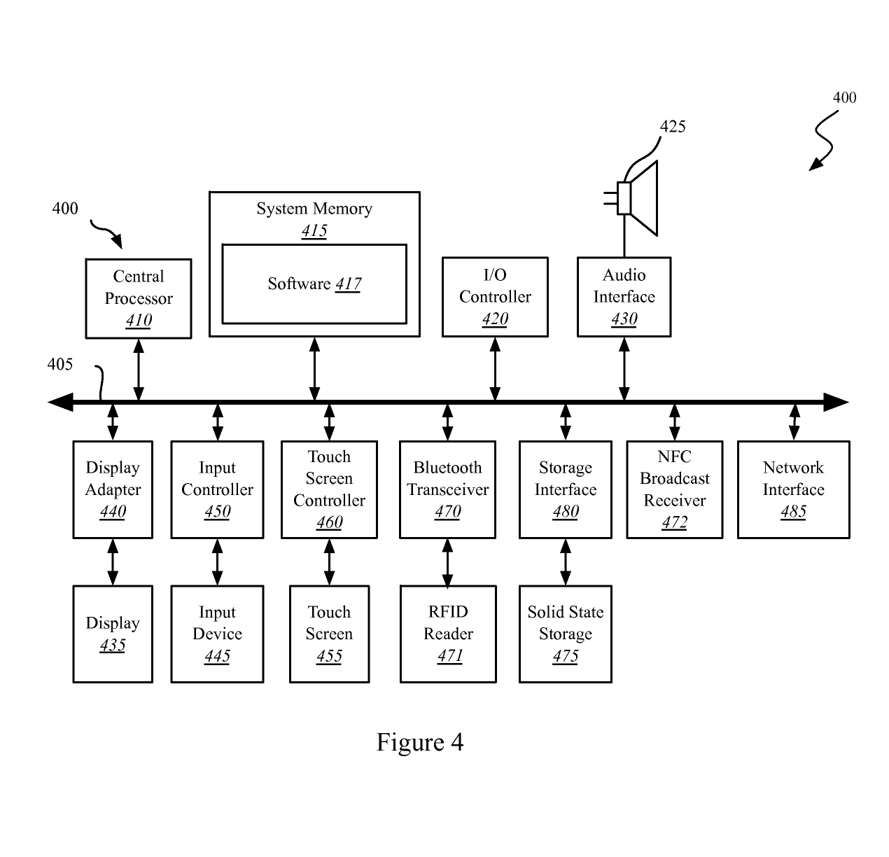

Referring now to FIG. 4, site device 400 is an example of a device 14, 16, or 20 (e.g., see FIG. 1). In one configuration, site device 400 includes a bus 405 which interconnects major subsystems of the site device 400, such as a central processor 410, a system memory 415 (typically RAM, but which may also include ROM, flash RAM, or the like), an input/output controller 450, an external audio device, such as a speaker system 425 via an audio output interface 430, an external device, such as a display screen 435 via display adapter 440, an input device 445 (e.g., remote control device interfaced with an input controller 450), a touch-screen device 455 (coupled with a touch-screen controller 460), a storage interface 480 to a solid state storage 475. Also included is a network interface 485 which can be coupled directly to bus 405. In some embodiments, the touch-screen 455 can include a touch-sensitive display overlay. The touch-screen 455 and the touch-screen controller 460 can be connected to the display adapter 440. The site device 400 may further include a plurality of communication ports for enabling communication of the processor with external peripherals, such as external video sources, expansion buses, or other displays, a SCSI port or a key pad. The site device may also include one or more credential-reading mechanisms, such as an NFC broadcast receiver 472, an RFID reader 471 connected to the bus 405 via a Bluetooth transceiver 470, or both.

Bus 405 allows data communication between central processor 410 and system memory 315, which may include read-only memory (ROM) or flash memory (neither shown), and random access memory (RAM) (not shown), as previously noted. The RAM is generally the main memory into which the operating system and game application programs are loaded. The ROM or flash memory may contain, among other code, the Basic Input-Output system (BIOS), which controls basic hardware operation such as the interaction with peripheral components or devices.

Storage interface 480, as with the other storage interfaces site device 400, can connect to a standard computer readable medium for storage and/or retrieval of information, such as a fixed disk drive. Solid state storage 475 can include, for example, solid state drives (SSD), solid state cards (SSC), solid state modules (SSM), and the like. Network interface 485 may provide a direct connection to a remote server via a direct network link. Network interface 485 may provide such connection using wireless techniques, including WiFi, digital cellular telephone connection, digital satellite data connection, or the like.

Many other devices or subsystems (not shown) may be connected in a similar manner (e.g., a display, computing device, keypad, camera, authentication device, and so on). Conversely, all of the devices shown in FIG. 4 need not be present to practice the present systems and methods. The devices and subsystems therefore may be interconnected in different ways from that shown in FIG. 4. The aspect of some operations of a system such as that shown in FIG. 4 are readily known in the art and are not discussed in detail in this application. Computer instructions to implement the present disclosure may be stored in a non-transitory computer-readable medium such as one or more of system memory 415 or solid state storage 475.

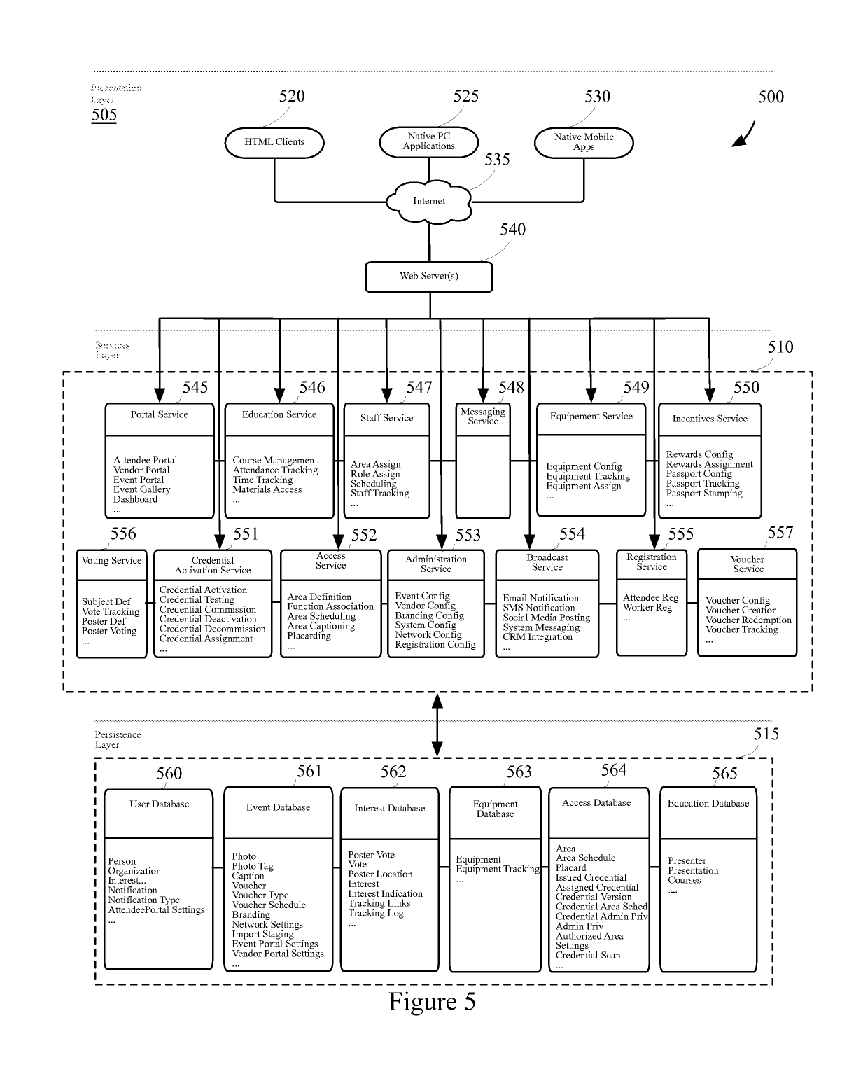

Referring now to FIG. 5, client devices can provide user interfaces to the functions of the interest collection and tracking system services 510. Such interfaces can include one or more of a browser-based interface, an application-based interface, and an app-based interface. In some embodiments, these applications can include application containers such as html clients 520, native computer applications 525, and/or native mobile apps 530.

The interest collection and tracking system architecture 500 can include a services layer 510 that exposes a variety of discreet services accessible to authorized clients 520, 525, 530. It is through these services that information can be added to, and retrieved from, the databases found in the persistence layer 515. The services layer 510, together with the persistence layer 515, can, in part, consist of a collection of distributed web services and data stores providing the interest collection and tracking system functionality.

In some embodiments, the portal service 545 provides methods and data structures for the interest collection and tracking system portal generation and display functionality and dashboard functionality. These methods are supported by data and data relations stored in various databases in the persistence layer 515.

The education service 546 can provide methods and data structures for the interest collection and tracking system education tracking functionality. These methods are supported by data and data relations stored in various databases in the persistence layer 515 including the education database 565 and the user database 560.

The staff service 547 can provide methods and data structures for the interest collection and tracking system staffing functionality. These methods are supported by data and data relations stored in various databases in the persistence layer 515 including the user database 560, the equipment database 563, and the access database 564.

The messaging service 548 provides methods for preparing, packaging, transmitting, receiving, and parsing messages.

The equipment service 549 can provide methods and data structures for the interest collection and tracking system equipment configuration, assignment, and tracking functionality. These methods are supported by data and data relations stored in various databases in the persistence layer 515 including the user database 560 and the equipment database 563.

The incentives service 550 can provide methods and data structures for the interest collection and tracking system rewards functionality and passport functionality. These methods are supported by data and data relations stored in various databases in the persistence layer 515 including the user database 560 and the event database 561.

The voting service 556 can provide methods and data structures for the interest collection and tracking system voting functionality. These methods are supported by data and data relations stored in various databases in the persistence layer 515 including the user database 560 and the interest database 562.

The credential activation service 551 can provide methods and data structures for the interest collection and tracking system credential activation, deactivation, assignment, and testing functionality. These methods are supported by data and data relations stored in various databases in the persistence layer 515 including the user database 560 and the access database 564.

The access service 552 can provide methods and data structures for the interest collection and tracking system area definition, area function association, area scheduling and area identification functionality. These methods are supported by data and data relations stored in various databases in the persistence layer 515 including the access database 564 and the event database 561.

The administration service 553 can provide methods and data structures for the interest collection and tracking system administrative and configuration functionality. These methods are supported by data and data relations stored in various databases in the persistence layer 515.

The broadcast service 553 can provide methods and data structures for the interest collection and tracking system notification, social media posting, and third-party systems integration functionality. An SMS or other notification message can be sent to staff by the broadcast service 553 when defined workers' or attendees' credentials are activated, or they enter a restricted area. A message can be sent to one or more social media platforms when a worker's or attendee's credentials are activated. These methods are supported by data and data relations stored in various databases in the persistence layer 515 including the user database 564 and the event database 561.

The registration service 555 can provide methods and data structures for the interest collection and tracking system registration functionality. These methods are supported by data and data relations stored in various databases in the persistence layer 515 including the user database 564 and the event database 561.

The voucher service 557 can provide methods and data structures for the interest collection and tracking system registration functionality. These methods are supported by data and data relations stored in various databases in the persistence layer 515 including the user database 564 and the event database 561.

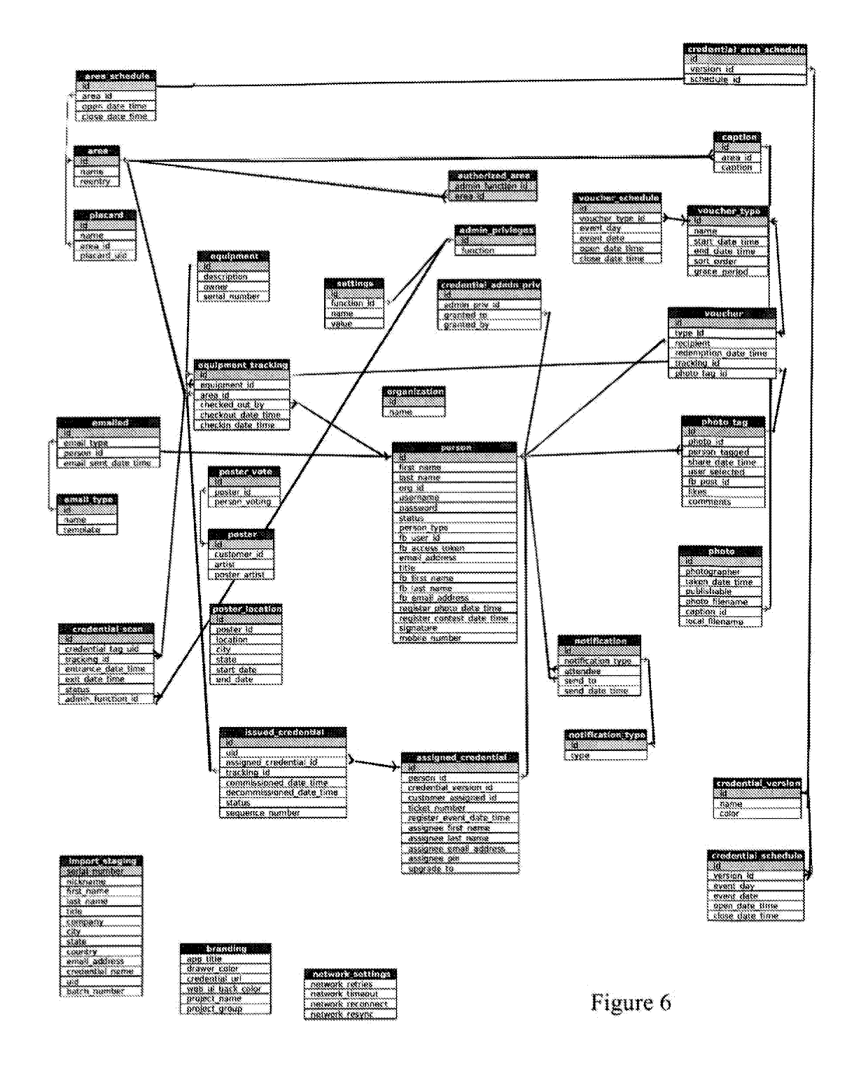

Referring now to FIG. 6, an entity relationship diagram based on an underlying relational data model is described for implementing the interest collection and tracking system 24 according to an exemplary embodiment. Included are a series of database tables supporting the interest collection and tracking system services 510. Moreover, regarding the tables, fields and relations described in FIG. 6, those skilled in the art will recognize how to construct data structures using a relational querying mechanism such as SQL, database view, or the like to support the interest collection and tracking system services 510.

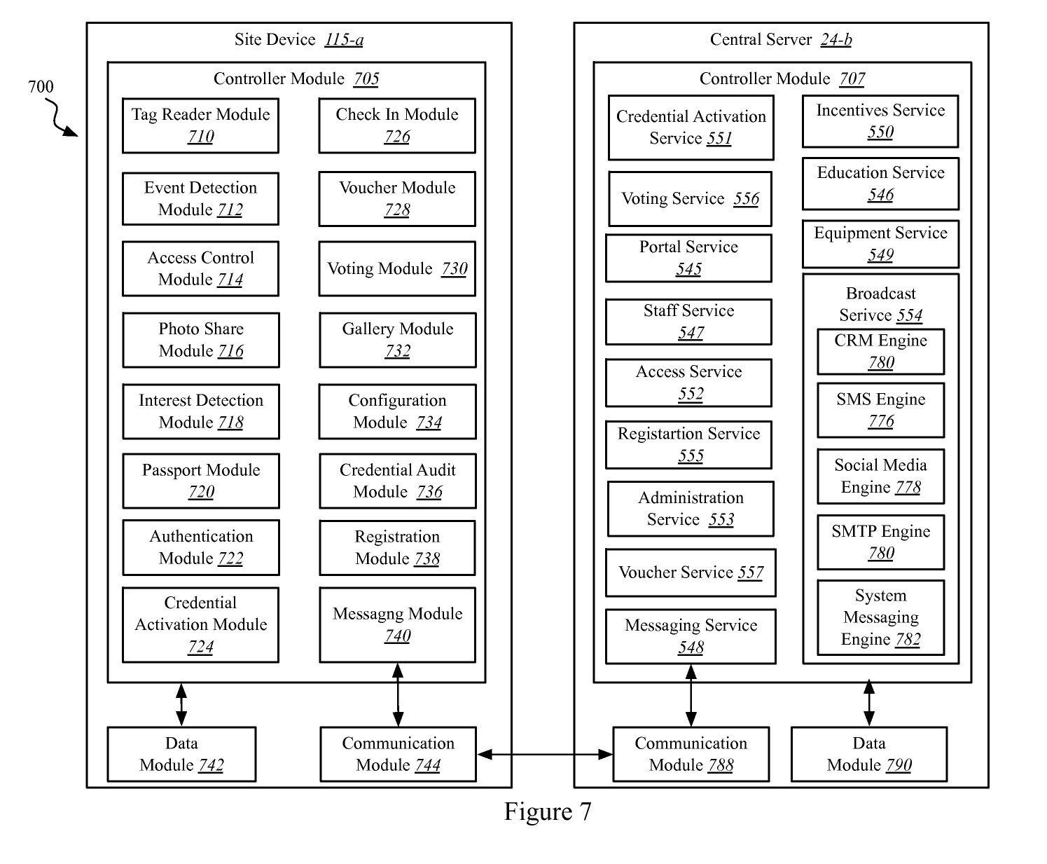

Referring now to FIG. 7, a site device 115-a and one or more central servers 24 implement various complimentary modules 714, 720, 724, 726, 728, 730, 732, 734, 736, 738, exposing and performing various functions of the interest collection and tracking system 10. In addition, in some embodiments, the site device implements non-complimentary modules with functions specific to the site device 115-a. In some cases, a tag reader module 710 reads data associated with tags included with, for example, credentials. This data is then made available to other modules for performance of complimentary functions such as credential auditing.

In some implementations, the site device 115-a can include an event detection module 712 configured to detect one or more types of events. Events can include, for example, a credential tap event, multiple credential tap events within a defined period of time, a credential proximity event, or a determination of credential proximity over time. The interest detection module 718 can associate one or more detected events with a predefined interest indication data structure. For example, the detection of multiple credential taps can be regarded as an increased level of interest in an asset or activity associated with the site device 115-a. Similarly, the duration of time between an event indicating arrival and event indicating departure can be compared to a threshold time period where exceeding the threshold value is indicative of an increased level of interest in the activity attended.

An authentication module 722 can authenticate a user of a device 115-a such as a worker. Authentication of the user can determine, at least in part, the level of functionality made available to the worker based on information retrieved from the interest collection and tracking system database 36.

A photo share module 716 can capture, store, pre-process, and transmit photos captured at an event. This module can implement calls to the native camera mechanism and imaging features and functions of the site device 115-a. In some instances, the publication of photos can be made contingent on acceptance of a model release by one or more subjects captured in the photo.

In some embodiments, an Administrative Interface allows an administrator to configure an event, application, and portal, and to monitor/report on activity. The following is a list of objects that can be configured through the Administrative Interface:
Equipment Object—for reasons such as security, specific identified equipment can be configured to have access to the system to the exclusion of other equipment.
Person Object—can include, for example attendees, workers, and staff members,
Organizations Object—a group to which one or more persons may be associated. For attendees, this can be, for example, the company they work for, a business association, or any other grouping of people.
System User Object—some workers may be assigned system privileges that can allow them to perform specific functions within the system.
Credential Type Object—the type of credential assigned to a Person. The Type refers to the type of person at the event (e.g. artist, staff, attendee, media, etc.).
Restricted Area Object—a defined section or area of the venue other than the “general admission” area. Those Persons with specific credential versions are permitted in restricted areas.
   Areas may optionally be assigned a set of schedules when admission will be permitted. If schedules are used, Credential Types can be further restricted by the schedules of the restricted area.
   Areas can be configured designating which system functions are allowed in the area. For example, the Guest Services Restricted Area may be configured for Registration and Credential Activation whereas the VIP Tent Restricted Area may be configured for Access Control and Voucher Redemption as described further below.
   One or more Access Points can be configured for an area. Access Points can be entry points that provide access to a Restricted Area. Each Access Point can have a reader device, such as a kiosk or a sign, identifying the area as a Restricted Area and providing Credential Type verification services.
Voucher Objects—items the event owner, vendor, or both wishes to make available to one or more Persons. Vouchers can be provided free of charge, sold, or both, and can be redeemed during a time range, such as a period of time specified by the event owner. Examples of vouchers include meals, T-shirts, drinks, and tours.
Branding Elements—there can be various branding elements in the system including, for example:
   Admin Interface with various header sections for logos, wallpaper/background, etc.;
   App with wallpaper/background;
   Photo sharing with portrait and landscape photo frames, and watermarking; and
   Credential artwork, along with an optional URL written to the “chip” in the credential.

In some embodiments, a Worker Registration Module and an Attendee Registration Module provides one or more interfaces for registration of Persons.
Realtime Registration Data Feed Engine—When a third party system is processing registration and ticketing activities, the third party system can sends a stream of registration information, ticketing information, or both to the interest collection and tracking system for post processing and storage.
Data Loader Engine—for an event that will handle late registrants manually, the system can load registration information from an entry form on a site device, through the uploading of a list such as, for example, and Excel spreadsheet, or both.
Staff Registration Form—for loading invited guest details manually, a web-based form can be provided for collecting registration details for persistent storage.
Self-Registration Form—a form for online event registration for attendees, workers, and the like.

In some embodiments, an app provides various modules as described previously in FIG. 7, including the following:
Credential Activation Module 724—this module associates a technology-enabled credential (e.g. RFID tag, other wearable technology, etc.) to an event worker or attendee and writes worker or attendee-specific information to the credential, to an associated credential information data store (local or remote), or both.
   Function Activation—Specific locations or areas can be configured through the Administration Service for worker and/or attendee credential activation. The credential activation function for the app on a particular device may only become active in the app if the user has permission to use the function and the area in which they're operating is configured for this function.
   Physical Credential Generation—The photo, name, and other Person attributes can be printed and added to the physical credential for those Persons who did not register in time for the physical credential to be created with their information.
   Credential Deactivation—Damaged or lost credentials can be deactivated, replacement credentials can be activated, or both.
   Credential Upgrade—Activates a new credential with, or associates and existing credential, with a higher access level, privilege level, or both.
   The credential holder can be awarded points or vouchers by the Voucher Module or Passport Module when their credential is activated.
   Photo Share—A photo can be associated with a Person. The photo can either already be in the system or captured at or after the time of credential activation and associated with the Person.
Access Control Module 714—used to determine access to restricted areas. When a credential comes within read range of an app-associated reader, the app can display a visual indication or generate an audio indication of whether access is granted. For example, the app may display a “green light” or “red light” image indicating to the app user whether or not the credential holder may enter the Restricted Area.
   Function Activation by Location—Specific locations or areas can be configured in the Location Engine for access control. The credential activation function for the app on a particular device may only become active in the app if the user has permission to use the function, the area in which they're operating is configured for this function, or both.
   Access Control areas can be assigned time ranges for specific functions, such as, for example, admittance. These time ranges can be further extended with a grace period, a buffer, or both.
   If a photo has been associated with a Person, the associated photo can be displayed on the display.
   Voucher and Point Awards—The credential holder can be awarded points or vouchers by the Voucher Module and Passport Module when workers' or attendees' enter a Restricted Area.
   If a lost, damaged, or otherwise invalid credential comes in range of an associated credential reader, the system can notify the app user of the detection of the “bad” credential.
   Notifications—An SMS or other notification message request can be sent to the broadcast service requesting notification be sent to a staff member indicating that a “bad” credential has been detected at a Restricted Area.
Check In Module 726—when a worker/attendee comes in range of the mobile device running the Check-In Module, a welcome message can be displayed.
   Specific areas can be defined as check in areas. The check-in function may become active in the app if the user has permission to use the function, the area in which the app is operating is configured for this function, or both.
   If a photo has been associated with a Person, the associated photo can be displayed on the display.
   Check-in areas can be assigned time ranges for specific functions, such as, for example, admittance. These time ranges can be further extended with a grace period, a buffer, or both.
   Notifications—An SMS or other notification message request can be sent to the broadcast service to notify staff by the Notification Engine when certain workers/attendees check in.
   Social Media Messaging—A message request can be sent to the broadcast service to broadcast to social media platform when a worker/attendee checks in.
   Voucher and Point Awards—The credential holder can be awarded points or vouchers by the Voucher Module and Passport Module when they check in.
   If a lost, damaged, or otherwise invalid credential comes in range of an associated credential reader, the system can notify the app user of the detection of the “bad” credential
   Notifications—An SMS or other notification message request can be sent to the broadcast service to notify a staff member indicating that a “bad” credential has been detected at a Checkin Area.
Voucher Module 728—used to redeem vouchers given to or purchased by workers/attendees.
   Specific areas can be defined as voucher redemption areas. This function may become active in the app if the user has permission to use the function, the area in which the app is operating is configured for this function, or both.
   If a photo has been associated with a Person, the associated photo can be displayed on the display.
   Vouchers can be assigned time ranges when they are valid. These time ranges can be further extended with a grace period.
   Notifications—An SMS or other notification message request can be sent to the broadcast service to notify staff when certain workers/attendees redeem a voucher.
   Social Media Messaging—A message request can be sent to the broadcast service to publish to one or more social media platforms when a worker/attendee redeems a voucher.
   Voucher and Point Awards—The credential holder can be awarded points or vouchers by the Voucher Module or Passport module when they redeem a voucher.
Voting Module 730—allows a worker/attendee to vote in one or more contests.
   Voting contests can be assigned voting time ranges when voting is permitted. These time ranges can be further extended with a grace period.
   Notifications—An SMS or other notification message request can be sent to the broadcast service to notify staff when defined voting activity occurs
   Social Media Messaging—A message request can be sent to the broadcast service to publish to one or more social media platforms when defined voting activity occurs
   Voucher and Point Awards—The credential holder can be awarded points or vouchers by the Voucher Module or Passport Module when defined voting activity occurs
Photo Share Module 716—using technology-enabled cameras (video or still), the app user photographs can capture images or videos, identifies who, if anyone, is in the photo or video by bringing their credential in range of the device, and post the photo or video to the Person's social media account, event stream, or the like.
   Specific areas can be defined as photo share areas. This function may become active in the app if the user has permission to use the function, the area in which the app is operating is configured for this function, or both.
   Prior to the photo/video being uploaded to the social media site, it can be branded. The branding can be done with, for example, an event owner's brand or a sponsor's brand.
   A caption can optionally be added to the photo prior to upload.
Gallery Module 732—allows the app user to access images captured by the user or images captured by others that include the user, tag or untag Persons in the image, post the image to the user's social media account, and identify the image as a favorite.
Tag Reader Module 710—this module allows exhibitors to gather information about Persons at an event when a Person brings their credential in contact with the reader device in the exhibitor's booth
   Voucher and Point Awards—The credential holder can be awarded points or vouchers by the Voucher Module or Passport Module when they engage.
Interest Detection Module—The interest level of a person in, for example, products and service can be detected based on interest indicating activities such as time spent within range of a reader device, defined interactions with a reader device, and the like.
   Additional points may be awarded to Persons who interact with a number of exhibitor booths beyond a pre-defined threshold number.
Passport Module 720—Provides the Person a “stamp” in their digital passport. Passport stamps may be awarded for the performance of pre-defined activities such as, for example, visiting designated areas at an event. These areas can be, for example, exhibitor booths, sports challenges, restaurants, or any other point of interest at an event.
Gamification Module—the type and degree of incentives can be awarded based on behavior. For example, the number of points, the type of voucher, the credential to which an attendee may be upgraded, the reward associated with acquiring a fully-stamped Digital Passport, etc. can be configured.
Credential Audit Module 736—displays information about the credential and the attributes of the Person associated with the credential. Attributes can include, for example:
   Name
   Title
   Company name
   Credential version type and history
   Restricted areas to which worker/attendee has access with this credential
   Granted voucher types and quantities
   Voucher redemption history
   Whether photo share registration for the event has occurred
   Whether photo and message upload to social media registration has occurred
   Number of photos uploaded
   Number of social media “Likes” their uploads have received
   Number of social media “Comments” their uploads have received
   Number of social media events (e.g. retweets, reblogs, etc.) associed with their uploads have occurred
   Number of points the credential holder currently has
   What votes have been cast
Exhibitors visited during the event including exhibitor's
   company name
   web site URL
   booth number/location
   date visited
   with whom the worker/attendee engaged
   items in which the worker/attendee was interested
   links to additional information based on interest
   specials offered to the worker/attendee for visiting the booth
   number of points received for engaging with exhibitor
Breakout sessions attended including
   Speaker details
      Name
      Company name
      URL
   Paper/speech title
   Feedback on the session including
      Number of points the worker/attendee has received for providing feedback as well as the total number of points possible for providing feedback
      If feedback was provided on exit, whether the worker/attendee liked, disliked, or was neutral on the session and the number of points received for providing the feedback
      If feedback was not provided on exit, the worker/attendee may provide feedback from the portal
      Link to provide additional, more detailed feedback and the number of additional points the worker/attendee will receive if they provide the additional feedback
      Statistics regarding feedback received from all workers/attendees
   Links to find additional information on the topic
Contact details for other workers/attendees
   Details exchanged are those setup by workers/attendees in their profile
   Date/time details were exchanged
   Notes entered during the exchange to remind the worker/attendee of discussion with the worker/attendee

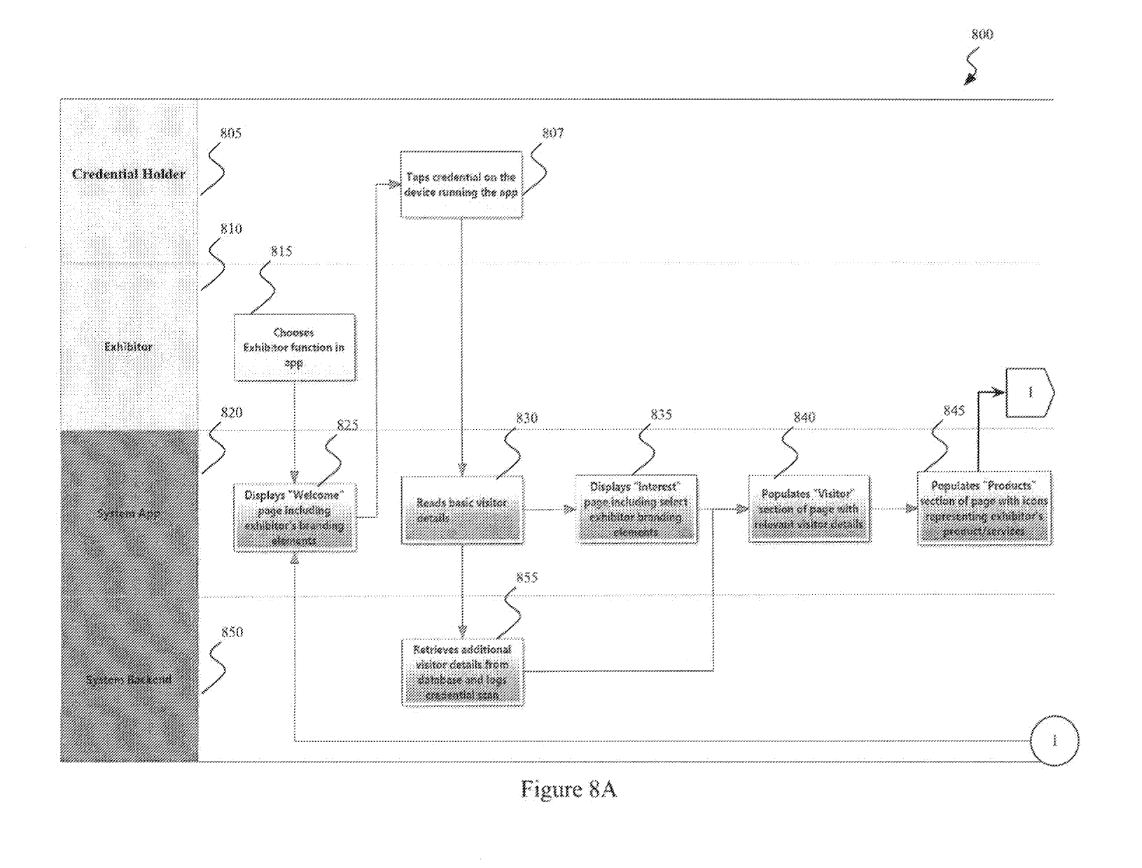

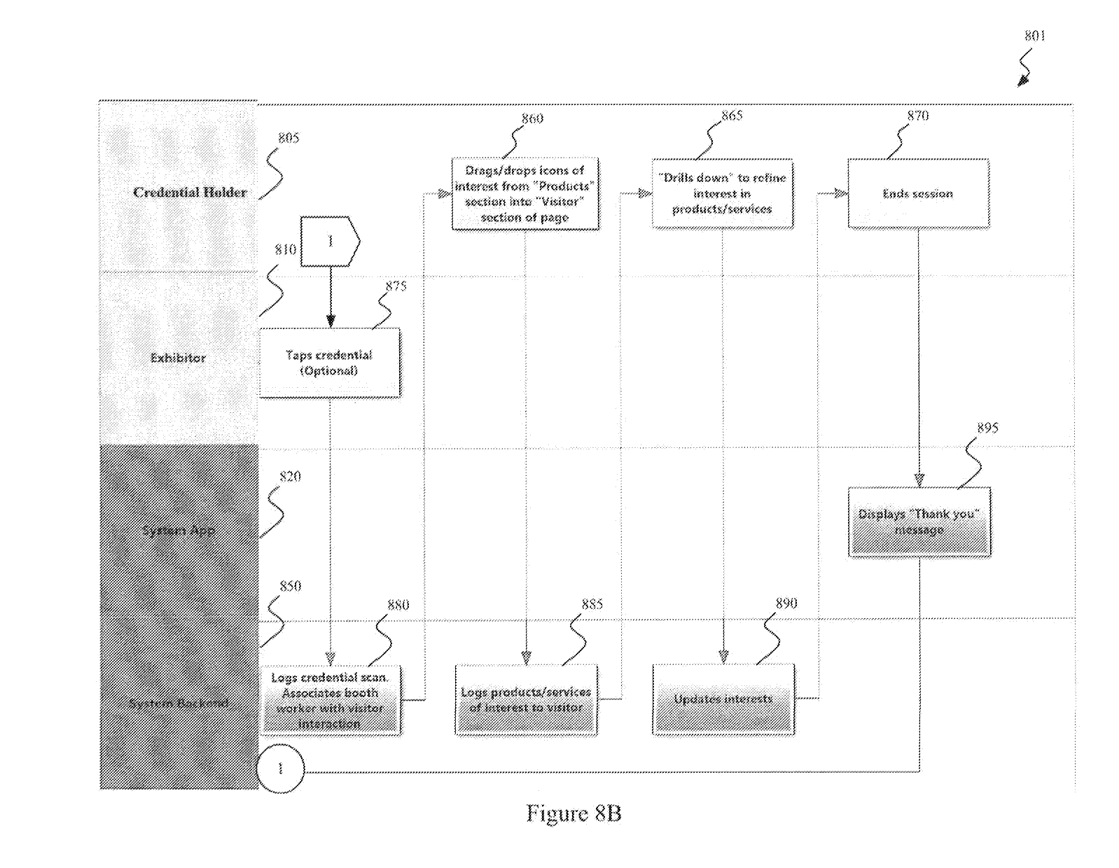

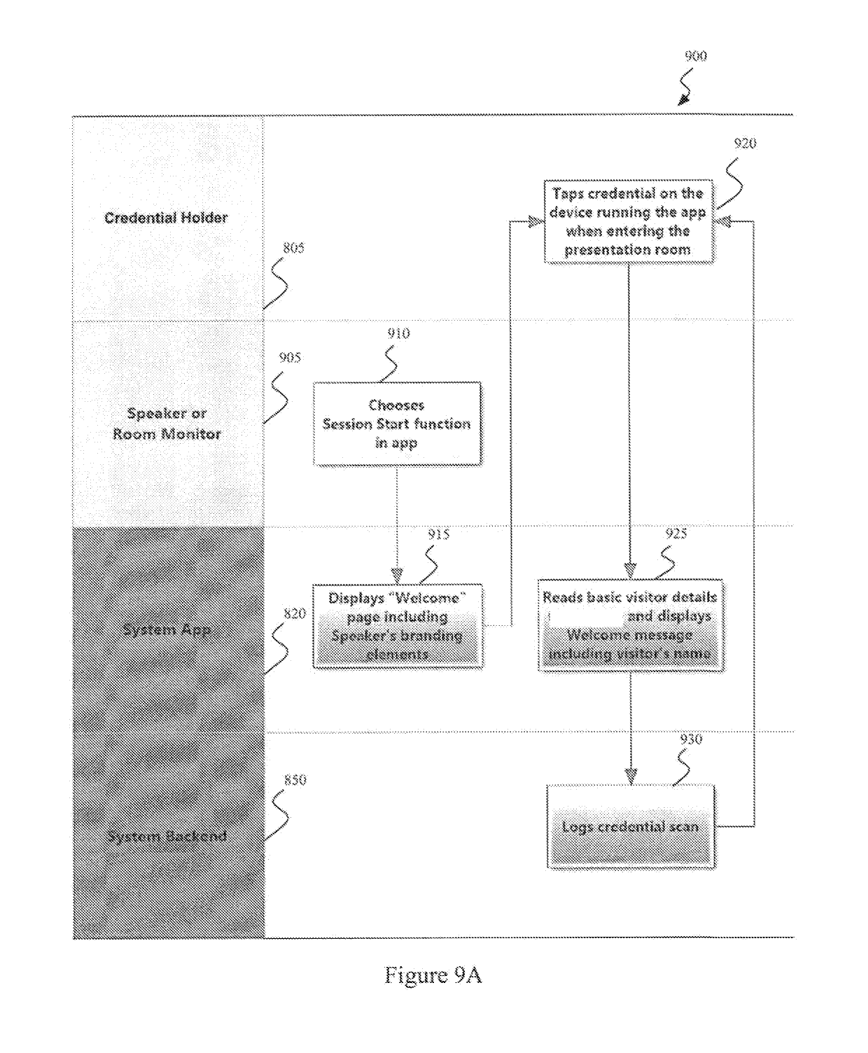

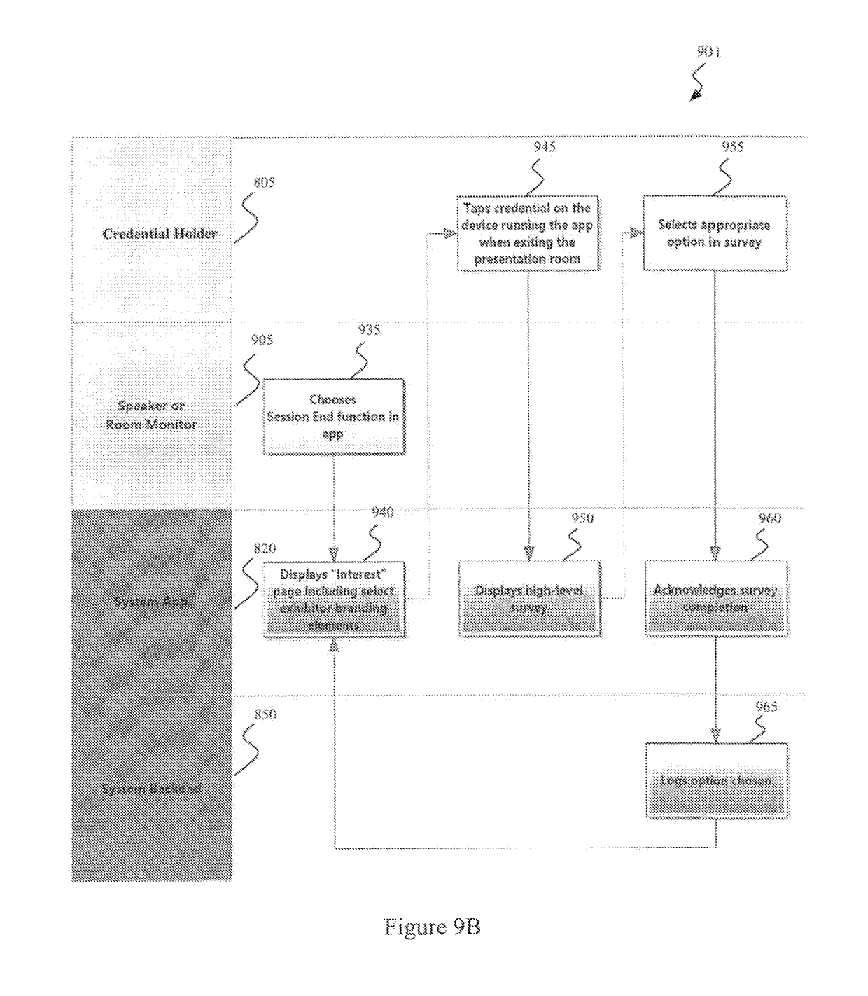

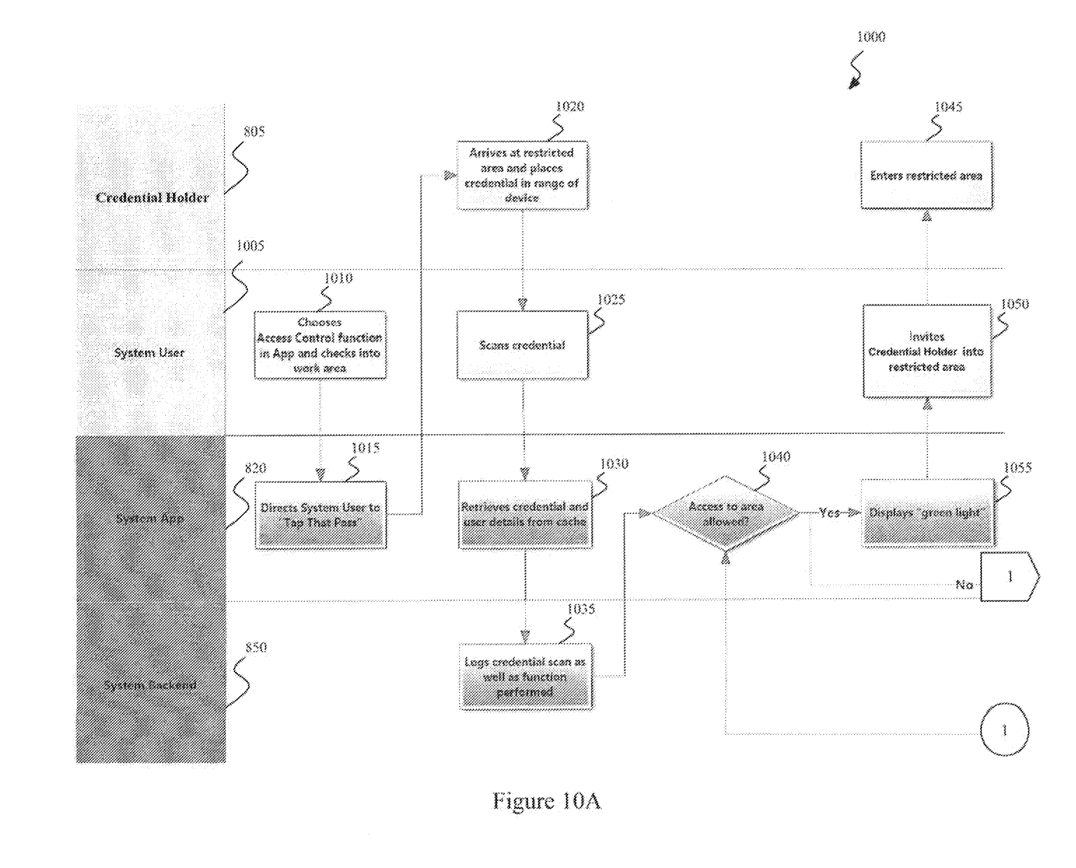

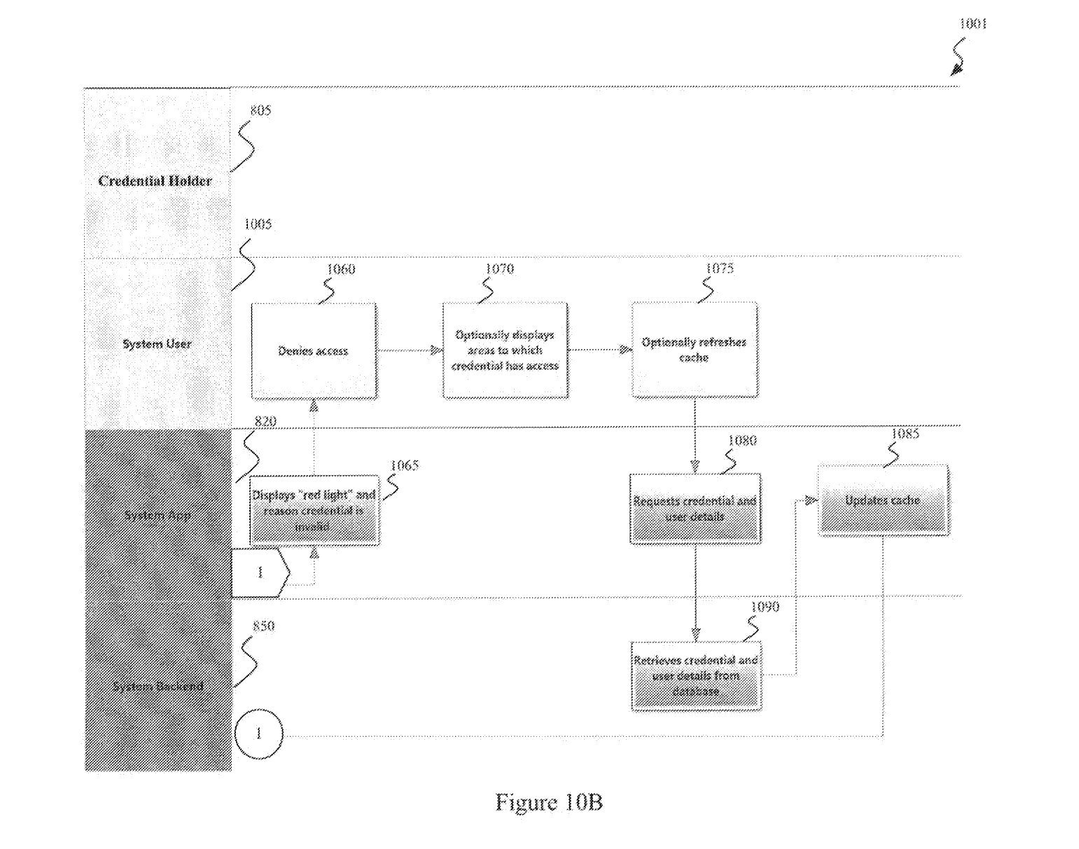

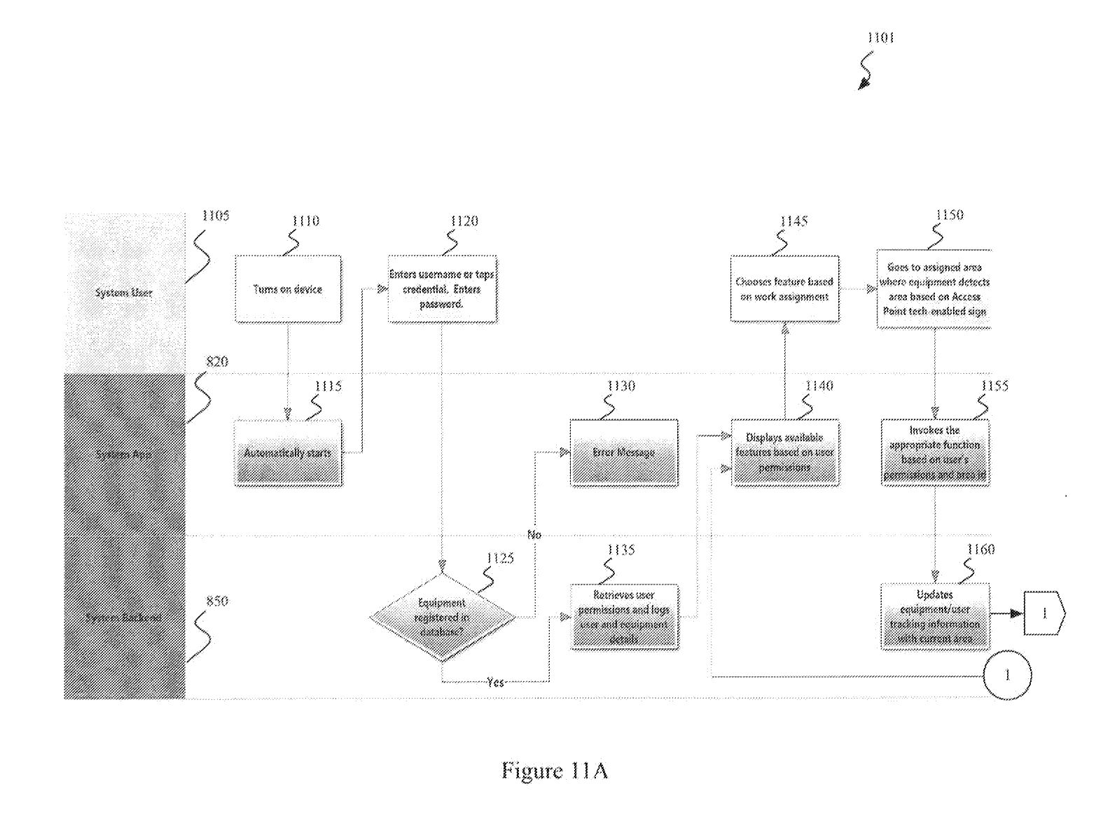

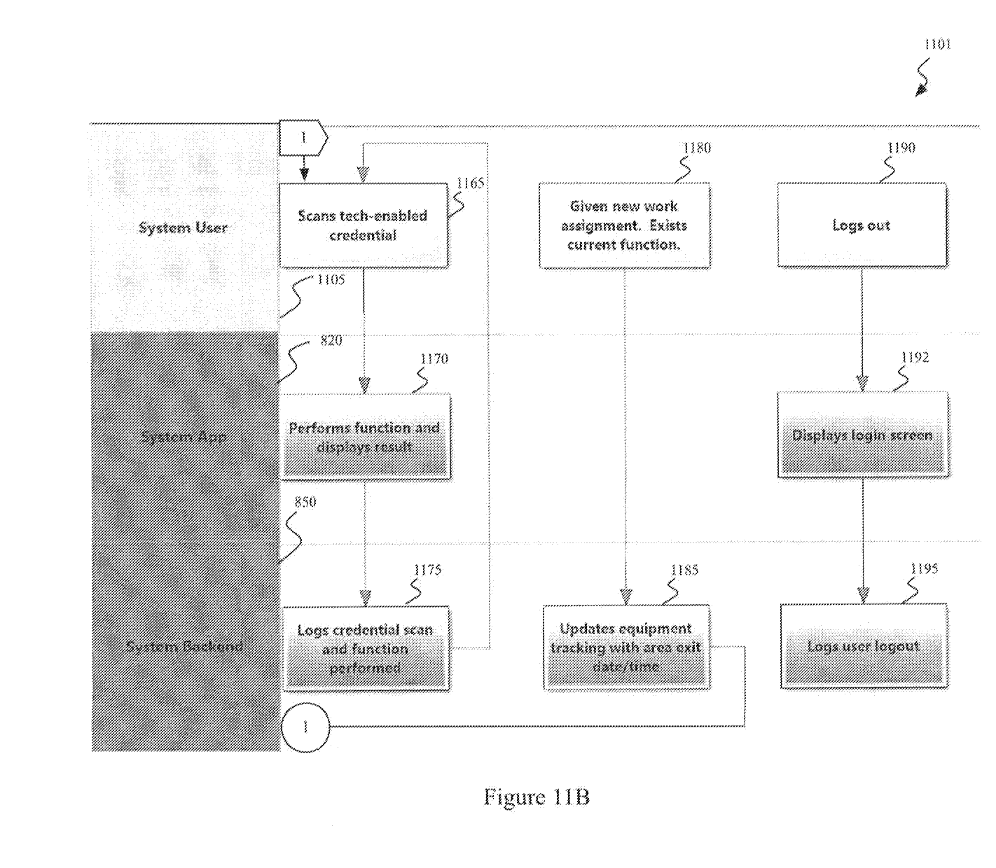

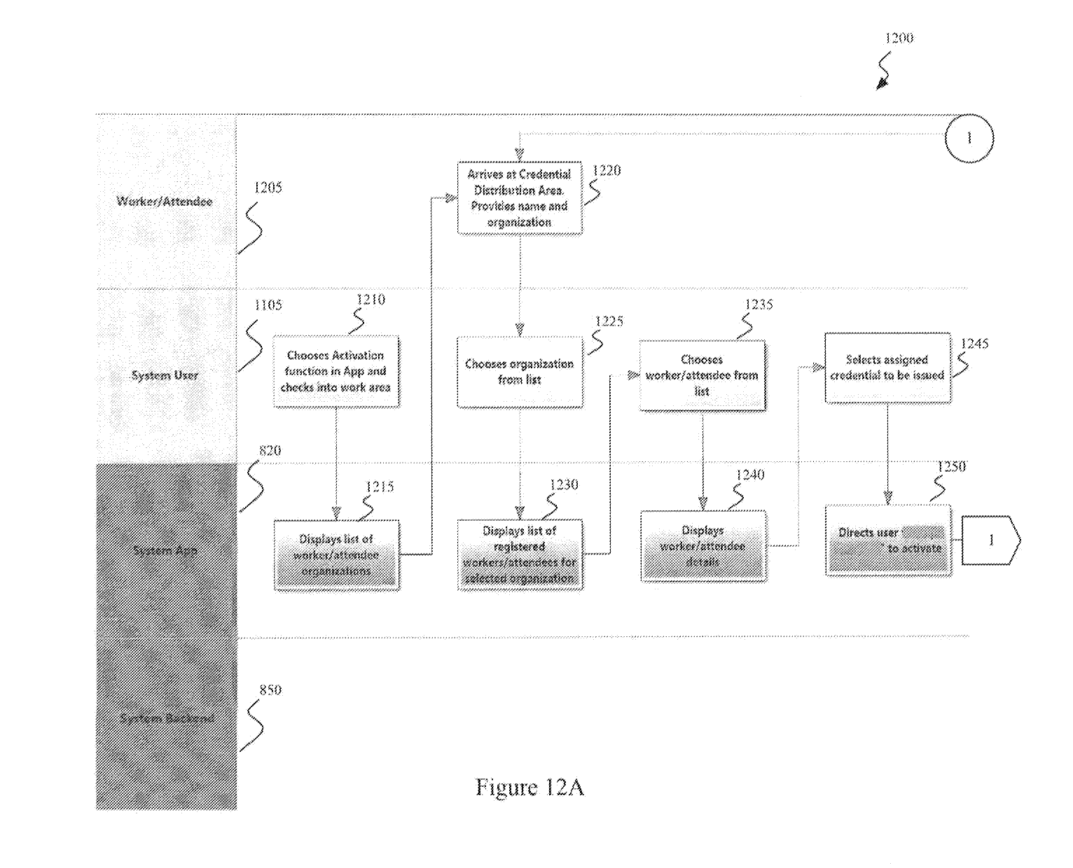

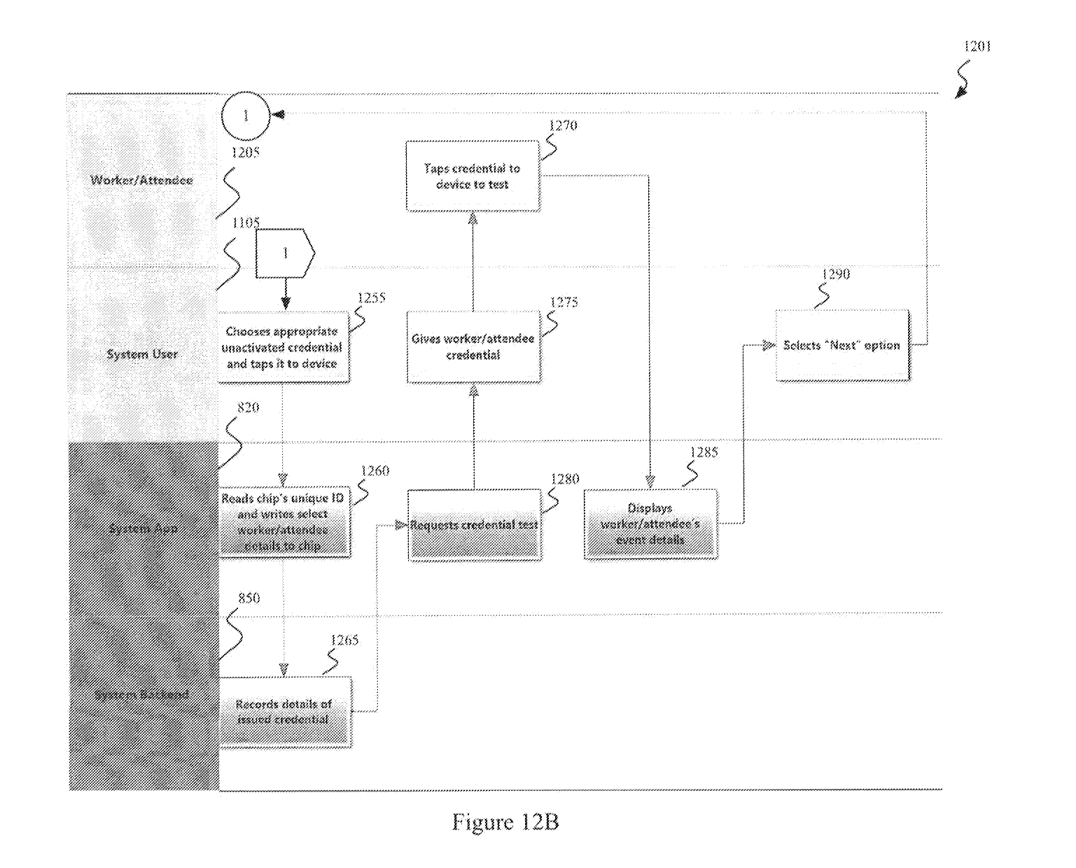

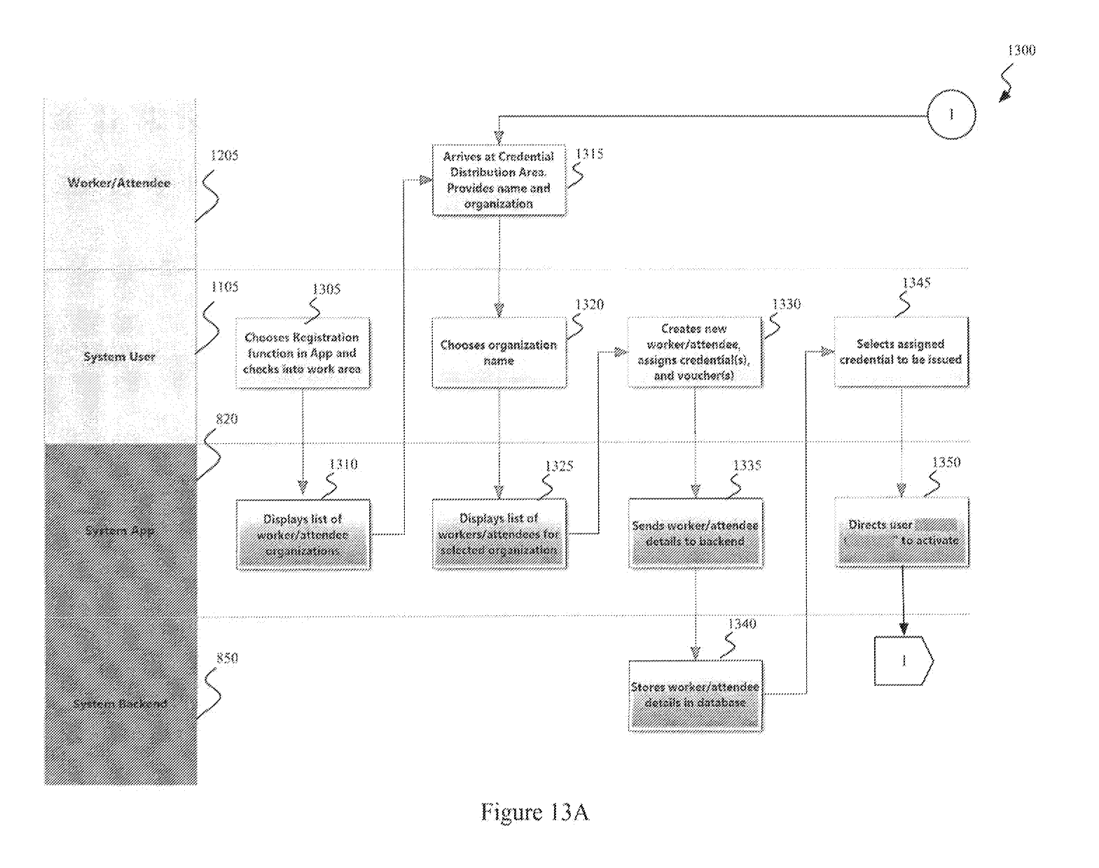

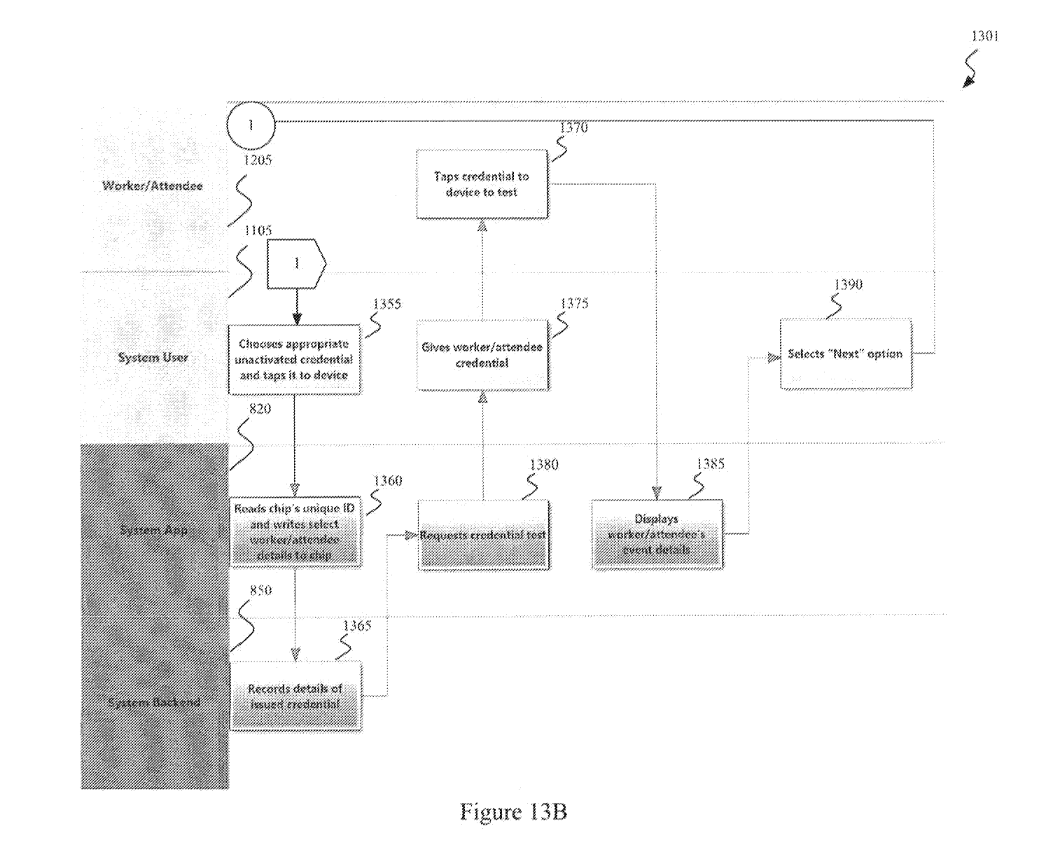

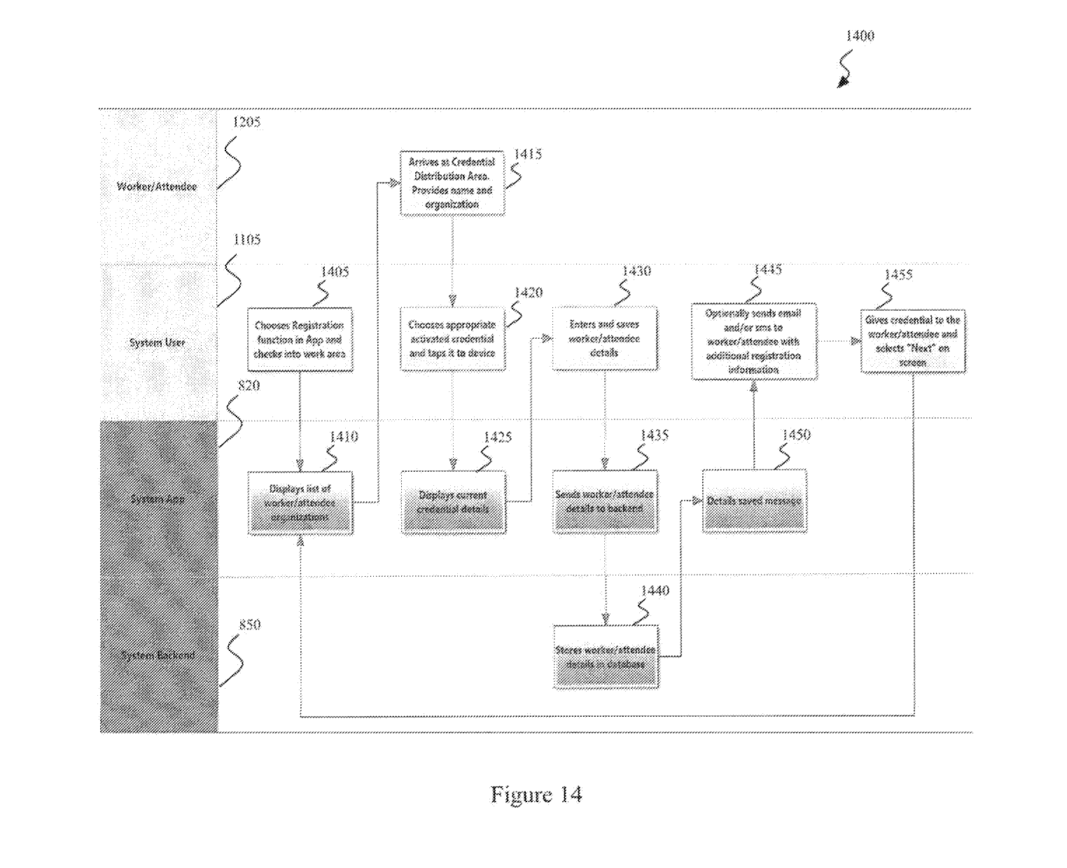

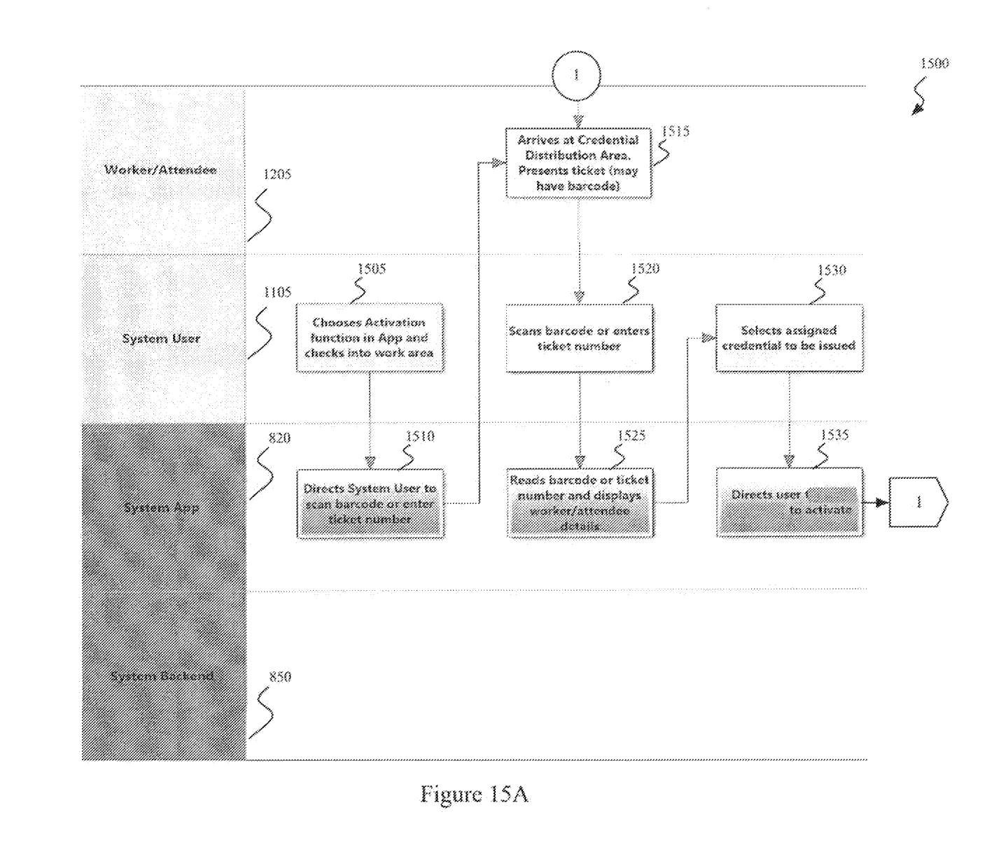

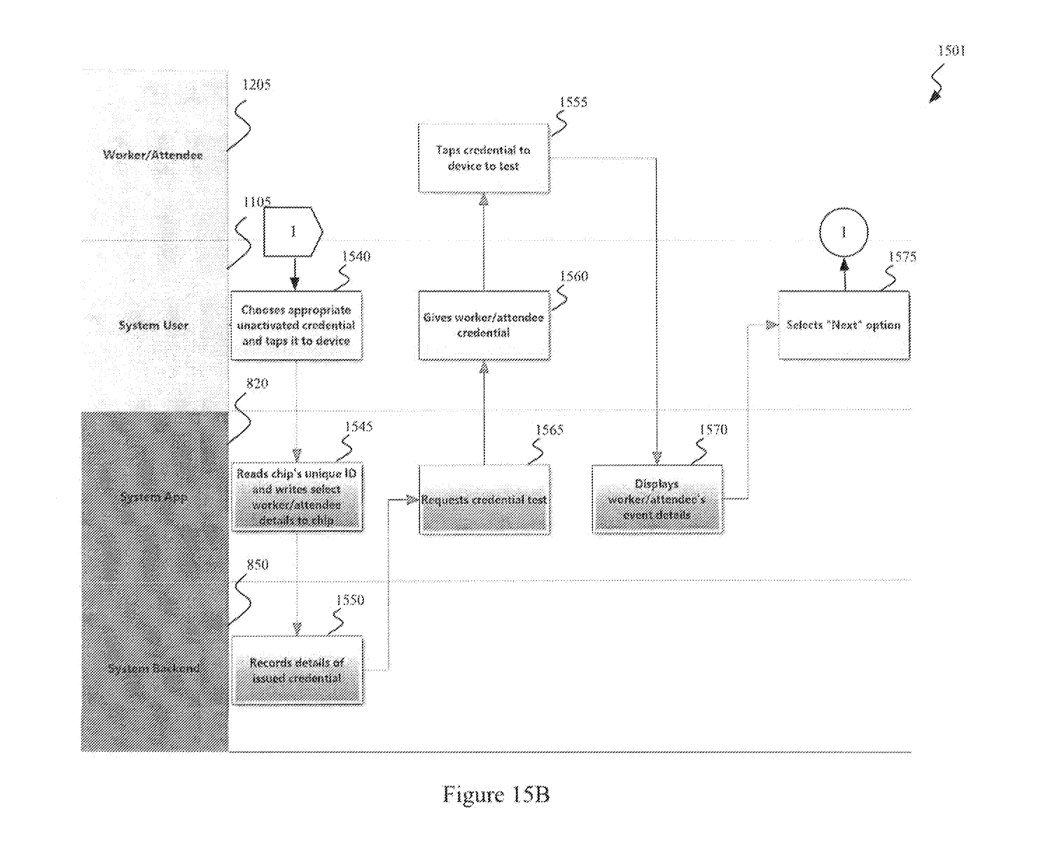

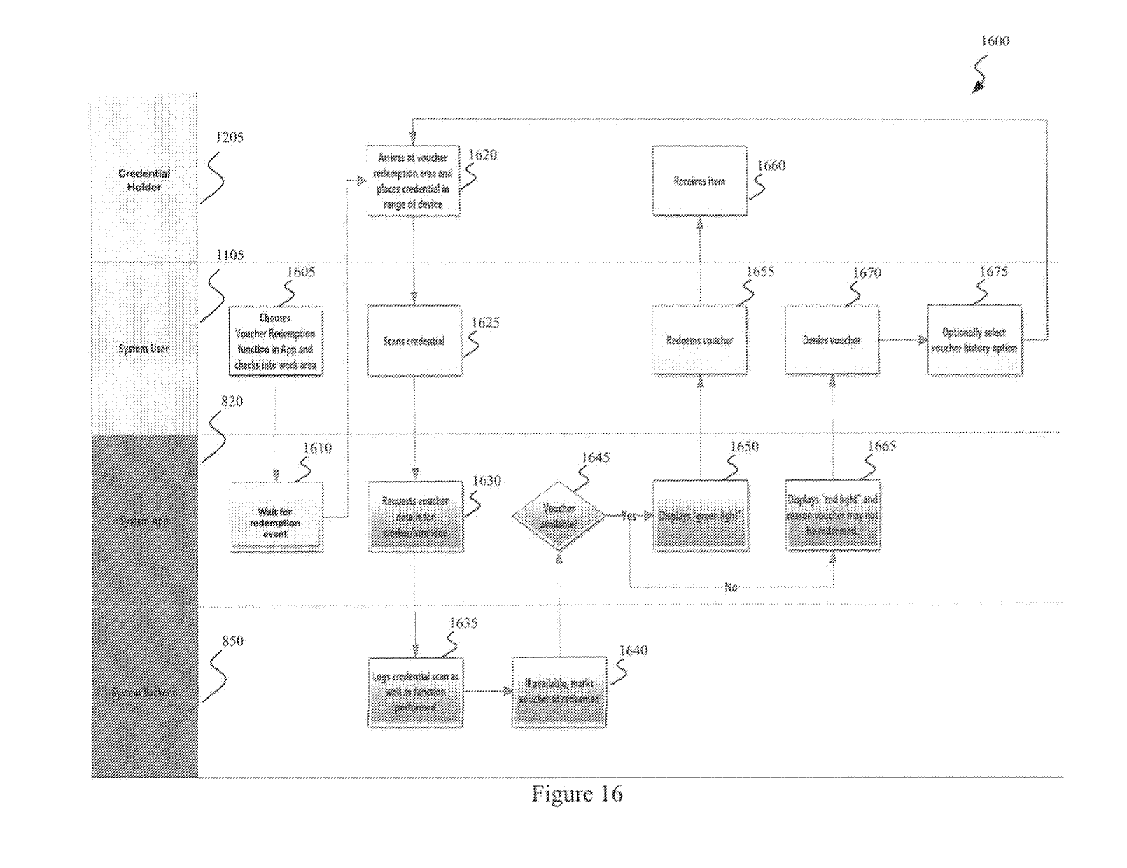

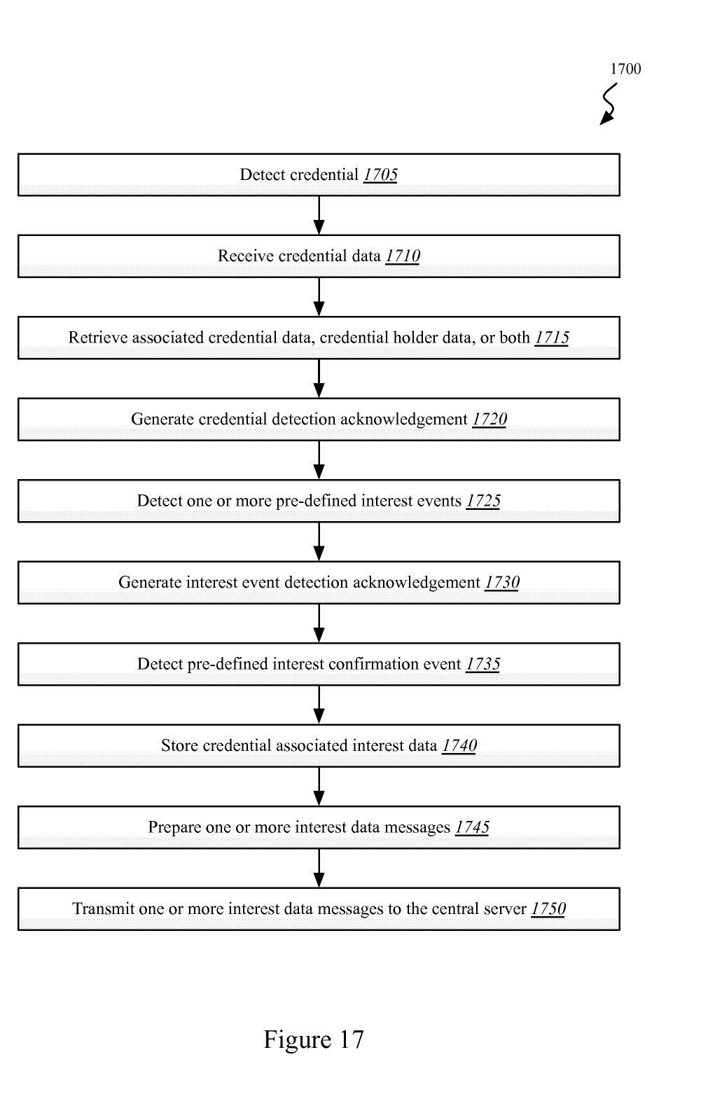

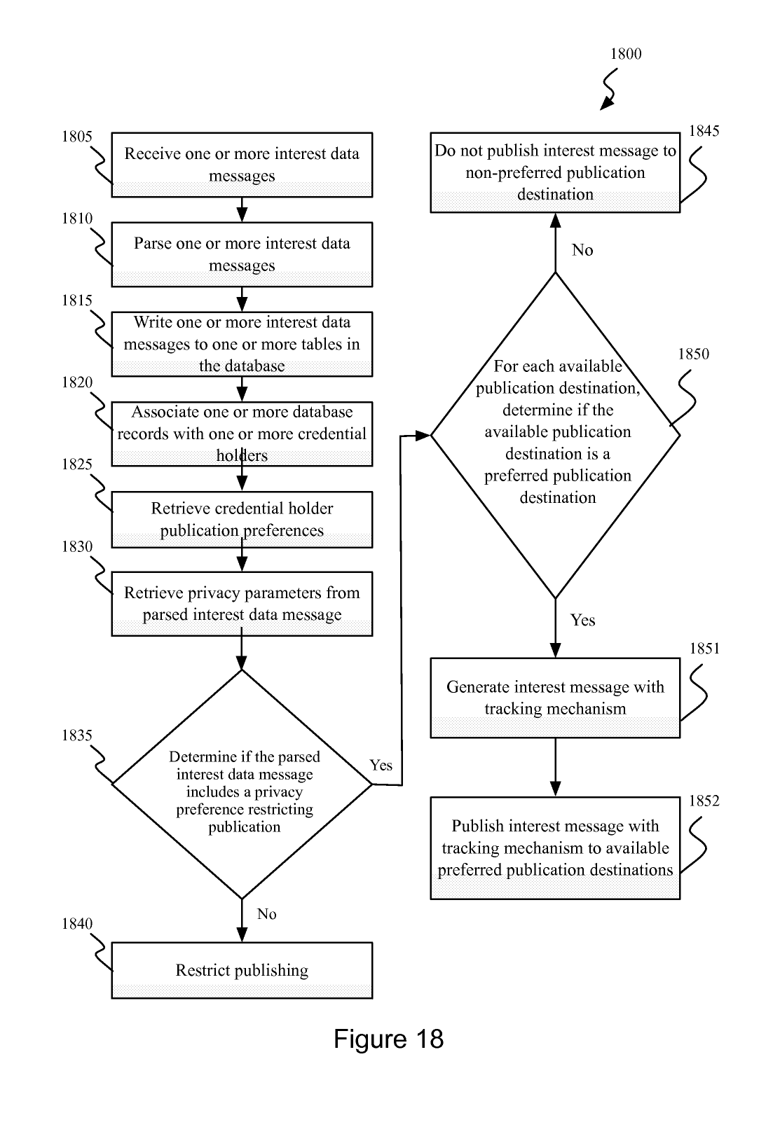

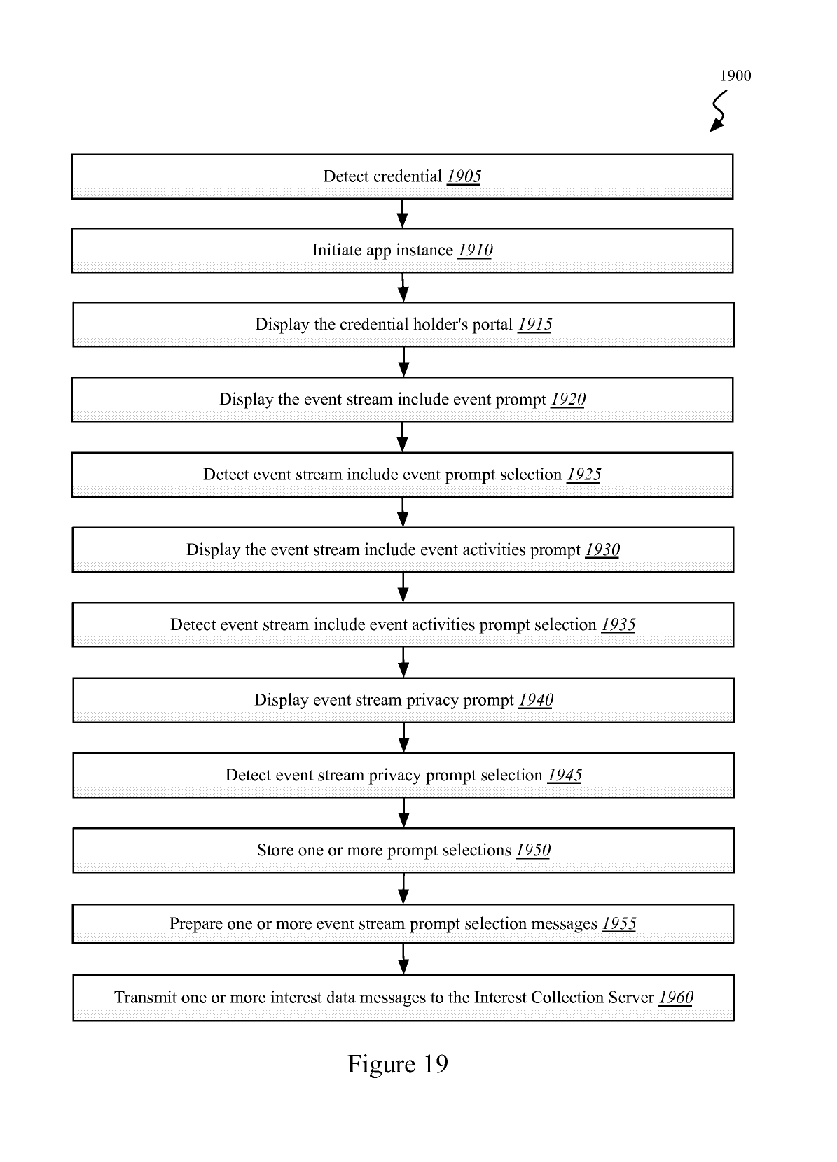

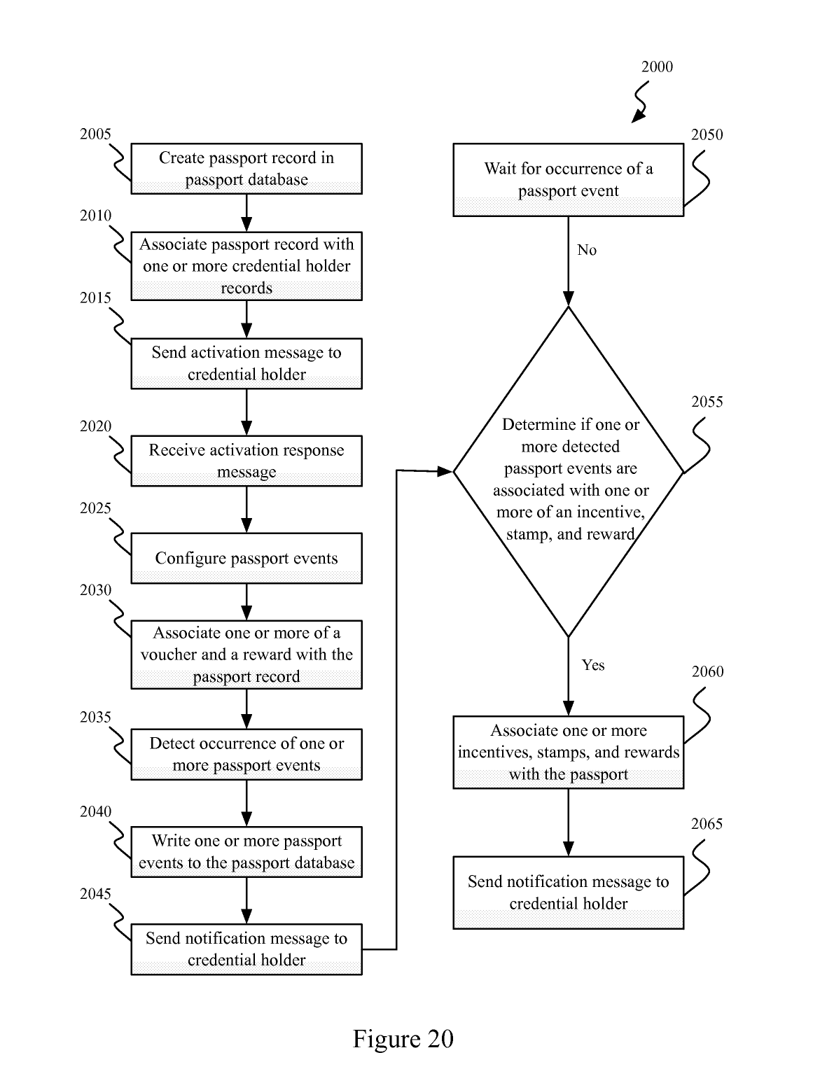

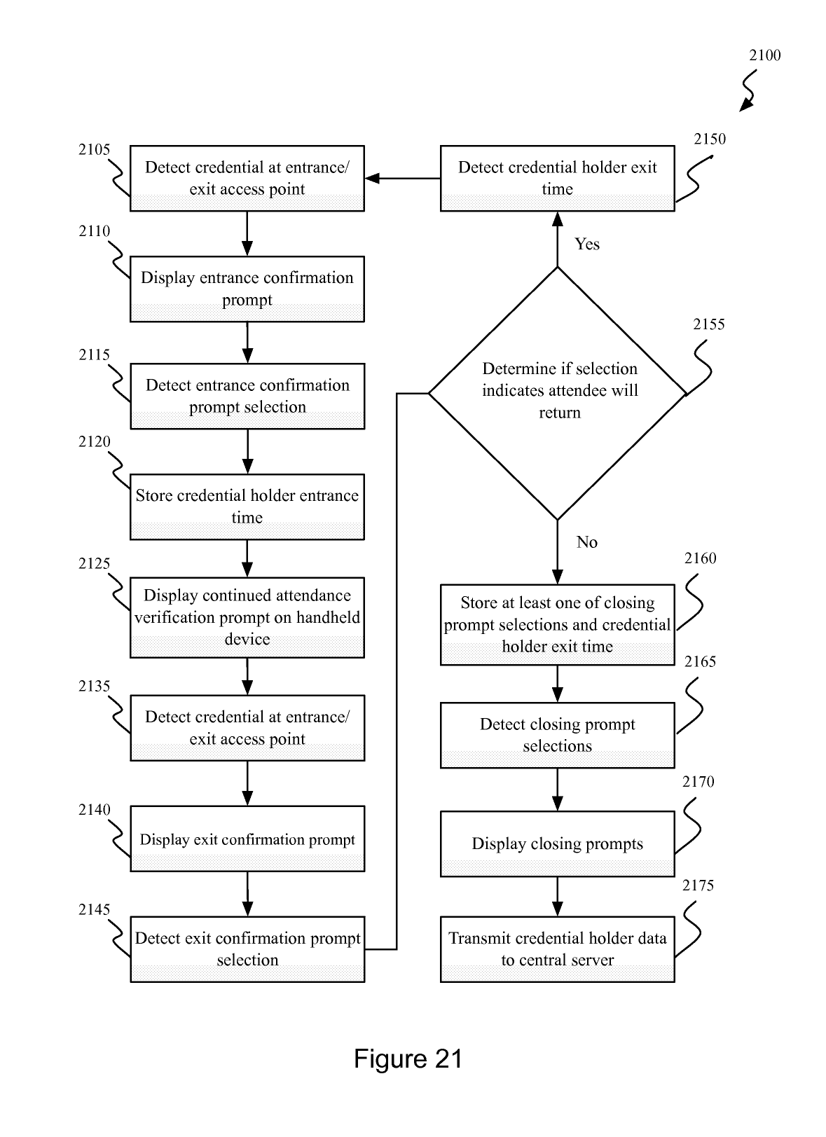

Referring now to FIG. 8 through FIG. 21, various processes flows for an automated interest collection and tracking system are included.

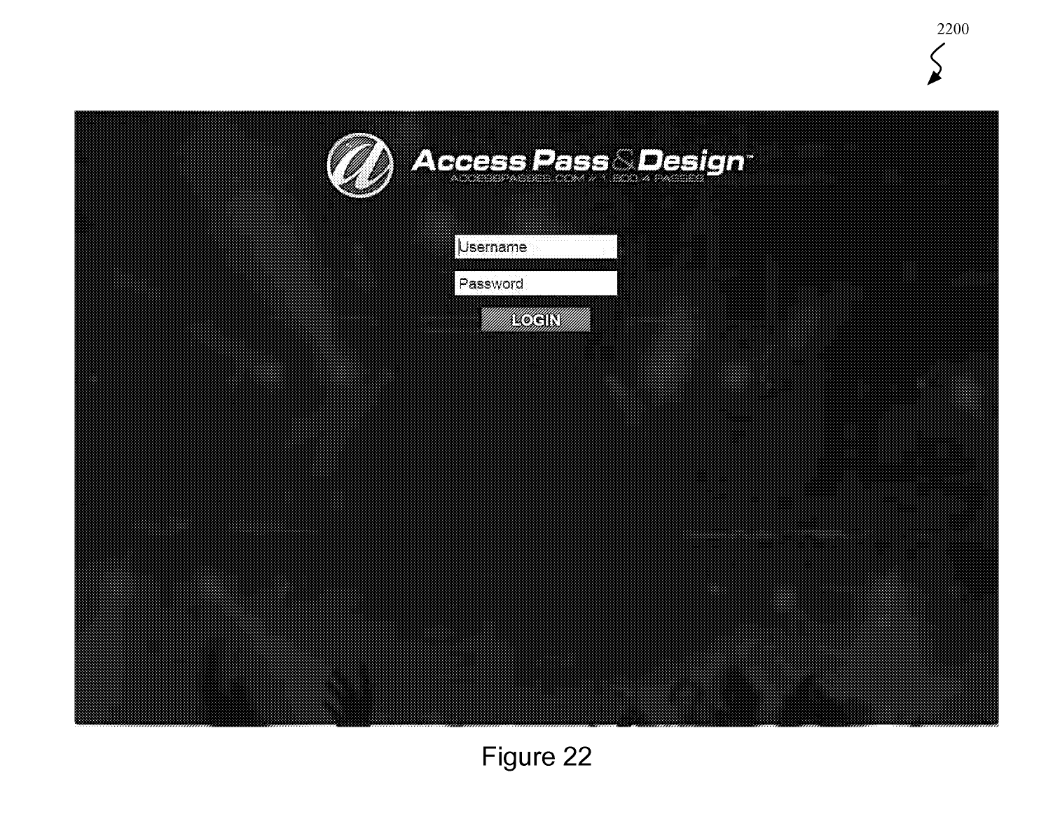

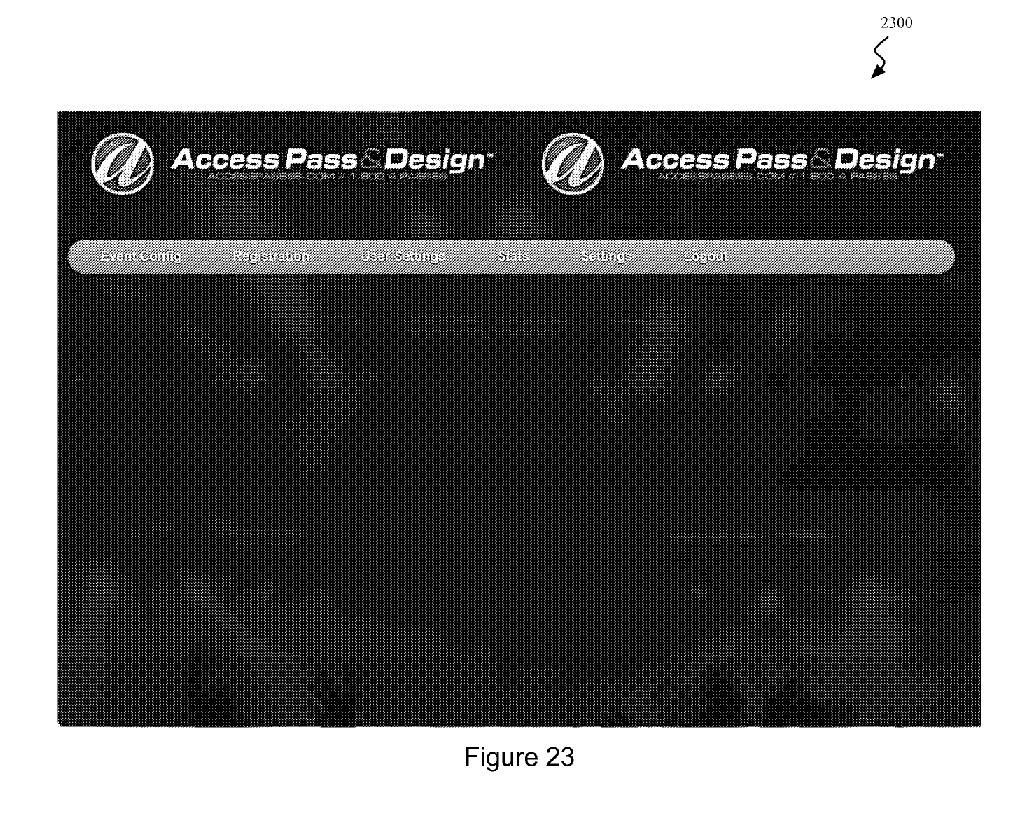

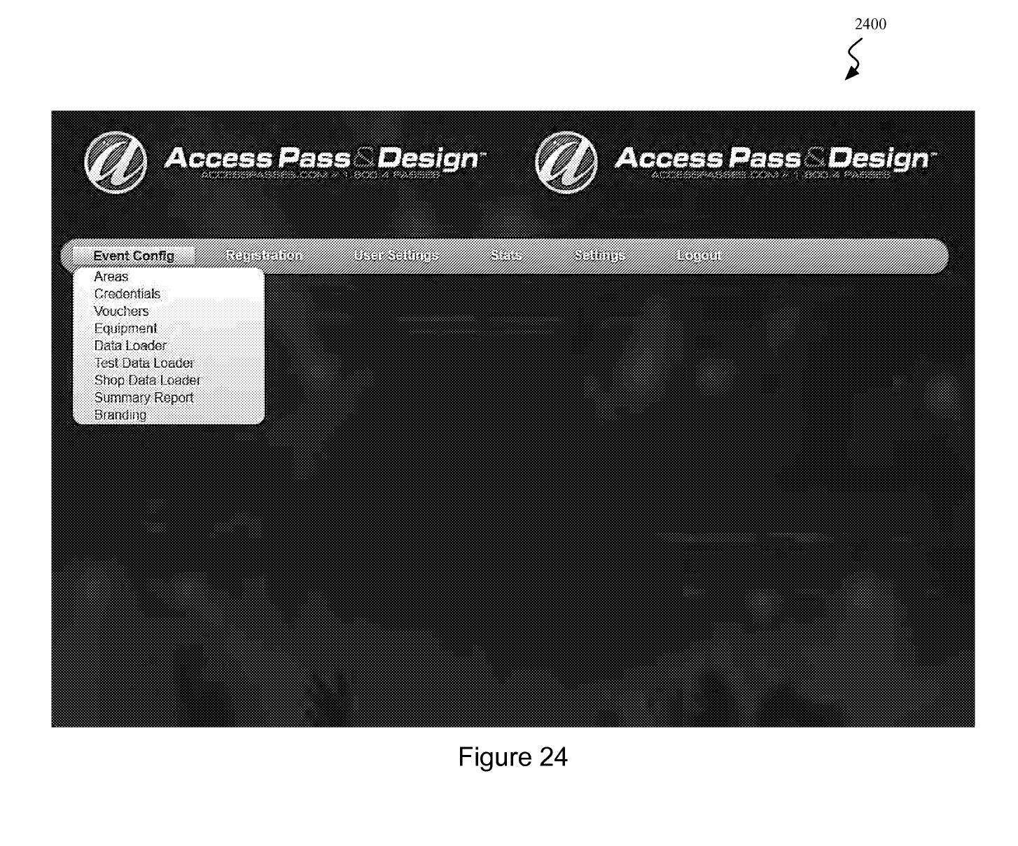

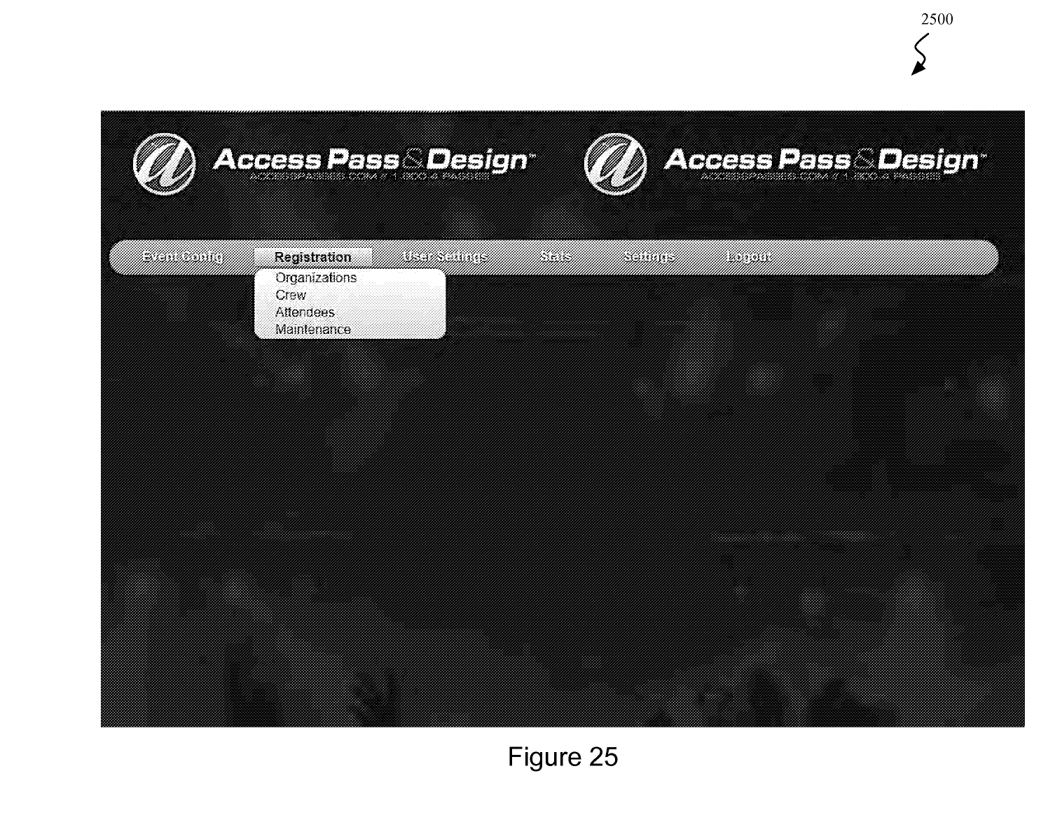

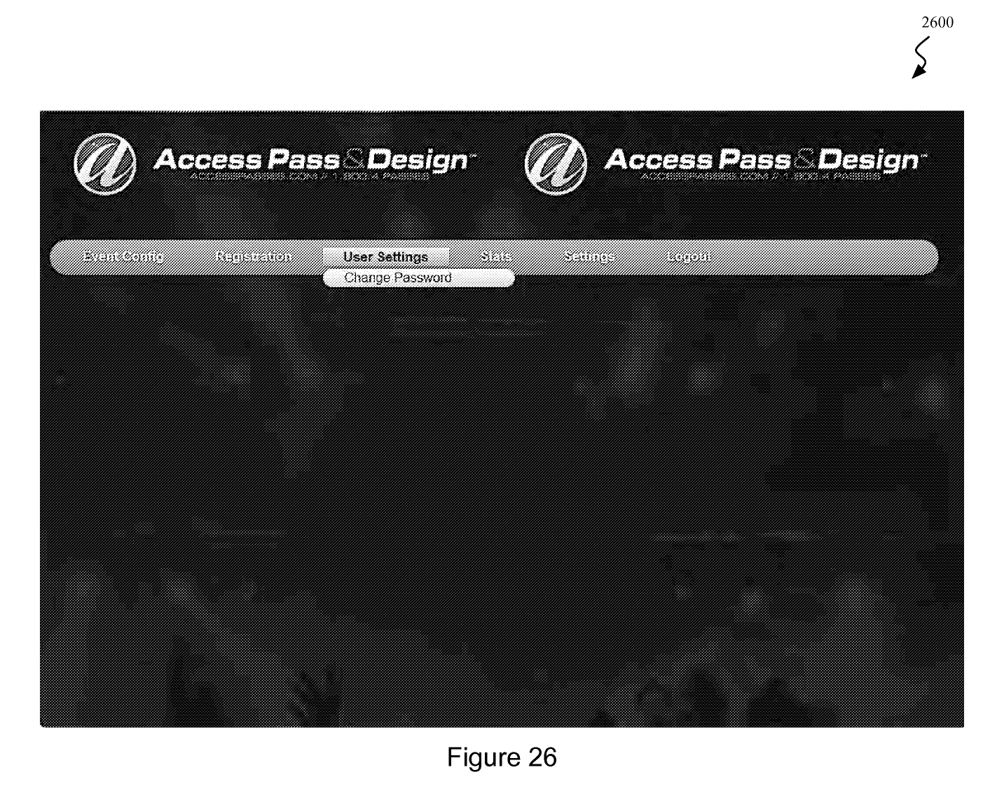

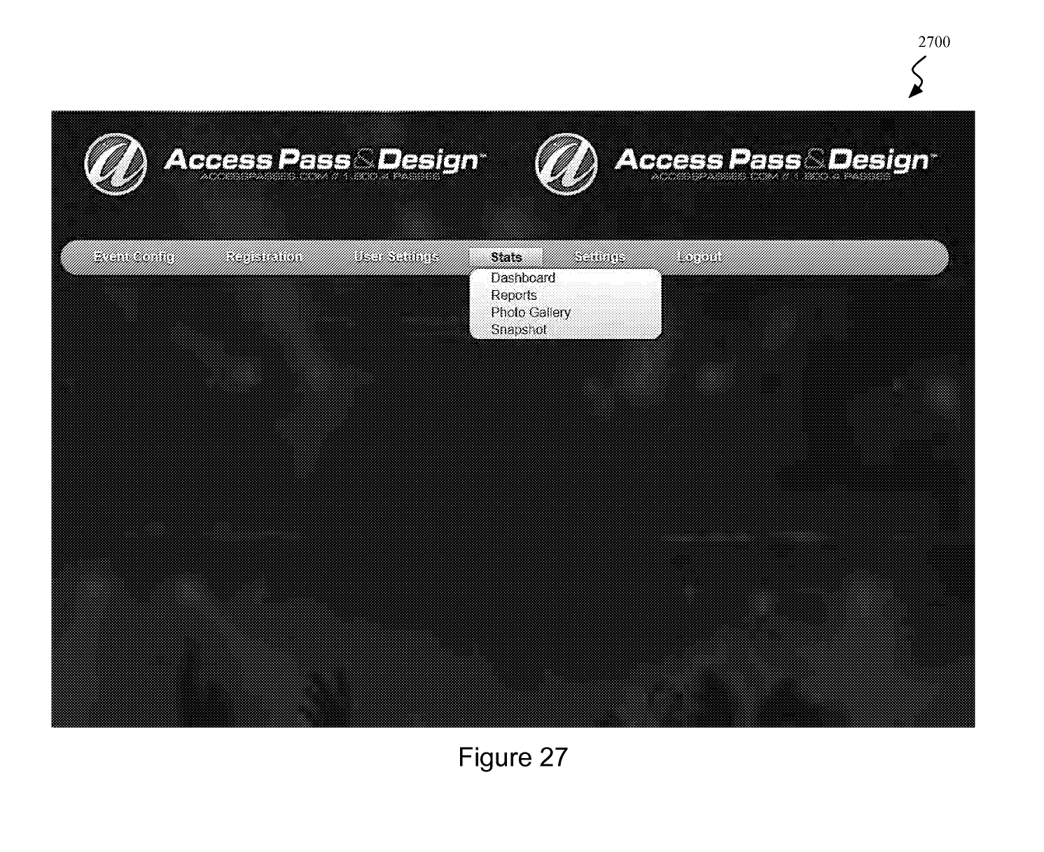

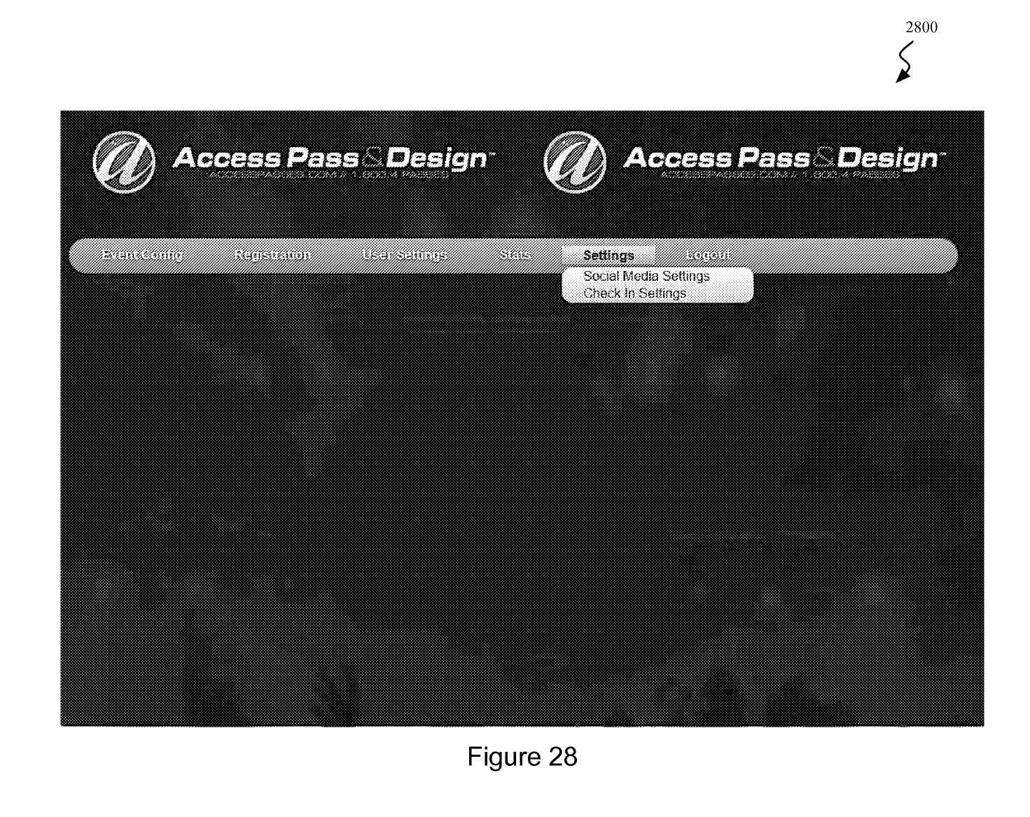

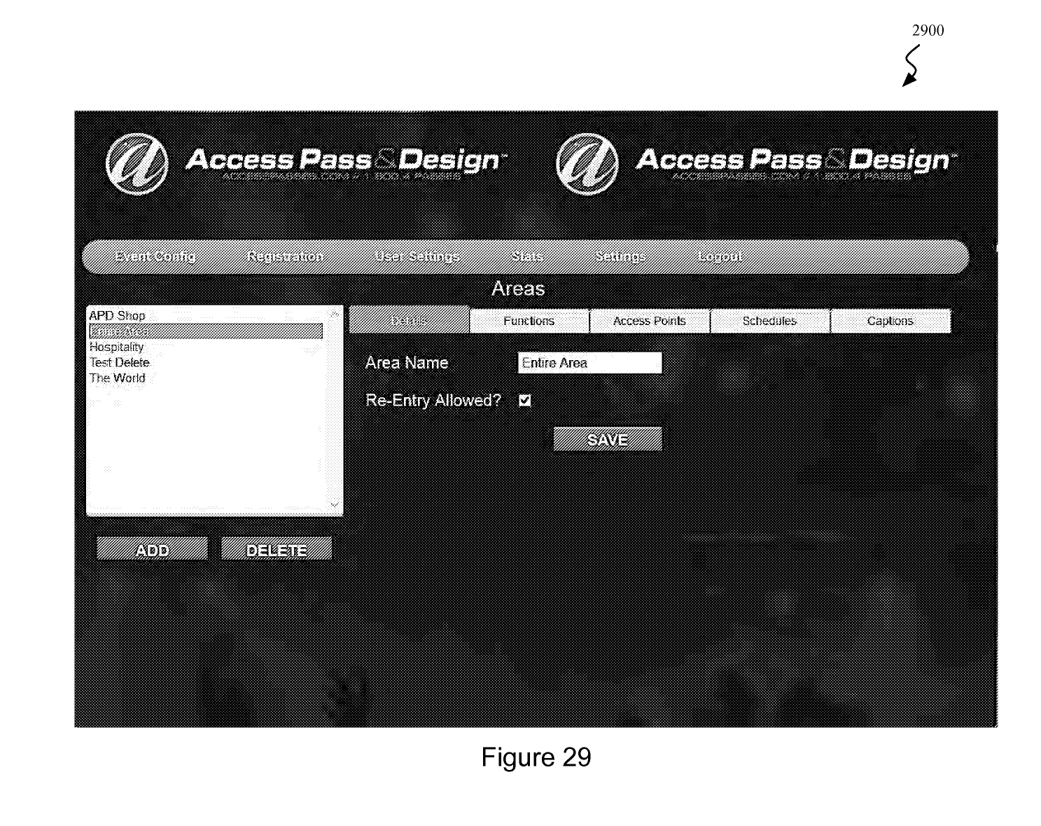

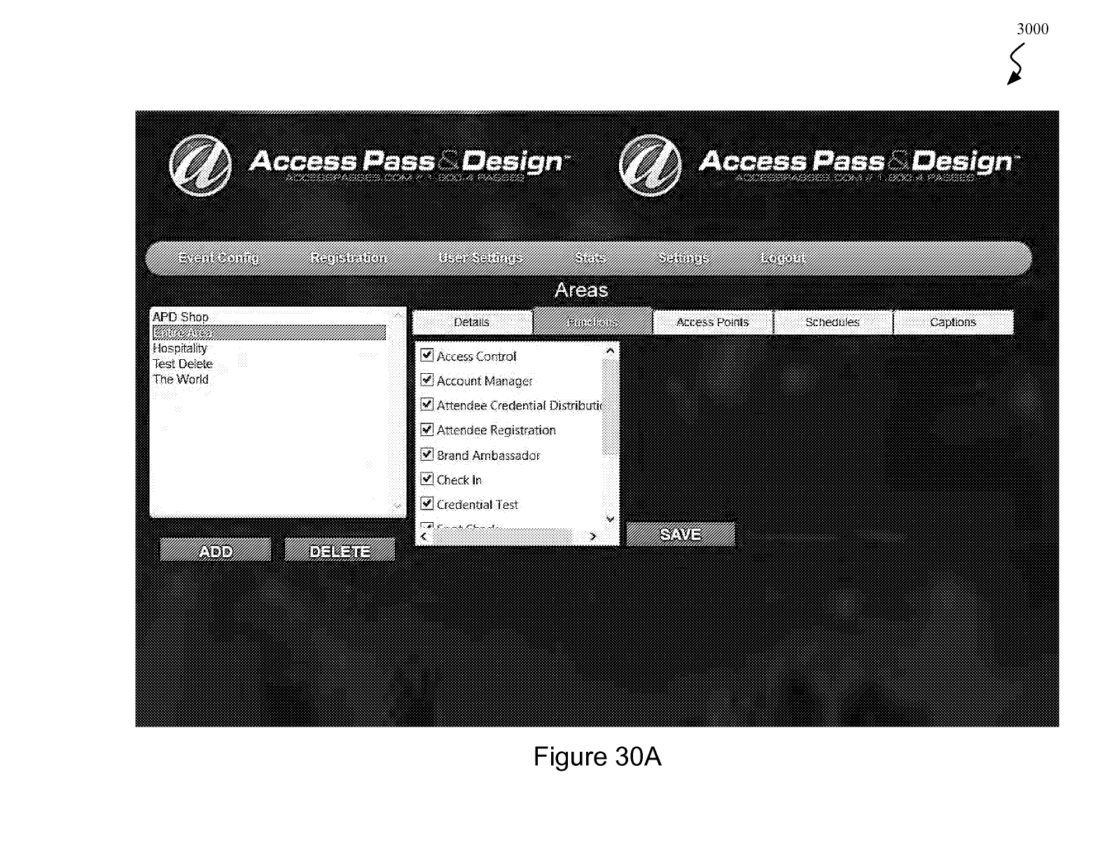

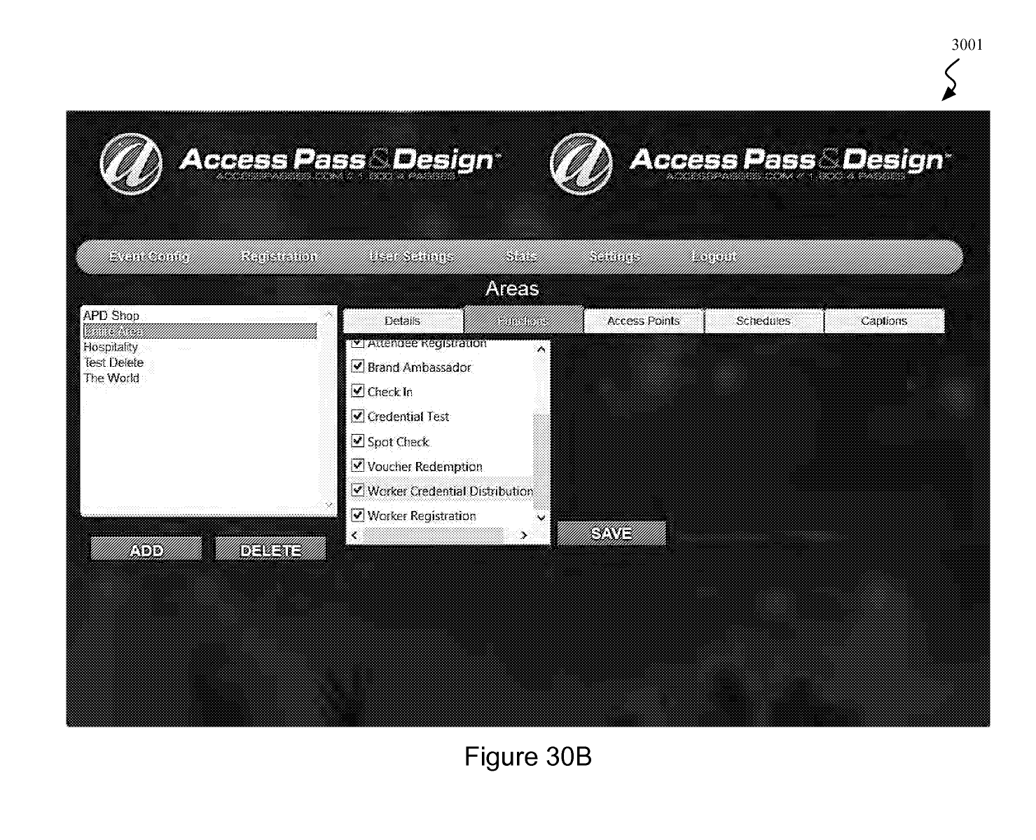

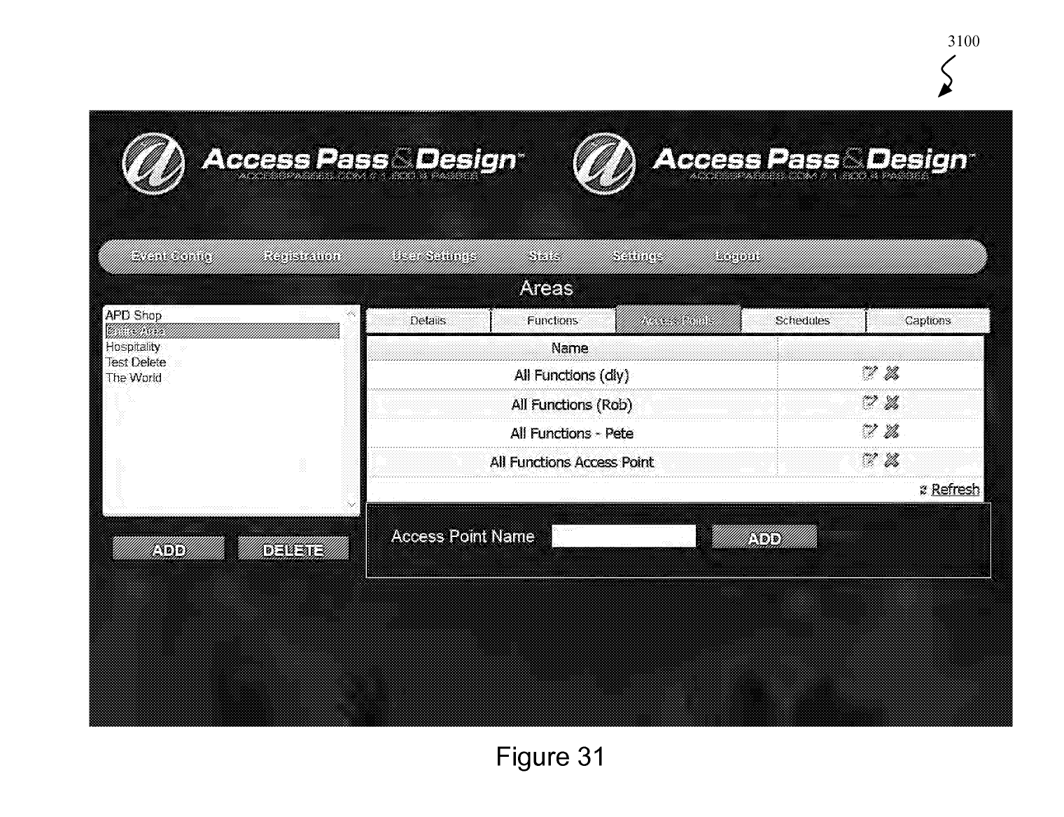

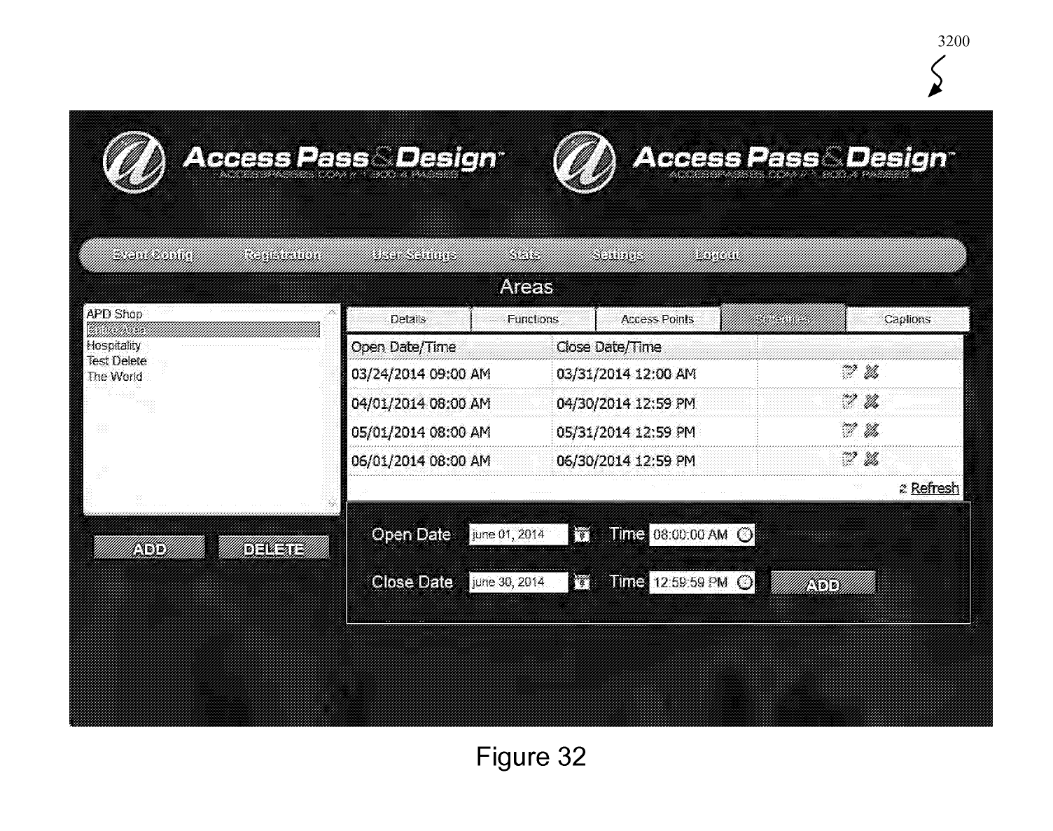

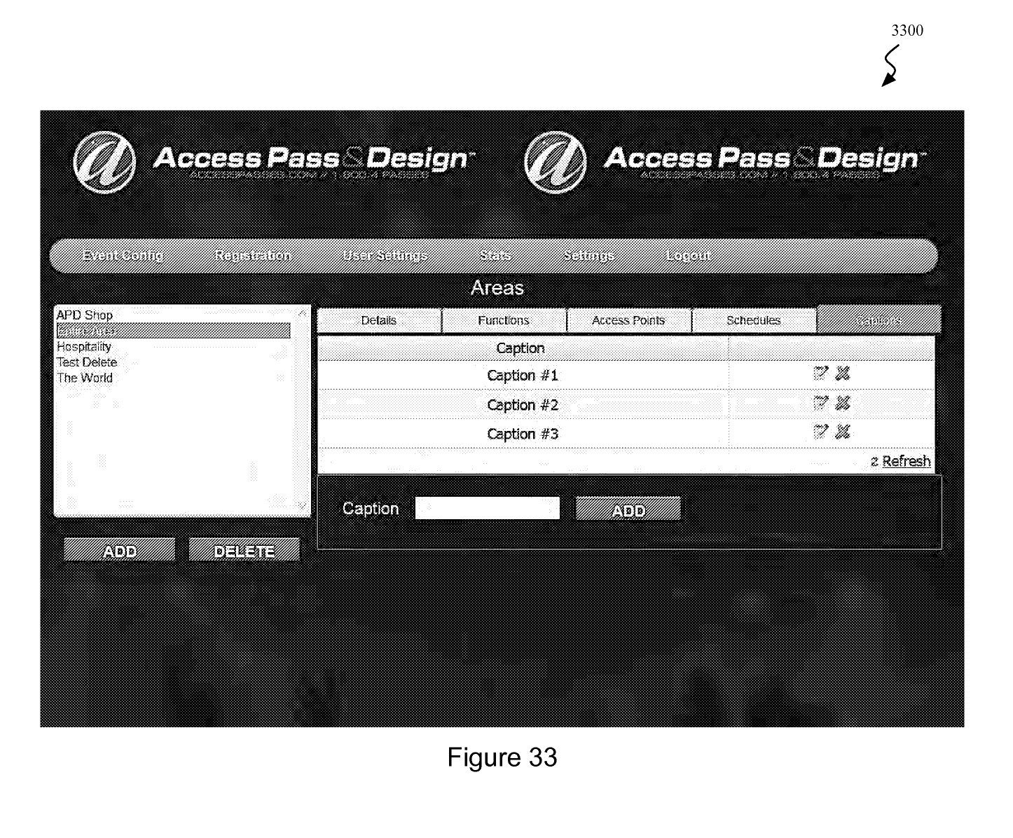

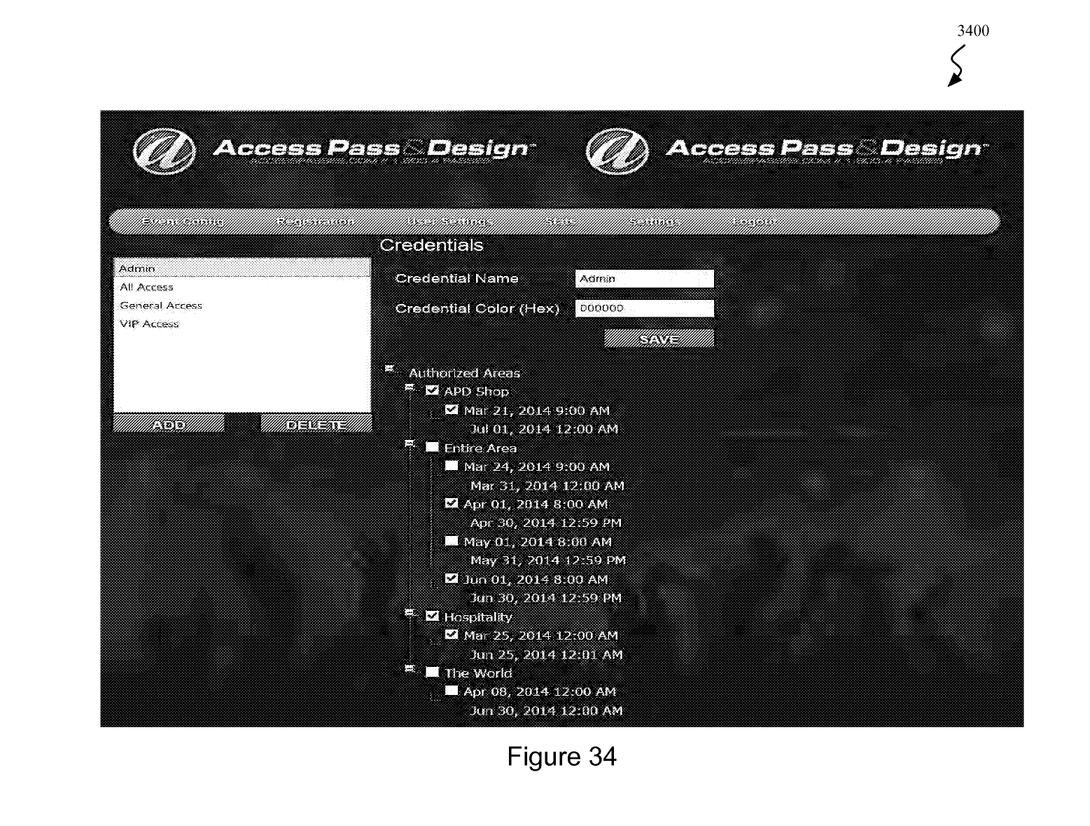

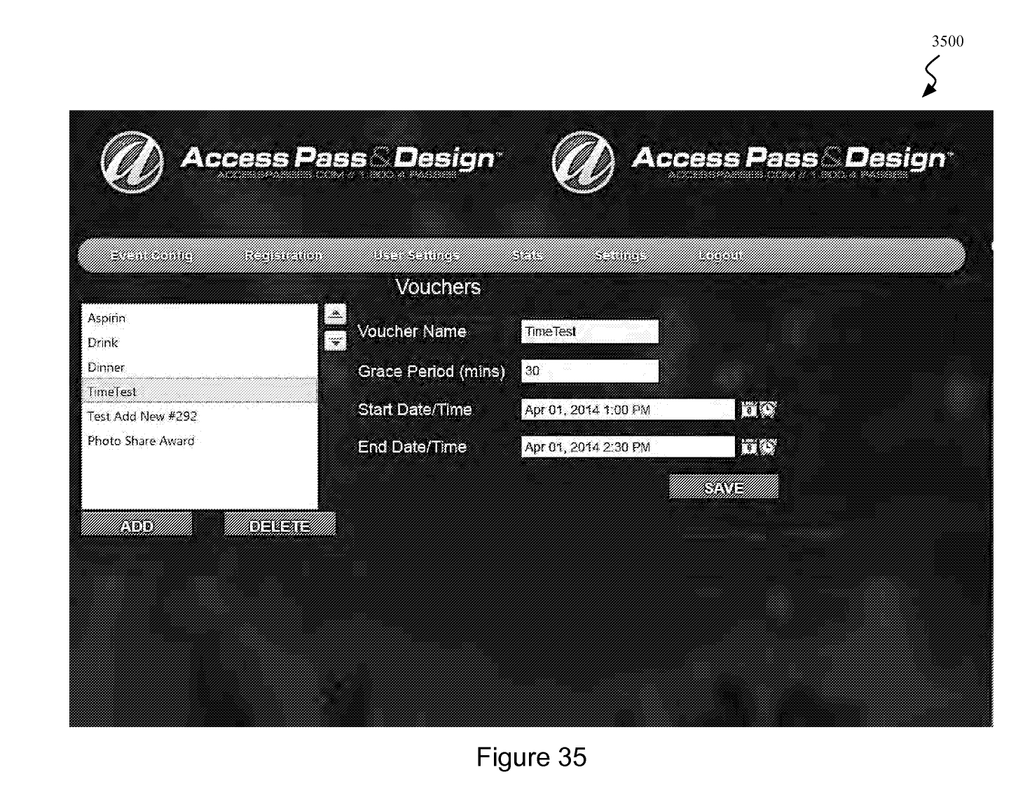

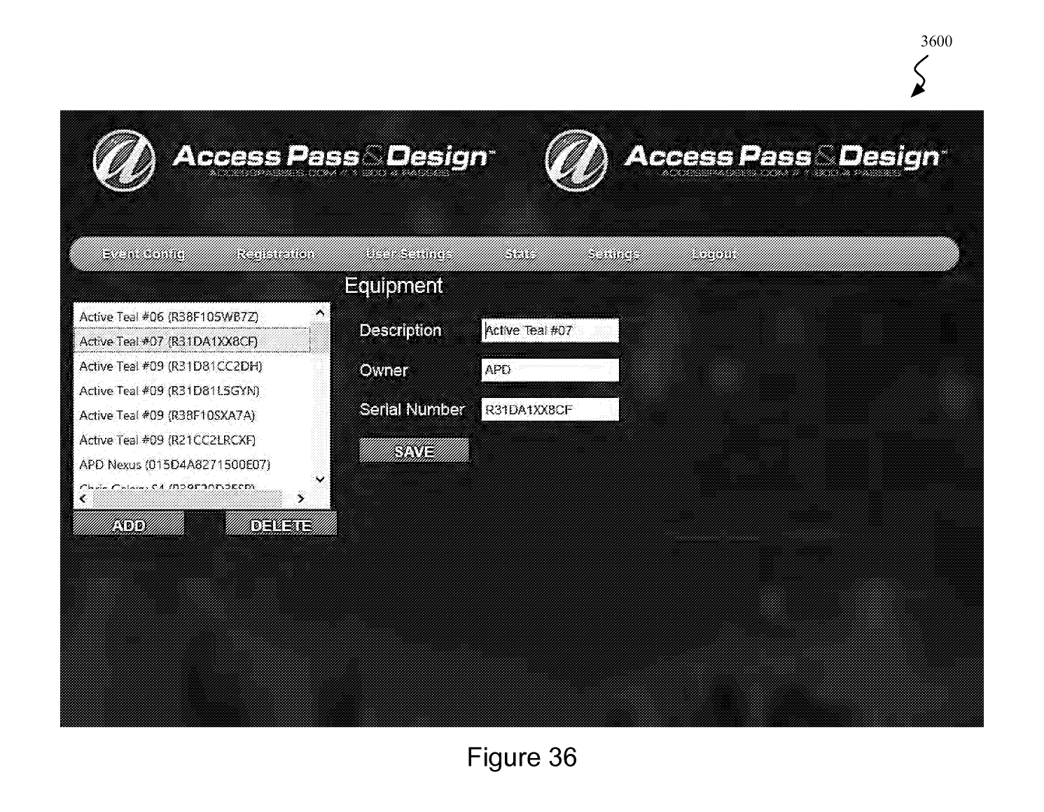

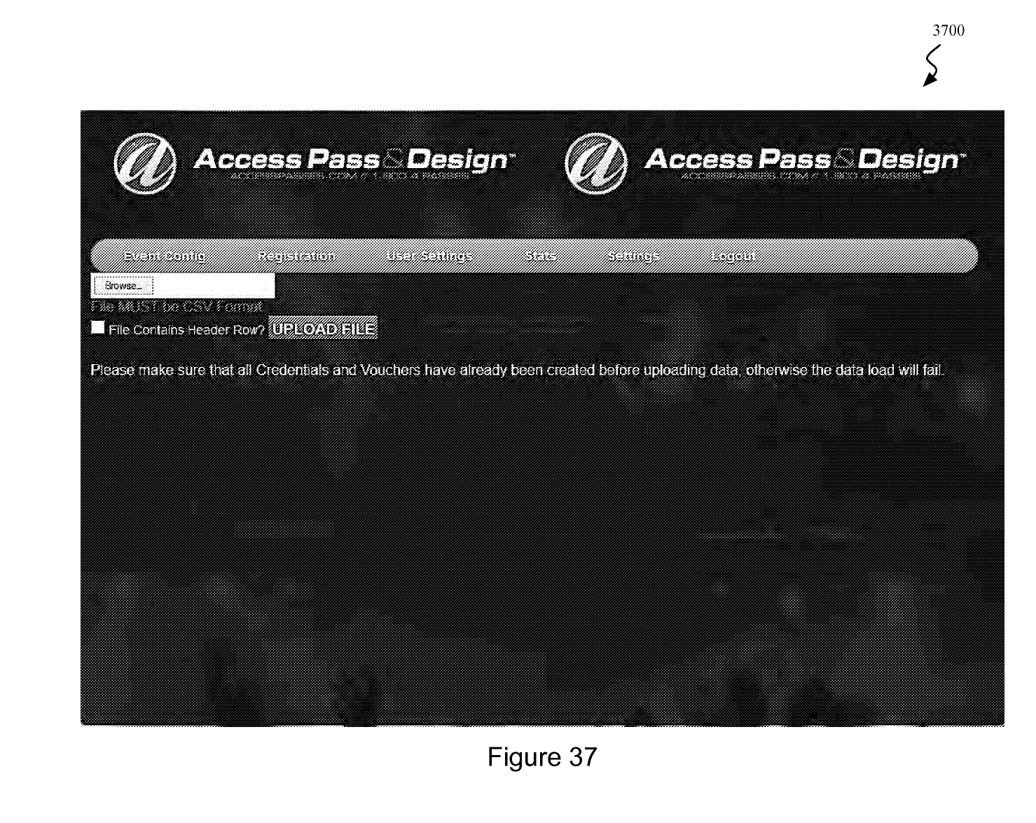

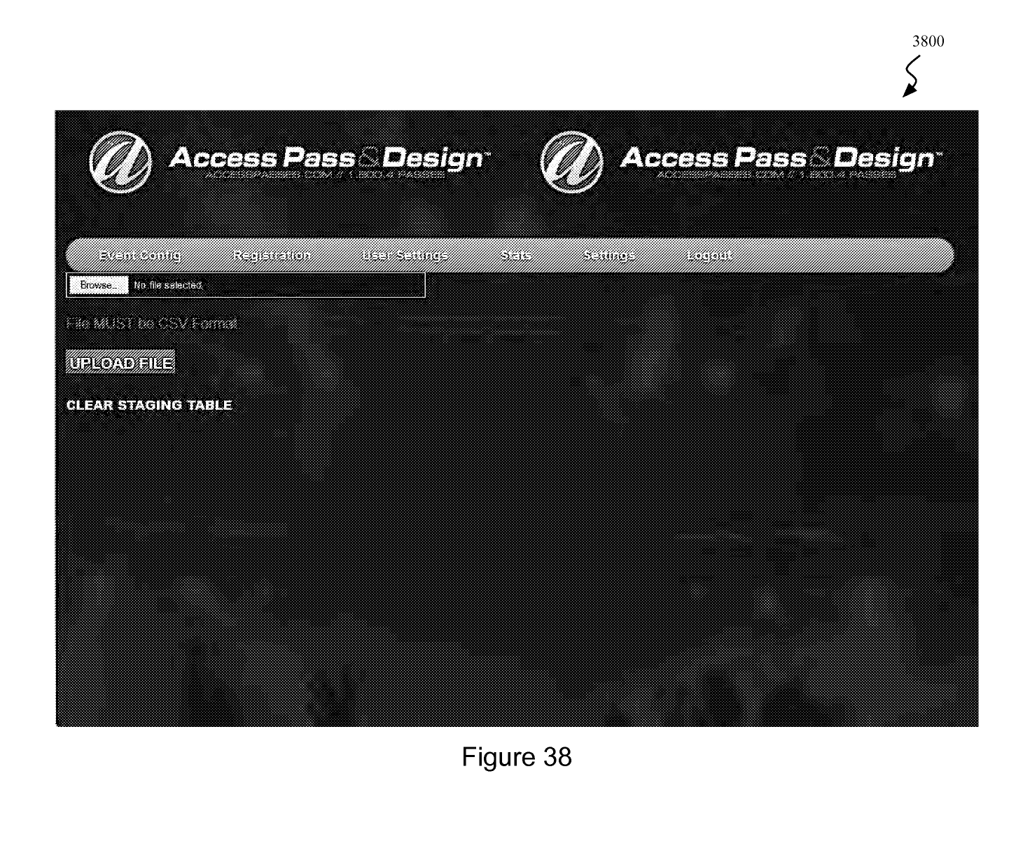

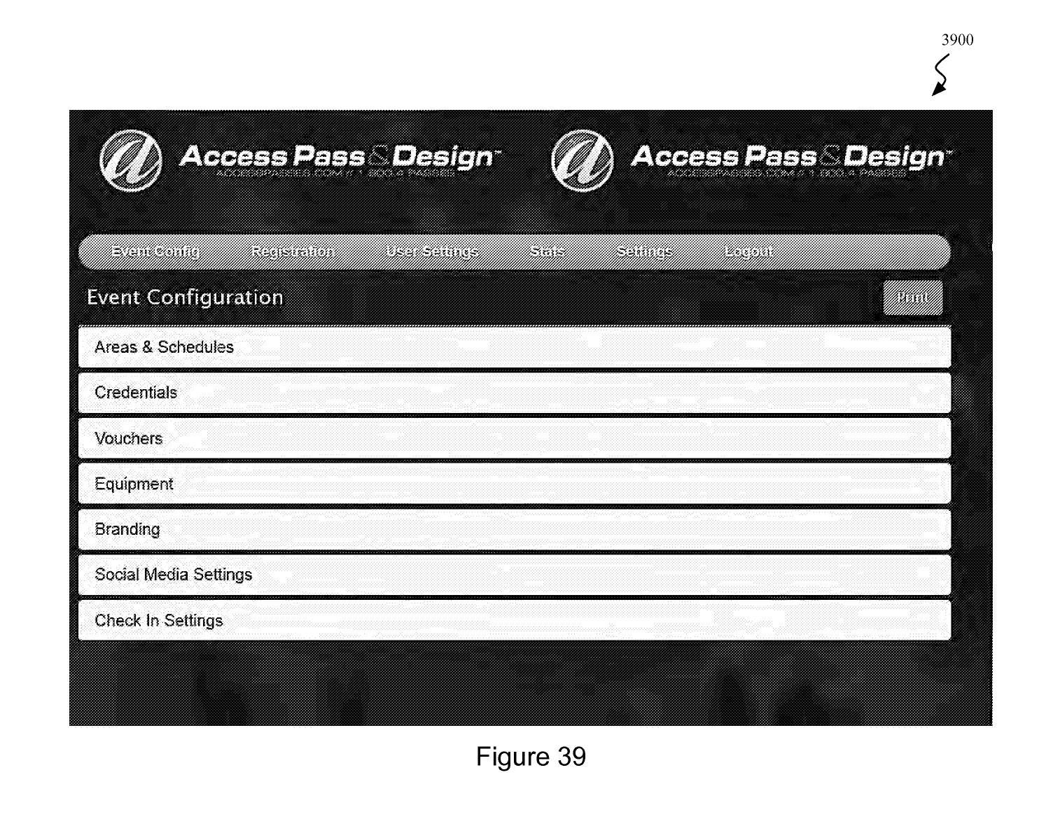

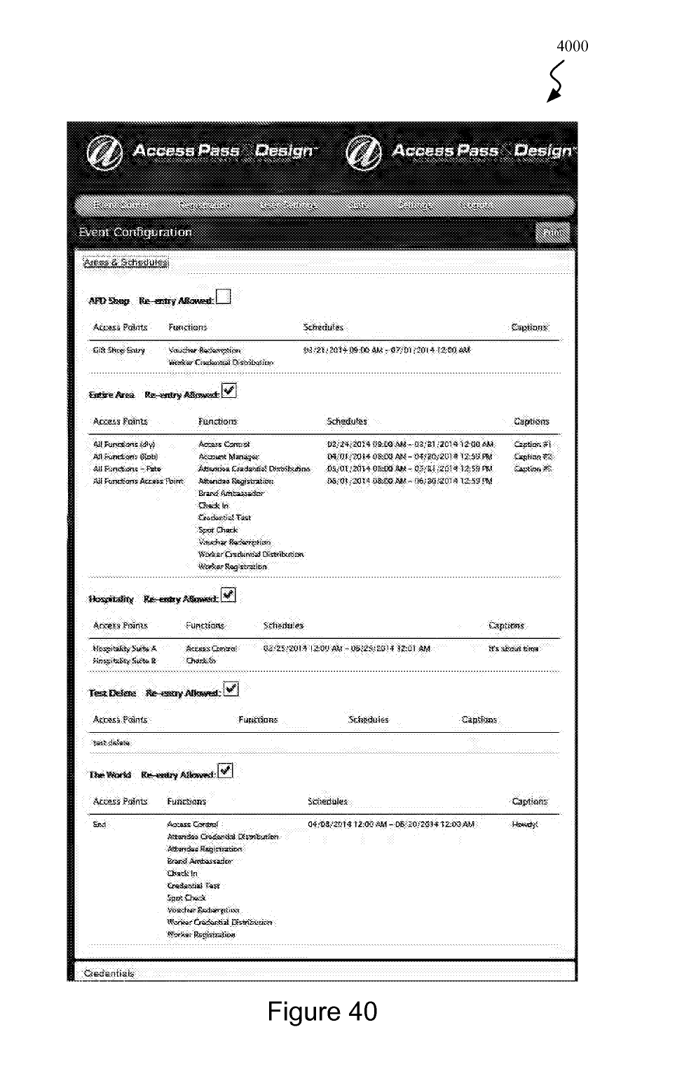

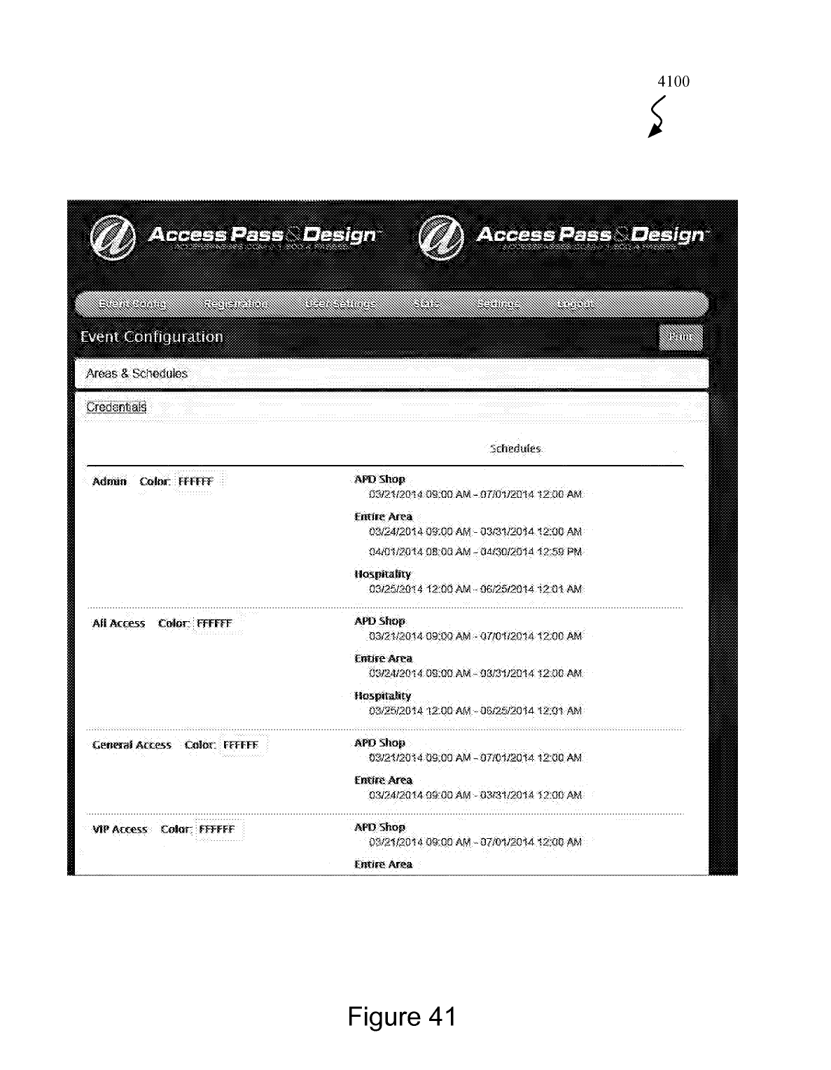

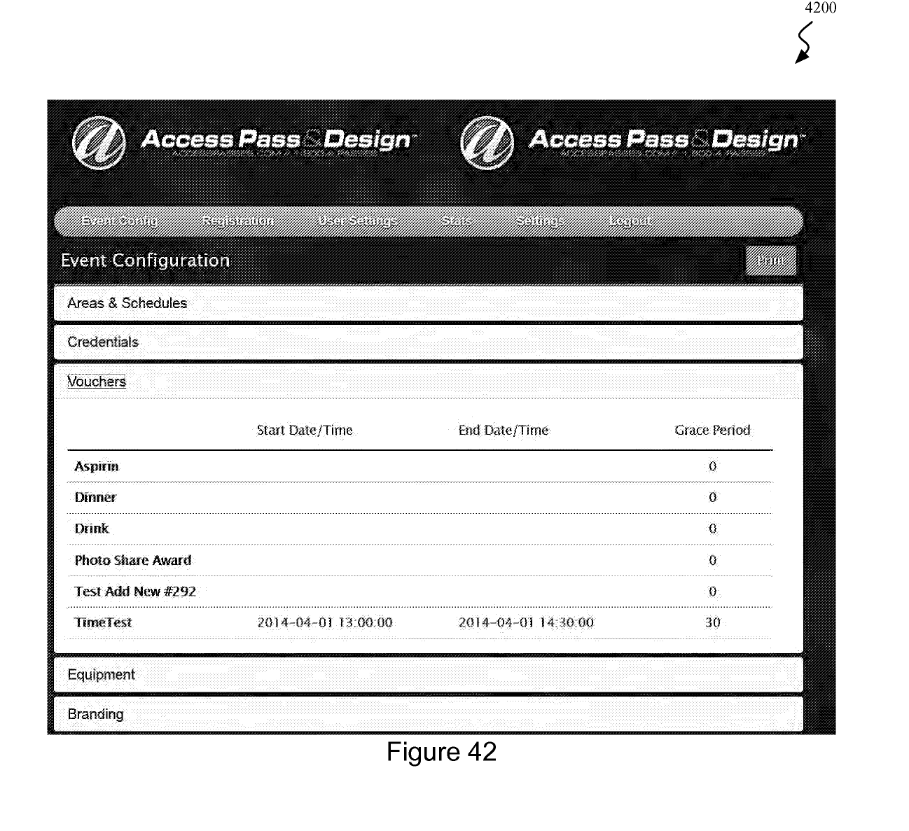

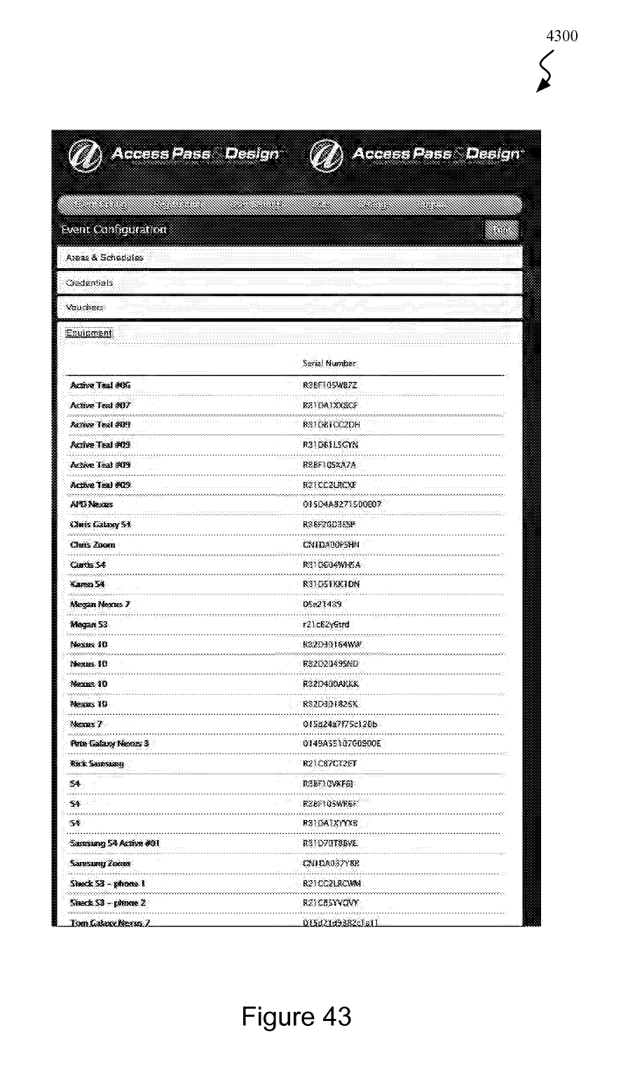

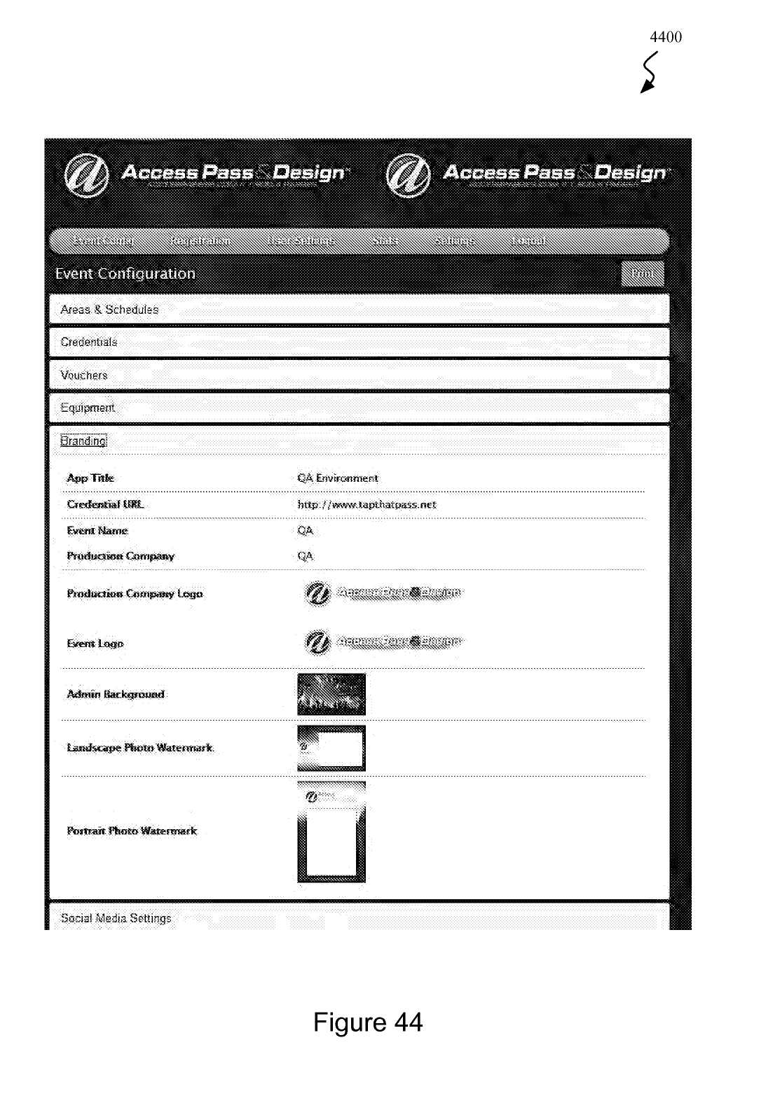

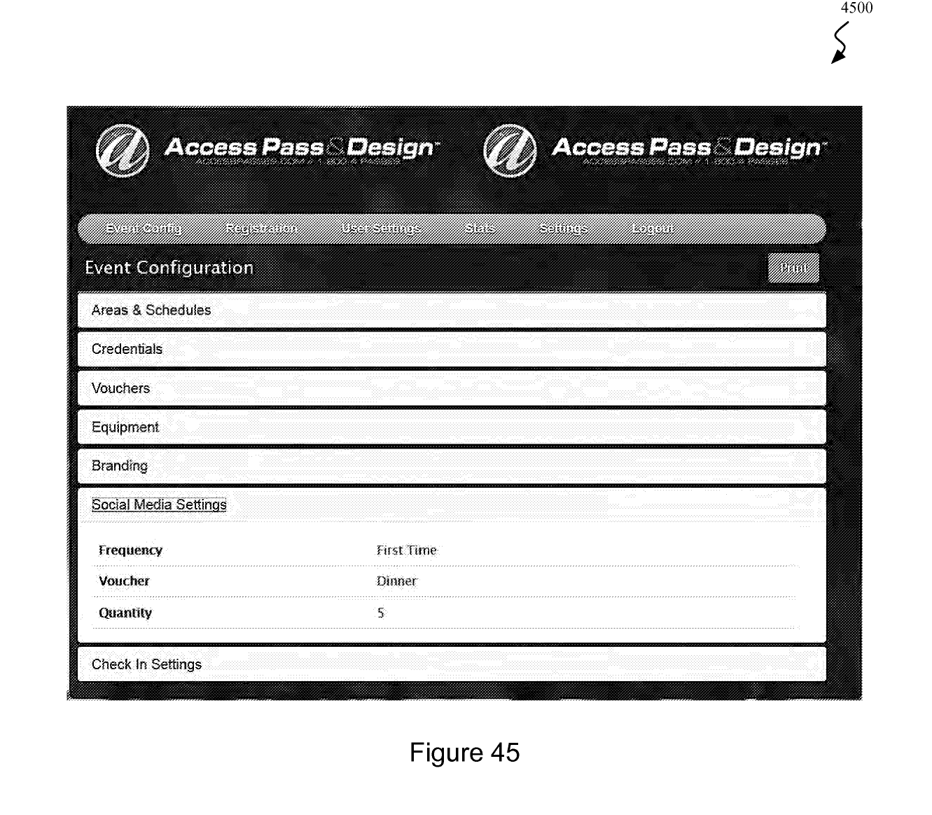

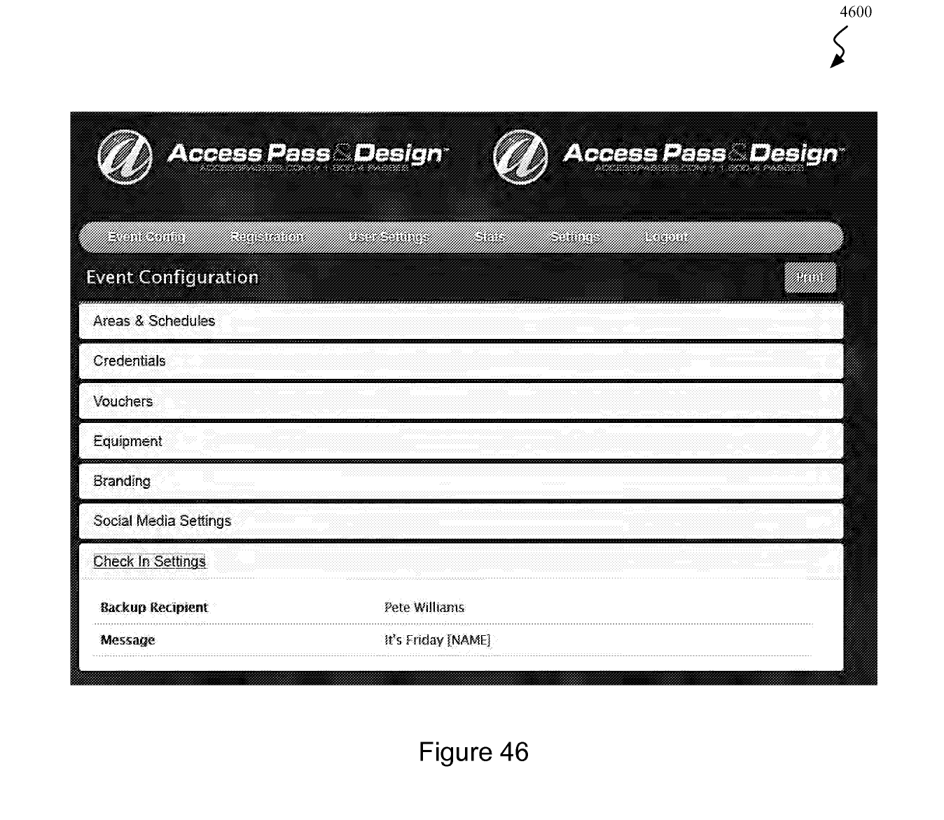

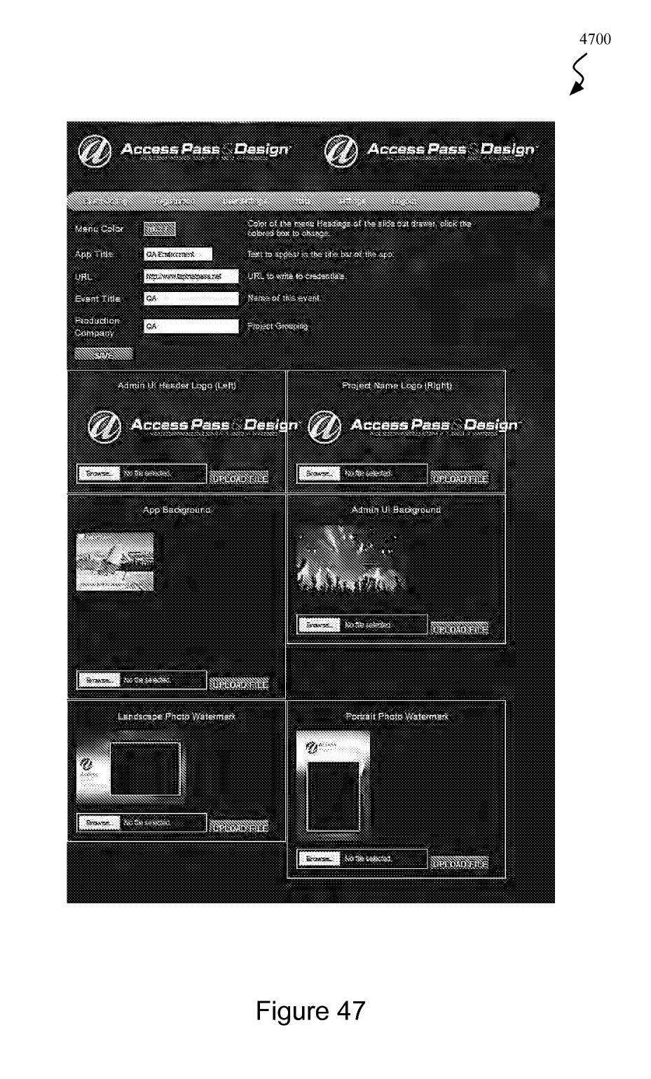

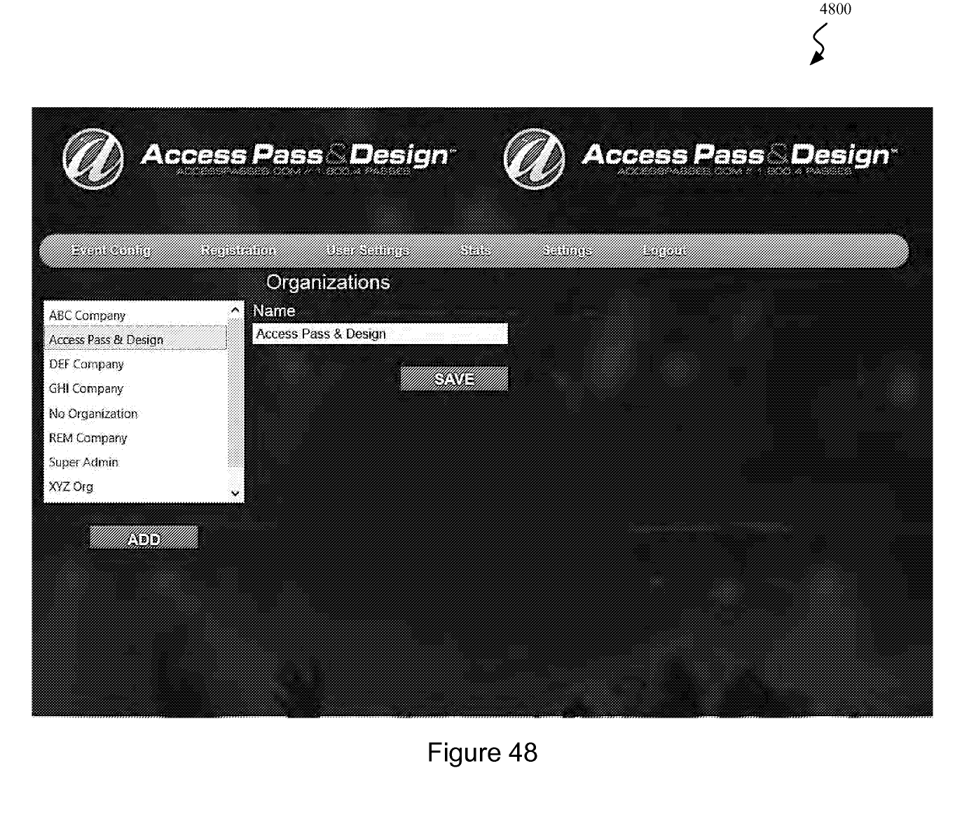

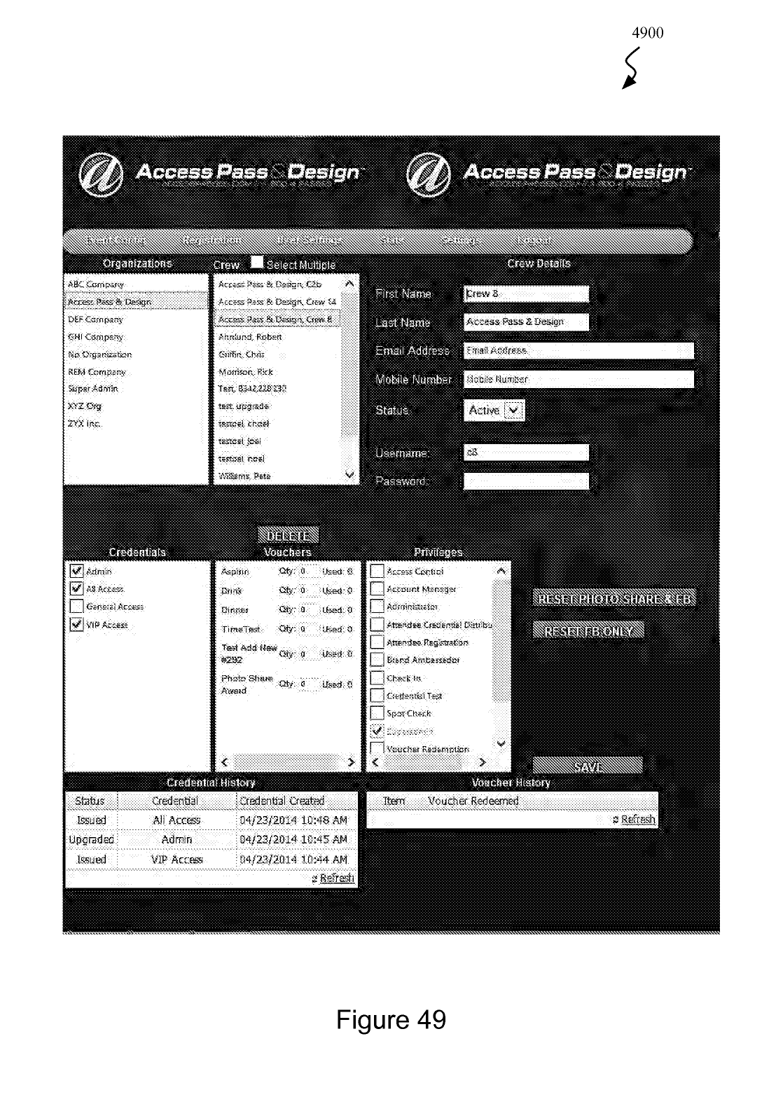

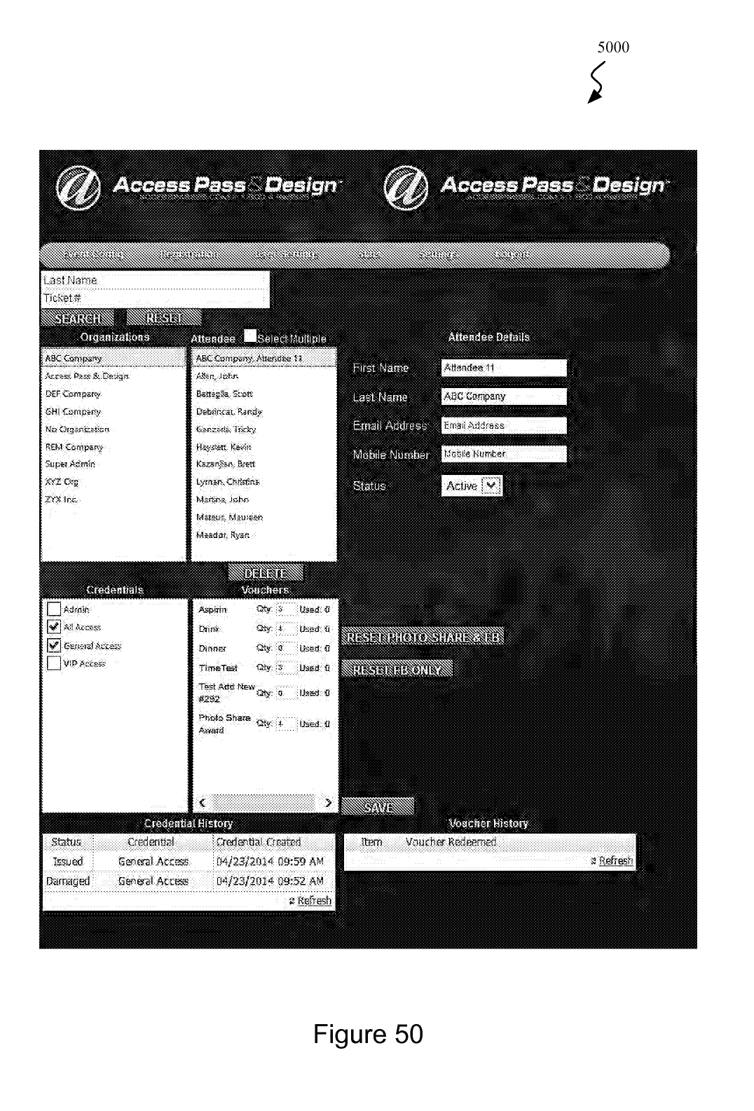

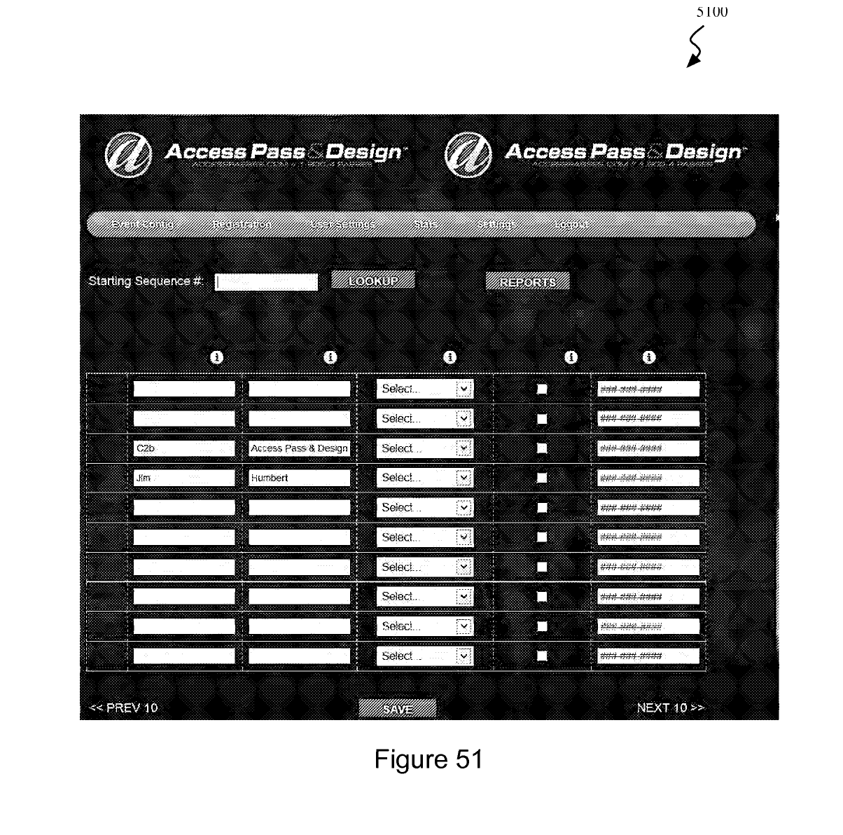

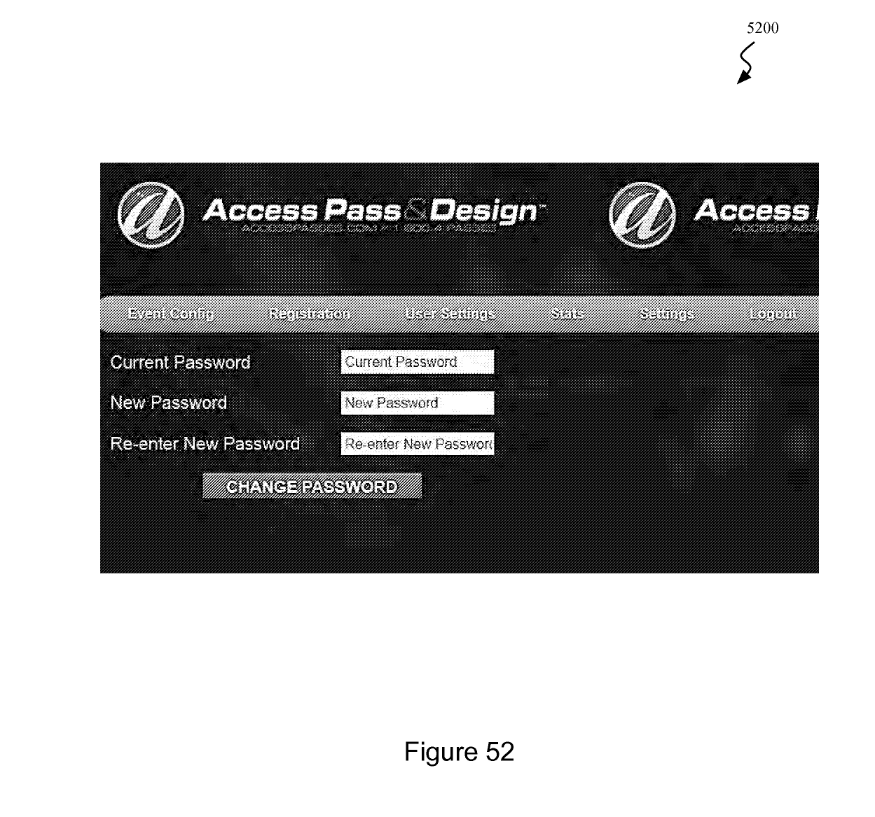

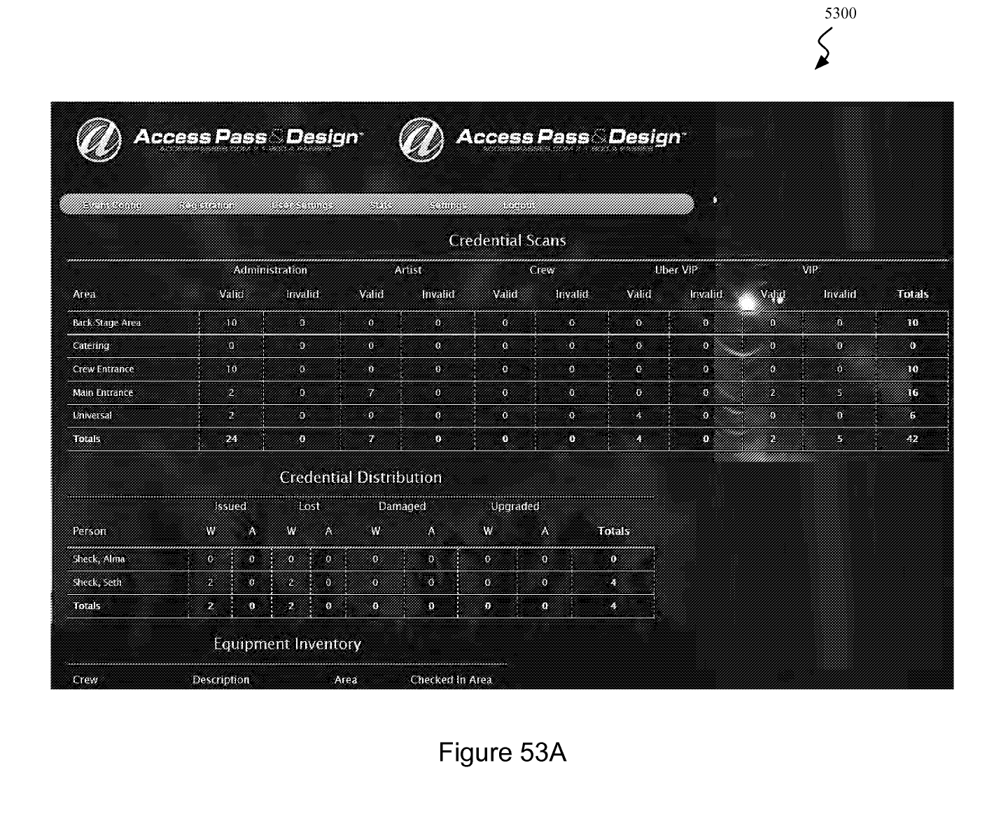

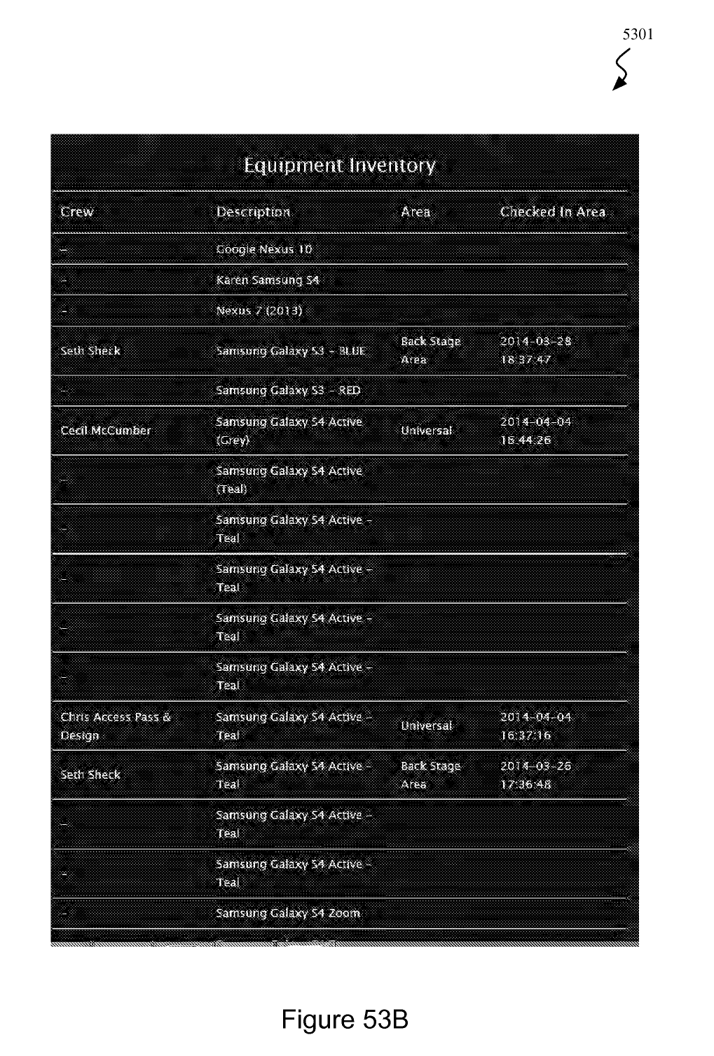

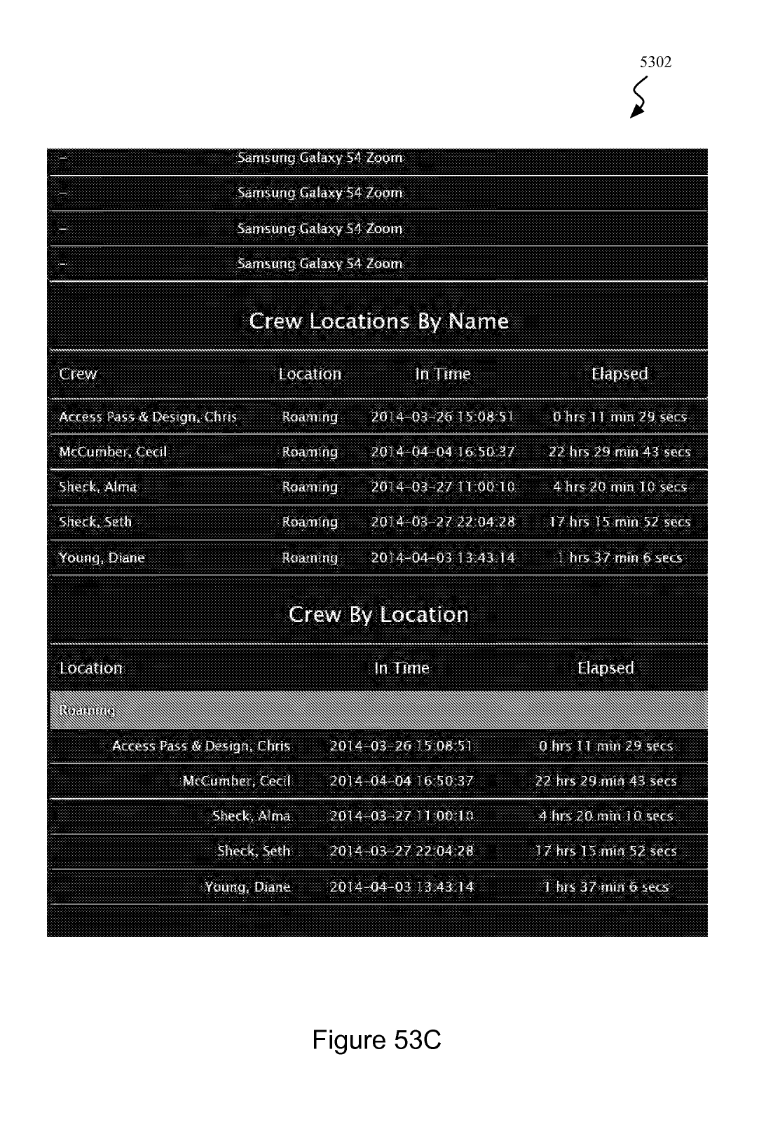

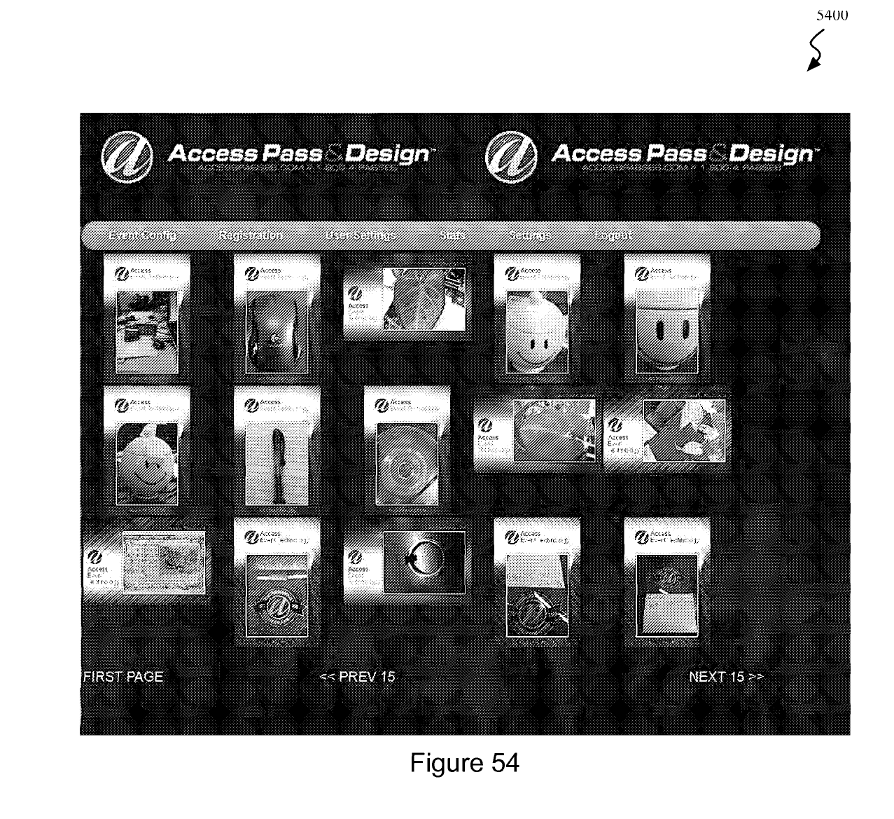

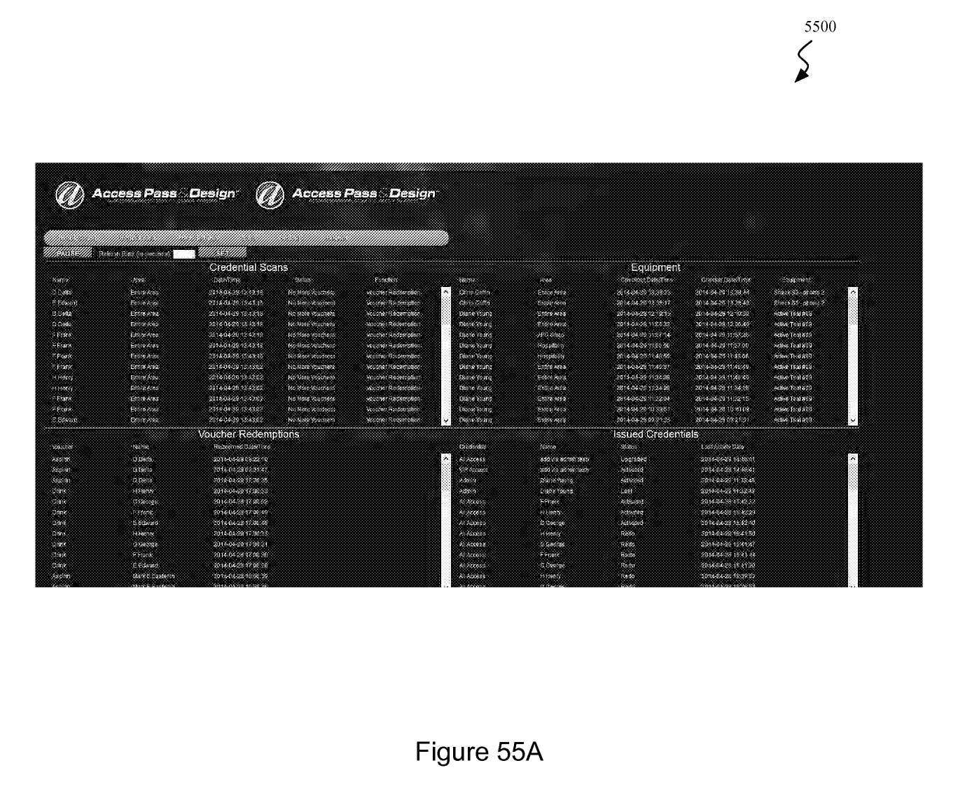

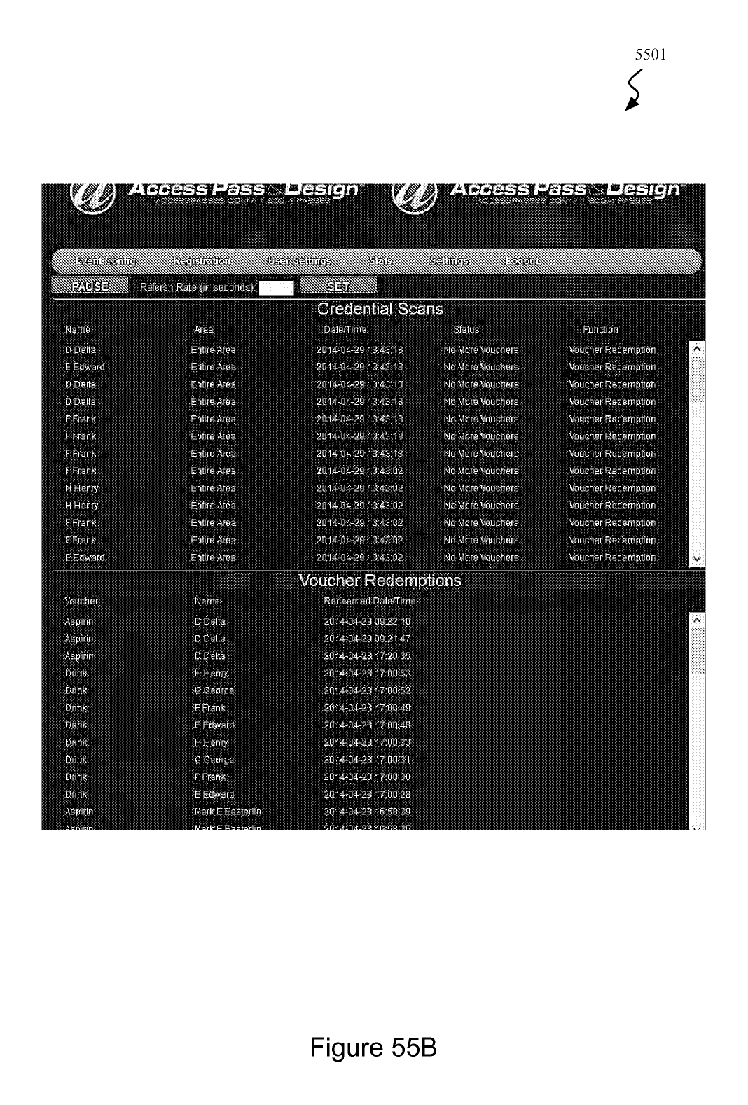

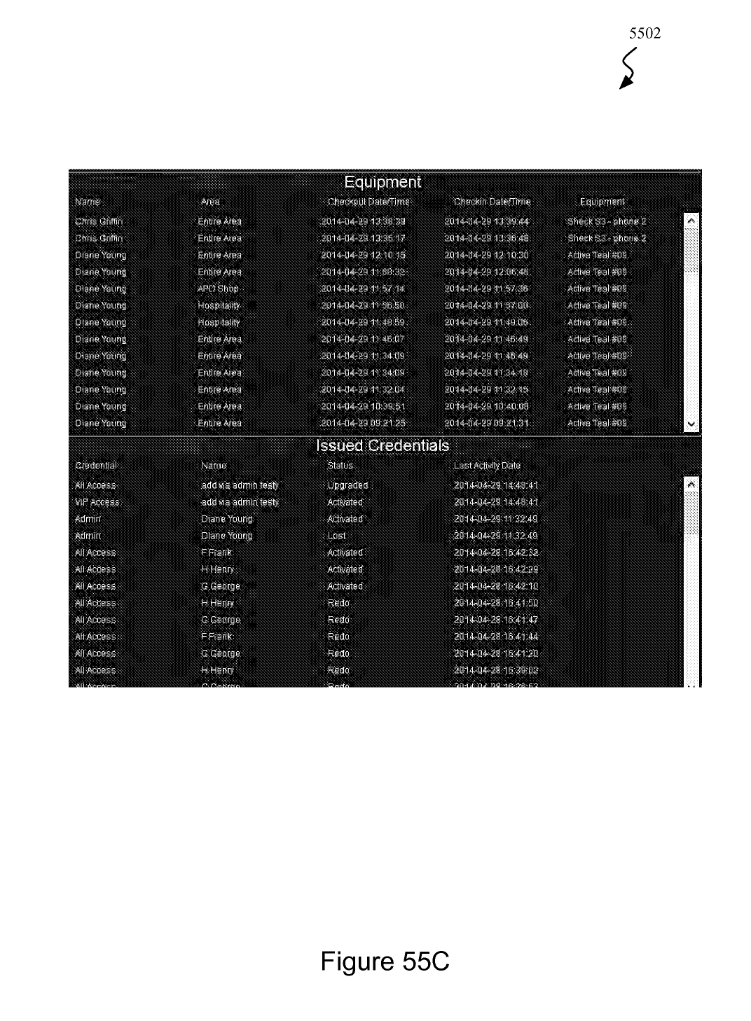

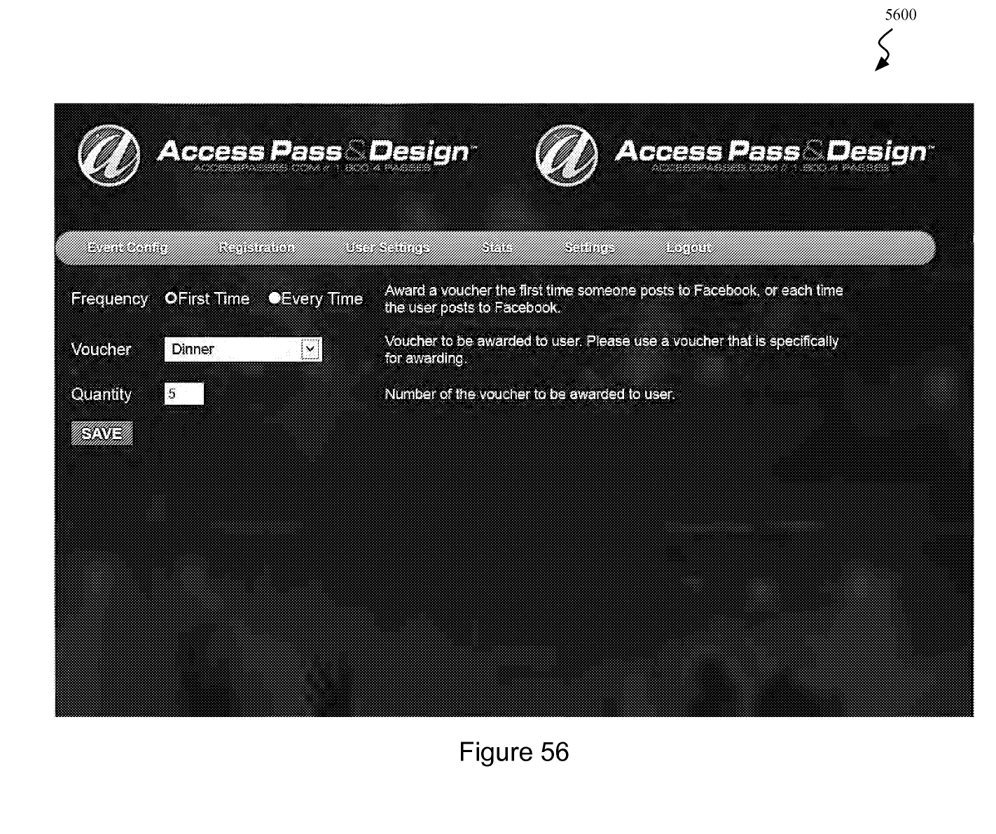

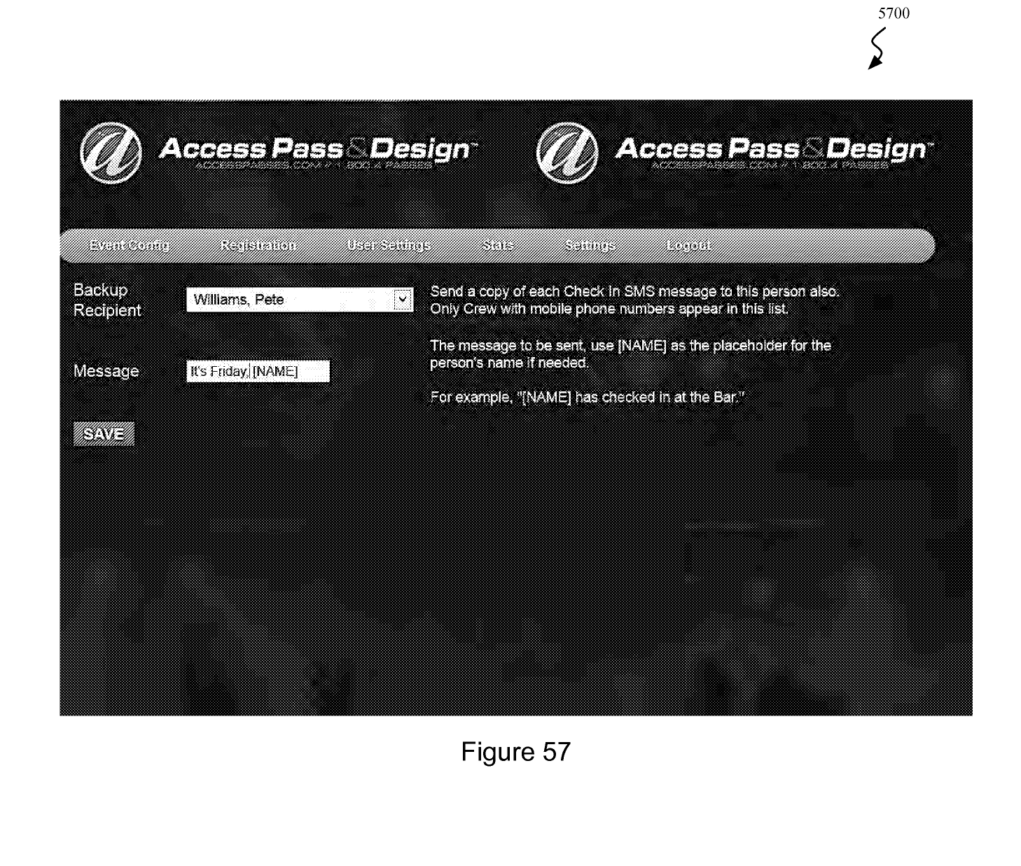

Referring now to FIG. 22 through FIG. 57, various screen captures for an Administrative Interface are included.

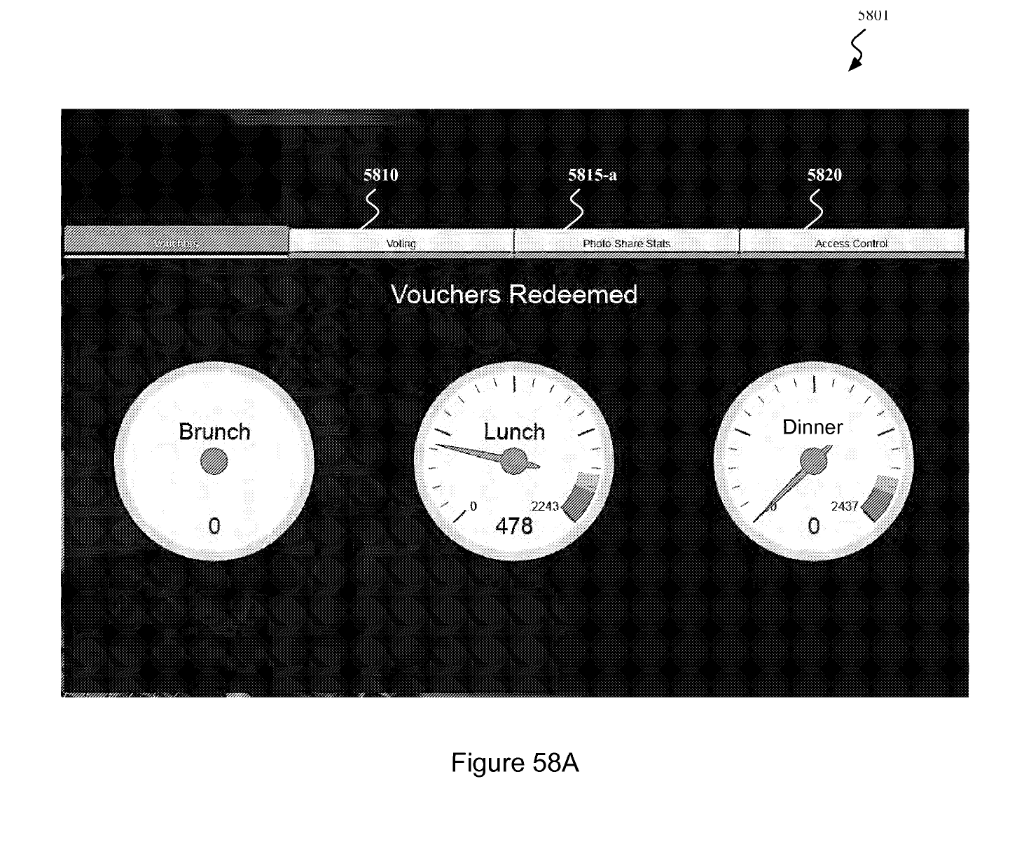

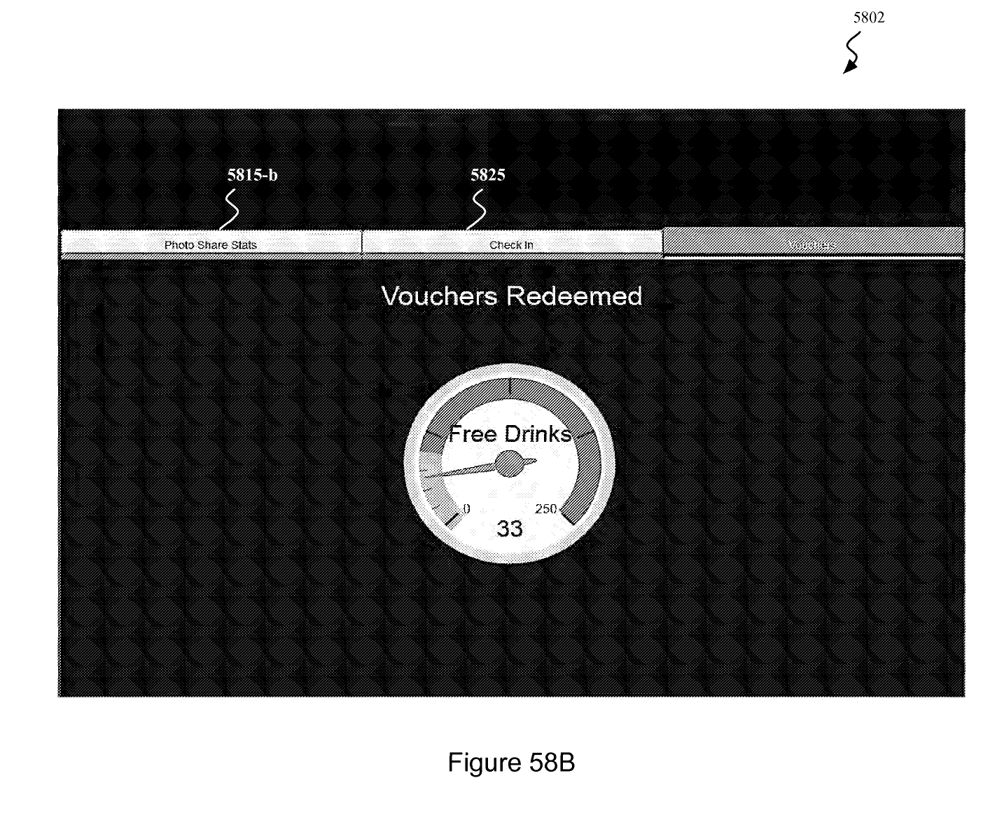

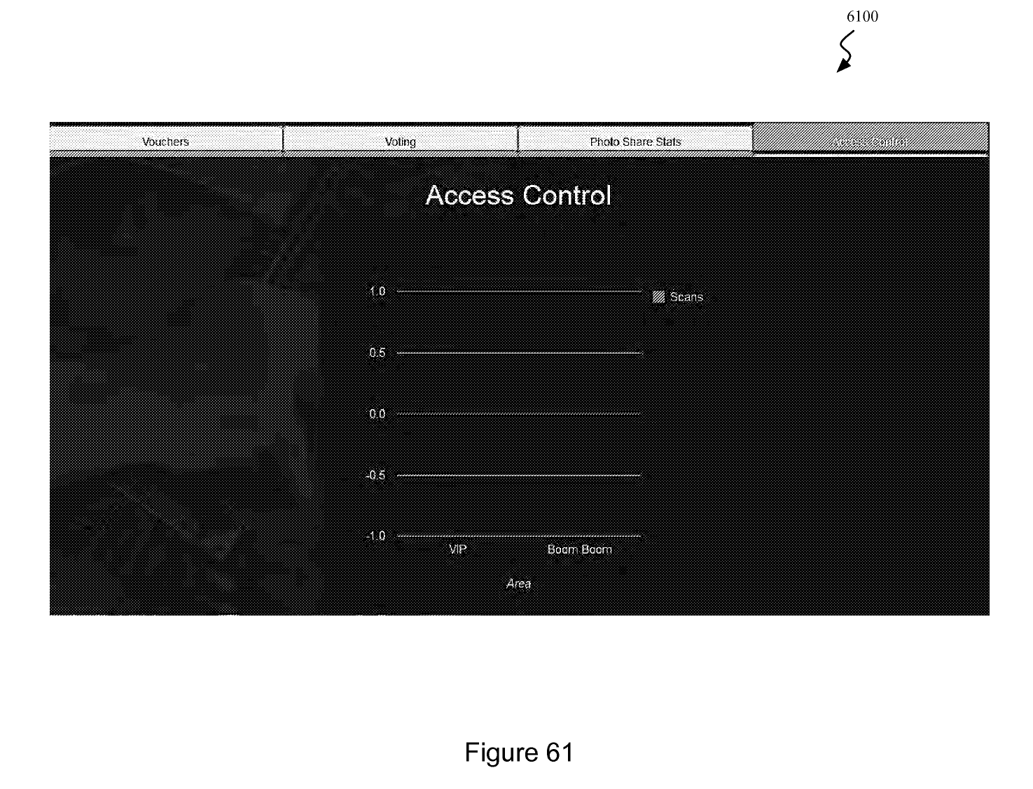

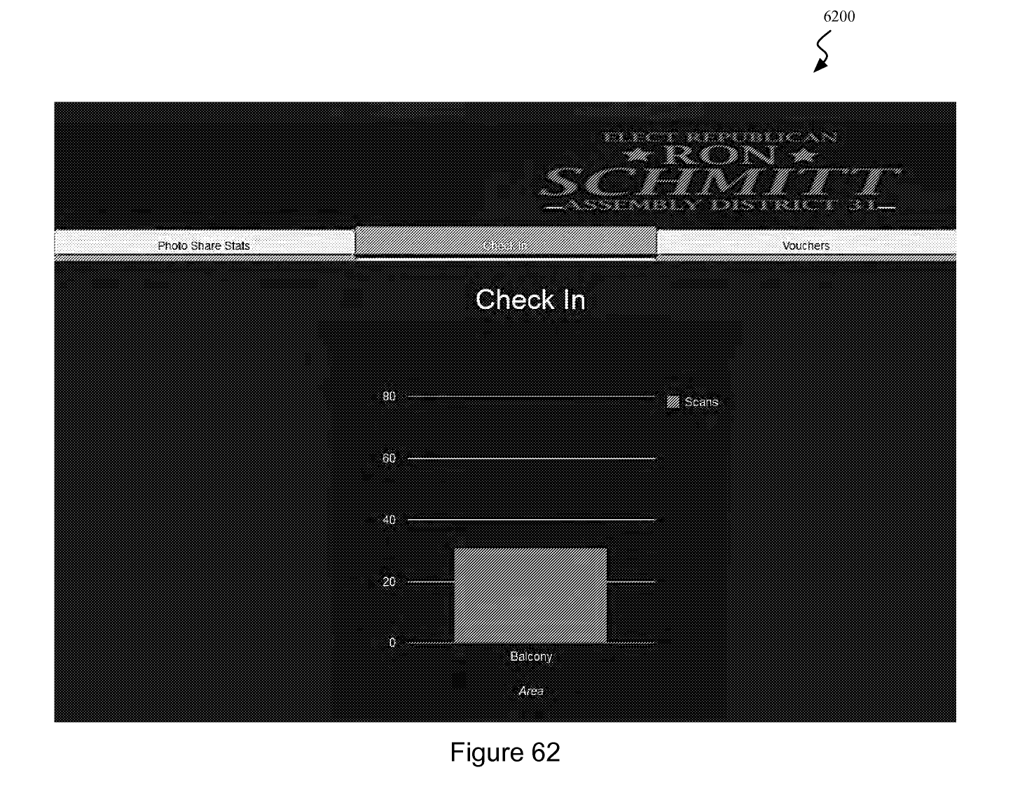

Referring now to FIG. 58 through FIG. 62, various screen captures for a dashboard interface are included. All or part of one or more dashboard interfaces may be publicly available to attendees and workers of an event, privately available to event organizers and vendors, or both. Dashboard interfaces can include, for example, summary graphics such as voucher redemption statistics by type 5801, 5802. The portal service 545 may provide other dashboard selection items, such as, for example, voting 5810, photo share stats 5815, access control 5820, and check in stats 5825. Referring now to FIG. 61 and FIG. 62, the portal service 545 can retrieve historical access and check in data from one or more interest collection and tracking database servers 36 and present access statistics organized by, for example, area 6100, 6200.

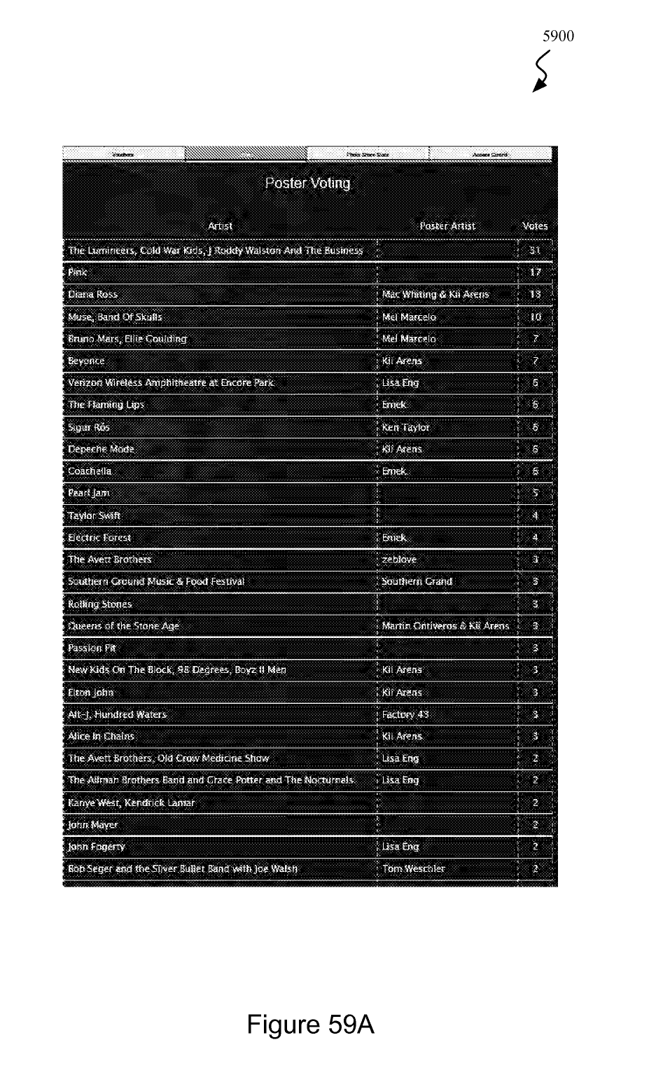

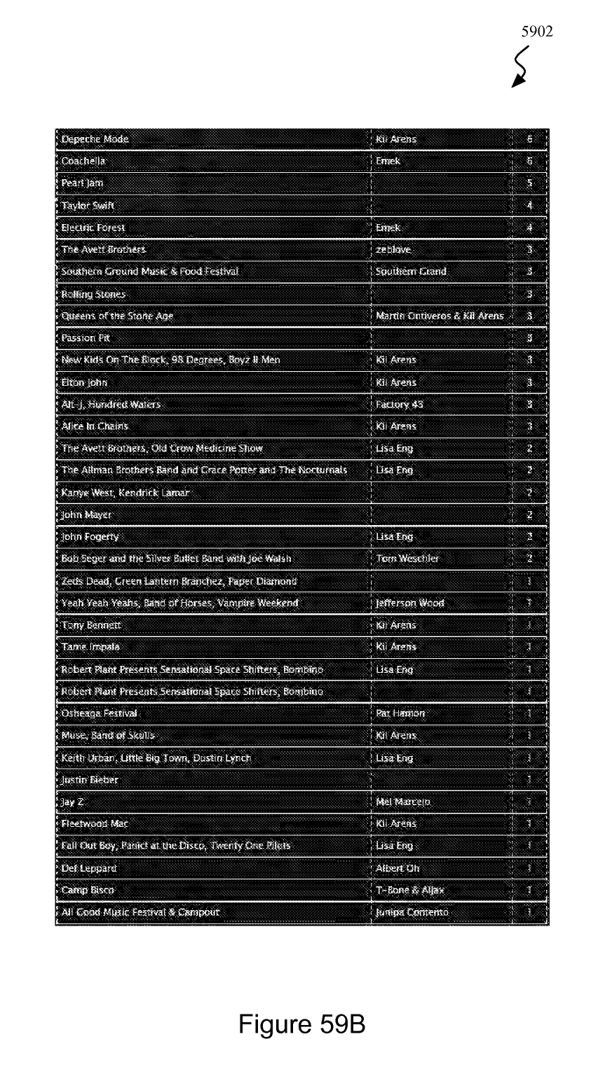

Referring now to FIG. 59A and FIG. 59B, in some instance, where voting functionality is enabled, the portal service 545 can retrieve voting data from one or more interest collection and tracking database servers 36 and format voting statistics for presentation. For example, the voting service 556 can track voting activity, such as poster voting, then provide voting statistics to the portal service 545 for display 5900, 5902 on a dashboard, portal, or both.

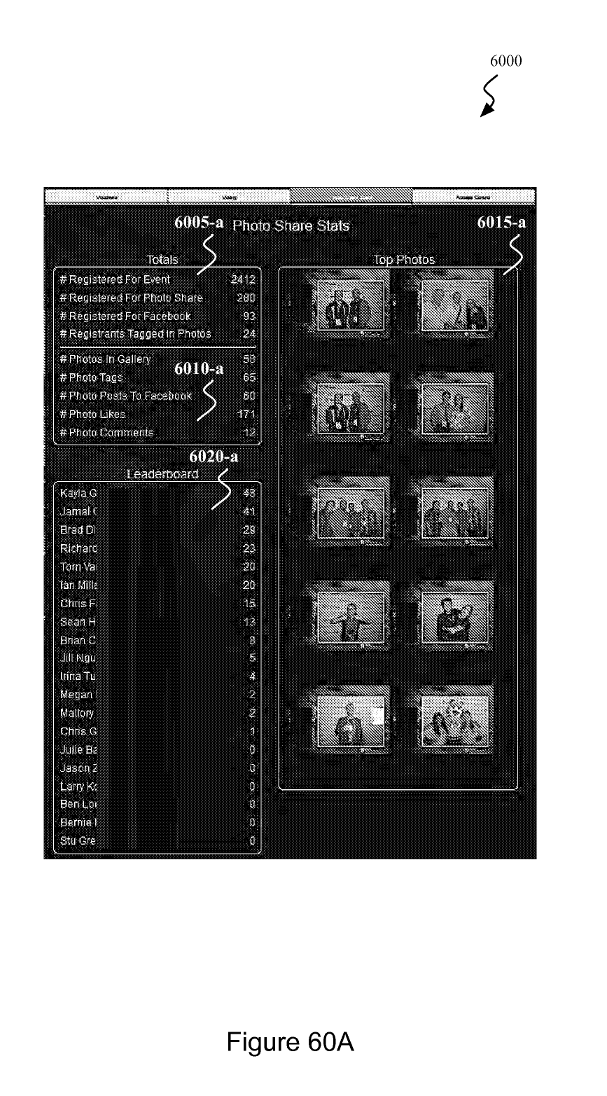

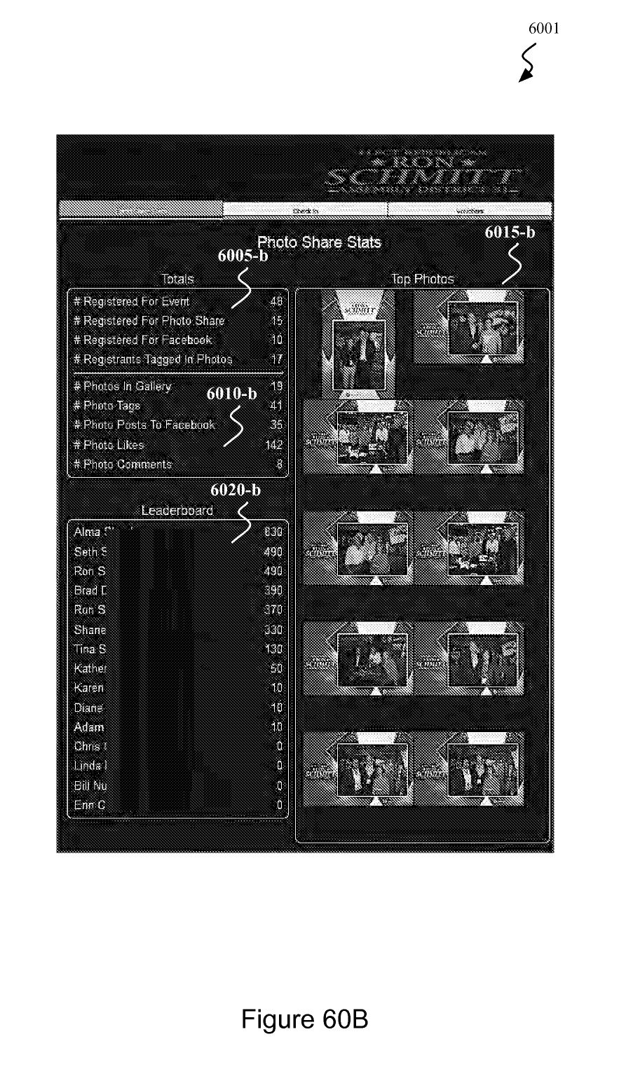

Referring now to FIG. 60A and FIG. 60B, in some implementations, where photo sharing is deployed at an event, the portal service 545 can retrieve photo sharing data and photos from one or more interest collection and tracking database servers 36 and format for presentation on a dashboard. Dashboard photo share presentation can include, for example, registration and registrant totals 6005, photo totals 6010, top photos 6015, and a photo share point leaderboard 6020.

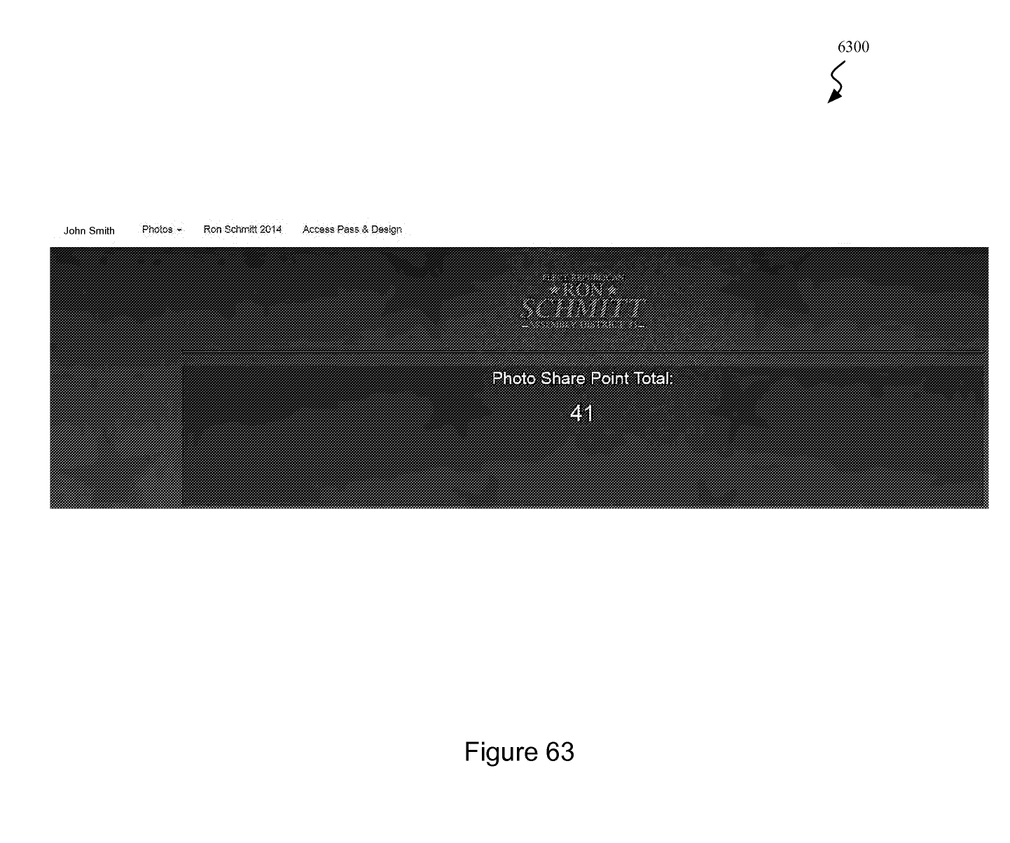

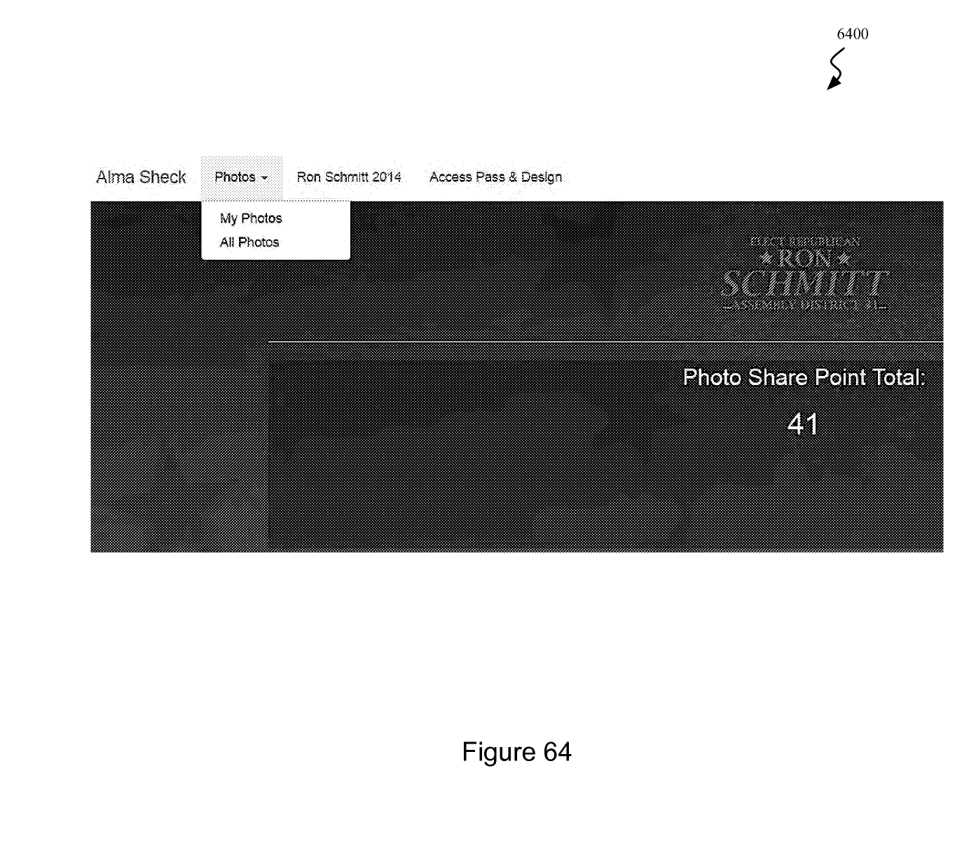

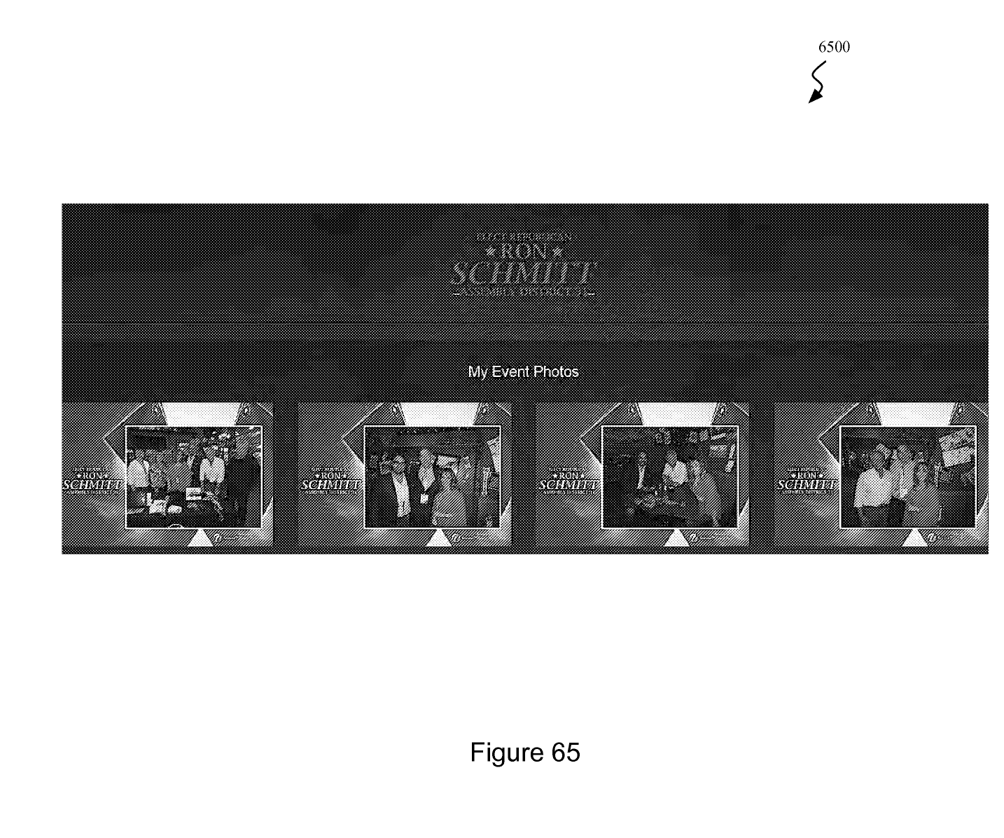

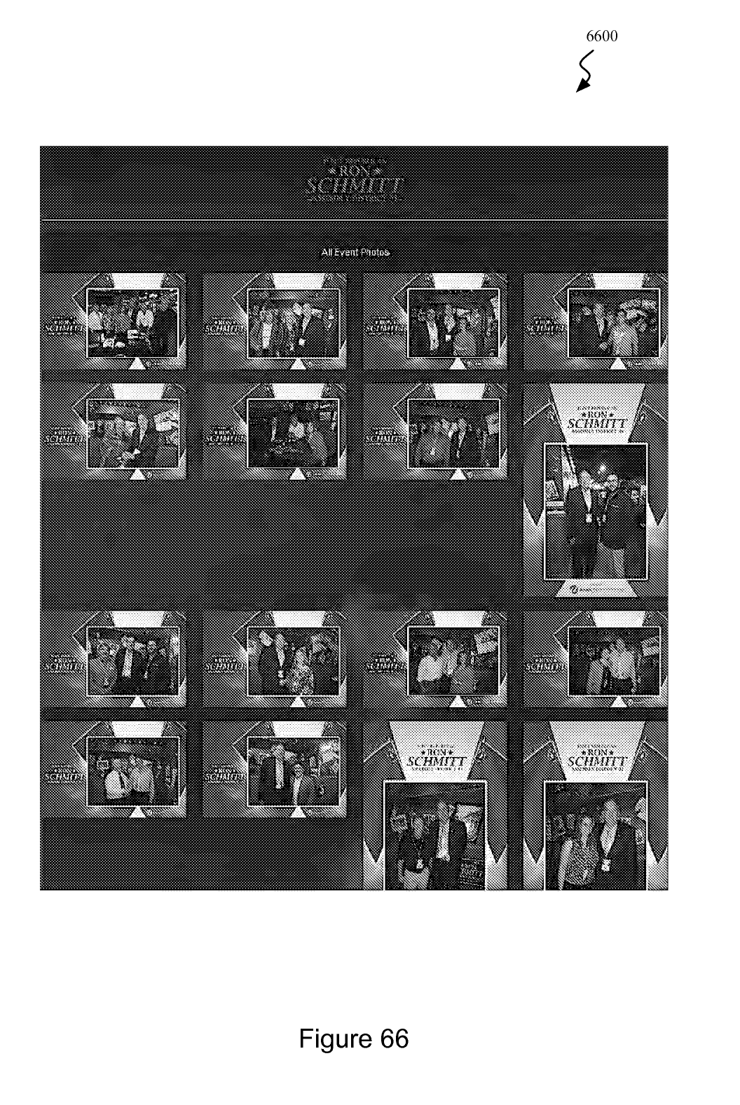

Referring now to FIG. 63 through FIG. 66, various screen captures for a portal interface are included. The portal service generates a credential portal interface 6300 for credential holder John Smith. A point calculation based on points attributable to photo sharing activity for the Ron Schmitt campaign event is displayed. The photo drop list can provide various filters such as displaying only John Smiths photos for the event 6500, or displaying all shared photos for the event 6600.

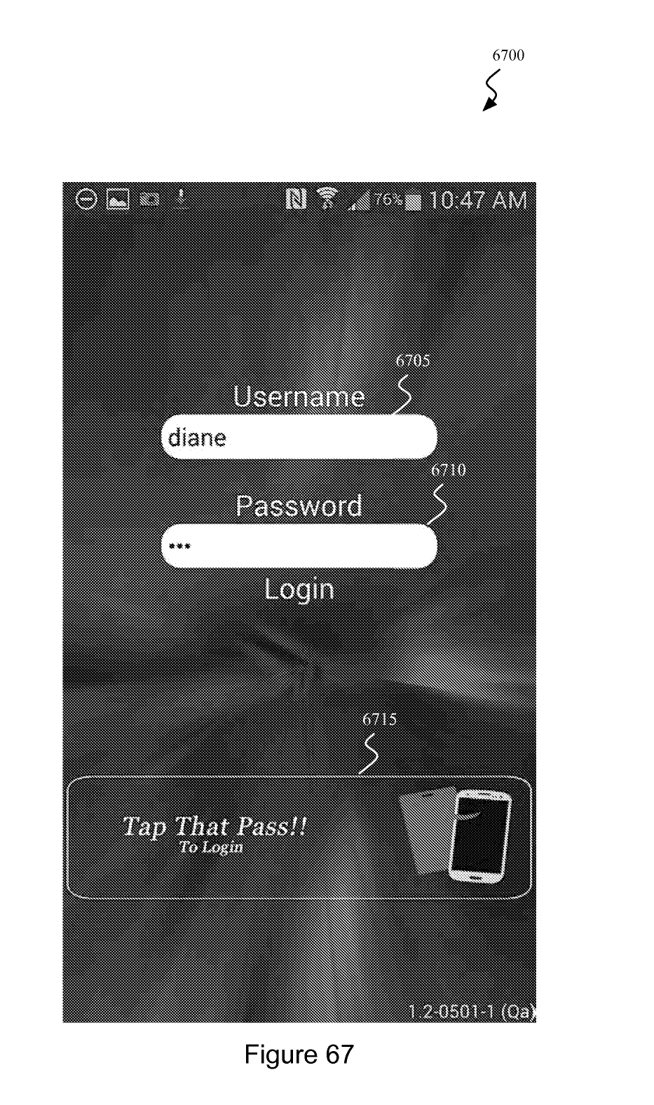

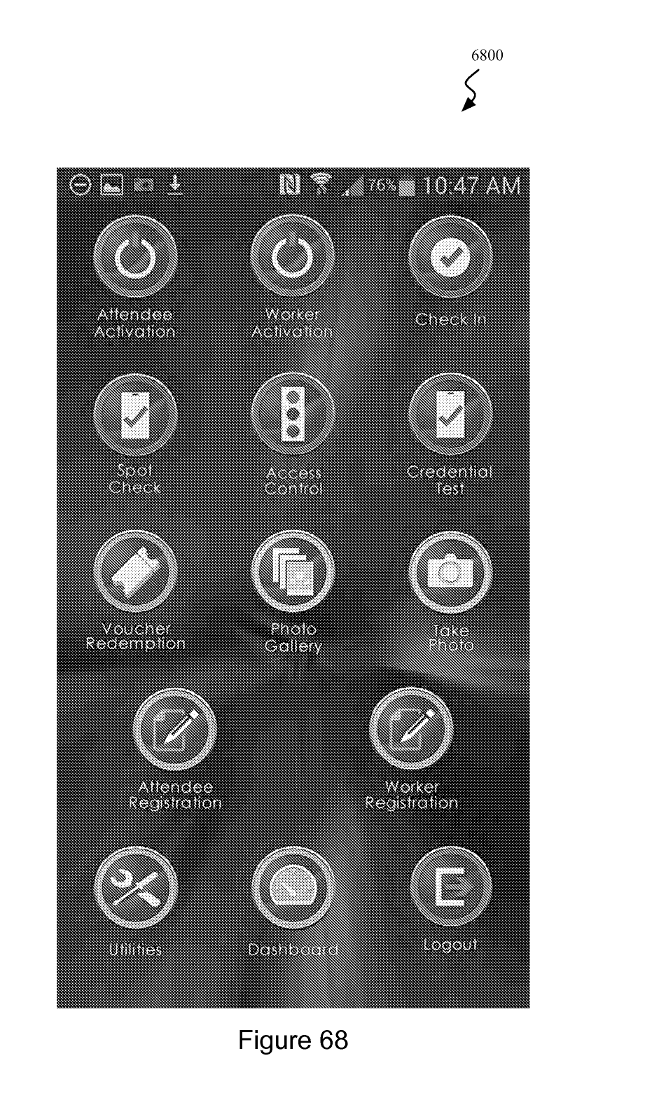

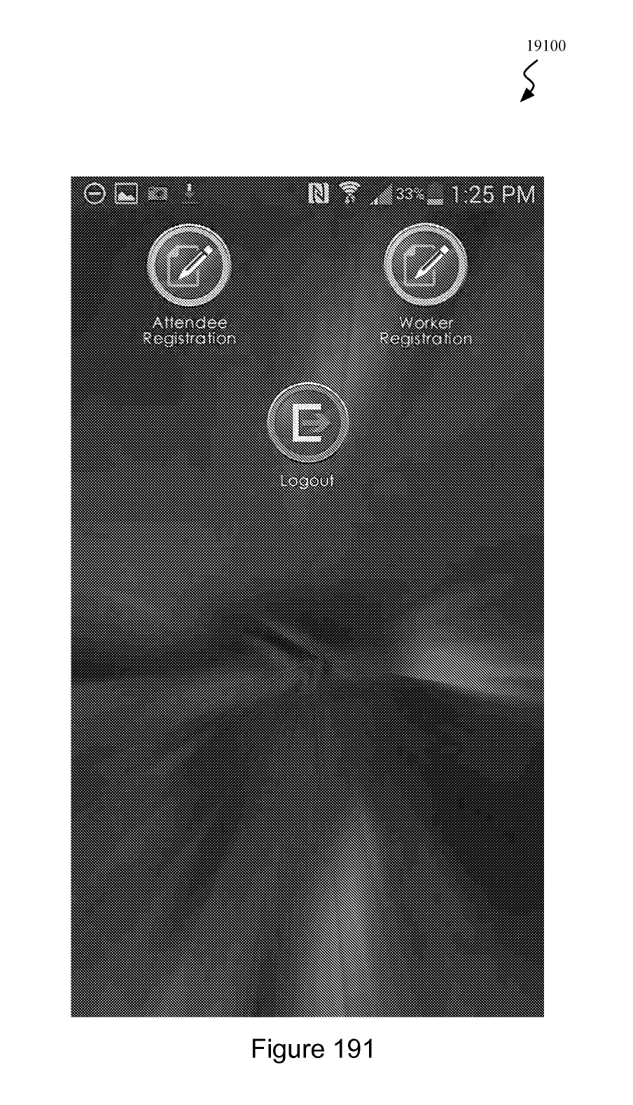

Referring now to FIG. 67 through FIG. 191, various screen captures for a site device interface are included. In some instances, the authentication module 722 generates a login view 6700 prompting a user for authentication credentials 6705. The authentication module 722 prompts the credential holder to tap their credentials, which triggers the transmission of the authentication message to a central server 24-b by the messaging module 740. Upon successful authentication, the app displays the home view 6800 with functionality enabled as determined, at least in part, but the privileges assigned to the authenticated user.

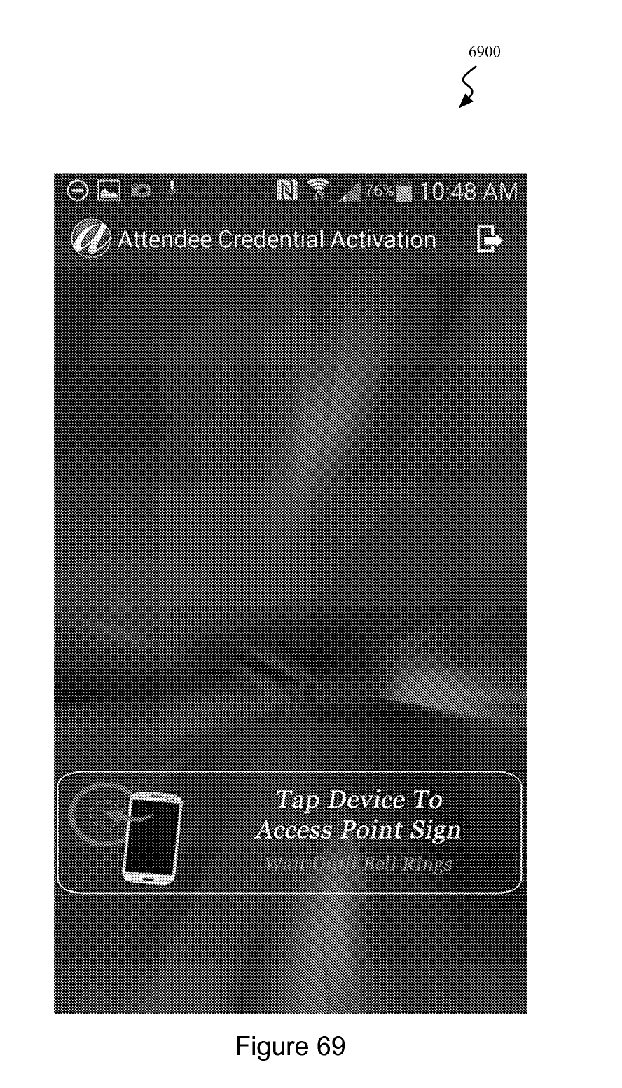

Referring now to FIG. 69, upon detection of the selection event associated with the attendee activation icon on the home view 6800, the credential activation module 724 generates the attendee activation credential start view 6900. The app user is directed to tap the device to the placard, also referred to as a sign. The tag reader module 710 obtains the tag information associated with the area where the placard is located and passes this information to the messaging module 740. The information is then transmitted to a central server 24-b for processing by the credential access service 551 where it is determined if the device is authorized to perform credential activation at the area indicated by the placard tag.

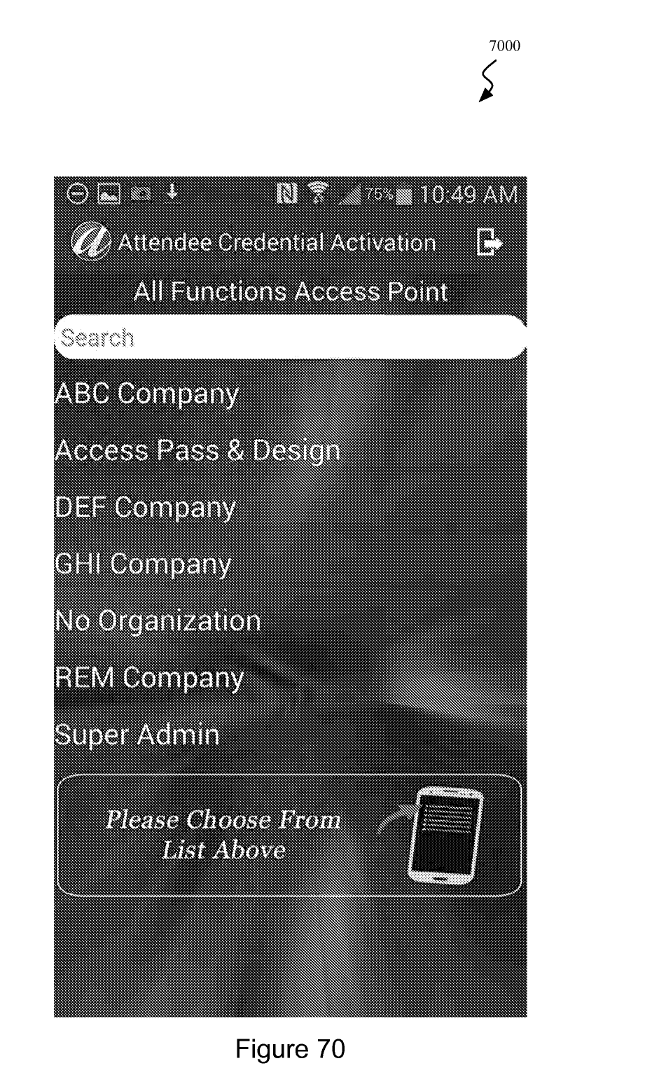

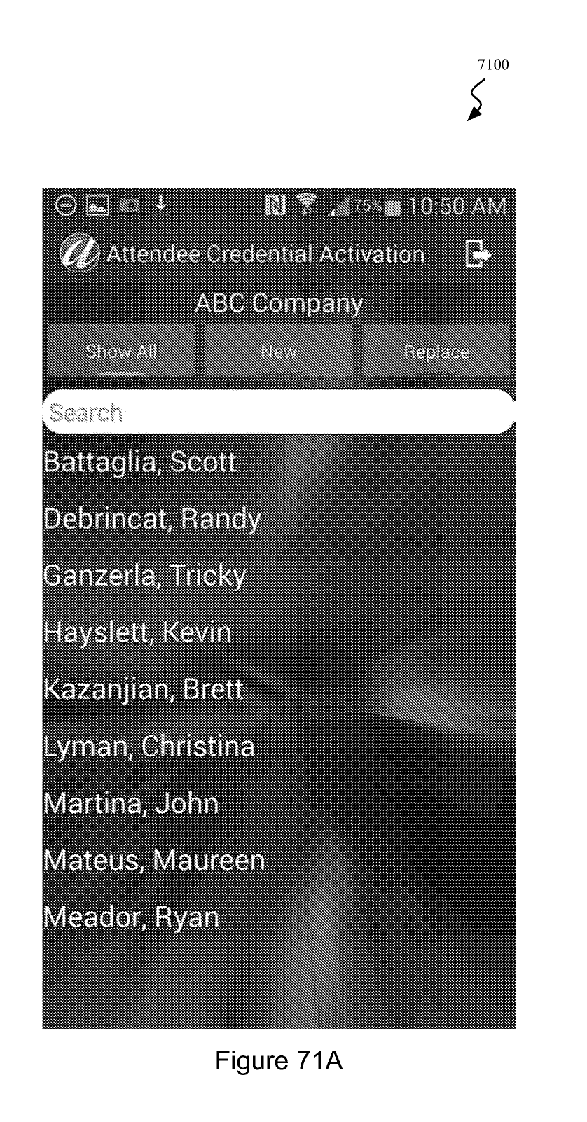

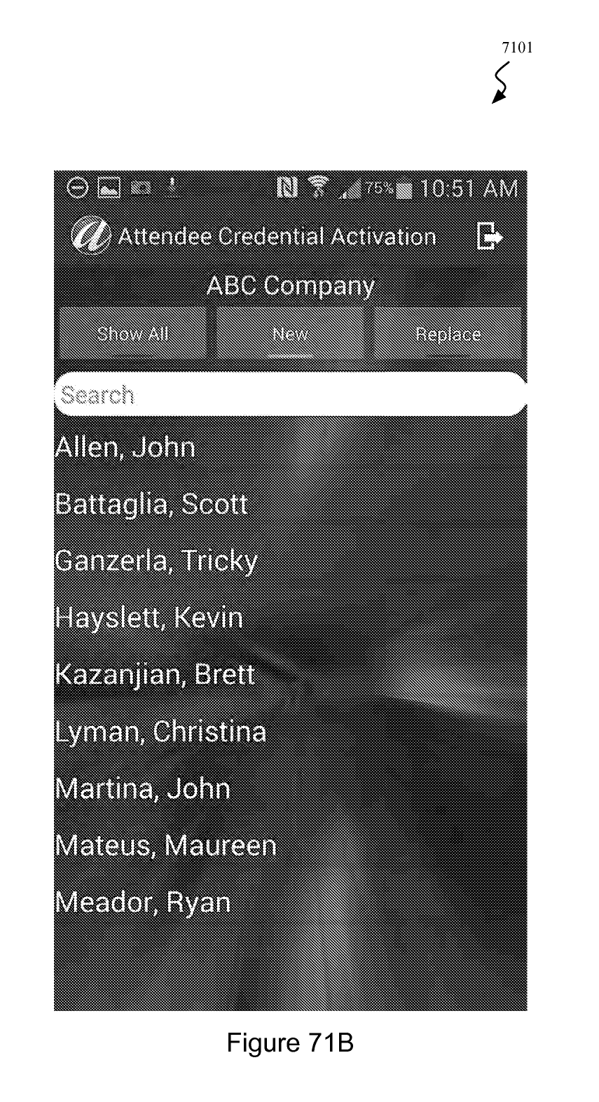

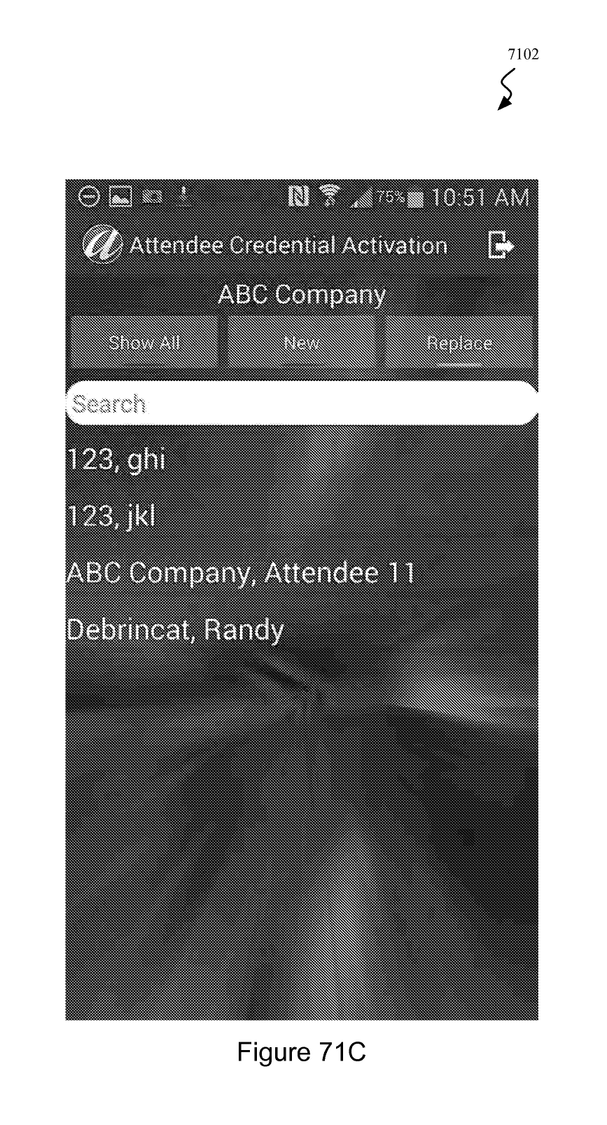

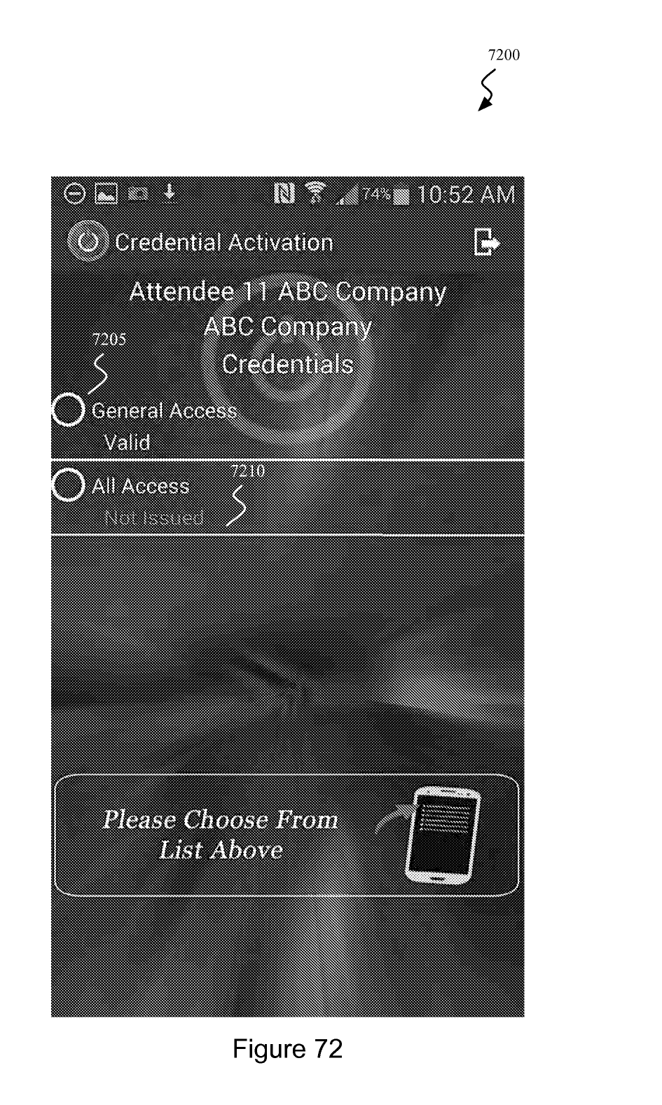

Referring now to FIG. 70 and FIG. 71, various interfaces are provided for the search and selection of an organization and a registered user. Referring now to FIG. 72, the credential activation view for user Attendee 11 of ABC company is displayed. The display indicates that the credential is activated and that the credentialed user can be authorized for general access, but cannot be authorized for all access. The activation information is communicated to the messaging module 740 for transmission to the interest collection and tracking servers 24 for use by various services on the services layer 510, including the portal service 545.

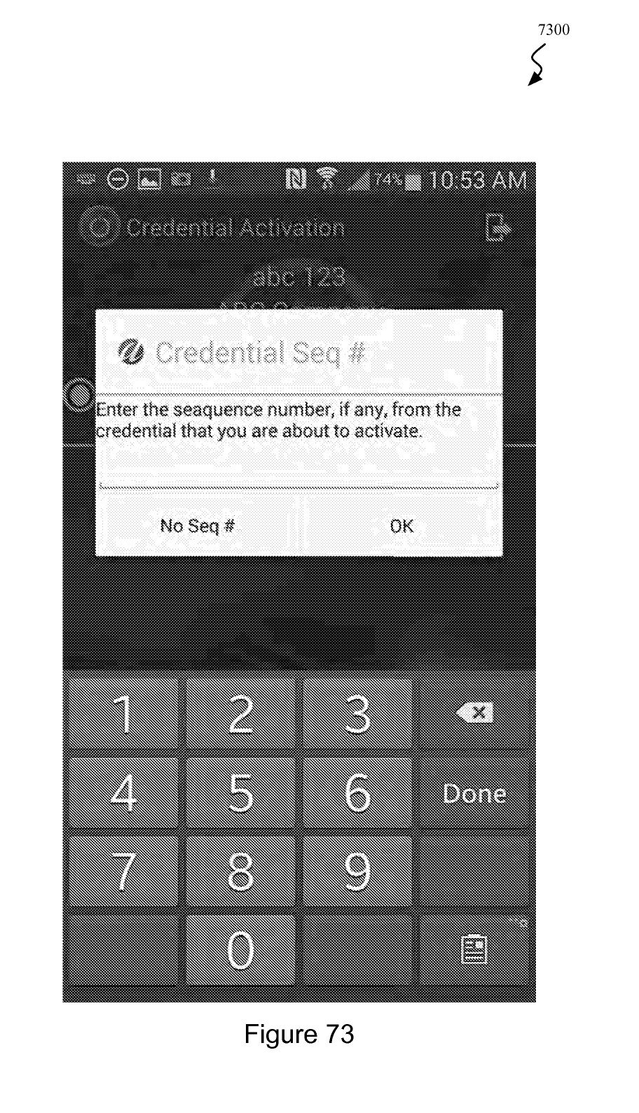

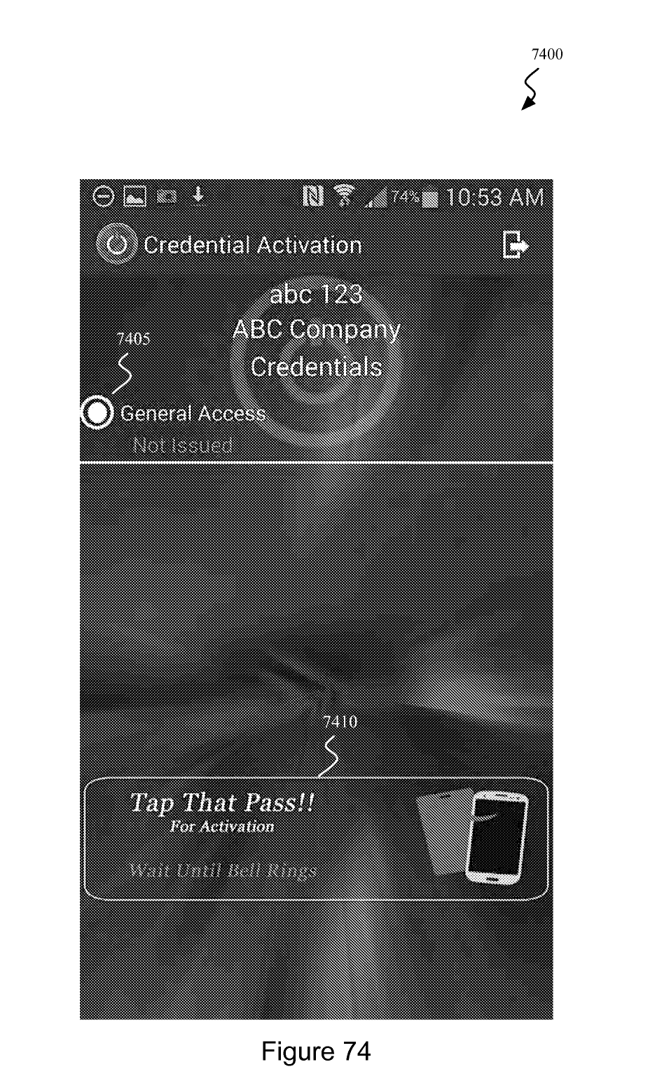

Referring now to FIG. 73 and FIG. 74, a manual credential activation identification prompt is displayed, prompting for entry of the sequence number associated with the credential to be activated. The credentialed user is authorized for general access, and the view indicates that the credential has not yet been issued 7405. A prompt requesting a credential tap is displayed 7410 that activates the credential.

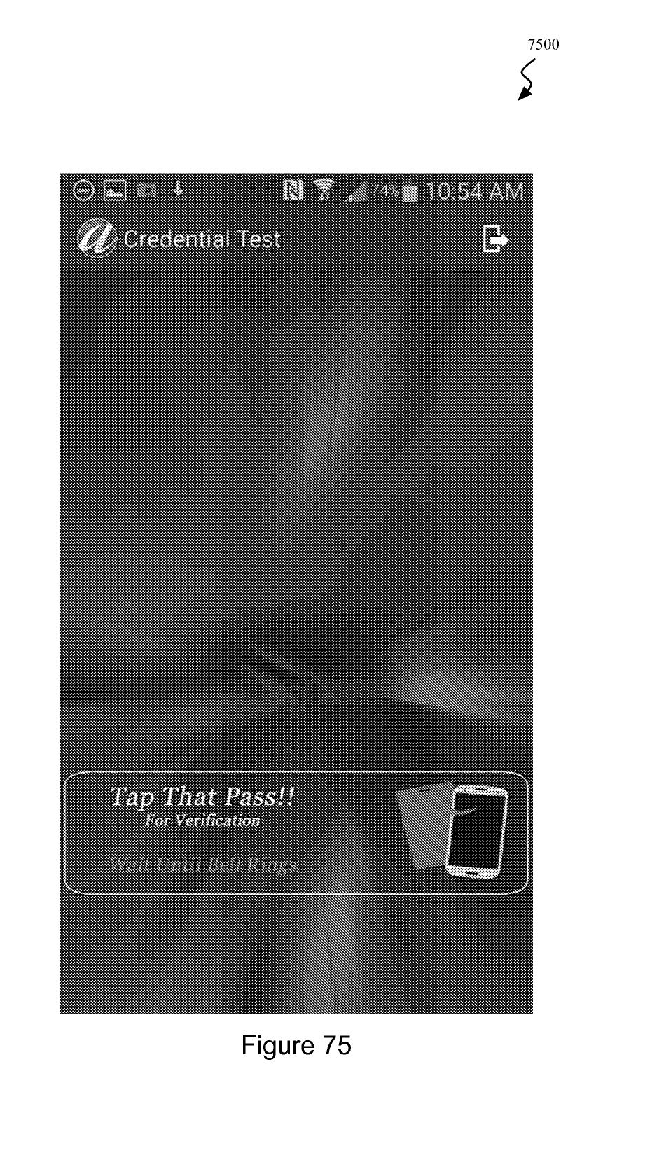

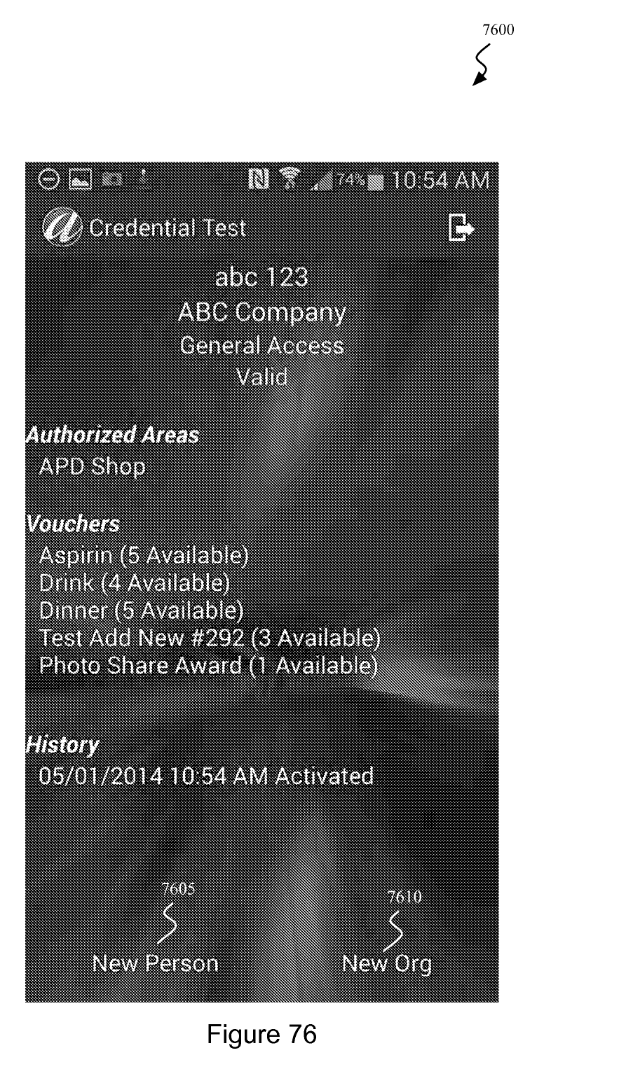

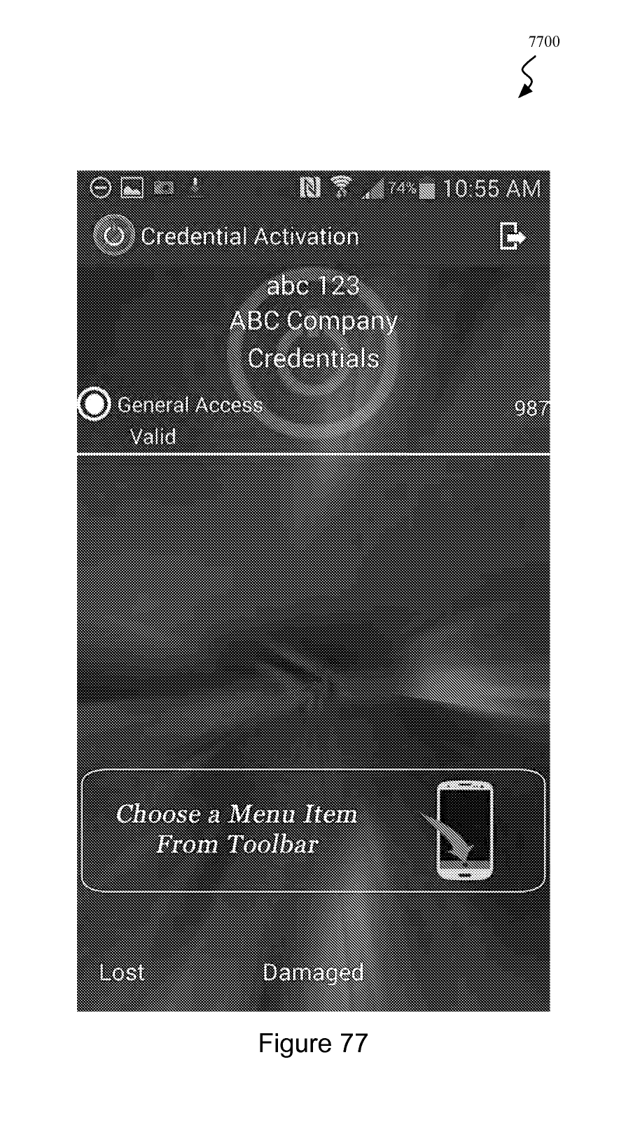

A credential test can be performed to verify the activation. Referring now to FIG. 75 and FIG. 76, the credential audit module 736 generates a credential test start view 7500 prompting for the tapping of the credential to the site device. Upon tapping the credential, information can be displayed including, for example, access level, the activation status, authorized areas, vouchers, and the credential history. Menu options provided can include the assignment of a new person to the credential 7605 and the assignment of a new organization to the credential 7610.

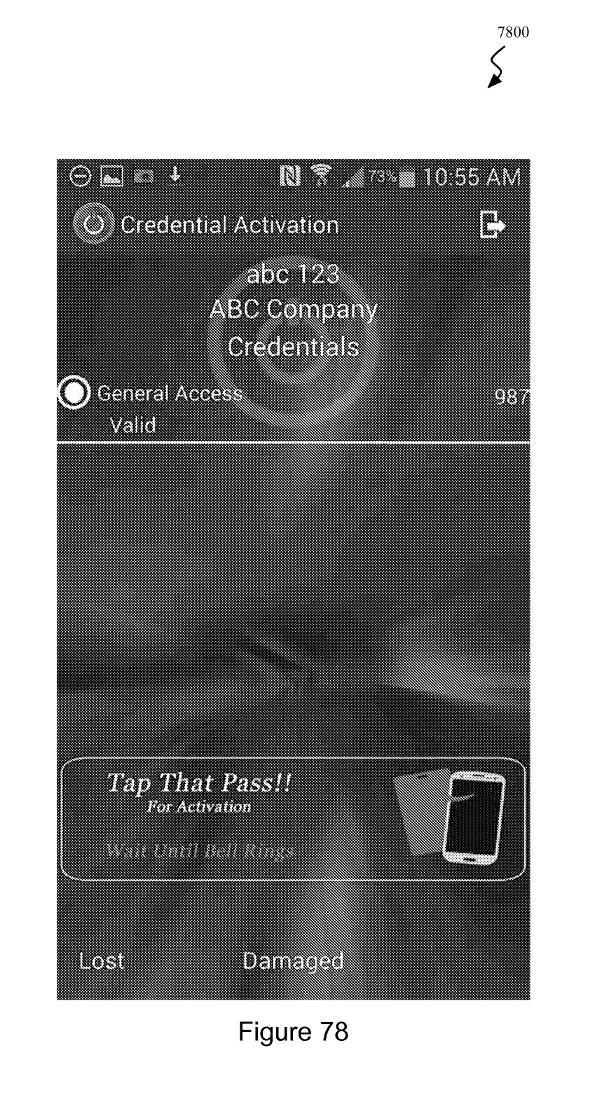

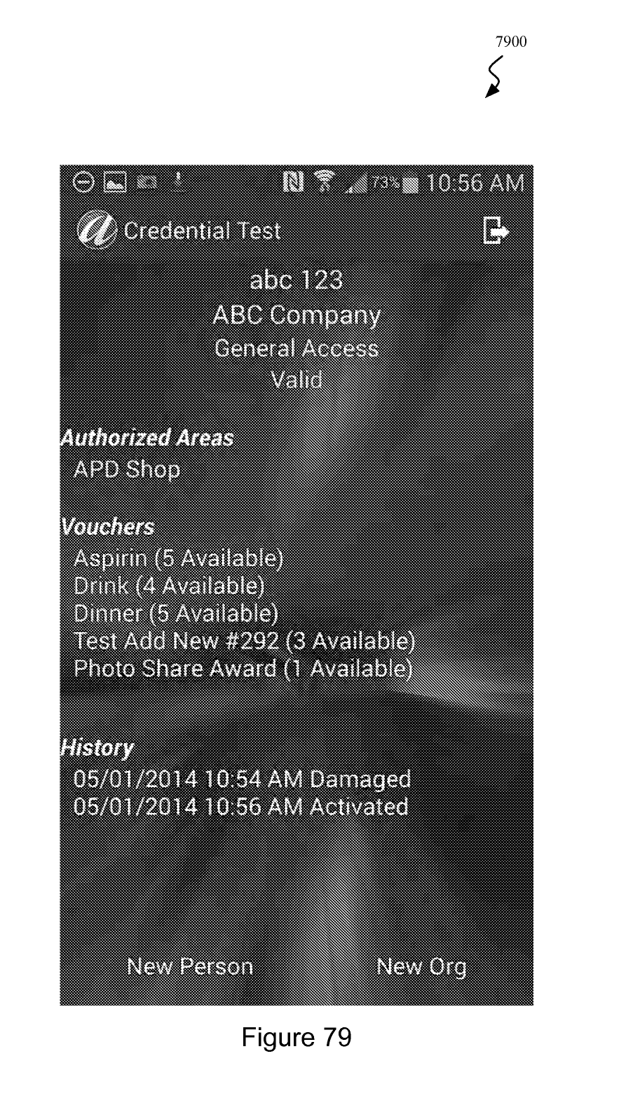

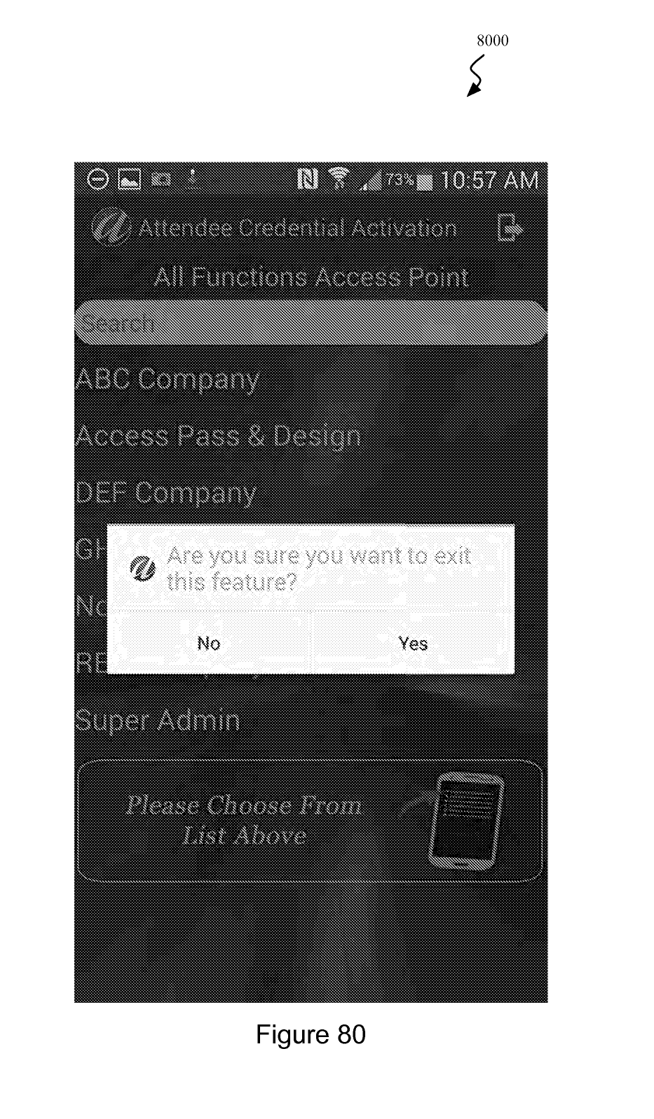

Once a credential is activated, additional menu options may be displayed, including activation of replacement credentials after credentials have been damaged or lost. Referring now to FIG. 78 through FIG. 80 upon tapping of the credential to the device, a menu selection can be made, such as a selection indicating the original credential was damaged. Performing a credential test on the newly-activated credential indicates the damaged status in the history log. Loss and damage information is communicated to the messaging module 740 for transmission to the interest collection and tracking servers 24 for use by various services on the services layer 510, including the portal service 545. Referring now to FIG. 80, an exit confirmation prompt is displayed when exiting the attendee credential activation module interface.

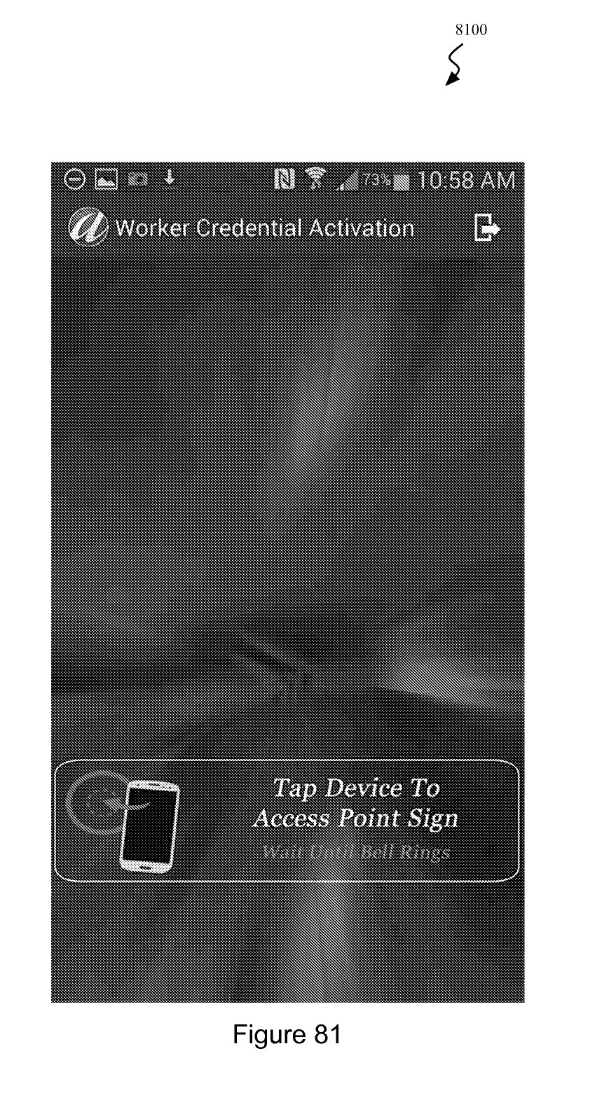

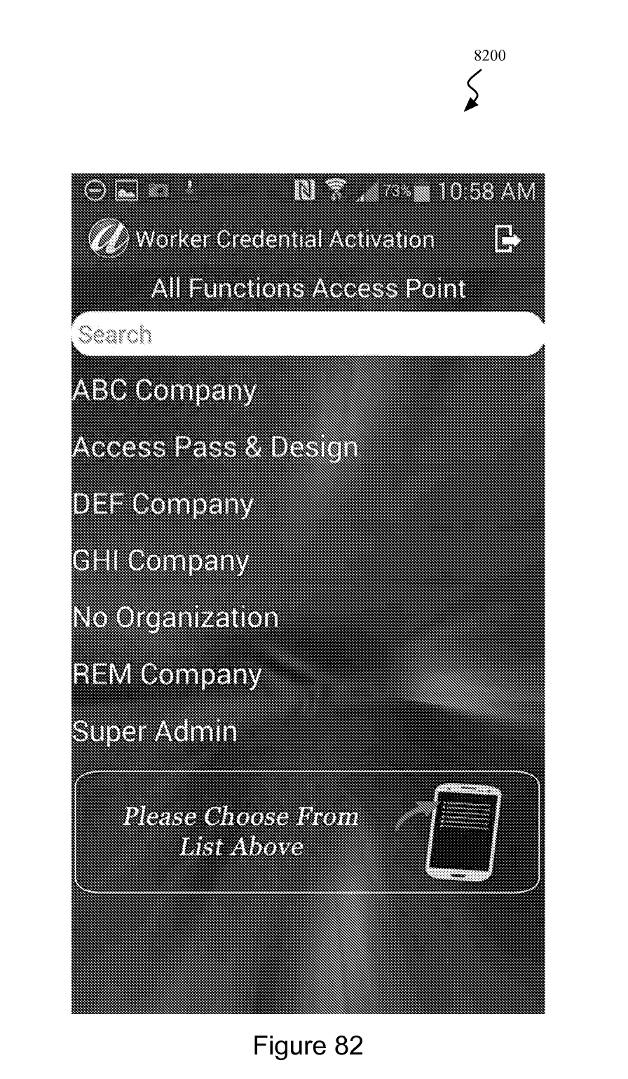

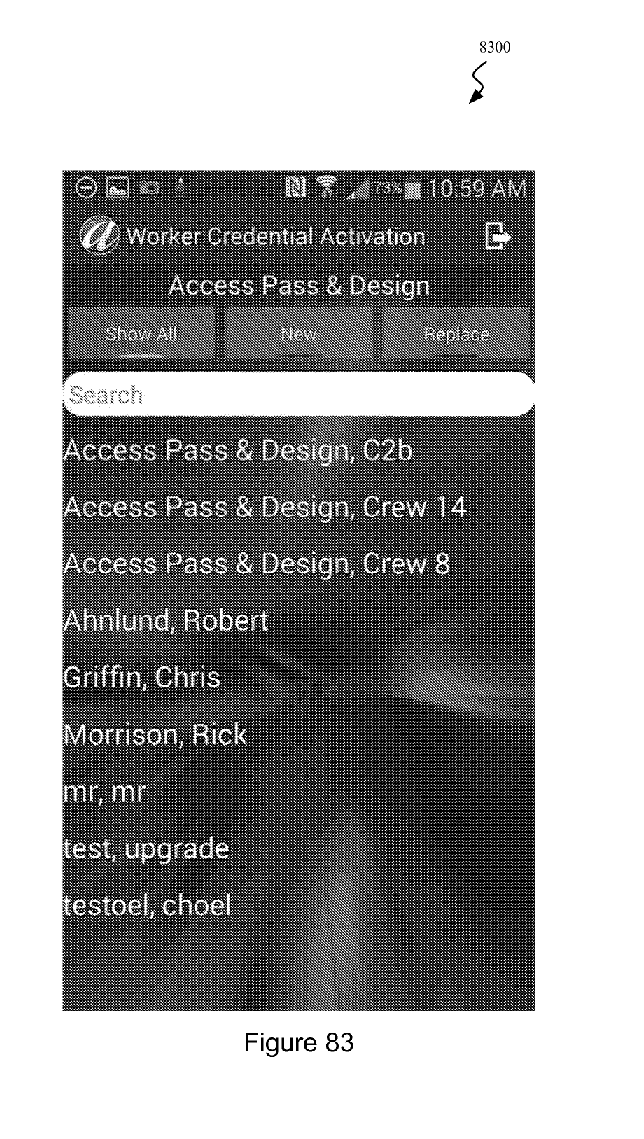

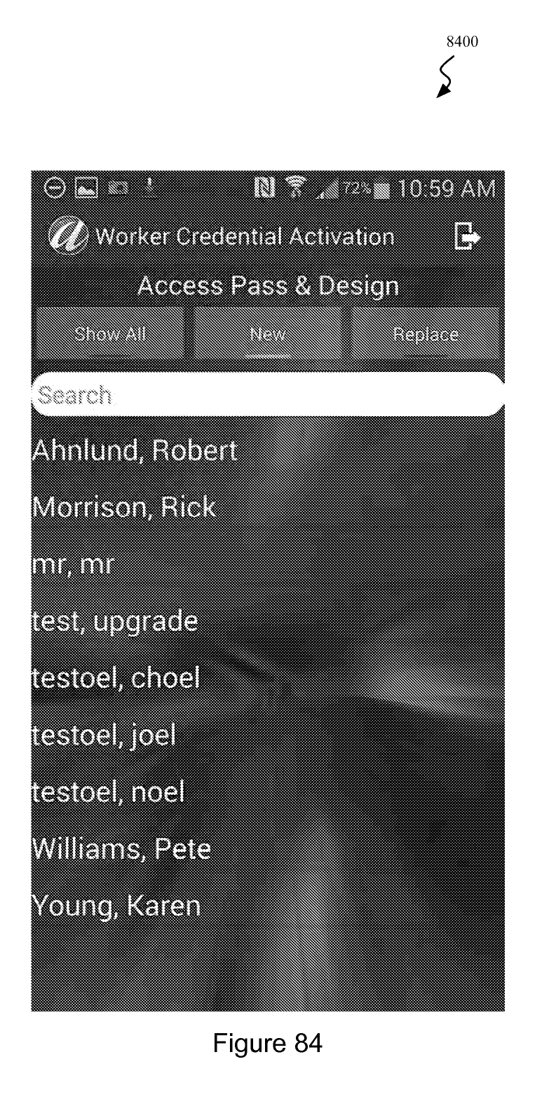

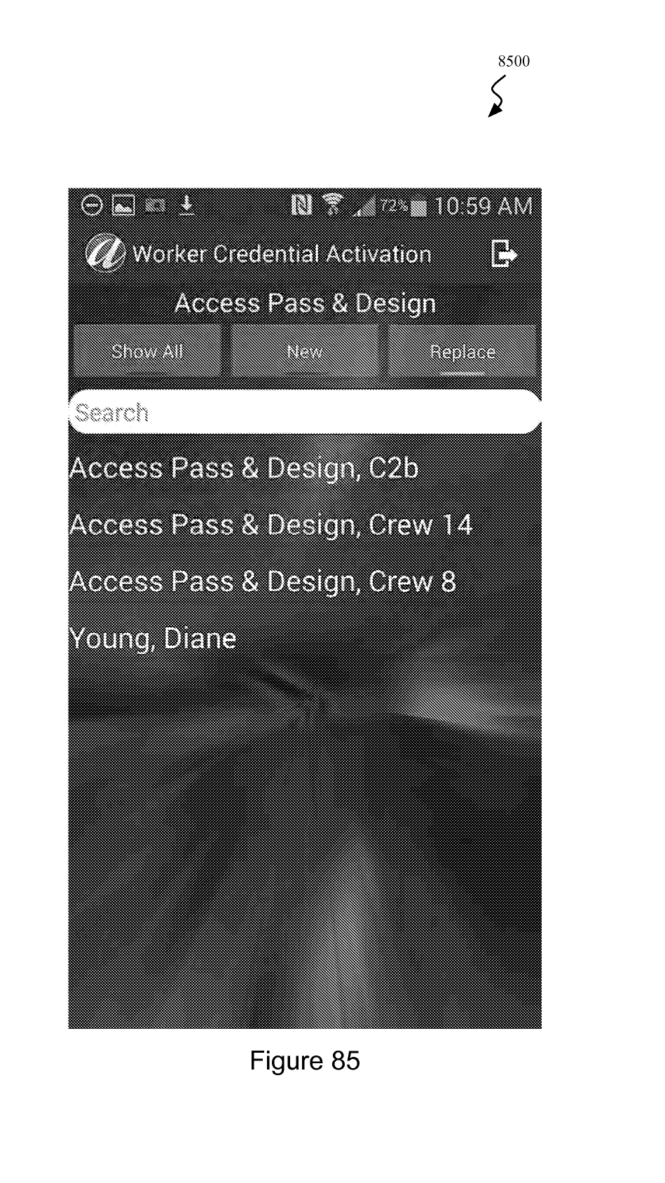

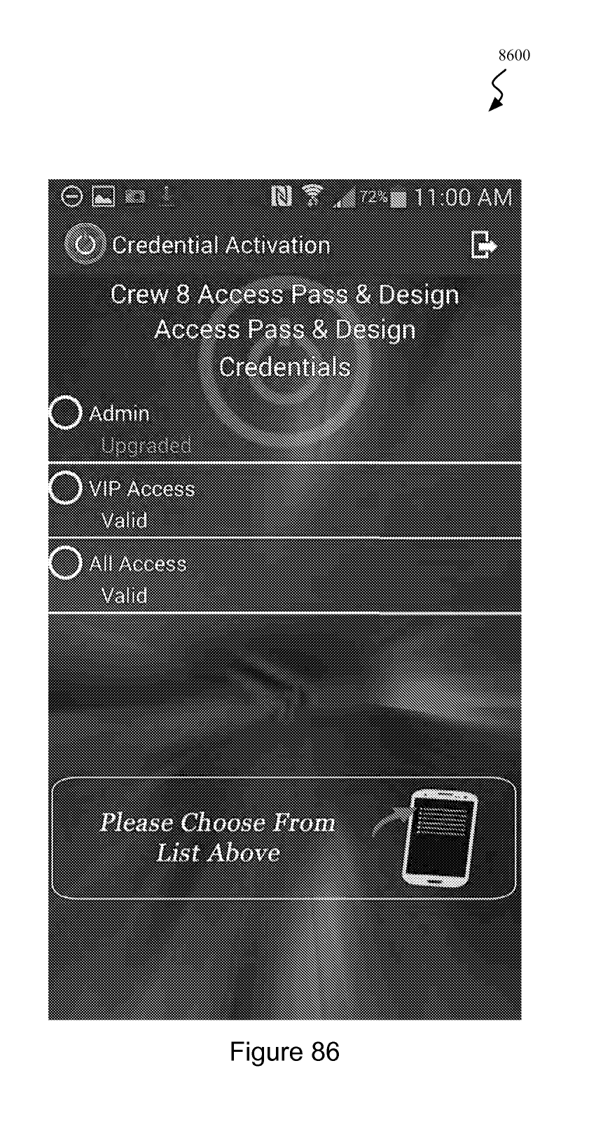

Referring now to FIG. 81 through FIG. 86, various worker credential activation views are included. These views and the modules supporting these views function similarly to the attendee credential activation views previously discussed.

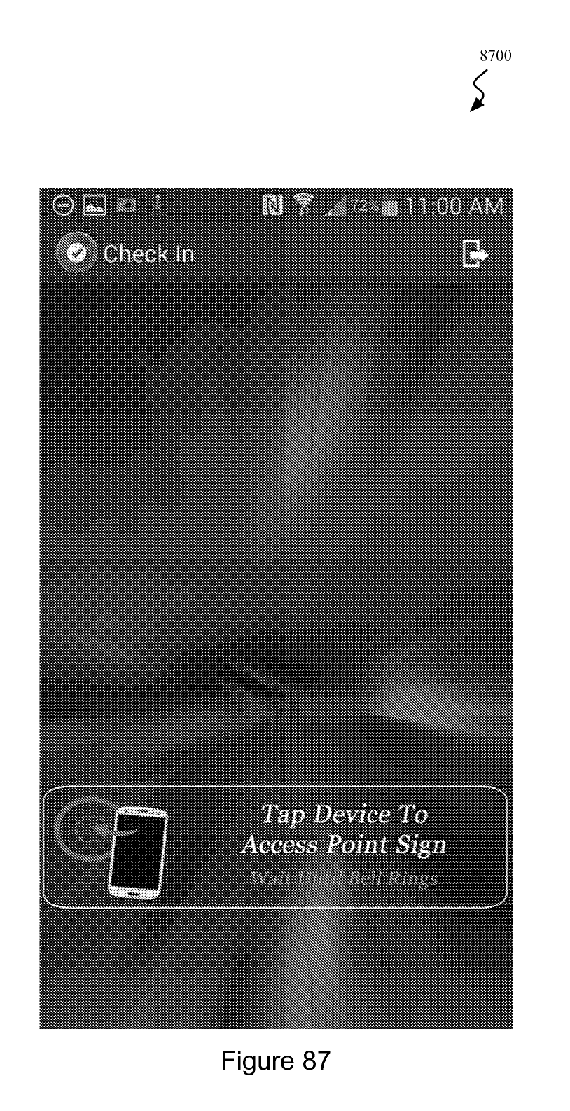

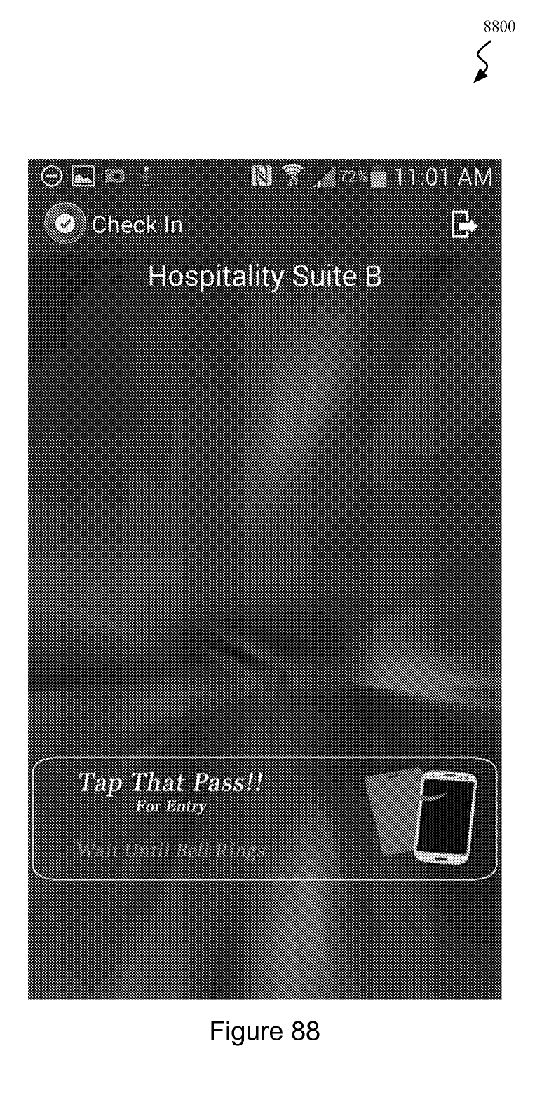

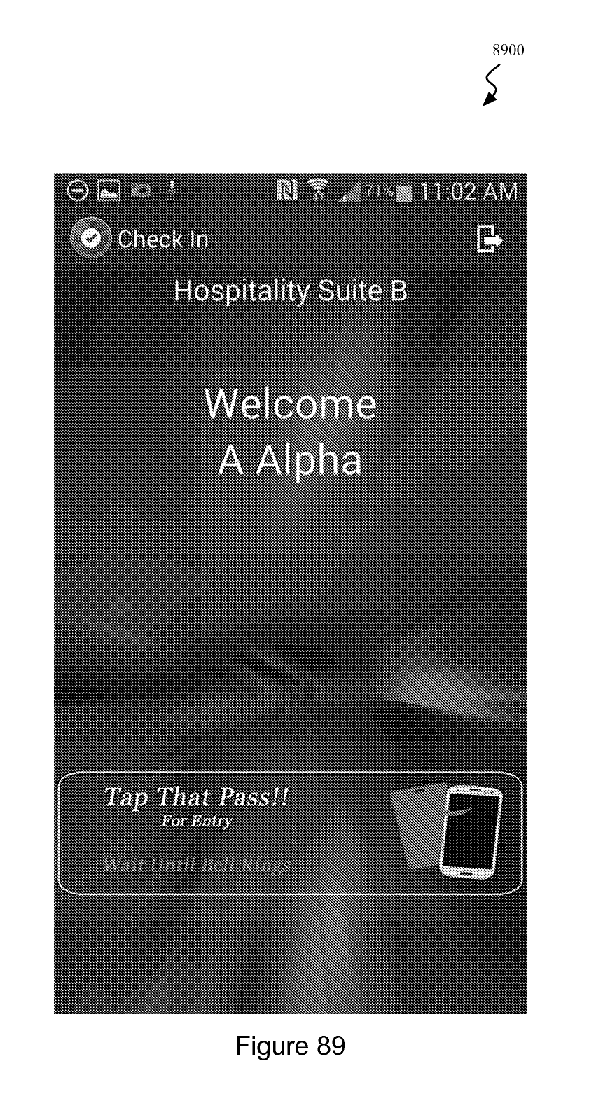

Referring now to FIG. 87 through FIG. 89, various check in views are included. Upon detection of the selection event associated with the check in icon on the home view 6800, the check in module 726 generates the check in start view 8700, prompting for the device to tap the tag associated with the placard, also referred to as a sign. Once the sign is tapped, if the area is designated as a check in area, the check in tap view for the designated area 8800 is displayed, prompting that the device is ready for the tag reader module 710 to read tapped credentials. Upon tapping of a credential authorized for check in at the designated area, a check in welcome view will be displayed by the check in module. The check in information is communicated to the messaging module 740 for transmission to the interest collection and tracking servers 24 for use by various services on the services layer 510, including the portal service 545.

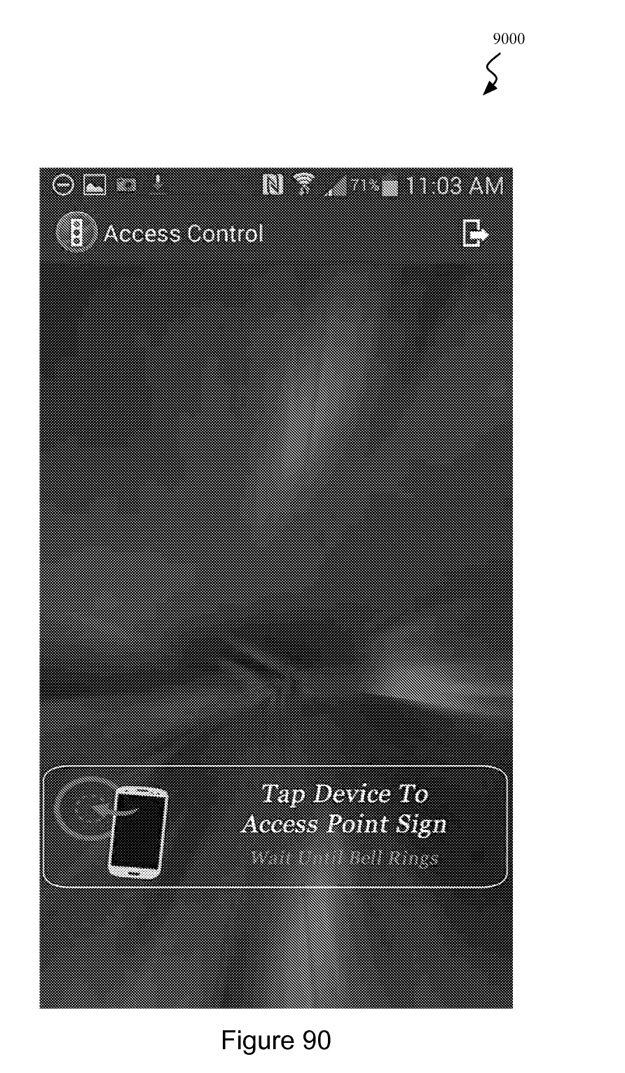

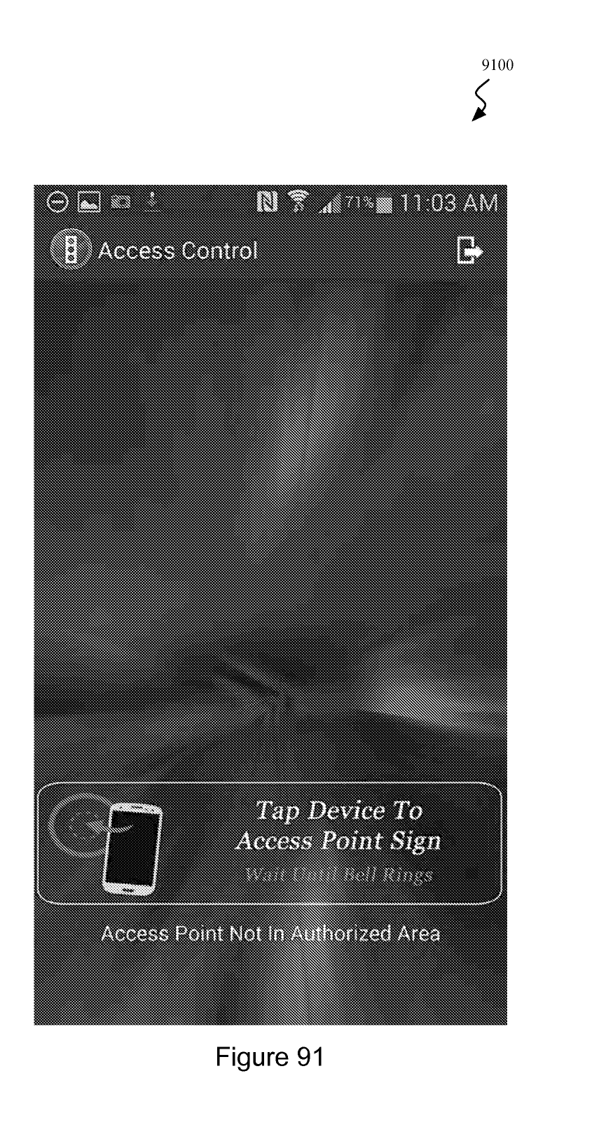

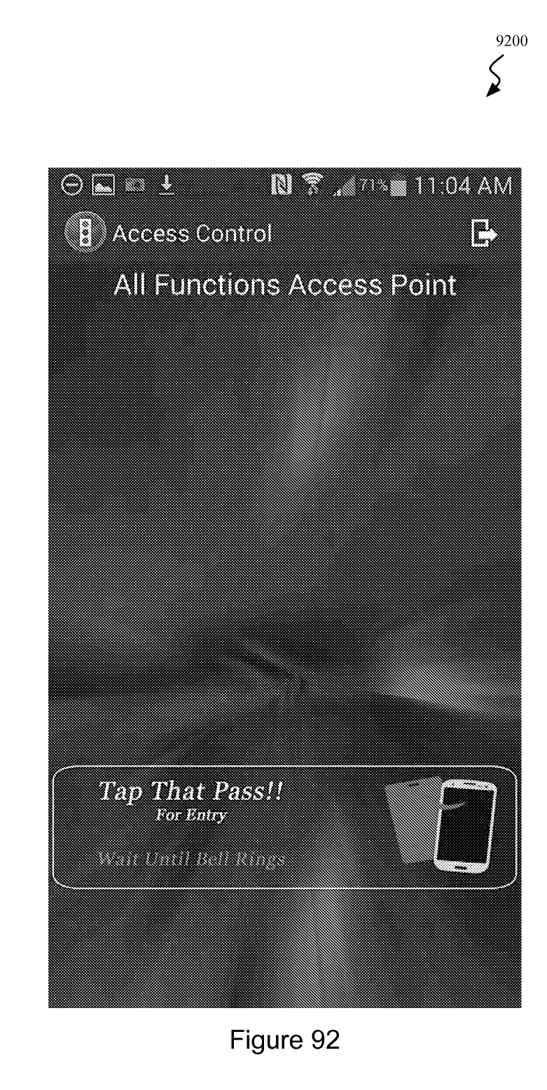

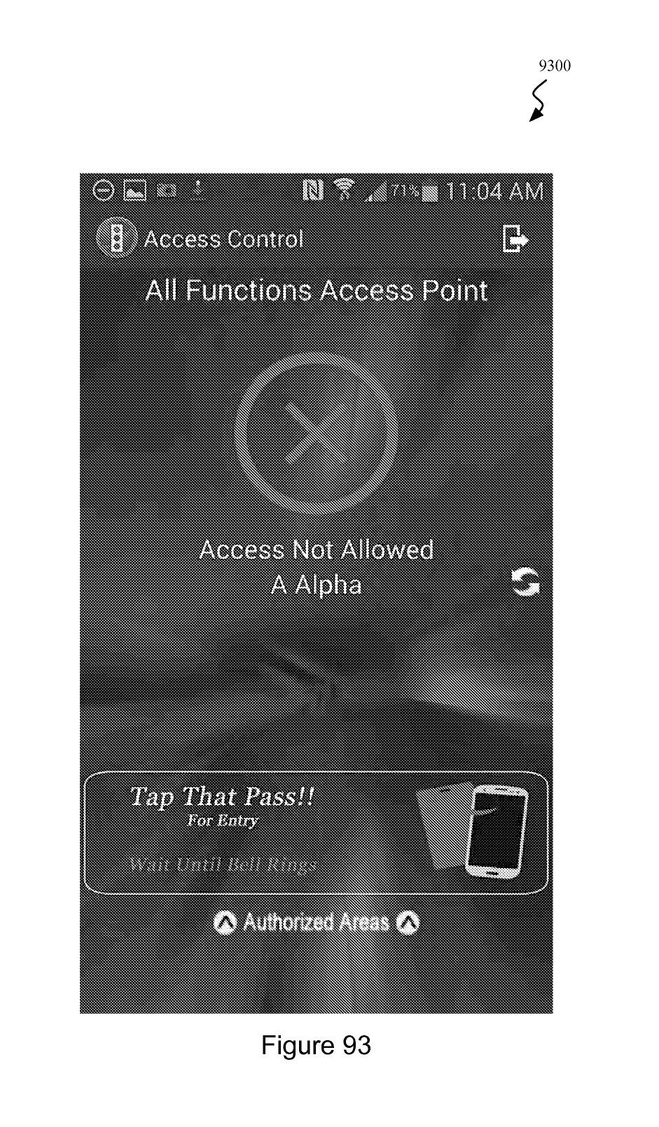

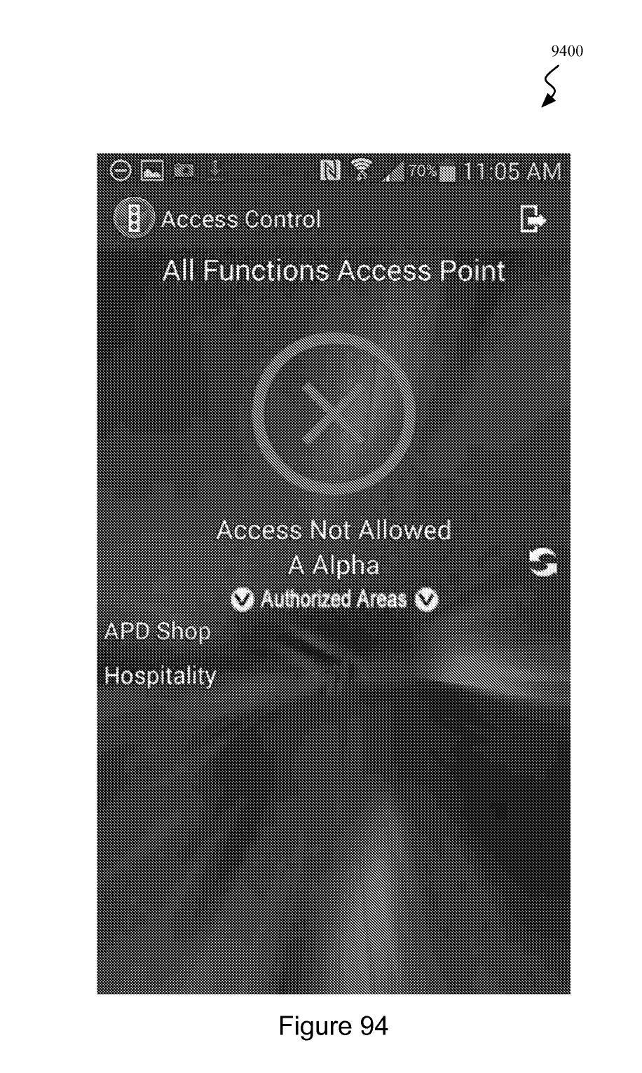

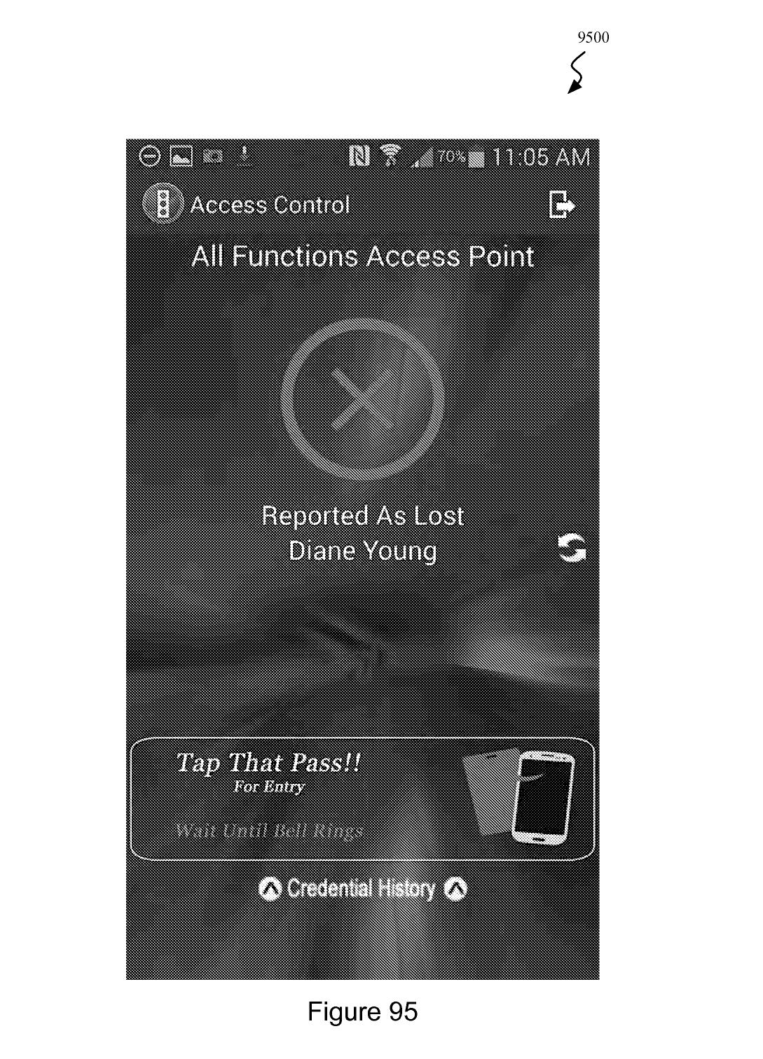

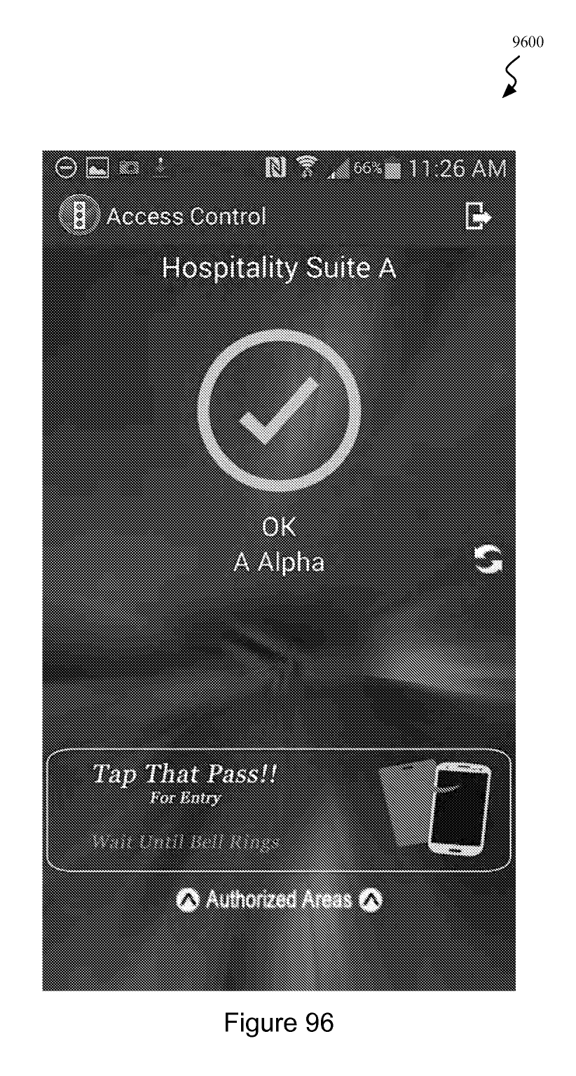

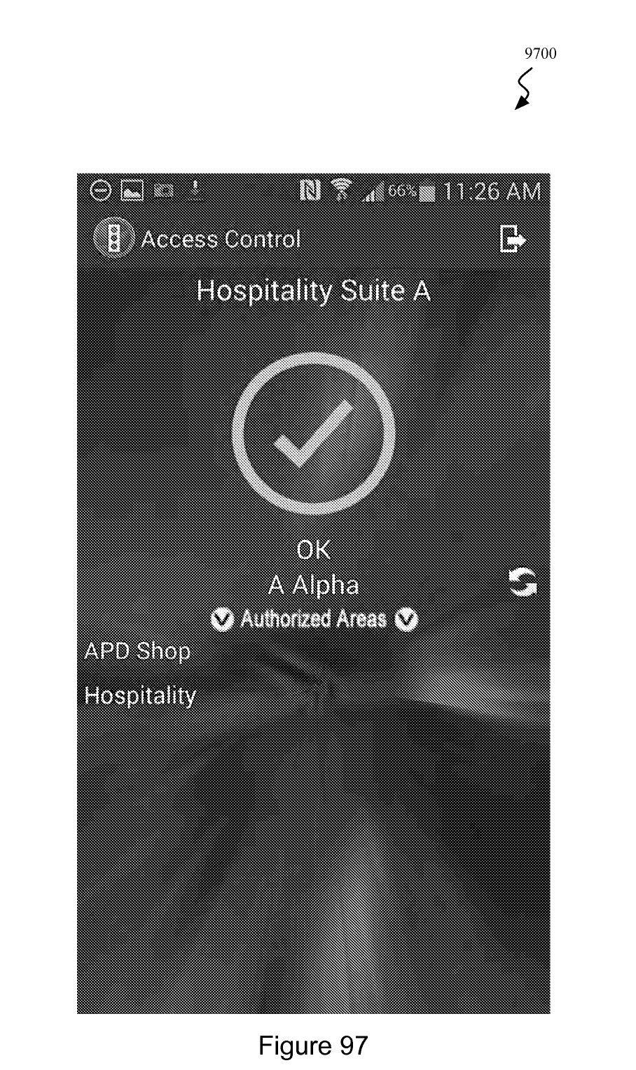

Referring now to FIG. 90 through FIG. 97, various access views are included. Upon detection of the selection event associated with the access icon on the home view 6800, the access control module 714 generates the access control start view 9000, prompting for the device to tap the tag associated with the placard, also referred to as a sign. Once the sign is tapped, if the area is not designated as an access control area, the unauthorized message view 9100 is displayed indicating that the access point is not in an authorized area. If the area is designated as an access control area, the access control tap credential view for the designated area 9200 is displayed, prompting that the device is ready for the tag reader module 710 to read tapped credentials.

Upon tapping of a credential that is not authorized for access to the designated area, an access control access denied view is displayed by the access control module. Detection of the selection event associated with the authorized area drawer control displays the access control authorized areas listing view 9400 for the attendee associated with the credential. If the credential was previously logged with the system 10 as being lost, the access control lost credential view 9500 is displayed. Attempted access information is communicated to the messaging module 740 for transmission to the interest collection and tracking servers 24 for use by various services on the services layer 510, including the portal service 545.

Upon tapping of a credential that is authorized for access to the designated area, an access control access allowed view 9600 is displayed by the access control module 714. Detection of the selection event associated with the authorized area drawer control displays the access control authorized areas listing view 9700 for the attendee associated with the credential. If the credential was previously logged with the system 10 as being lost, the access control lost credential view 9500 is displayed. Attempted access information is communicated to the messaging module 740 for transmission to the interest collection and tracking servers 24 for use by various services on the services layer 510, including the portal service 545.

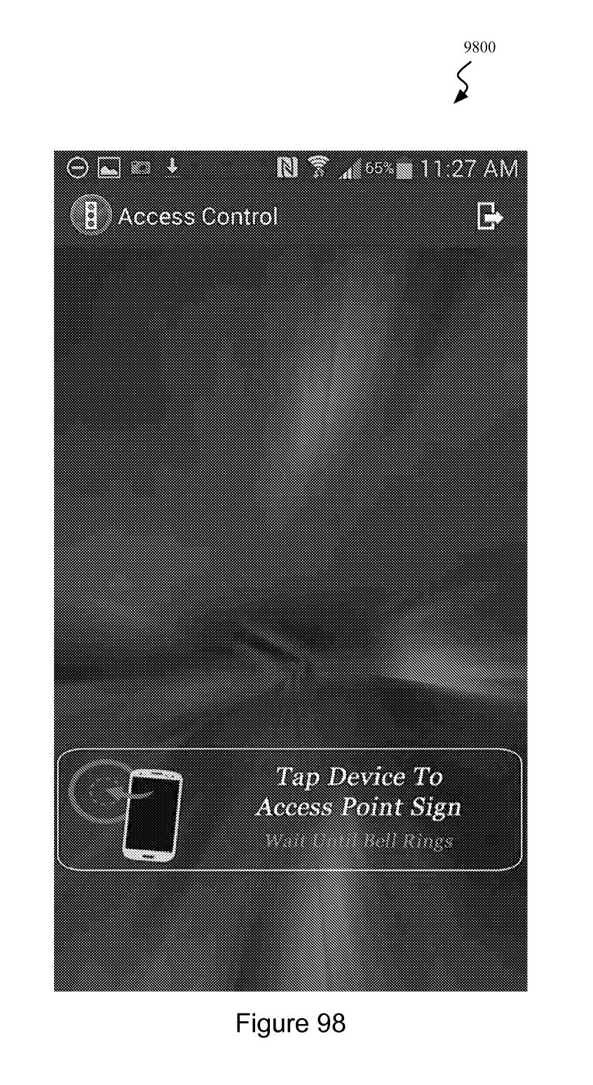

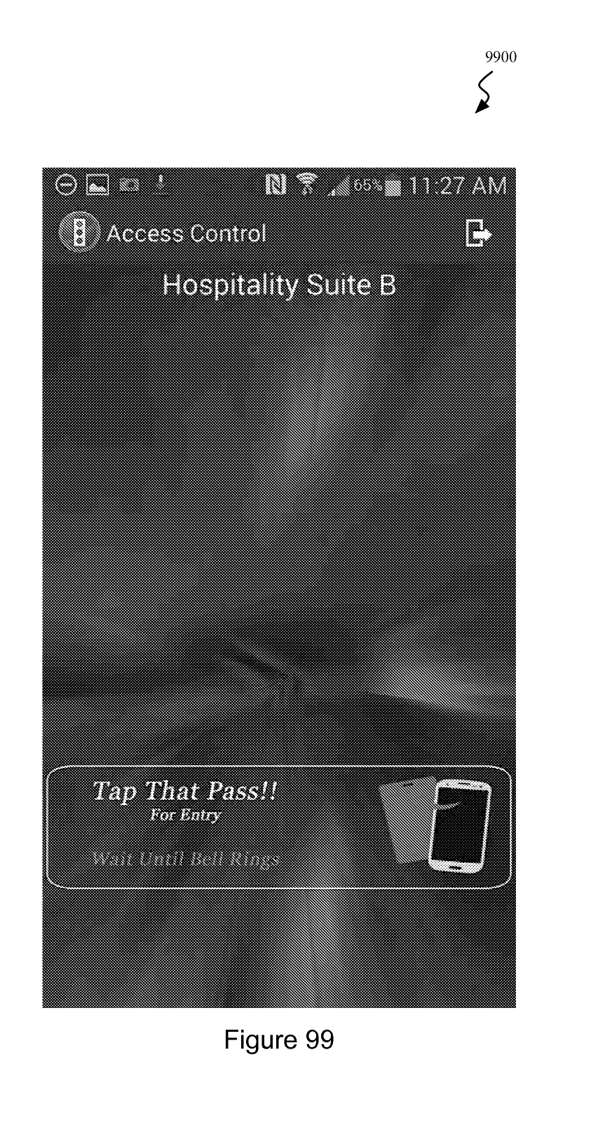

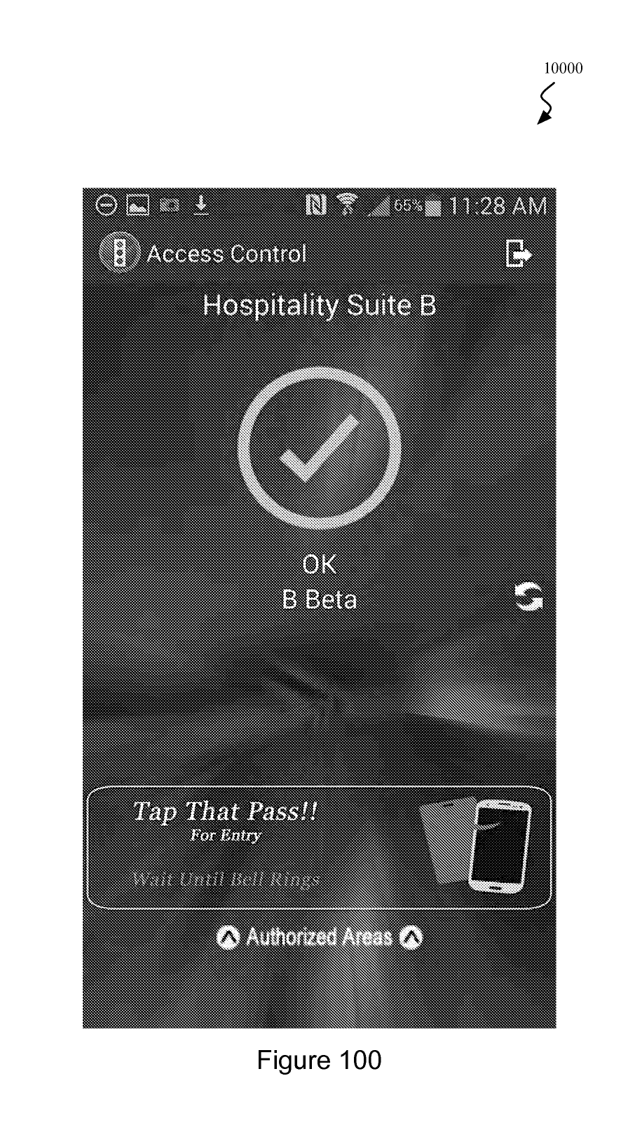

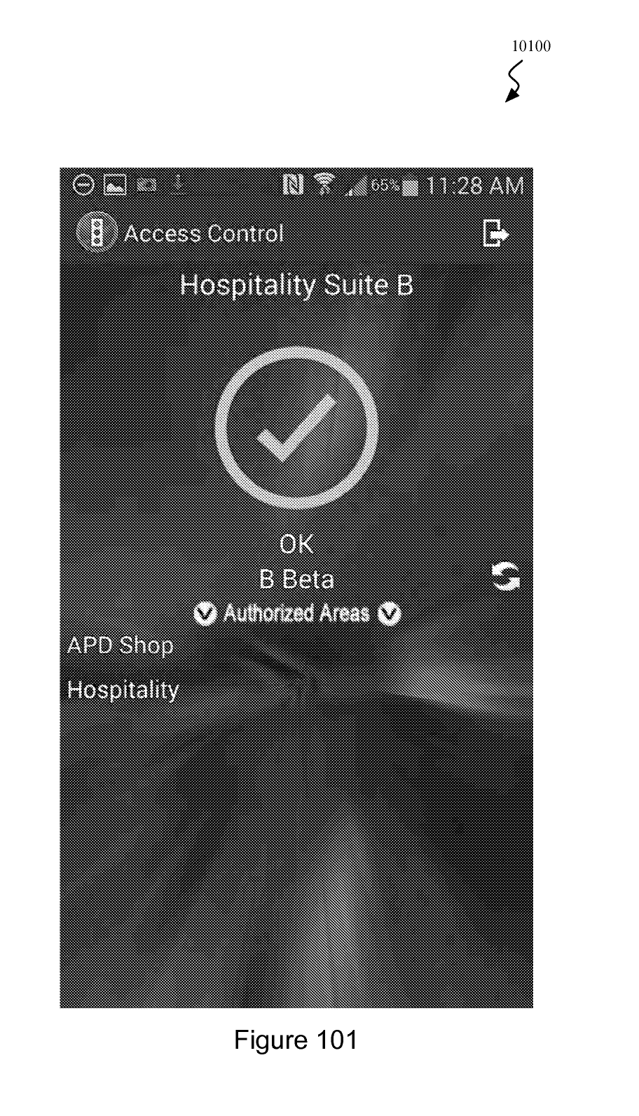

Referring now to FIG. 98 through FIG. 101, various access views are included for a second area. These views and the modules supporting these views function similarly to the access view previously discussed.

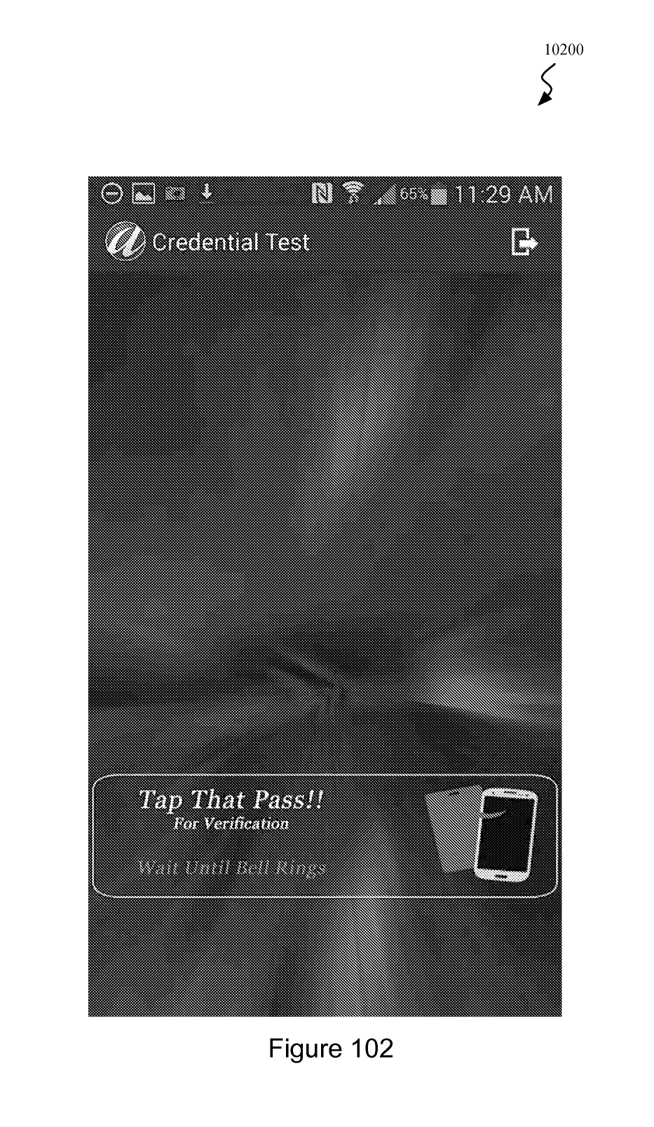

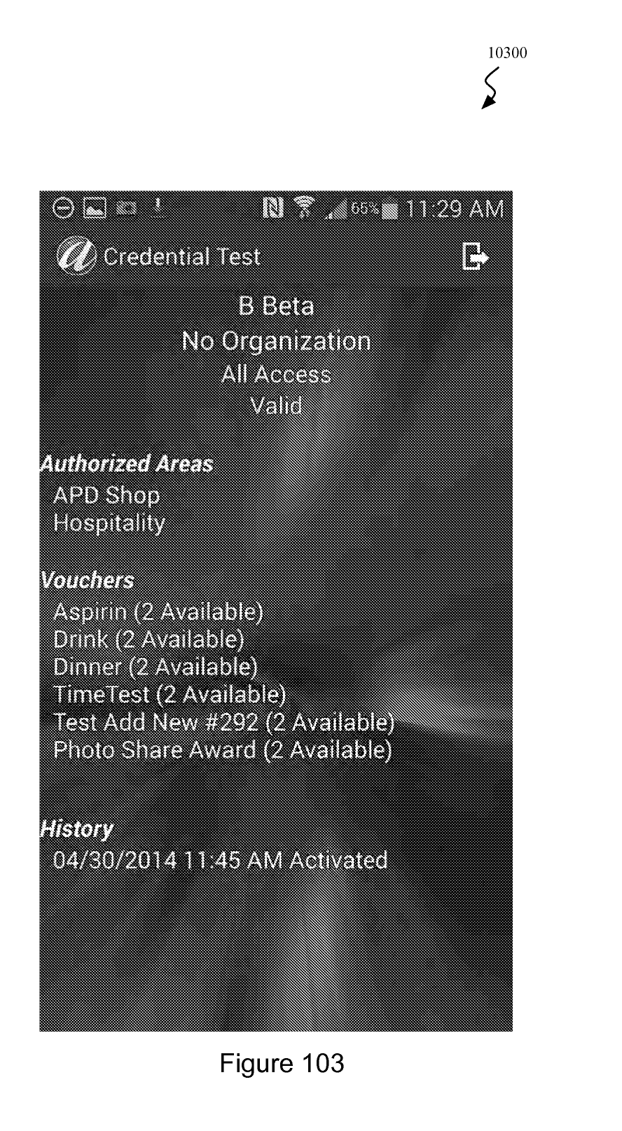

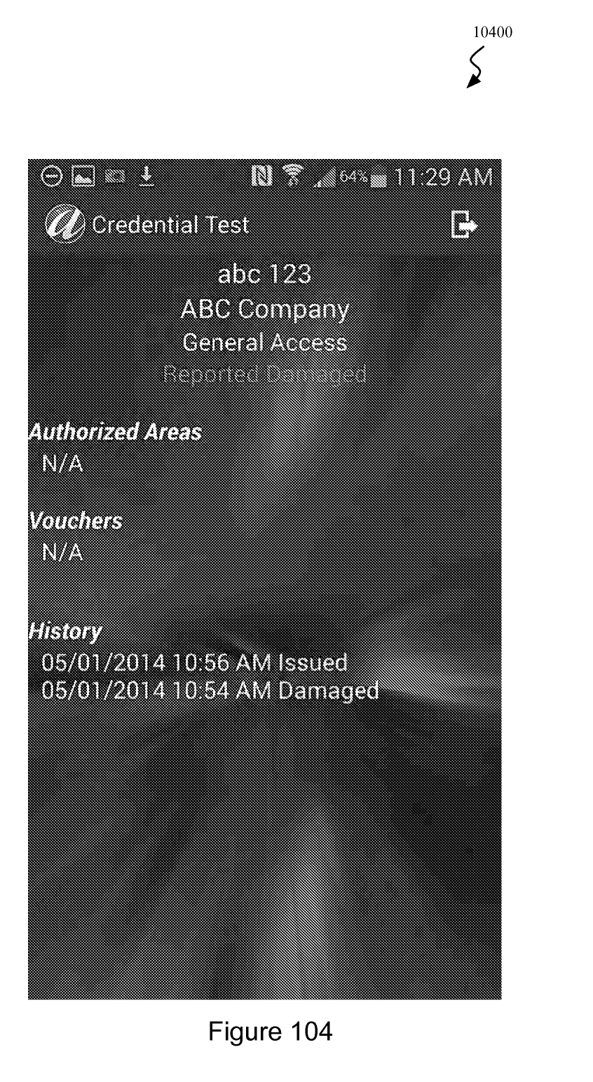

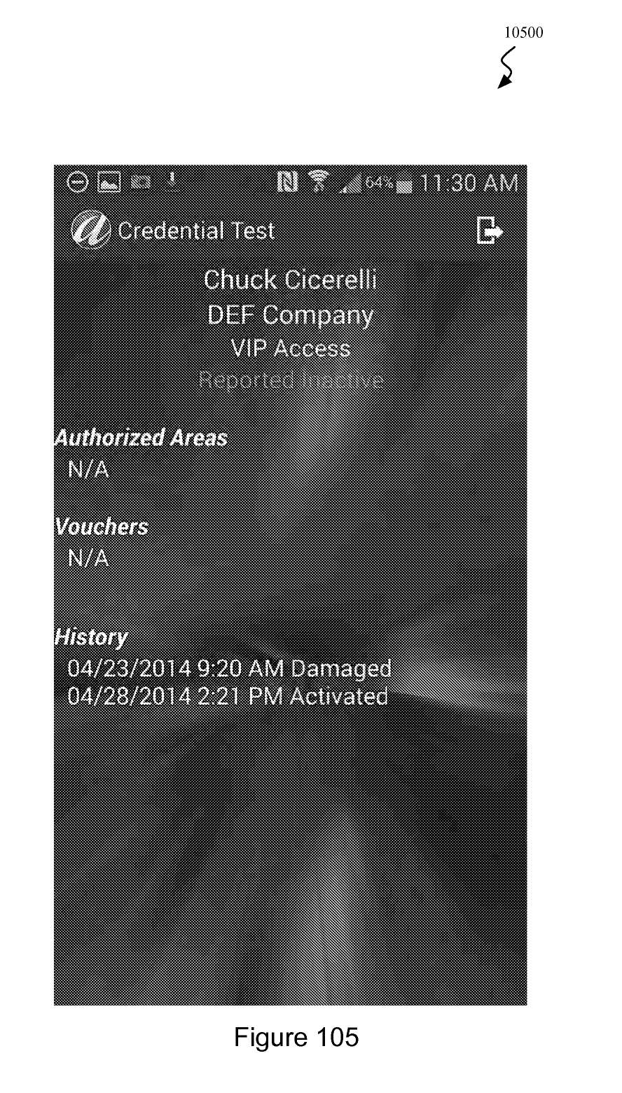

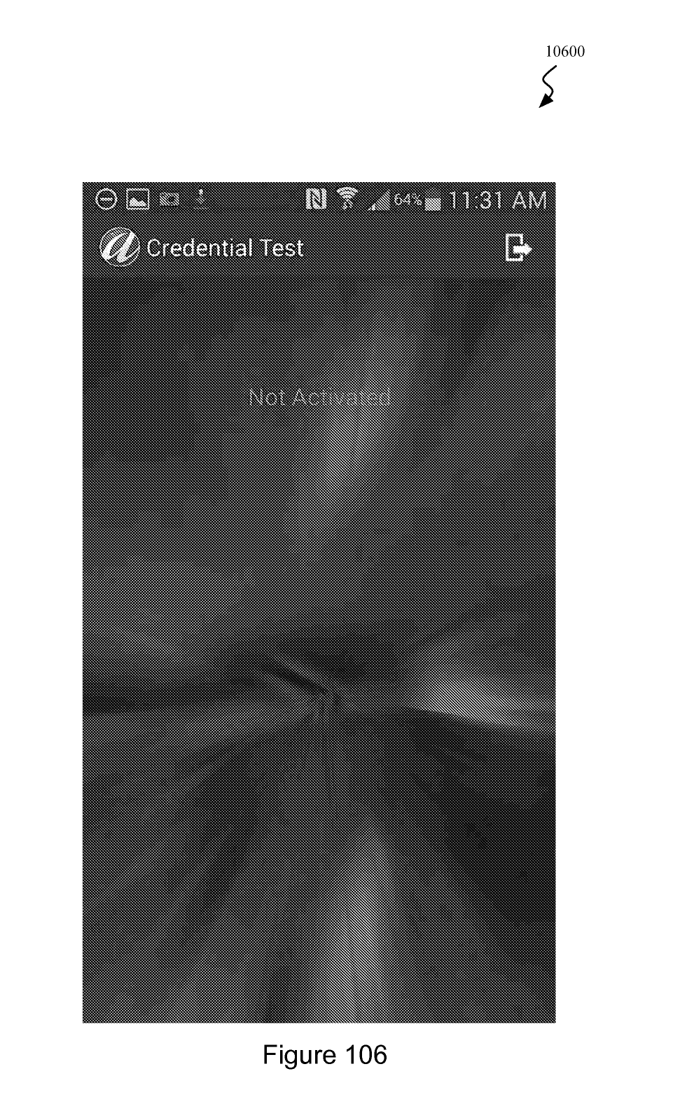

A credential test can be performed at any time. Referring now to FIG. 102 through FIG. 106, upon detection of the selection event associated with the credential test icon on the home view 6800, the credential audit module 736 generates a credential test start view 10200 prompting for the tapping of the credential to the site device. Upon tapping the credential, information can be displayed including, for example, credentialed user information, the activation status, authorized areas, vouchers, and the credential history 10300. Activation status can include such states as, for example, activated and valid 10300, issued and damaged 10400, inactivated 10500, and not activated 10600.

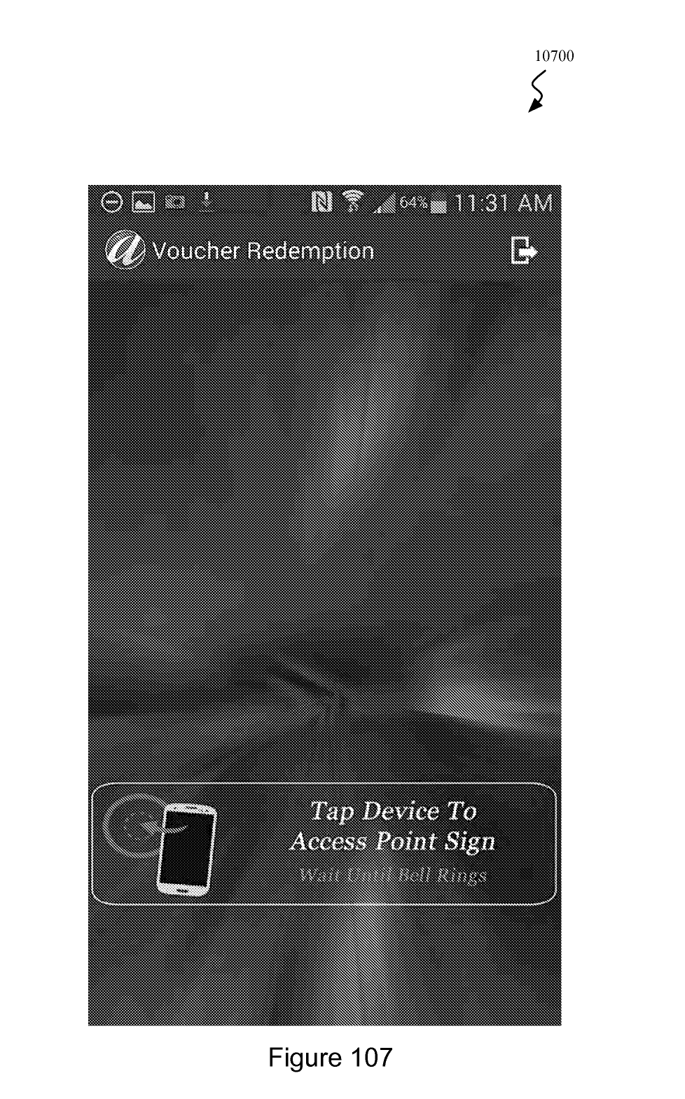

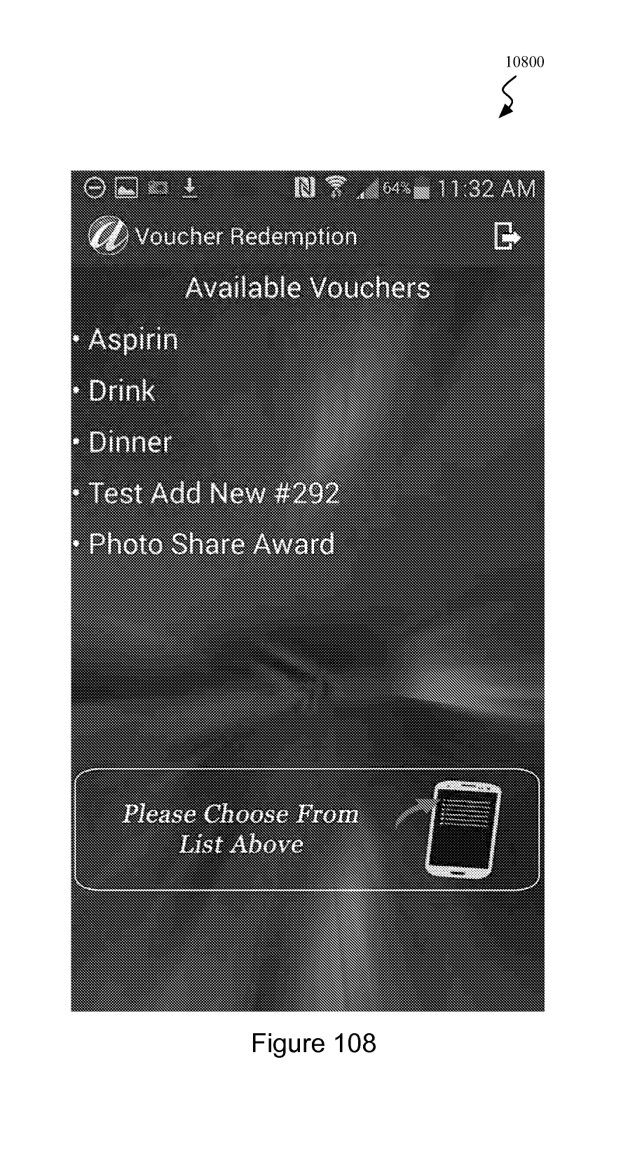

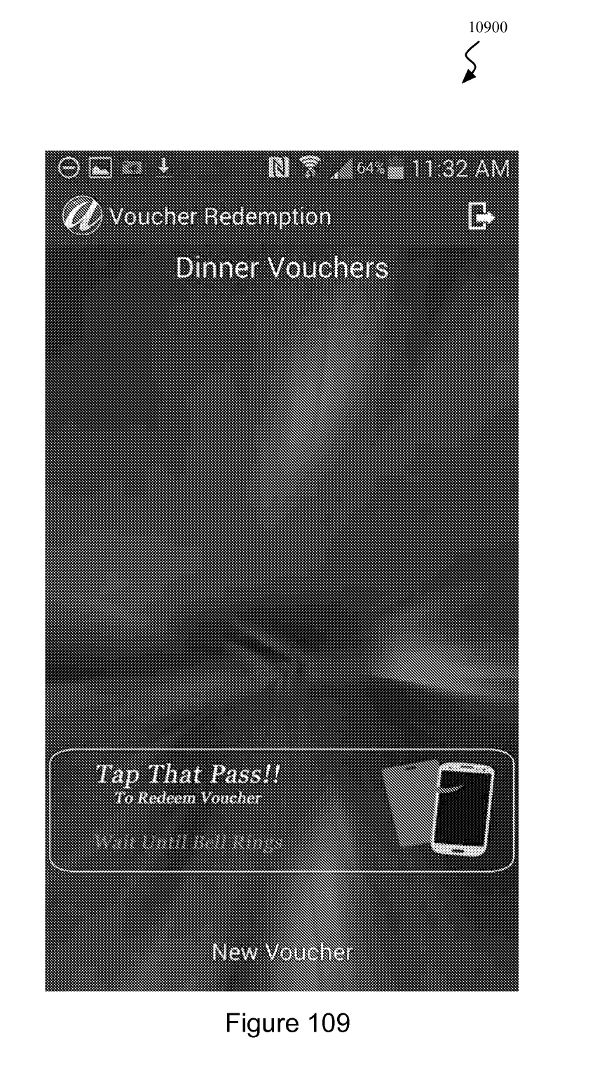

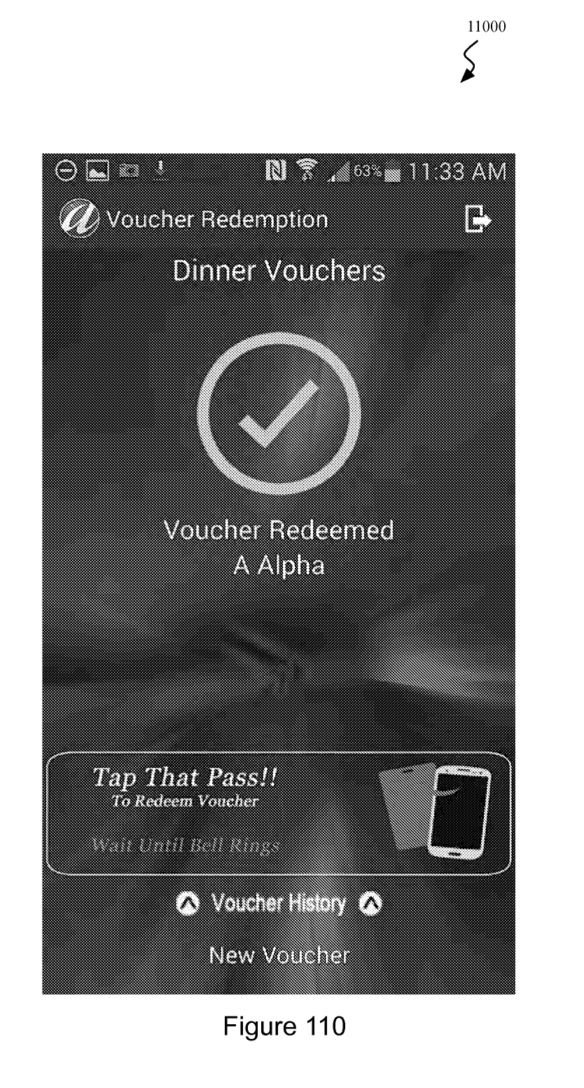

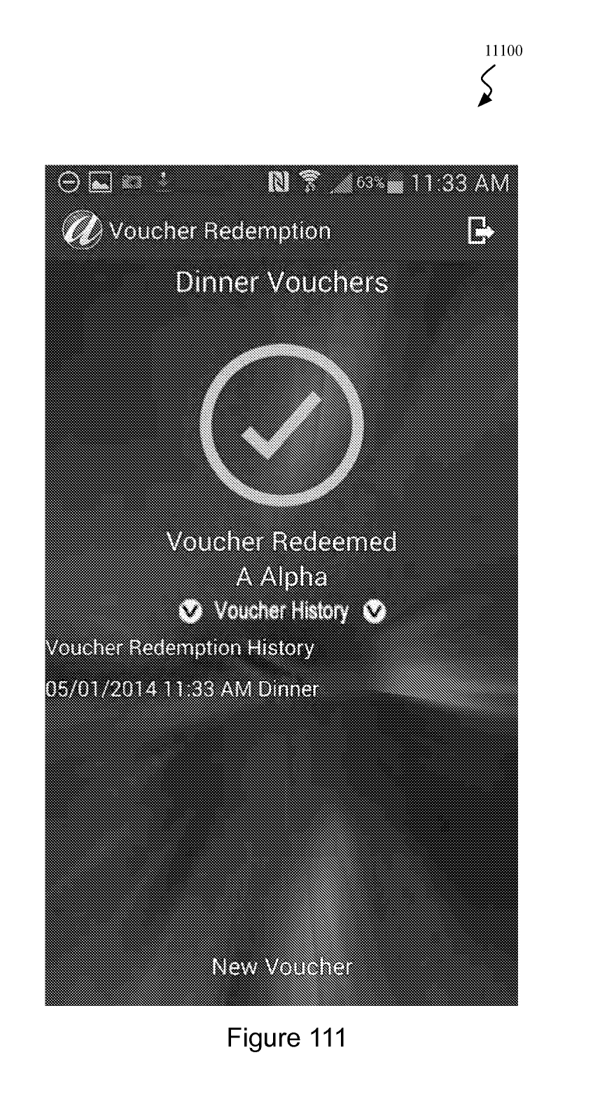

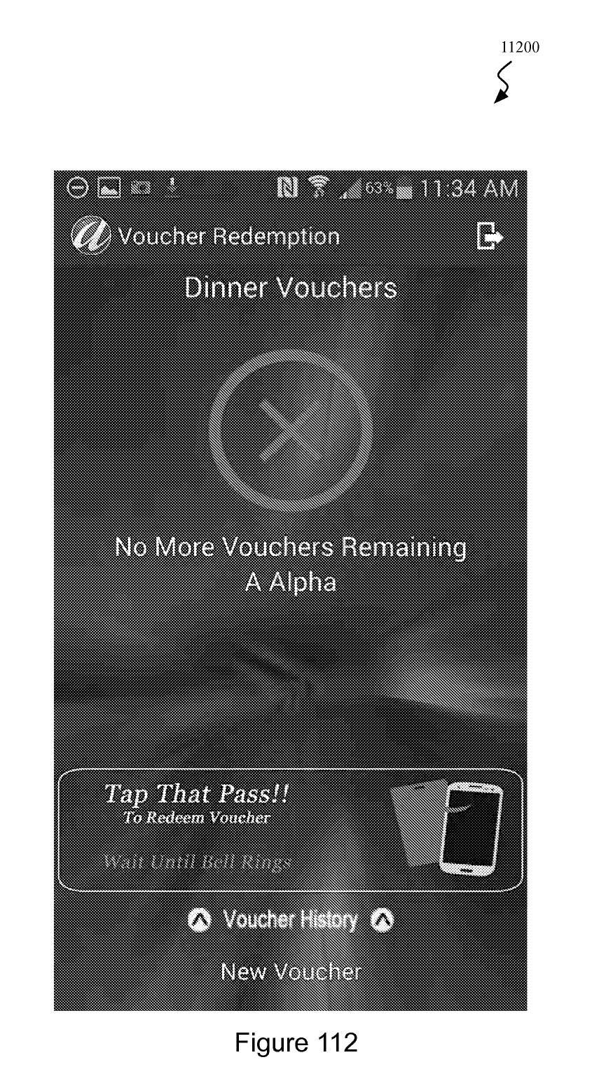

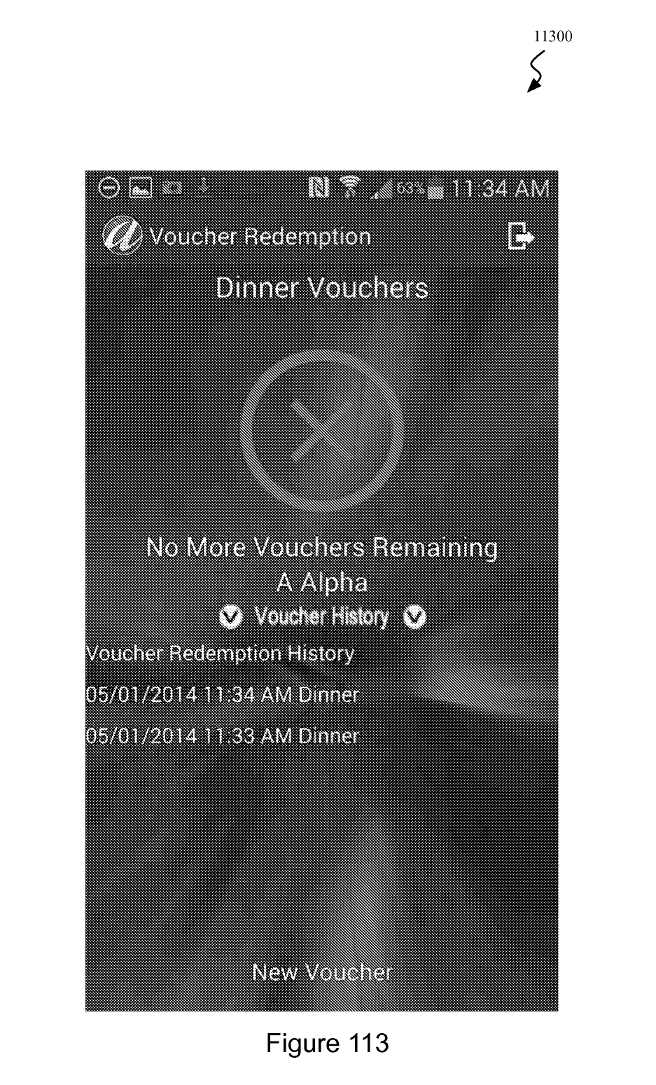

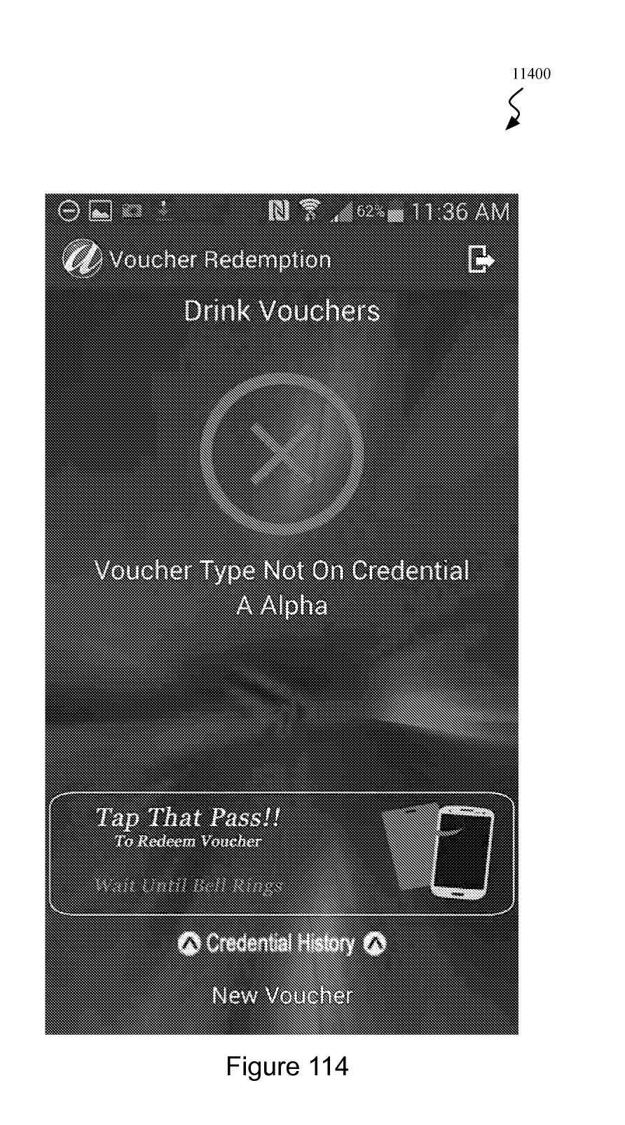

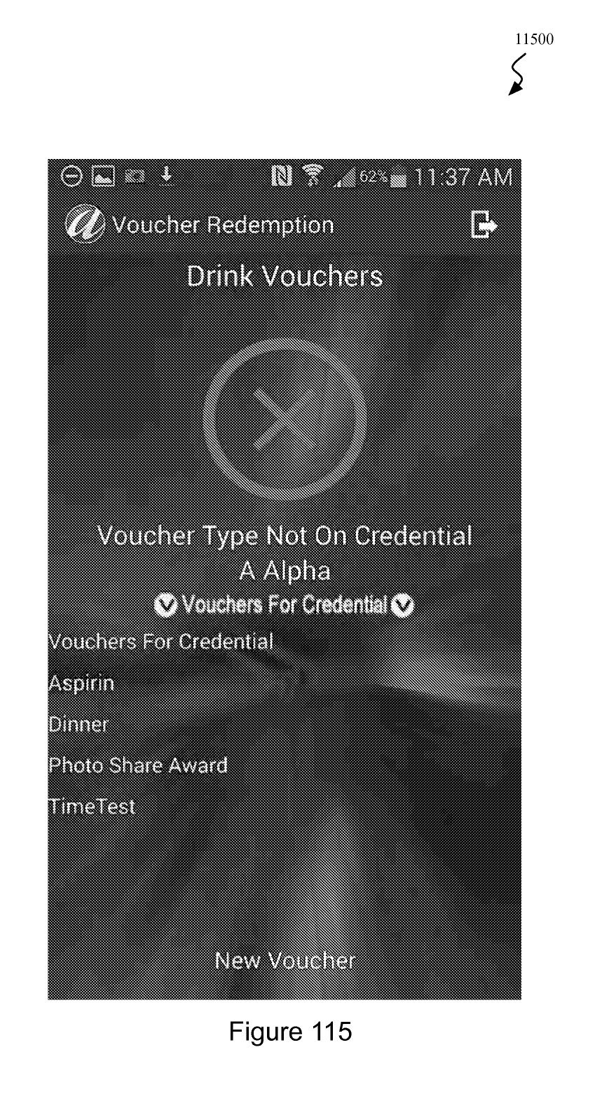

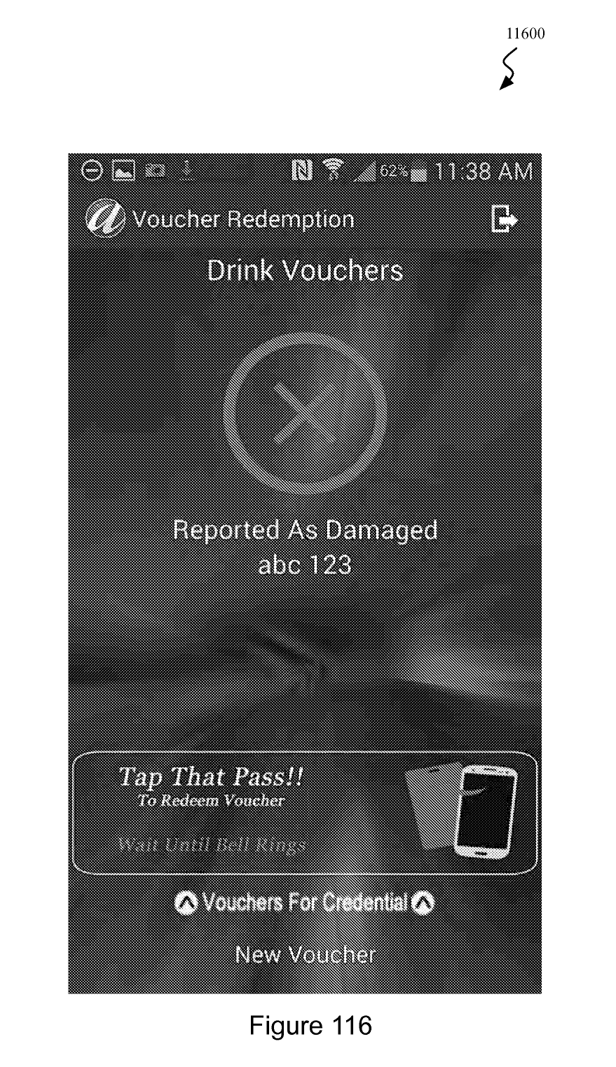

Referring now to FIG. 107 through FIG. 116, various voucher redemption views are included. Upon detection of the selection event associated with the voucher redemption icon on the home view 6800, the voucher redemption module 736 generates a voucher redemption start view 10700. The app user is directed to tap the device to the placard, also referred to as a sign. The tag reader module 710 obtains the tag information associated with the area where the placard is located and passes this information to the messaging module 740. The information is then transmitted to a central server 24-b for processing by voucher service 557 where it is determined if the device is authorized to perform credential activation at the area indicated by the placard tag.

Upon the detection of the credential tap event, the voucher information associated with the credentialed user is retrieved from the voucher service 557 and the available vouchers are presented in a voucher redemption available vouchers selection view 10800. The user of the app is prompted to select the voucher to be redeemed. Once the selection event associated with the voucher listing is detected, the voucher redemption voucher selections view 10900 is displayed, and a prompt is displayed requesting the tapping of the credential. Once tapped, the voucher redemption redeemed voucher view 11000 is displayed. Detection of the selection event associated with the voucher redemption history drawer control displays the voucher redemption voucher history view 11000, 11300. If there are not more vouchers associated with the credentialed user at the time the credential is tapped to the device, the voucher redemption module 728 displays the voucher redemption no vouchers available view 11200. Similarly, if there are no vouchers of the type authorized to be redeemed by the device associated with the credentialed user at the time the credential is tapped to the device, the voucher redemption module 728 displays the voucher redemption no voucher type available view 11400. Detection of the selection event associated with the vouchers for credential drawer control displays the voucher redemption voucher type list view 11500, displaying the voucher types available for the credentialed user. In the event the credential was reported to the system server 28 as damaged prior to attempting to redeem the voucher, the voucher redemption module 728 displays the voucher redemption view for a damaged credential. Voucher redemption information is communicated to the messaging module 740 for transmission to the interest collection and tracking servers 24 for use by various services on the services layer 510, including the portal service 545.

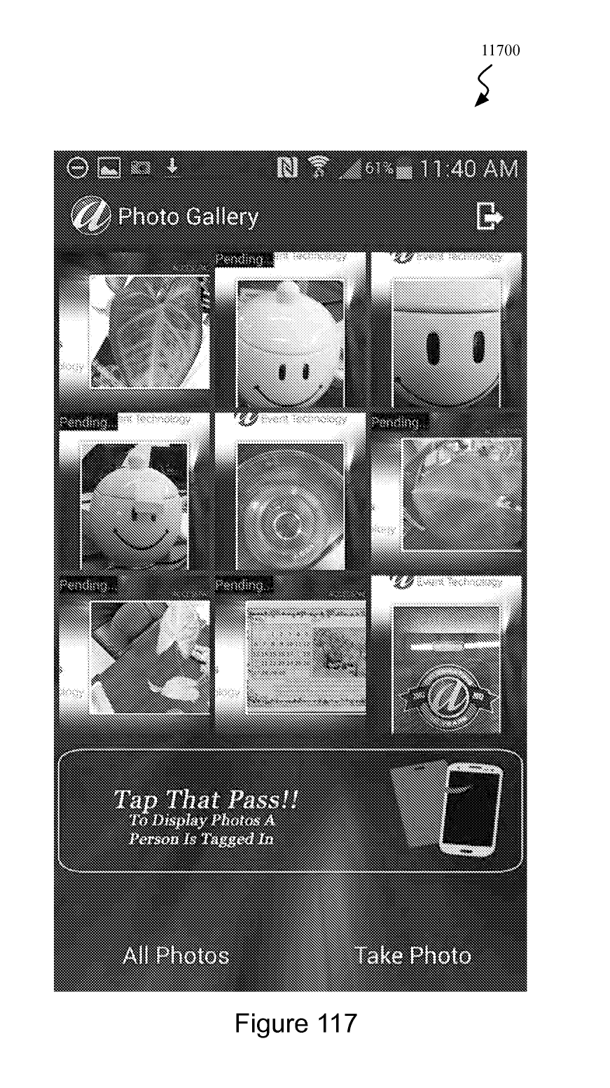

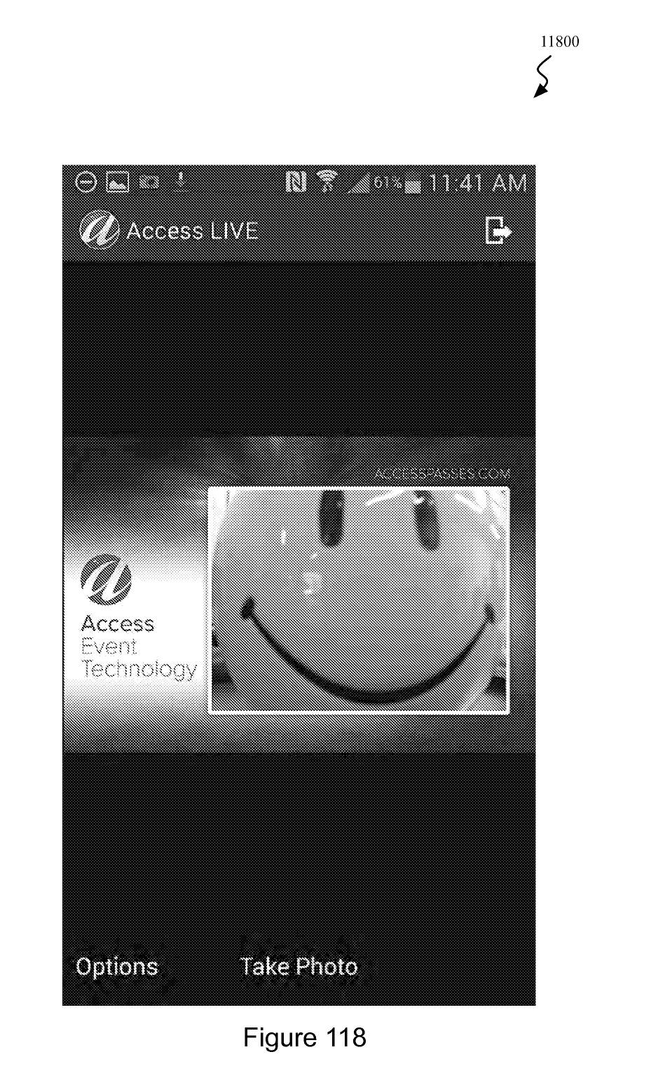

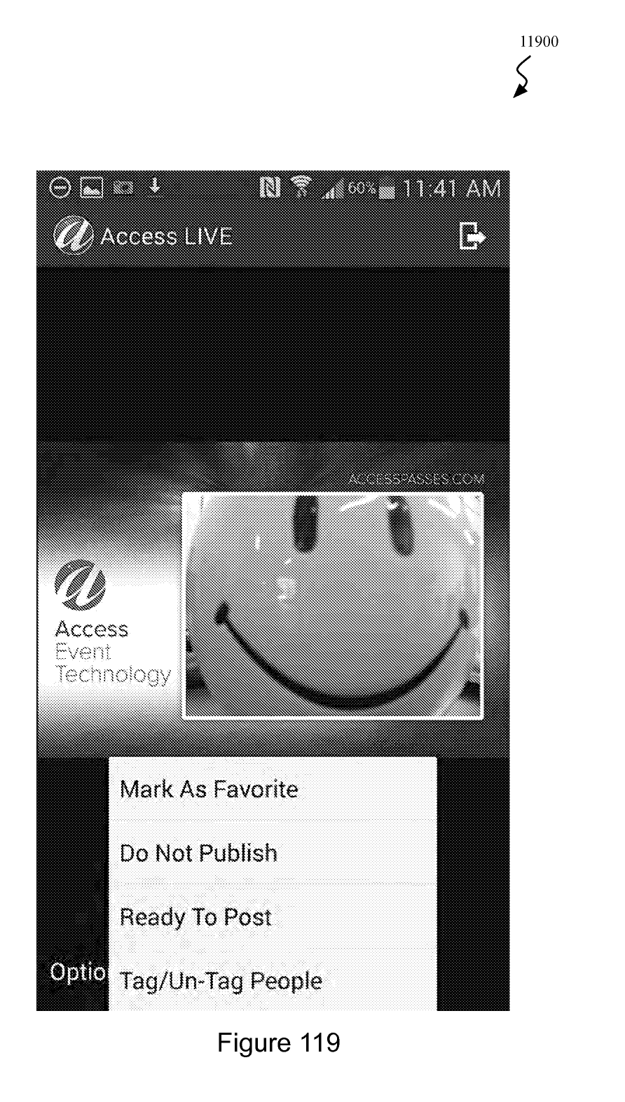

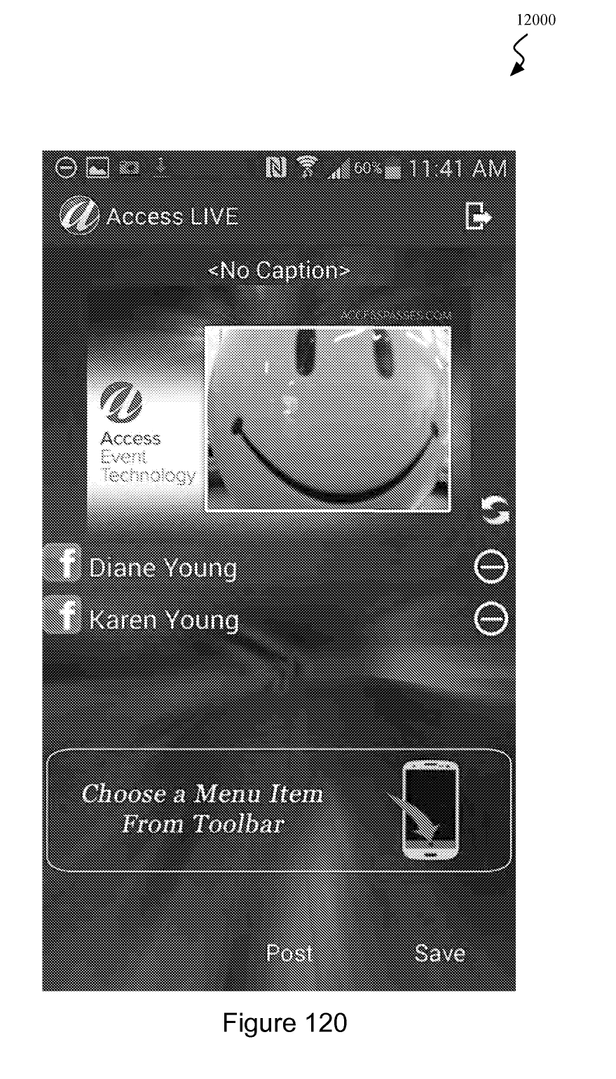

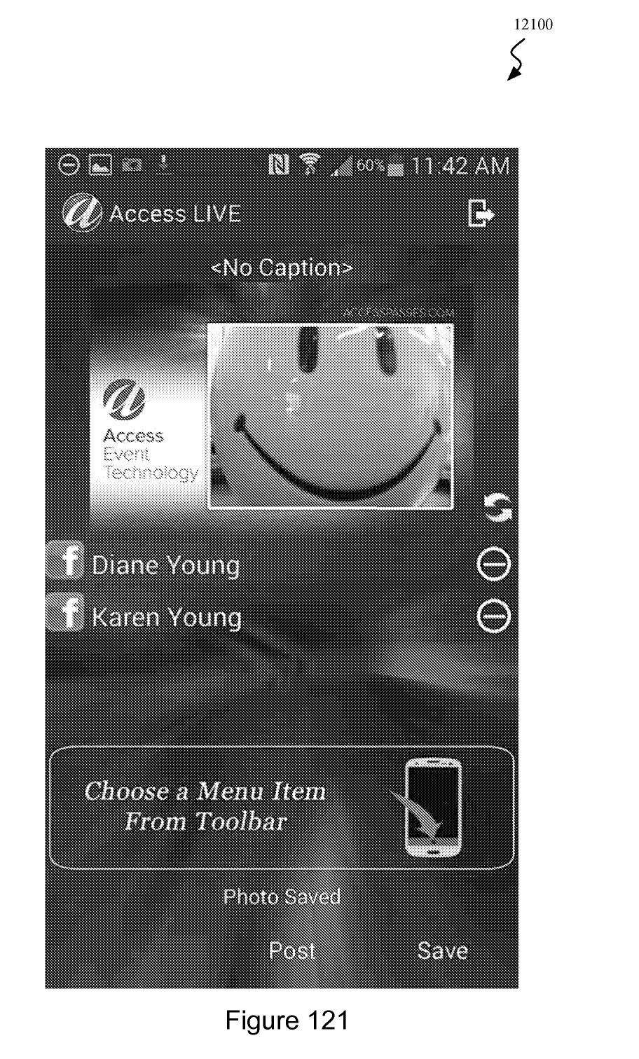

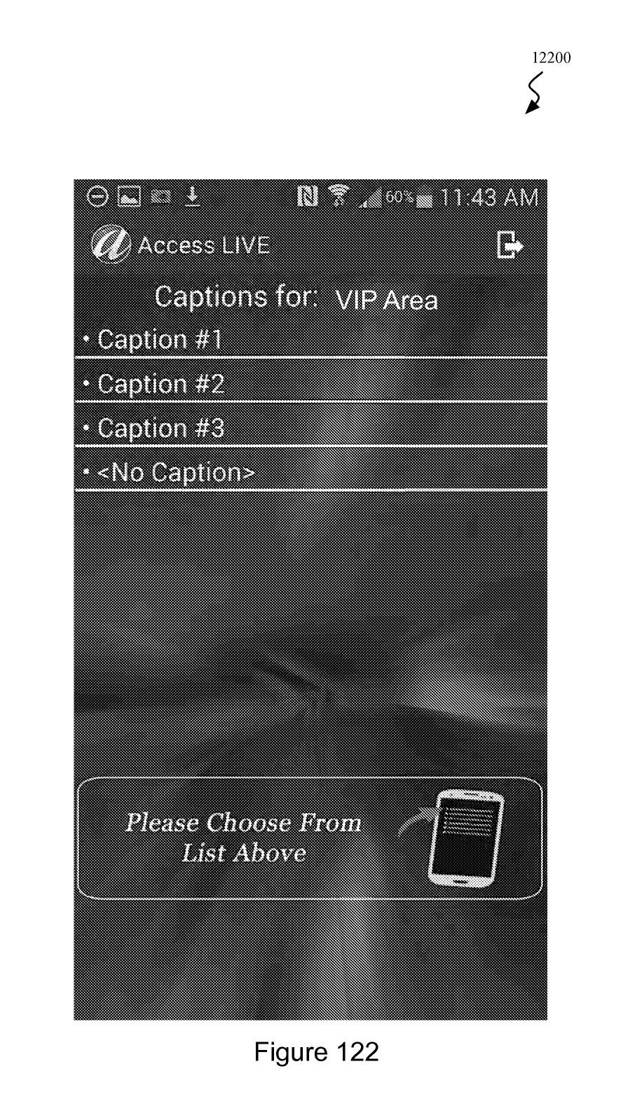

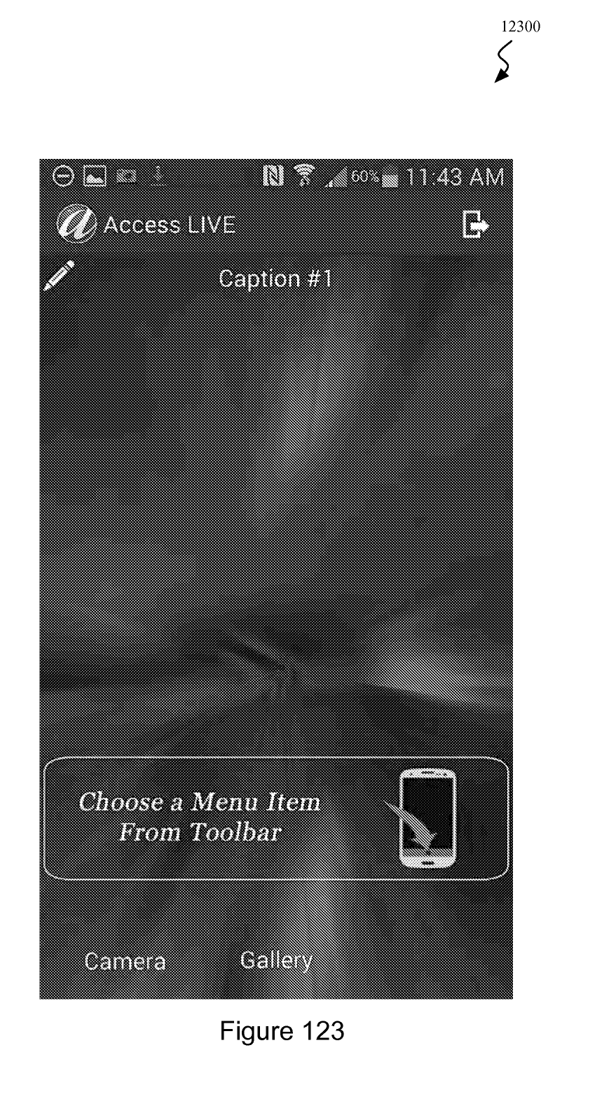

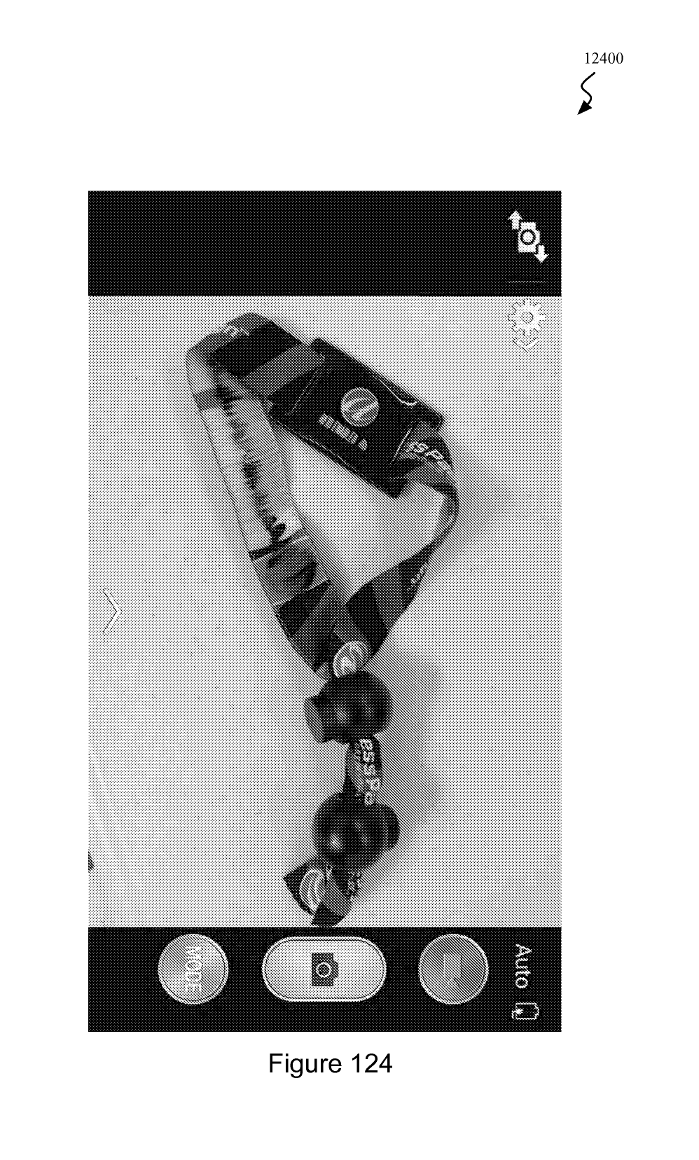

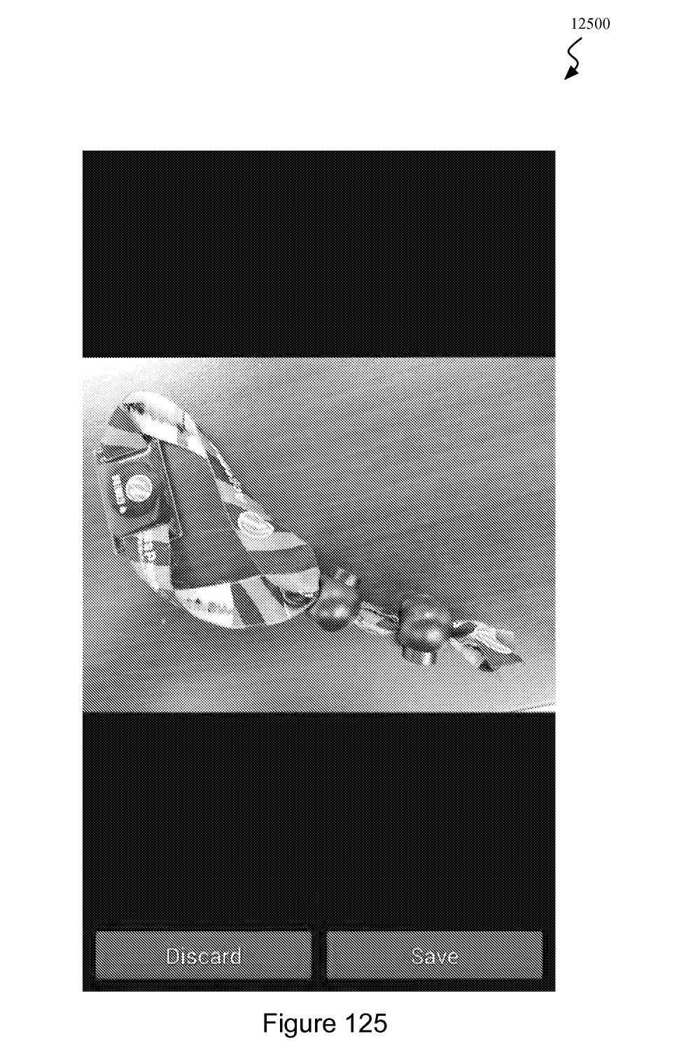

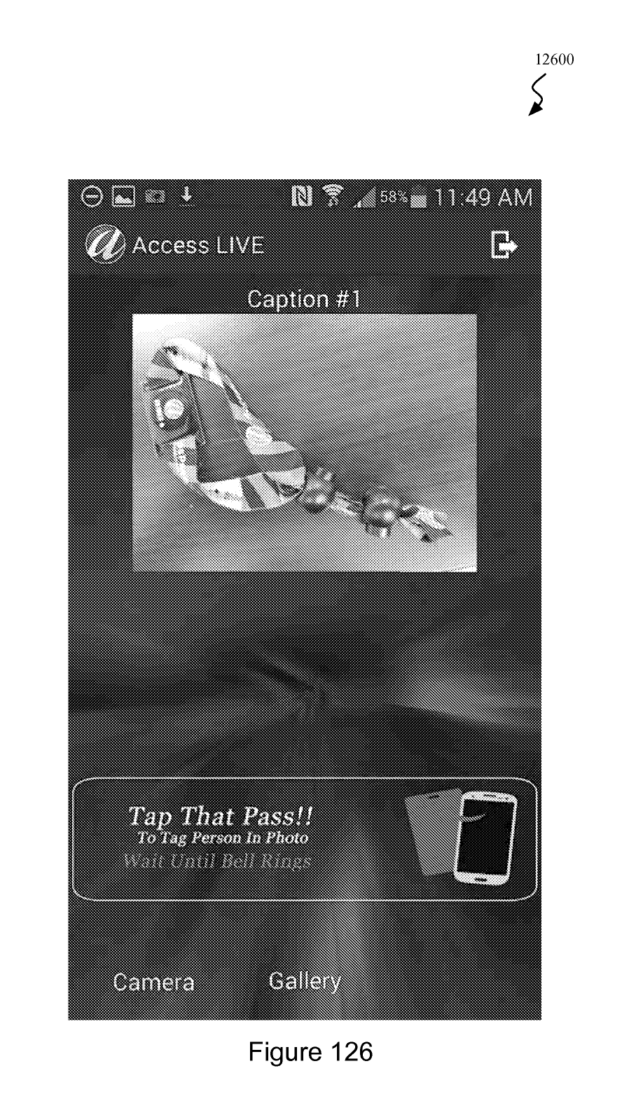

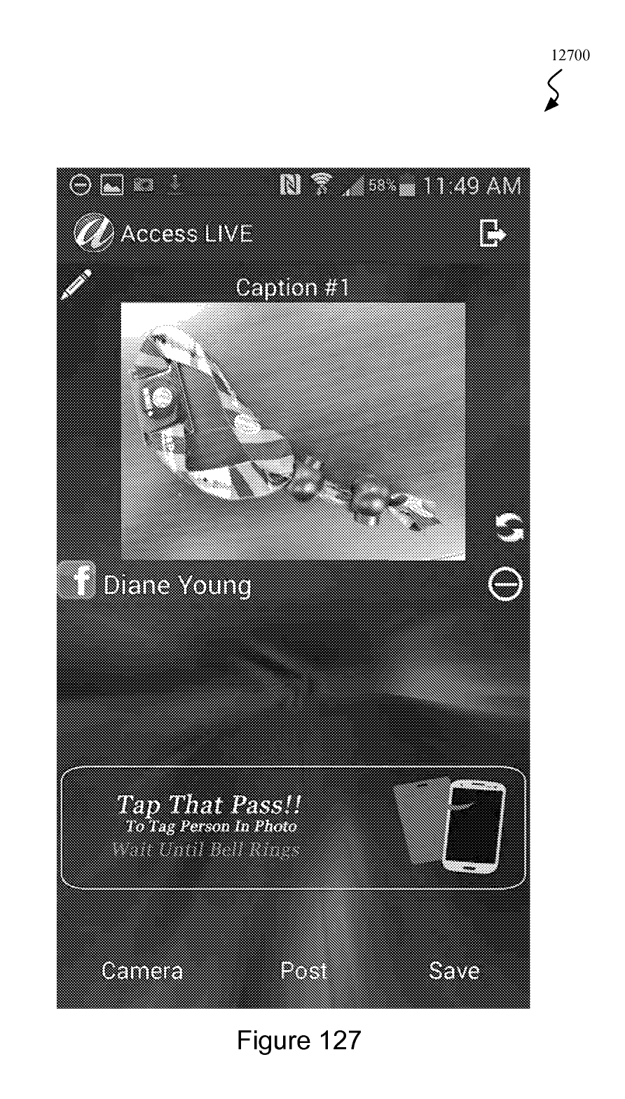

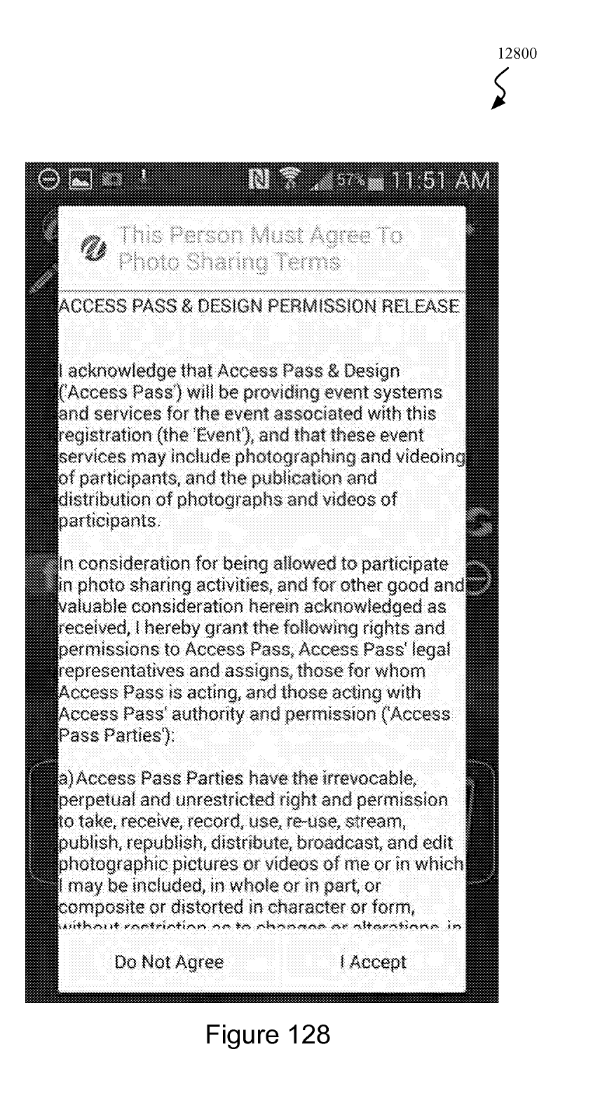

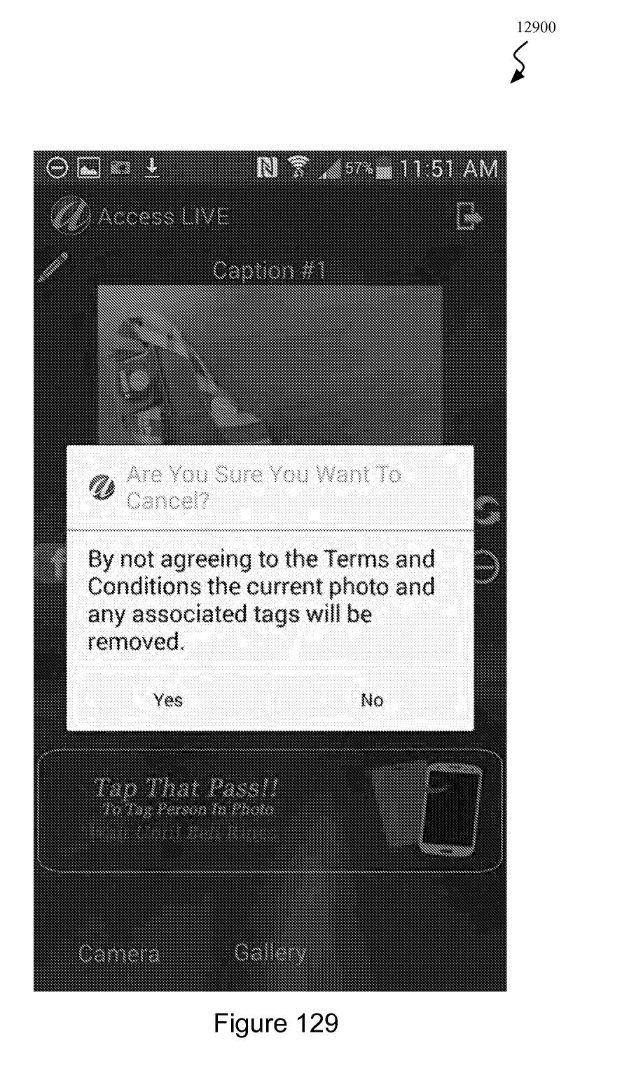

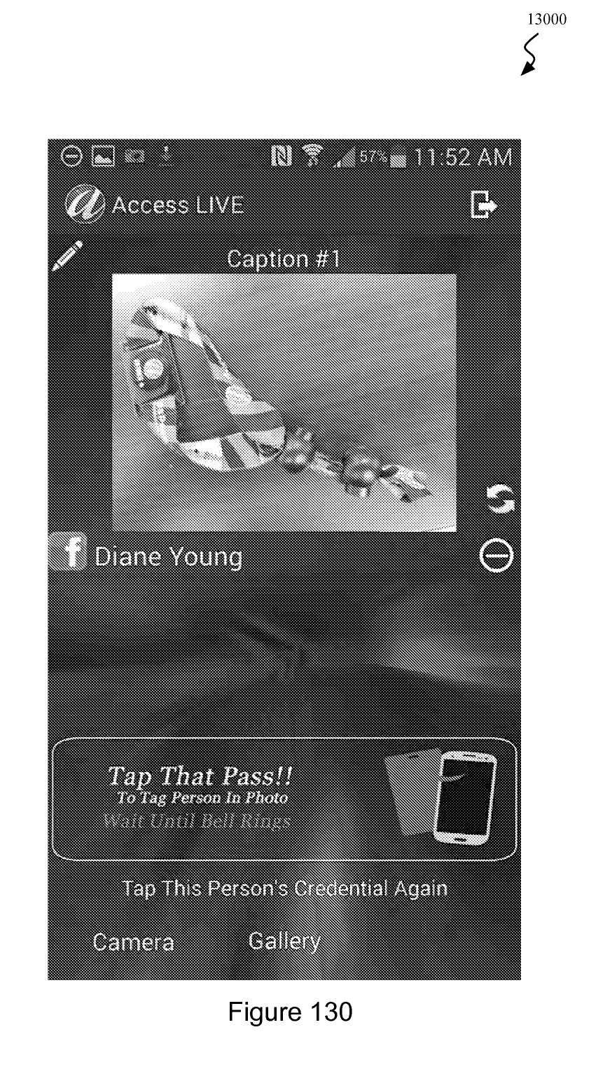

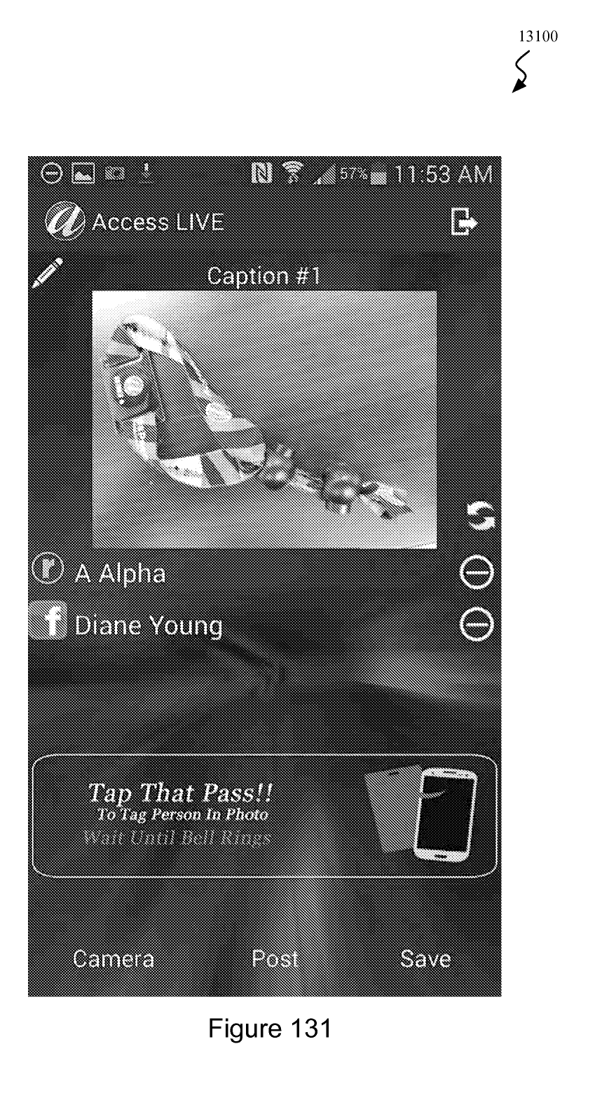

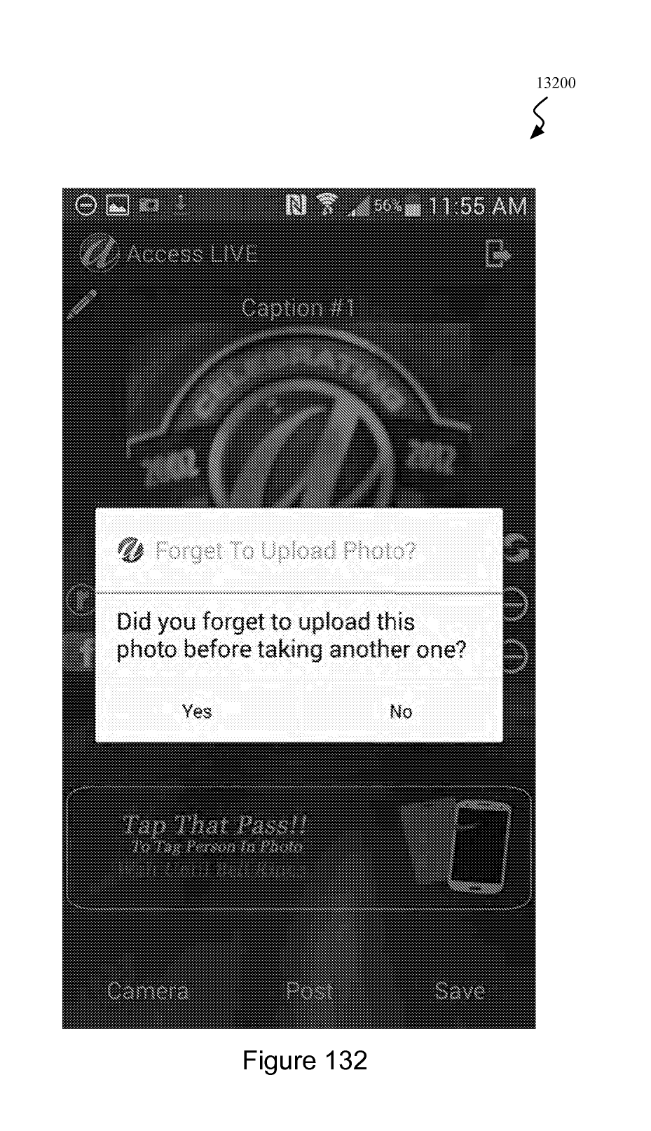

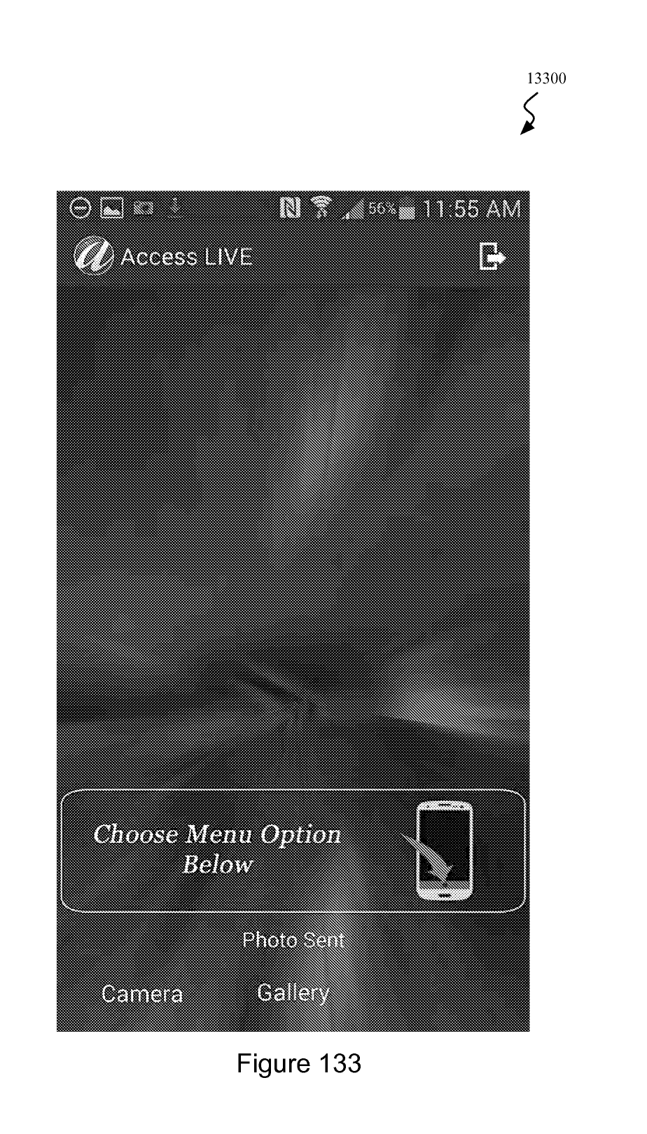

Referring now to FIG. 117 through FIG. 133, various photo share views are included. Upon detection of the selection event associated with the photo share icon on the home view 6800, the photo share module 716 generates a photo gallery view 11700, prompting the operator of the app to tap a user's credentials or select a menu item, such as take a photo or display all photos. If a credential tap event is detected, the photos that the credentialed person is tagged in can be displayed. The photo share module 716 will display the selected photo view 11800 upon detection of the selection event associated with a photo, image, or video displayed in the gallery. Detection of the selection event associated with the options menu item displays the selected photo menu options view 11900. Menu options can include, for example, marking the photo as a favorite, setting the privacy attribute of the photo to unpublish, setting the publication attribute of the photo to ready to publish, and toggling person tags.

Upon editing a photo, the edited photo view 12000 can be displayed and the photo changes saved 12100. Upon detection of the selection event associated with the caption control, the photo share module 716 displays the area specific photo caption selection view 12200. Upon detection of the selection event associated with a caption, the photo share module 716 displays the area specific selected photo caption view 12300, with one or more menu options available to select a photo, image, or video, such as a camera menu item and a gallery menu item.

Upon detection of the selection event associated with the camera menu item, the photo share module 716 can hand device control to the native image or video capture mechanisms of the device 12400. Once an image is captured, control is returned to the app and the save/discard 12500 photo view is displayed. If the photo is discarded, the user can select to take another photo or video, or select an image, photo, or video from the gallery. If the photo is saved, the photo share captioned view is displayed with the saved photo 12600. Upon detection of the selection event associated with the edit image control, the photo share edited photo view is displayed and one or more authorized social media publication targets can be selected. Upon selection of one or more publication targets, the post menu item is enabled 12700. Upon detection of selection of the post menu item, if one or more of the selected publication targets is not associated with database record indicating the target has accepted a model release, the model release acceptance prompt 12800 is displayed. The model release prompt 12800 can include an acceptance selection control and a refusal selection control. If the publication target opts for the refusal selection, a model release refusal acceptance message can be displayed indicating the results of the refusal. The operations that result from the refusal can be configured.

If the publication target opts for the acceptance selection, pre-posting credential tap prompt message 13000 is displayed requesting that the person tap their credentials, verifying their identity in advance of posting the photo, image, or video. In some instances, different social media and other publication targets can be selected 13100. In certain cases, if the user attempts to take a photo without uploading the previously prepared posting, the photo share module 716 will display the forgot to upload prompt, reminding the user that they did not upload the prior prepared posting. Once the posting is successful, a photo sent message is displayed 13300. Photos, images, videos, and their related information is communicated to the messaging module 740 for transmission to the interest collection and tracking servers 24 for use by various services on the services layer 510, including the portal service 545.

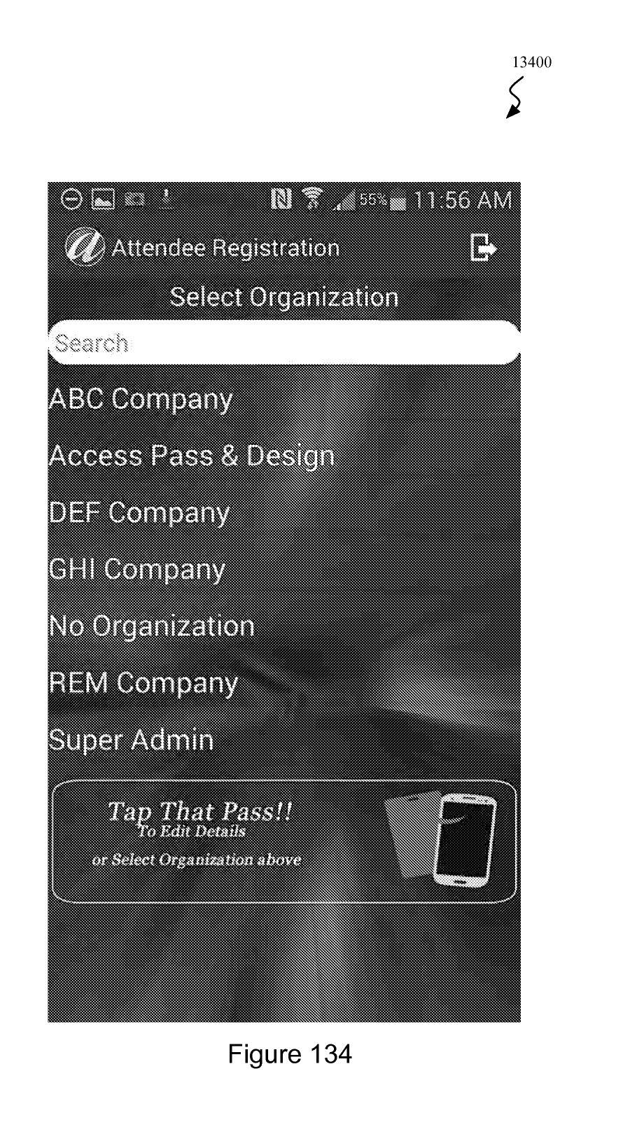

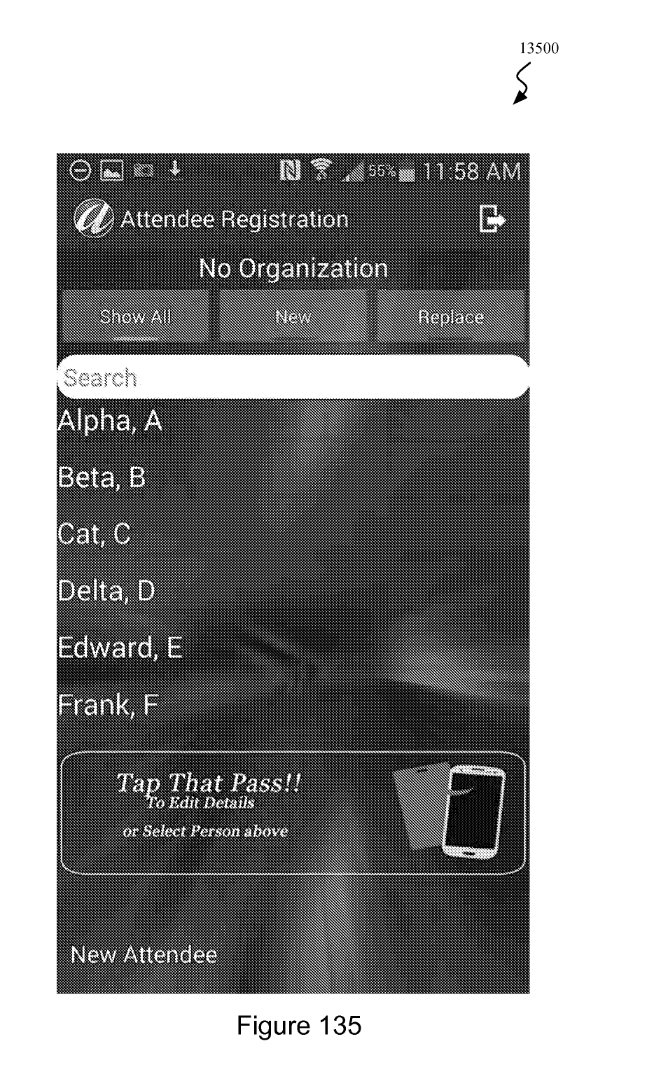

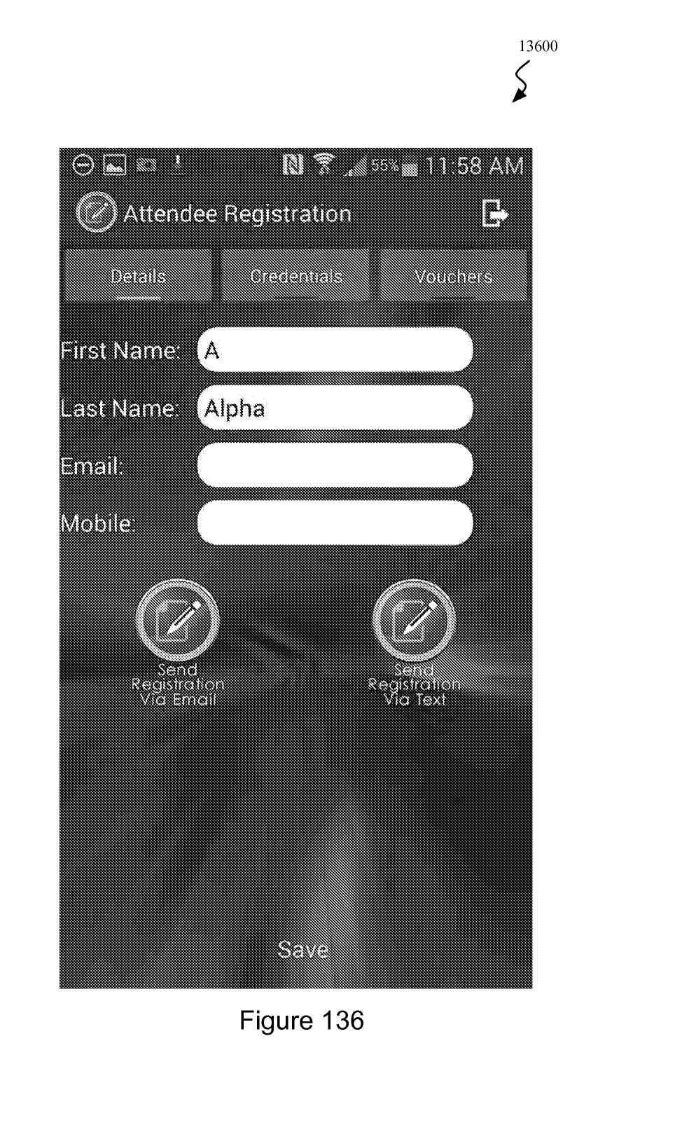

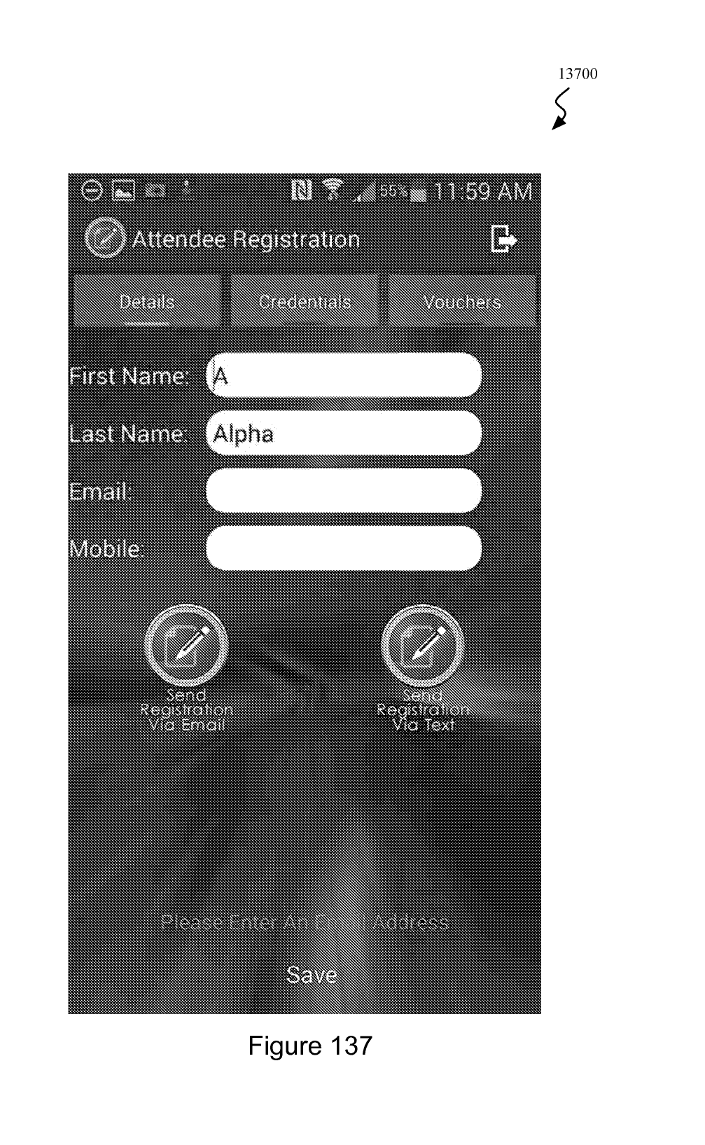

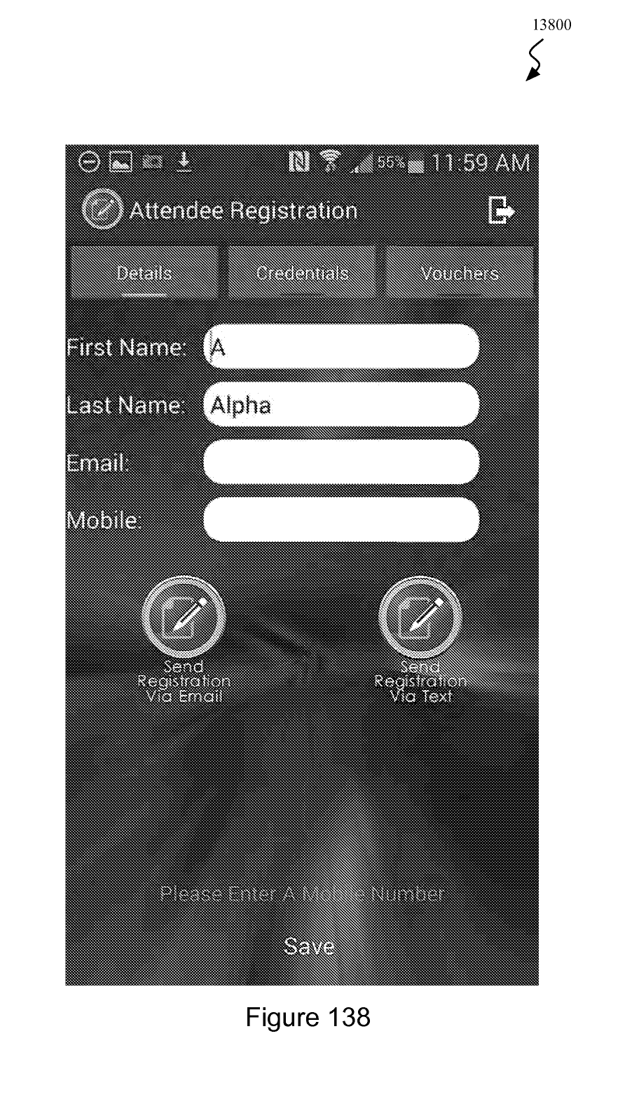

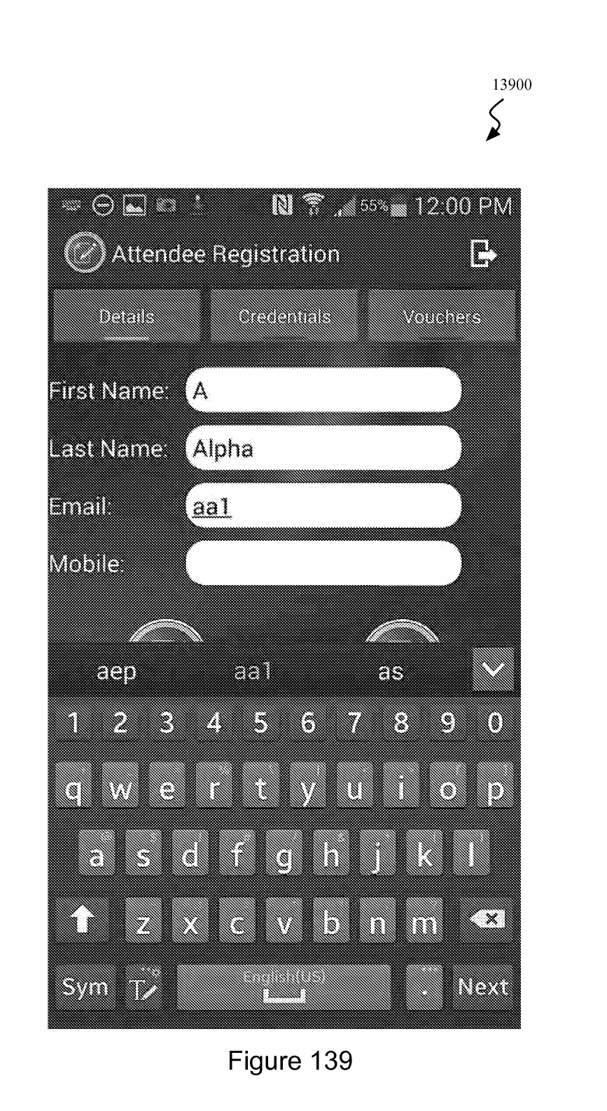

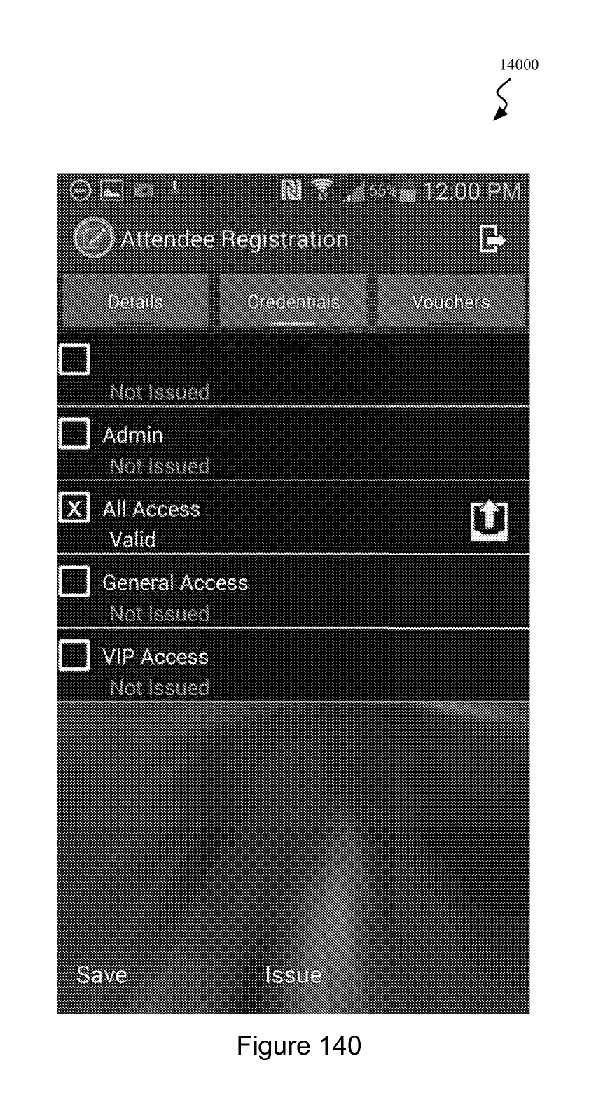

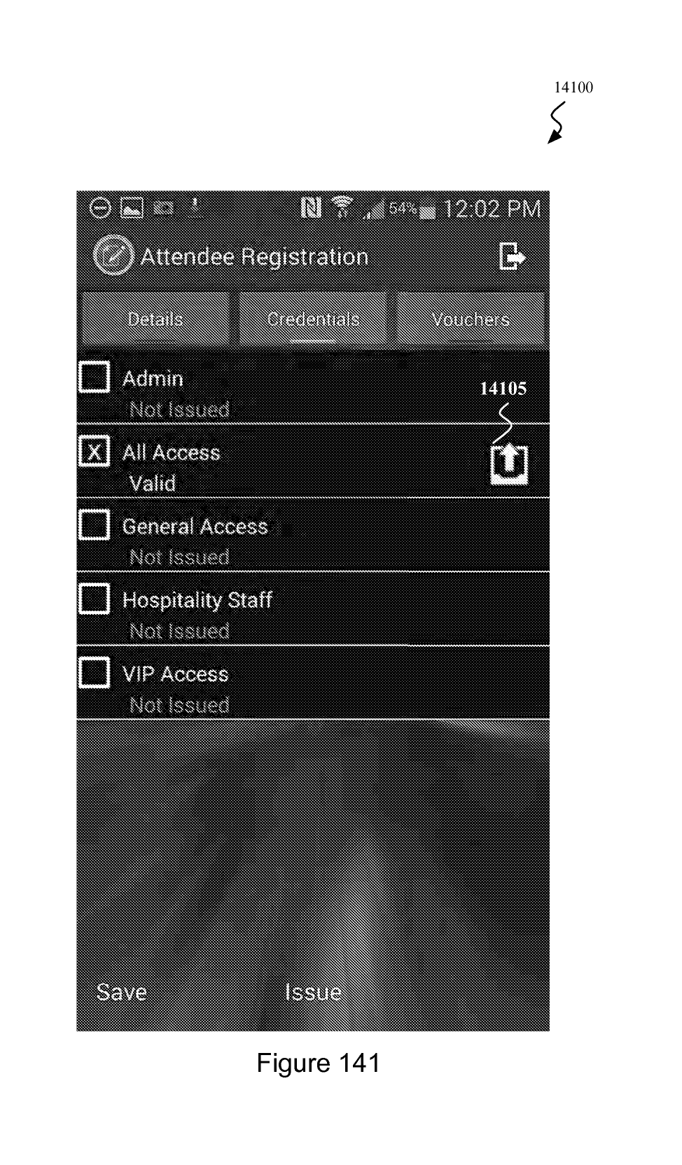

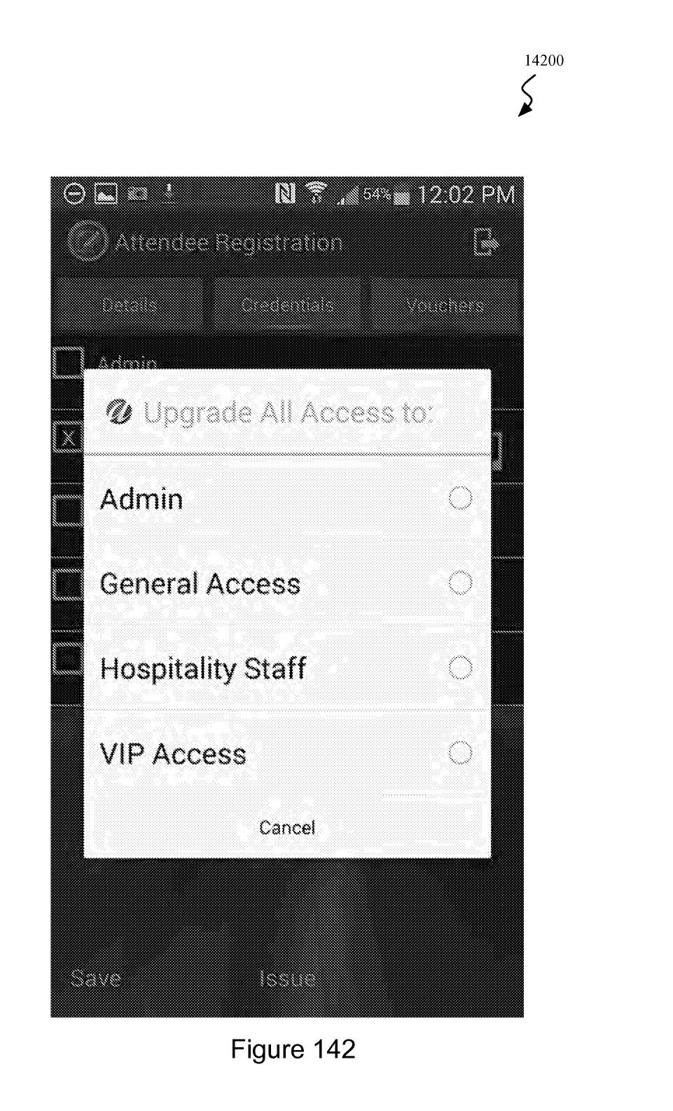

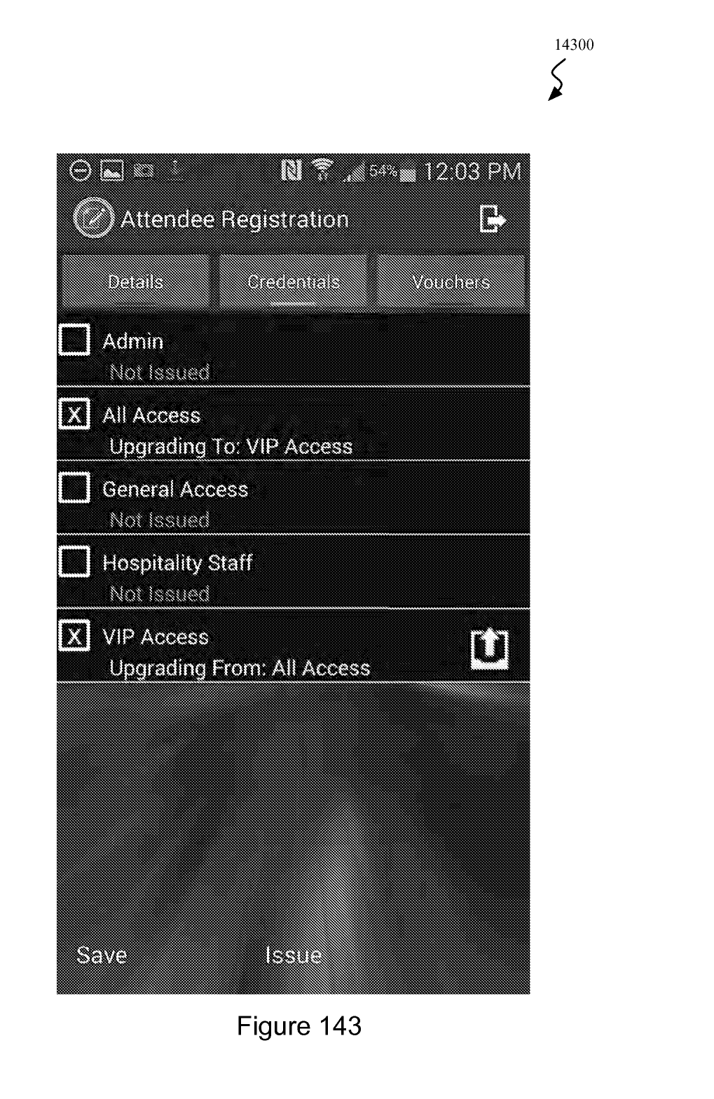

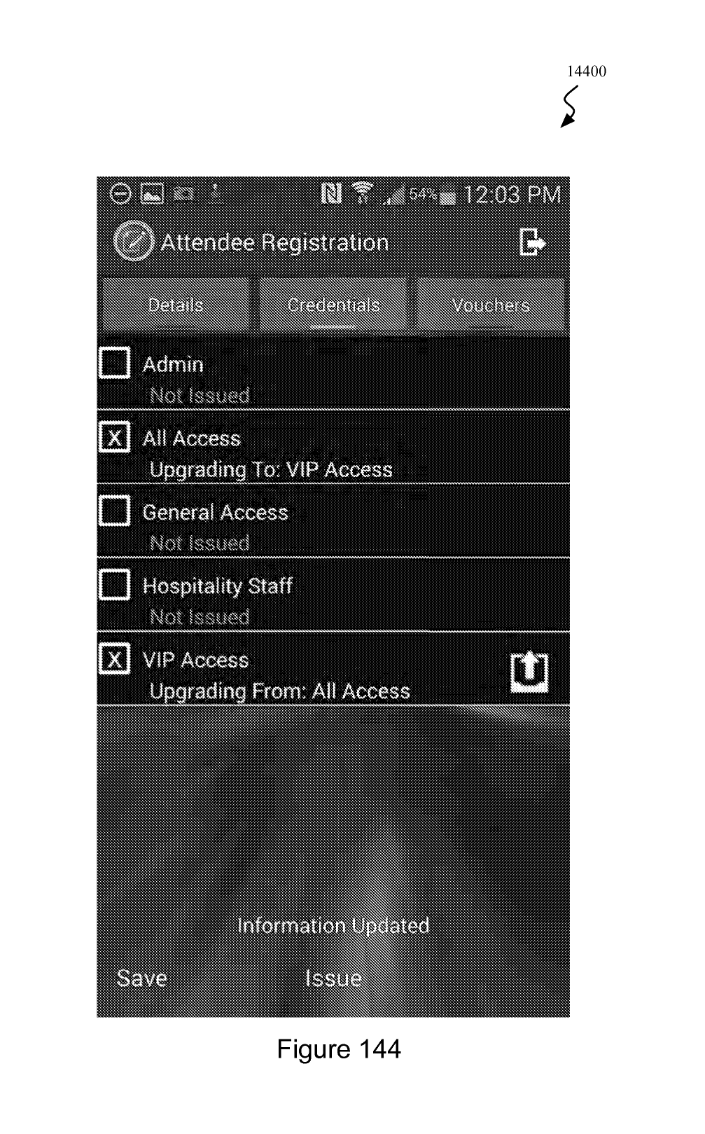

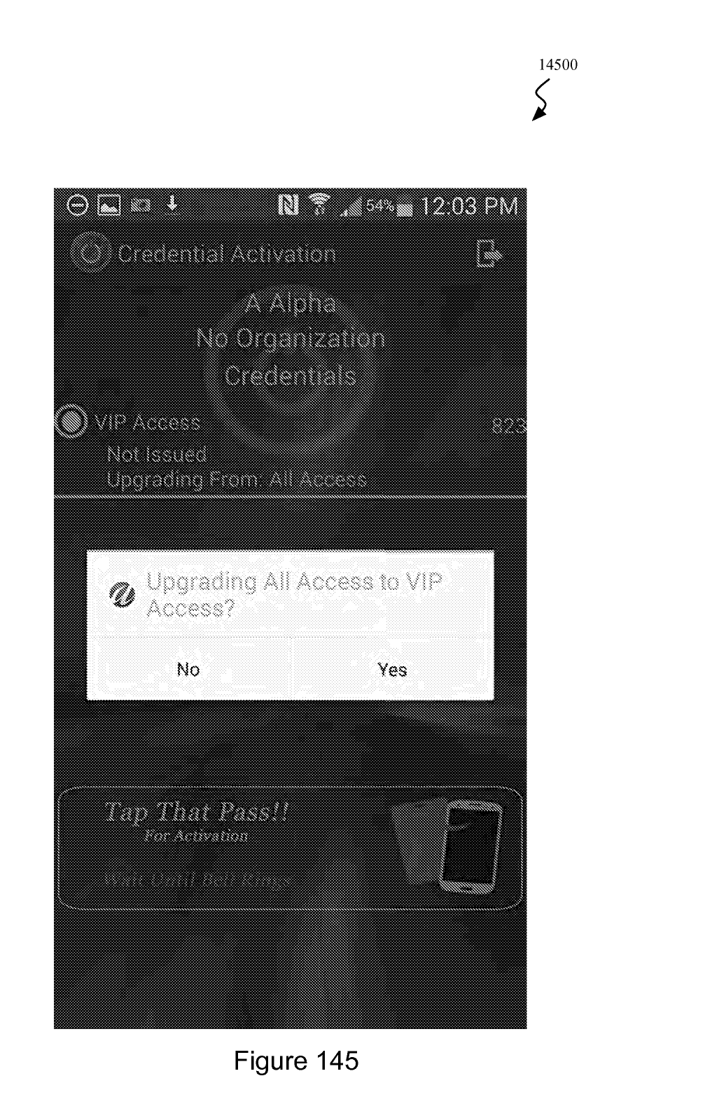

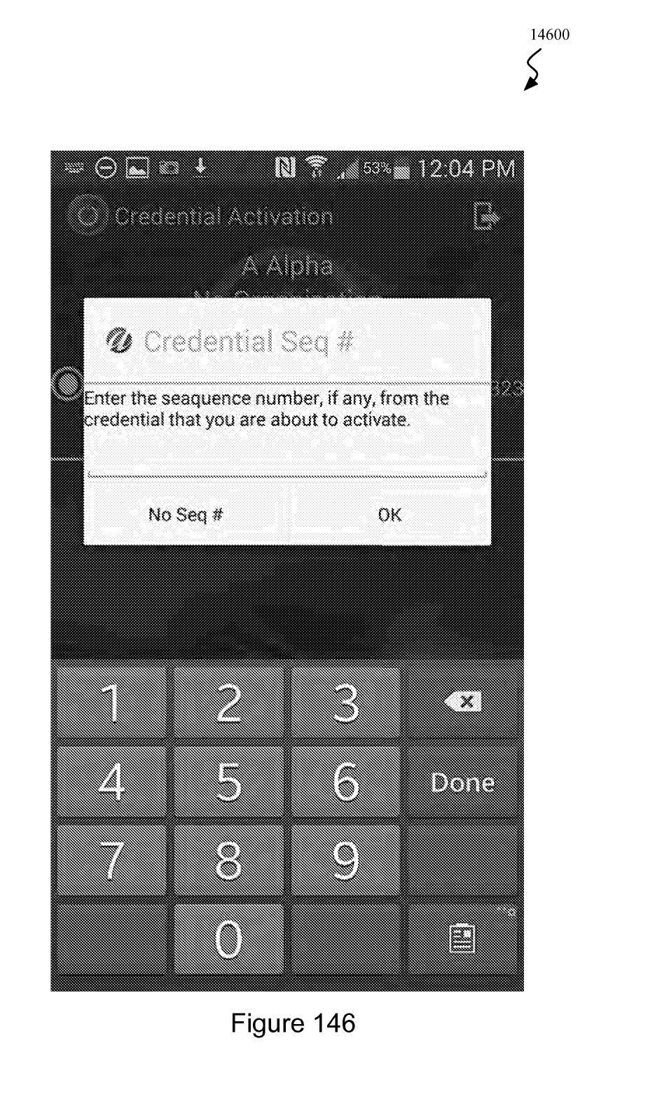

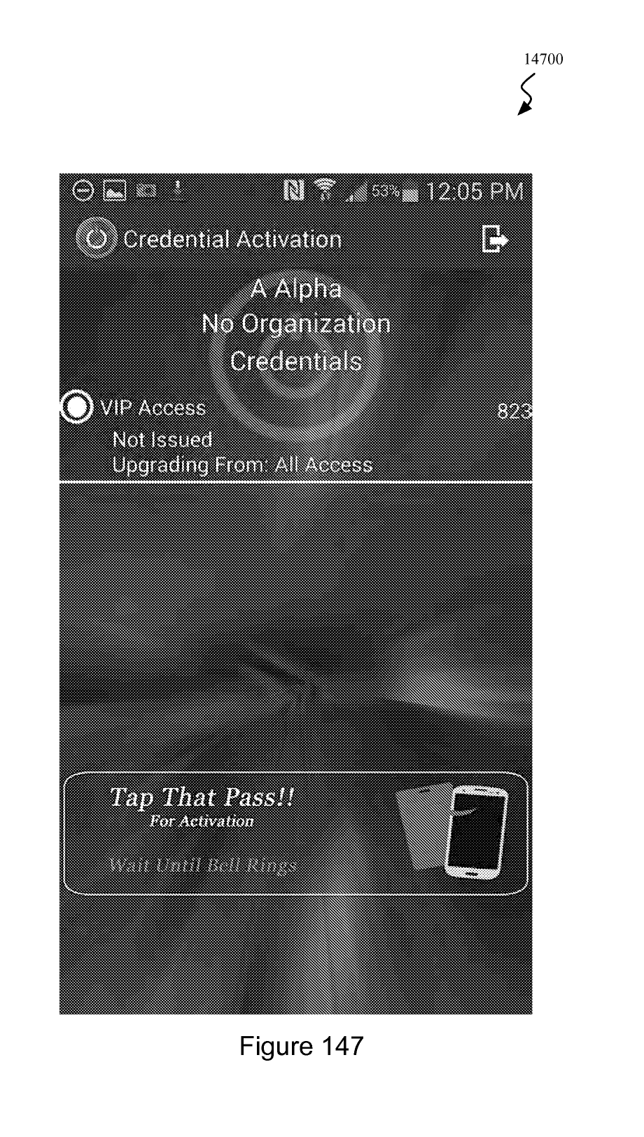

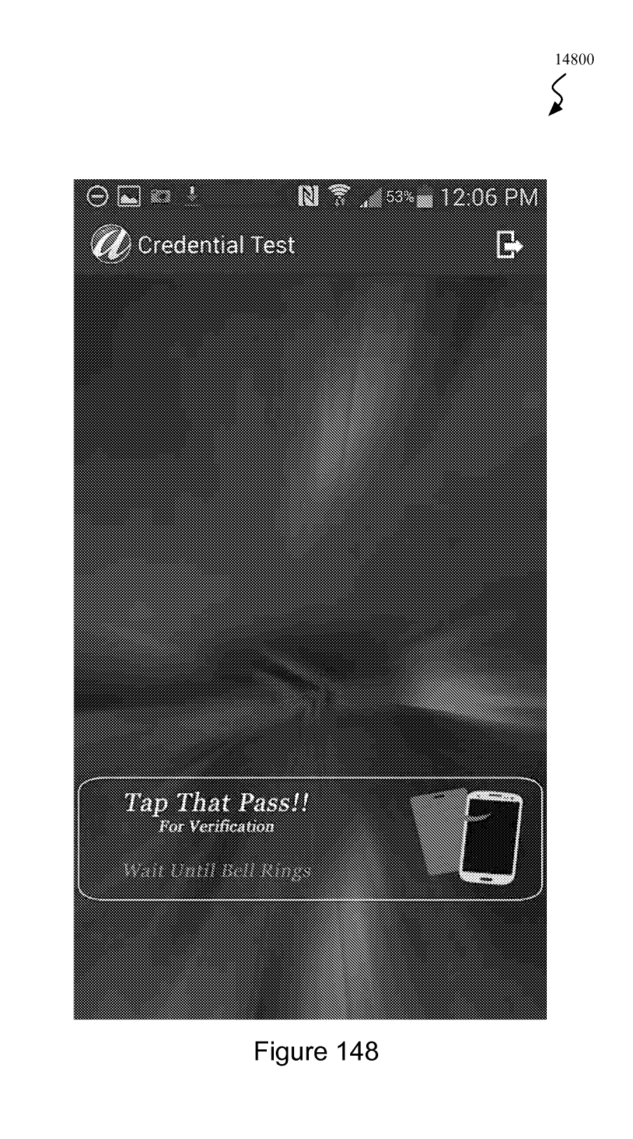

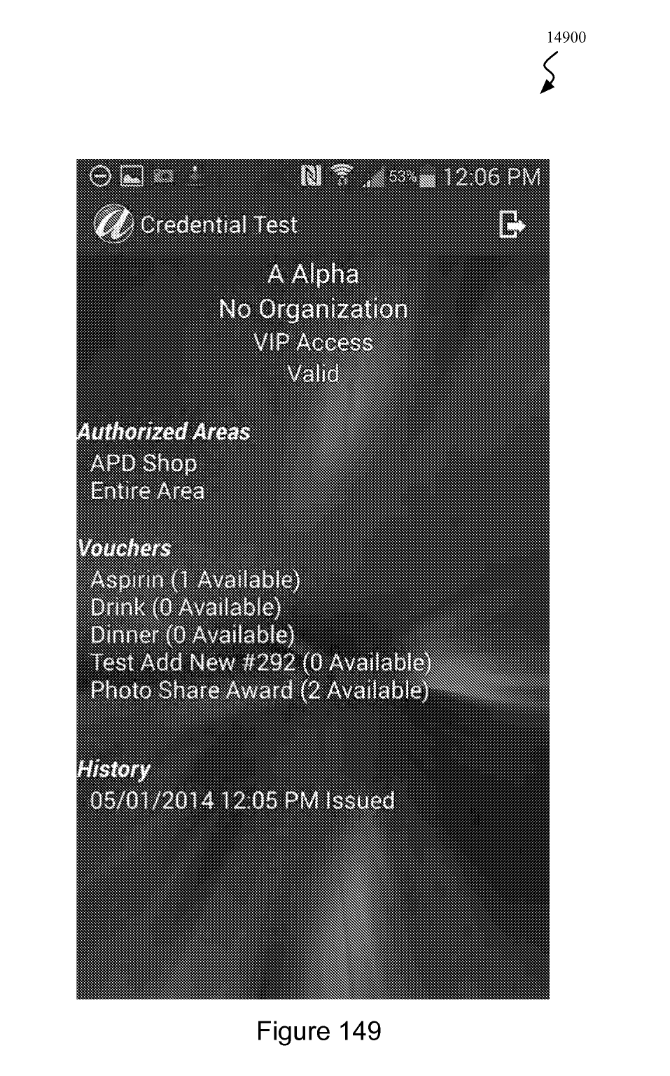

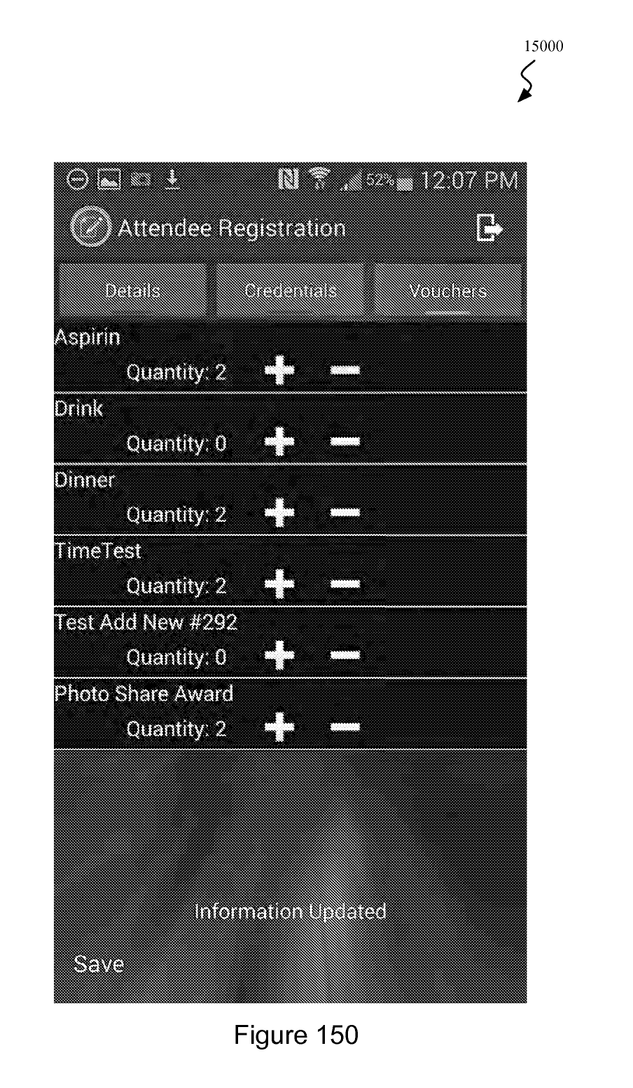

Referring now to FIG. 134 through FIG. 150, various attendee registration views are included. Upon detection of the selection event associated with the attendee registration icon on the home view 6800, the registration module 738 generates attendee registration organization selection view 13400. Upon detection of selection of the organization, the registration module 738 displays the attendee registration attendee selection view 13500. If an attendee does not already exist, selection of a new attendee menu item initiates a registration and displays the attendee registration manual data entry view 13600. In some instances, one or more fields such as, for example, first name, last name, email address, or mobile number may be a required field. If a field is configured as a required field, the registration module will generate a prompt indicating the field must be completed to proceed 13700, 13800, 13900.

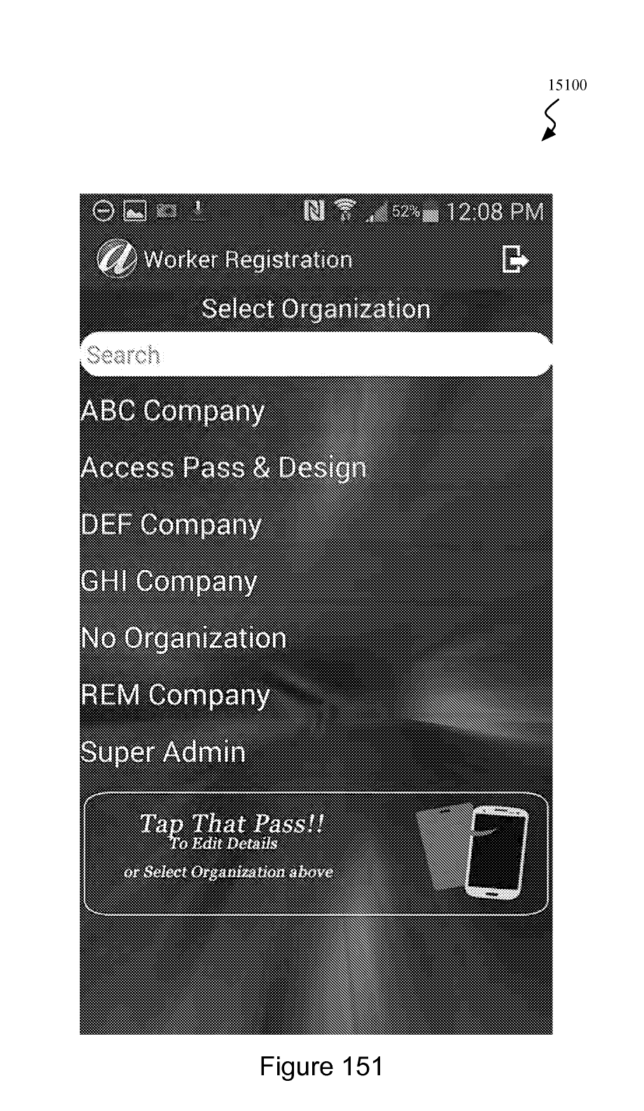

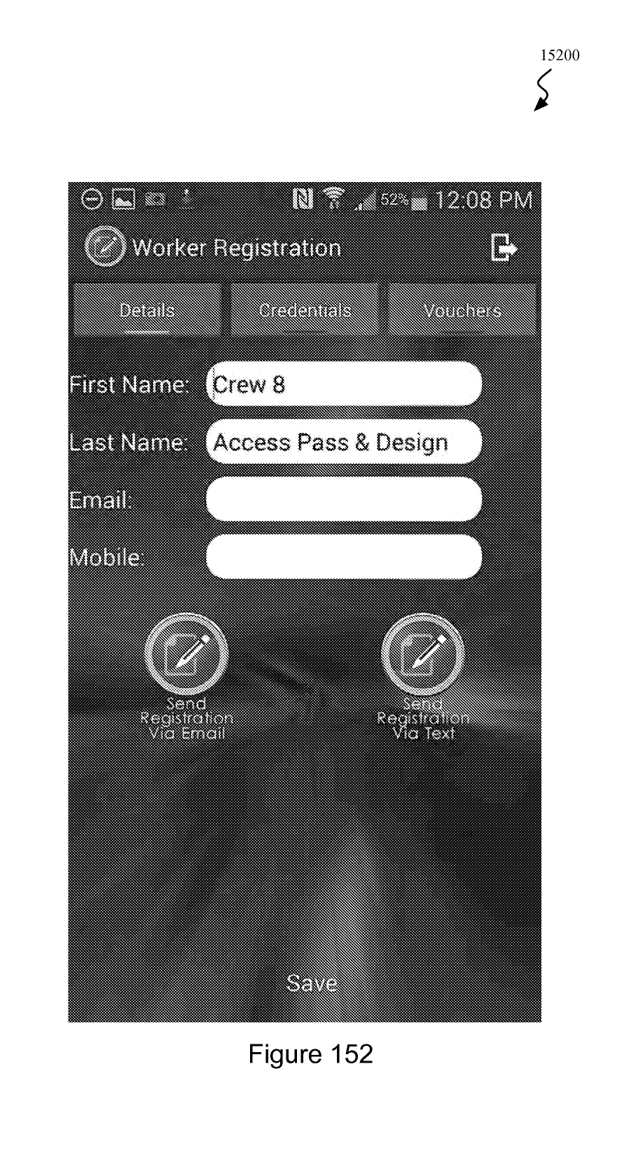

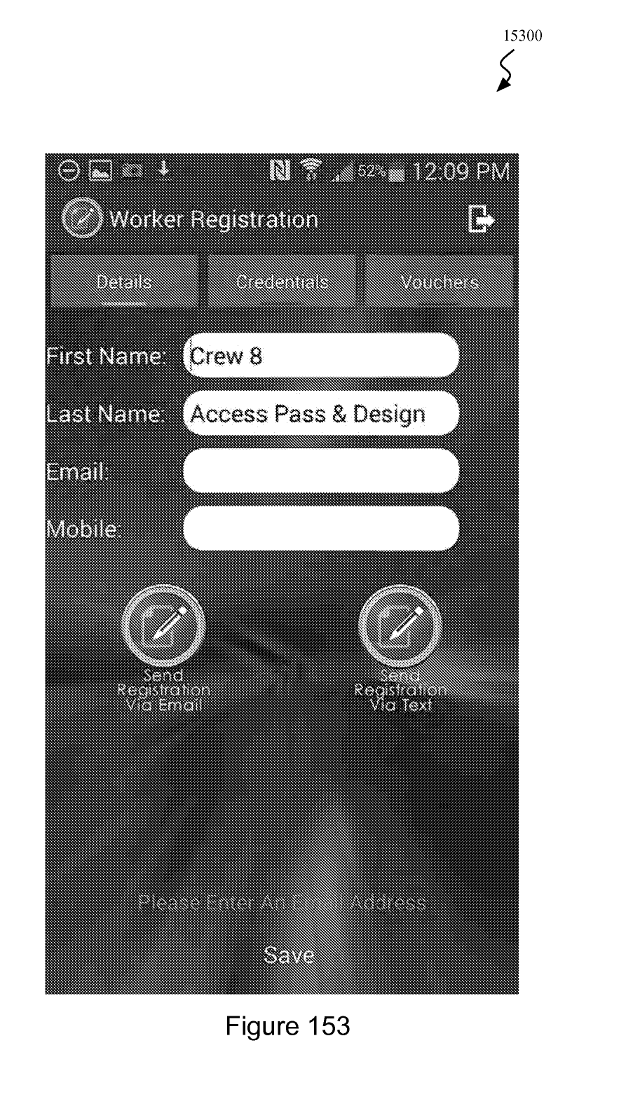

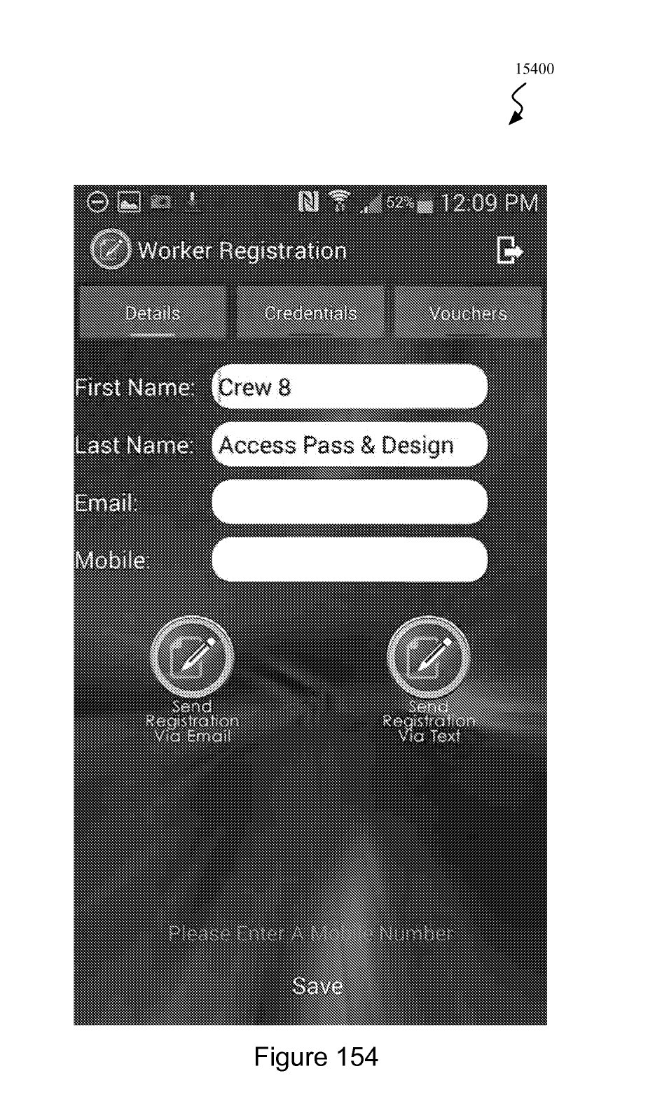

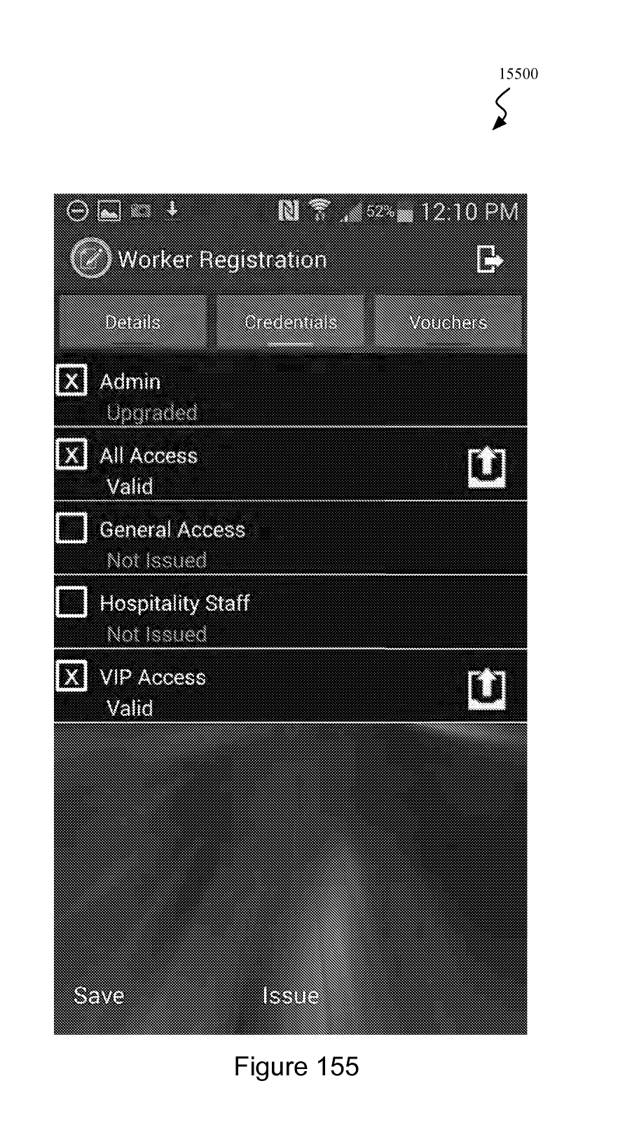

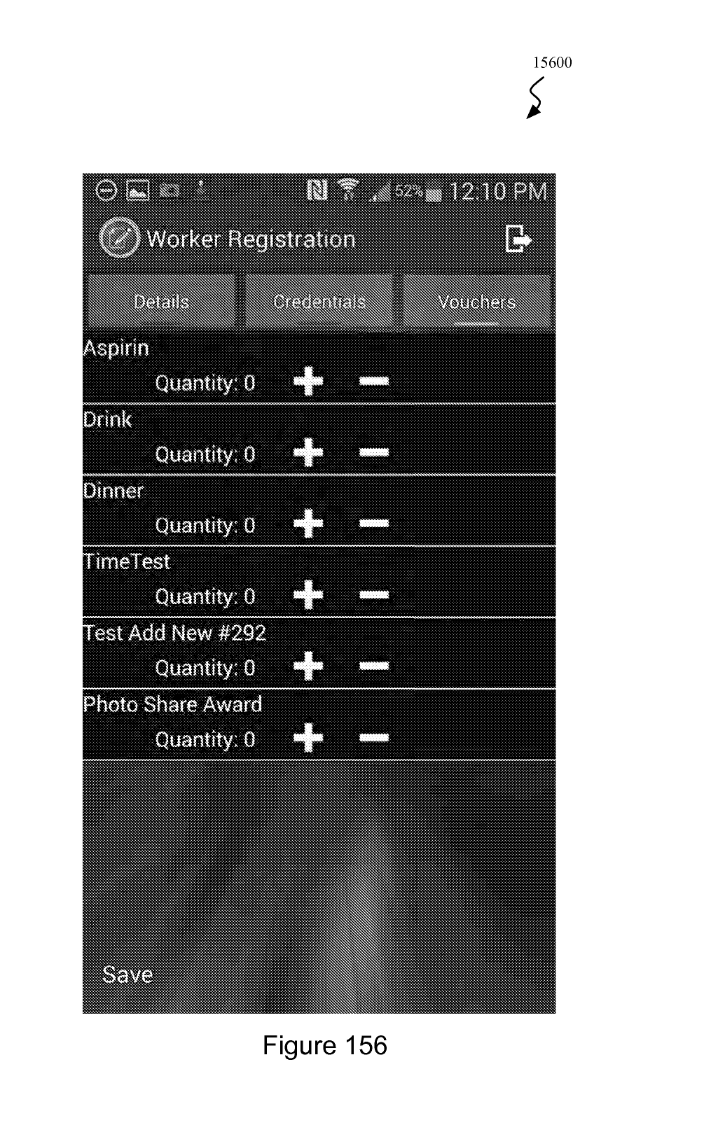

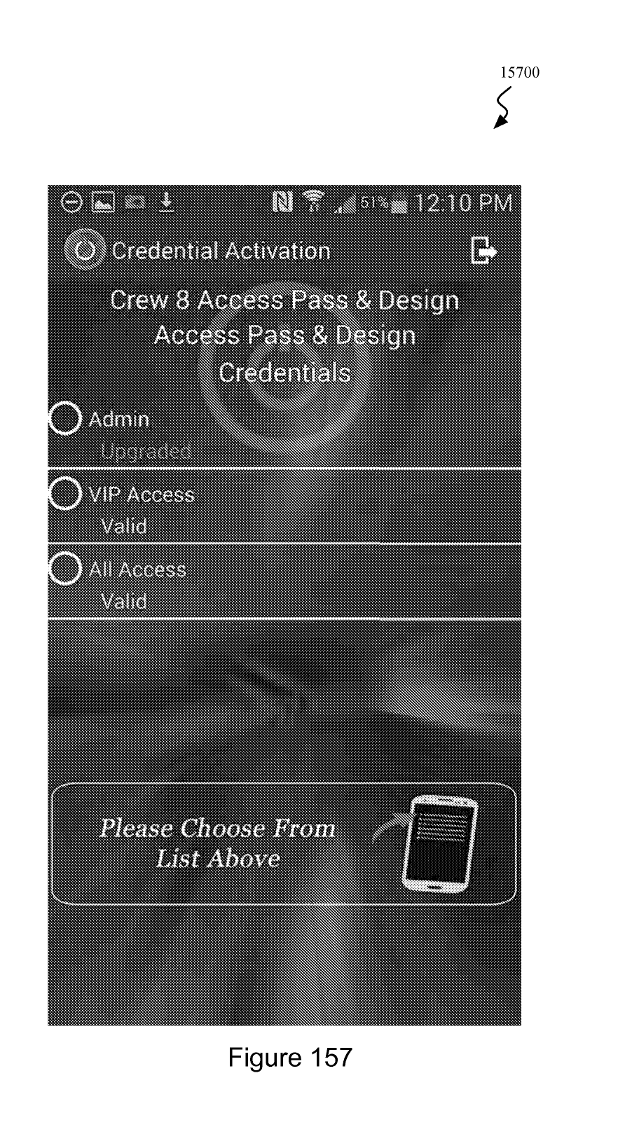

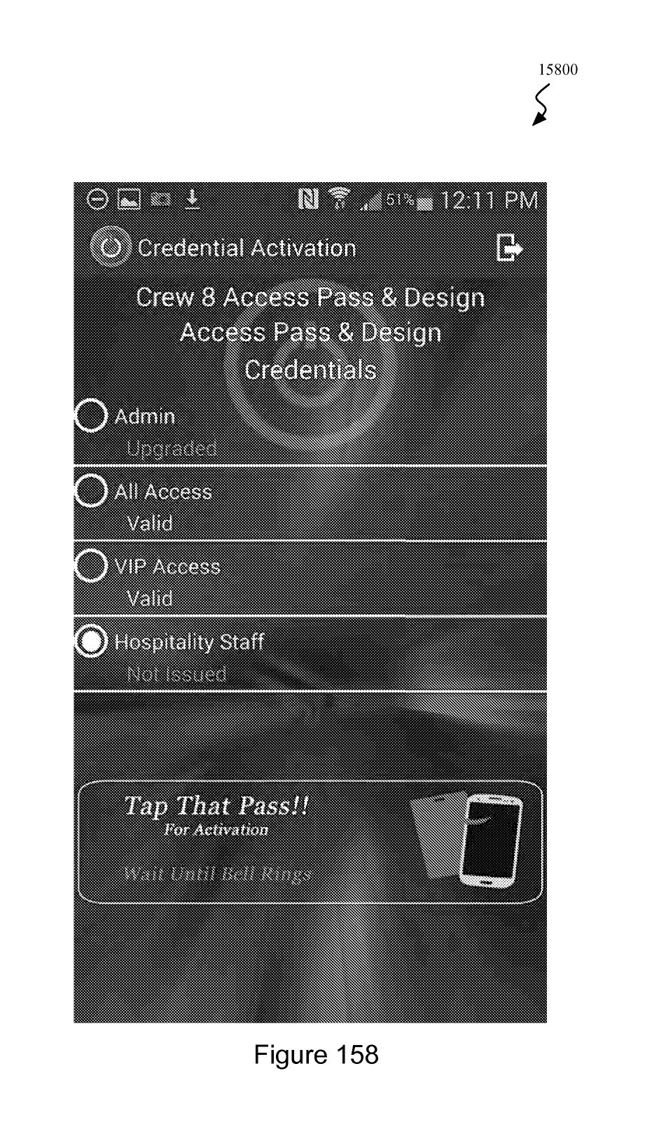

Upon detection of the selection event associated with the credential control, configured and issue credentials are displayed in the attendee registration credential issuance view 14000, 14100. In some instances, the registration module 738 may display an upgrade icon 14105 if an upgrade to access levels is available. Upon detection of the selection event associated with the upgrade icon 14105, the registration module 738 displays the attendee registration credential upgrade prompt 14200, displaying a list of available upgrades. Upon detection of an upgrade selection and selection of the save menu item 14300, the registration module sends a request to the messaging module 740 for transmission to the access control service on the interest collection and tracking servers 24 to effect an access upgrade of the credentialed user. When the information is updated, the registration module 738 generates a confirmation message 14400 indicating the update was successful. Upon detection of the selection event associated with the issue menu item, the flow proceeds in a manner similar to that of the credential activation flow discussed previously 14500, 14600, 14700, 14800, 14900. In some embodiments, detection of selection of a vouchers control displays an interface for granting or removing vouchers for the credentialed user 15000. Referring now to FIG. 151 through FIG. 156, various worker registration views are included. These views and the modules supporting these views function similarly to the attendee registration view previously discussed. Upgrade information and activity is communicated to the messaging module 740 for transmission to the interest collection and tracking servers 24 for use by various services on the services layer 510, including the portal service 545.

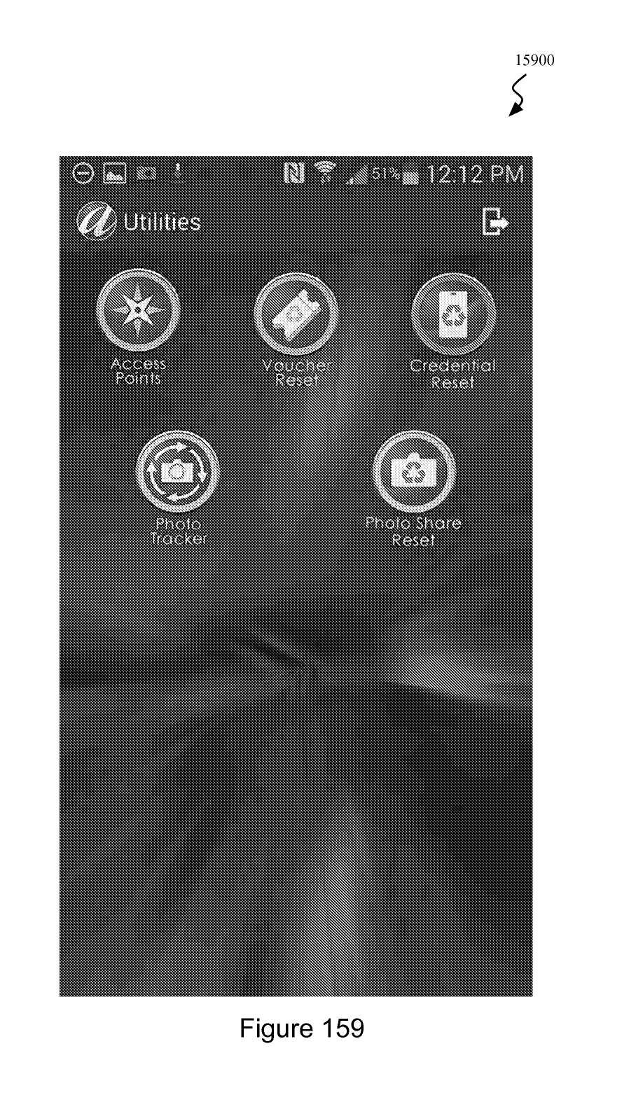

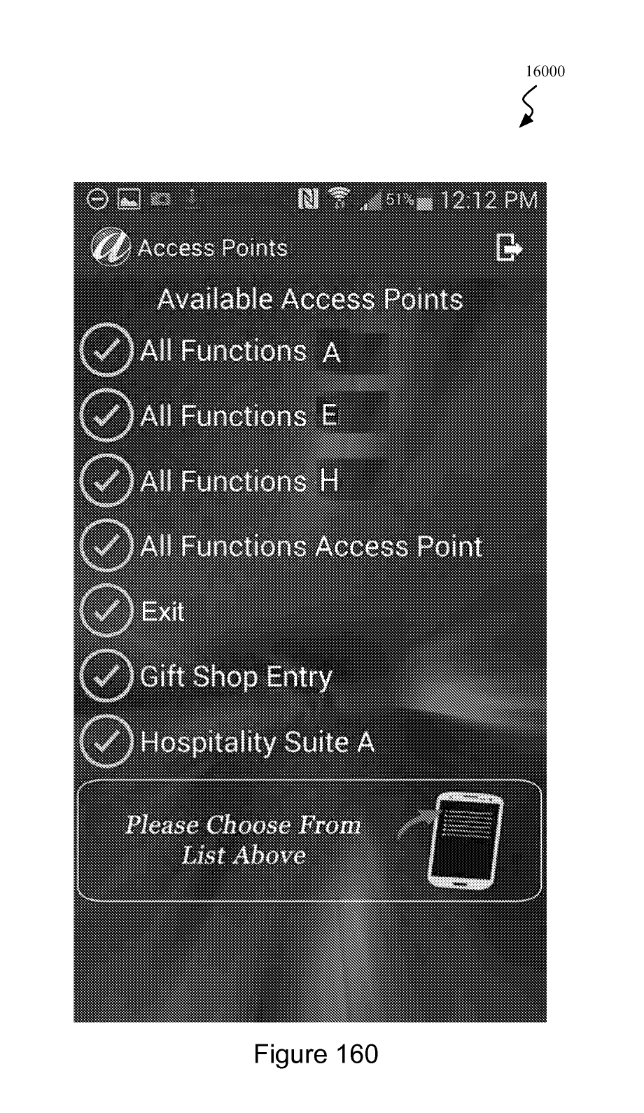

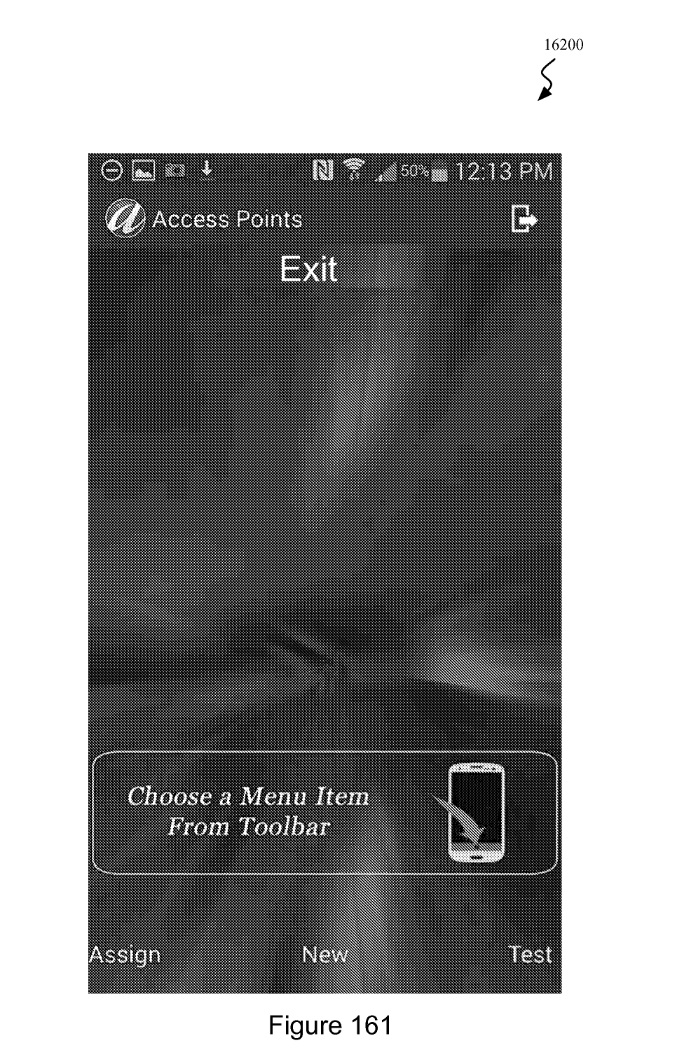

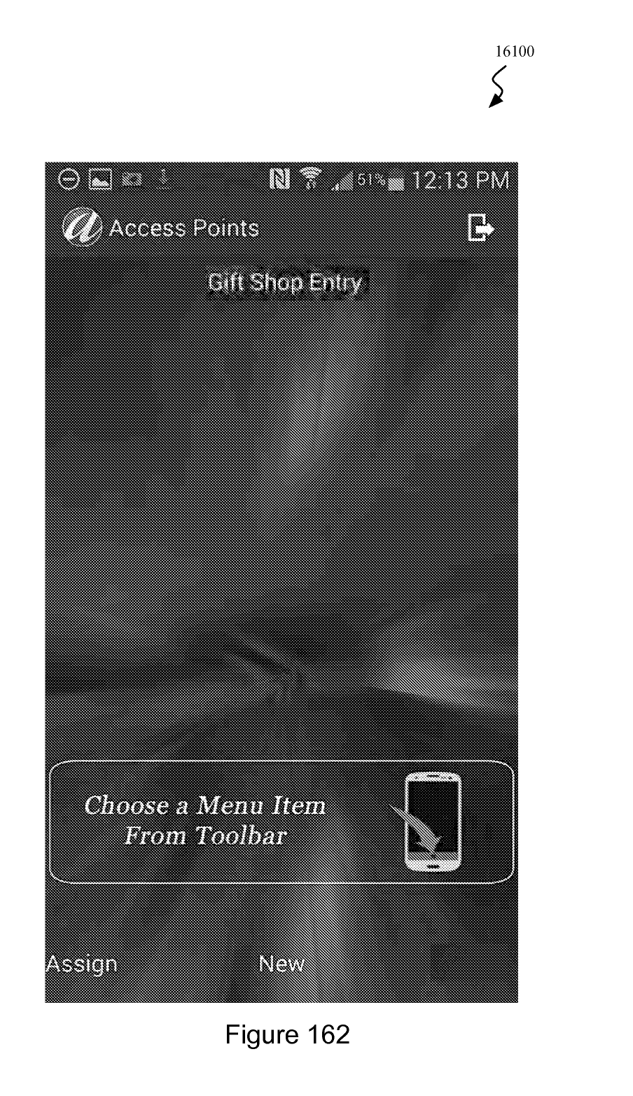

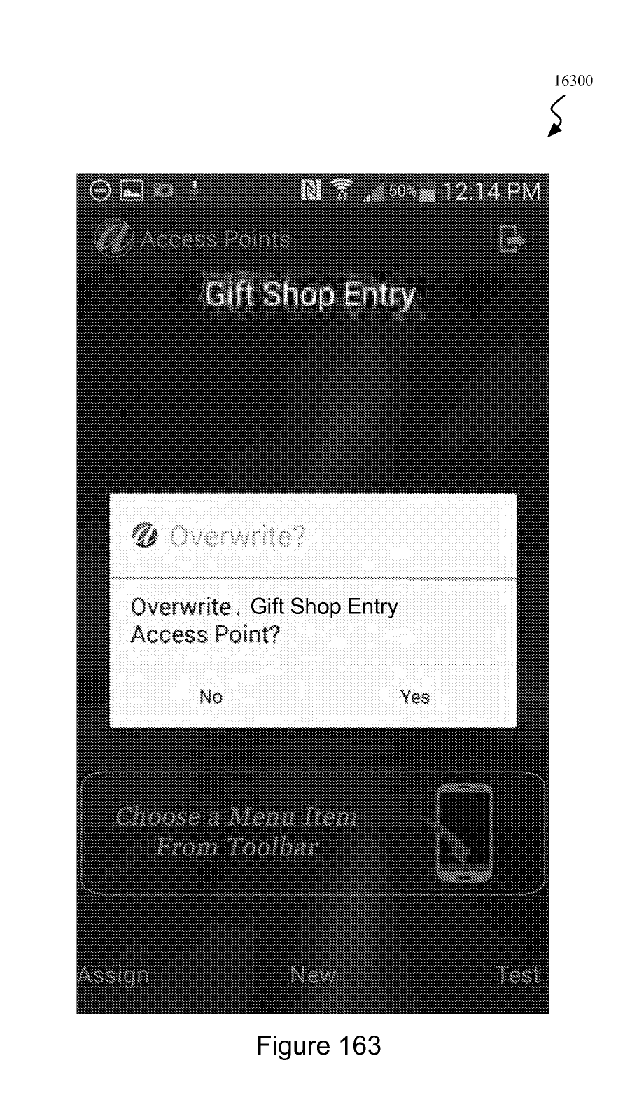

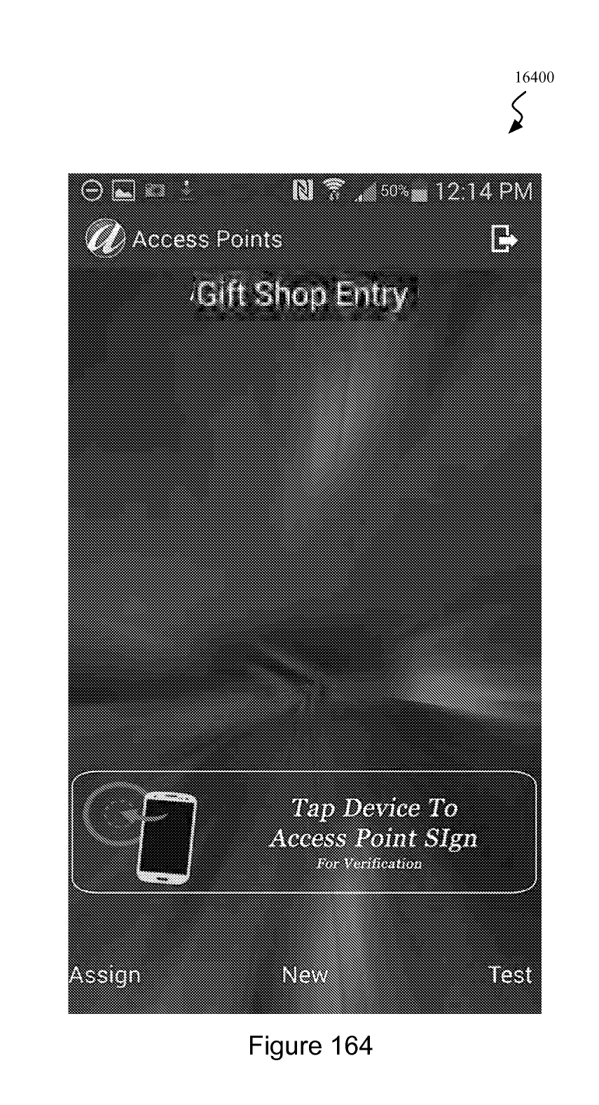

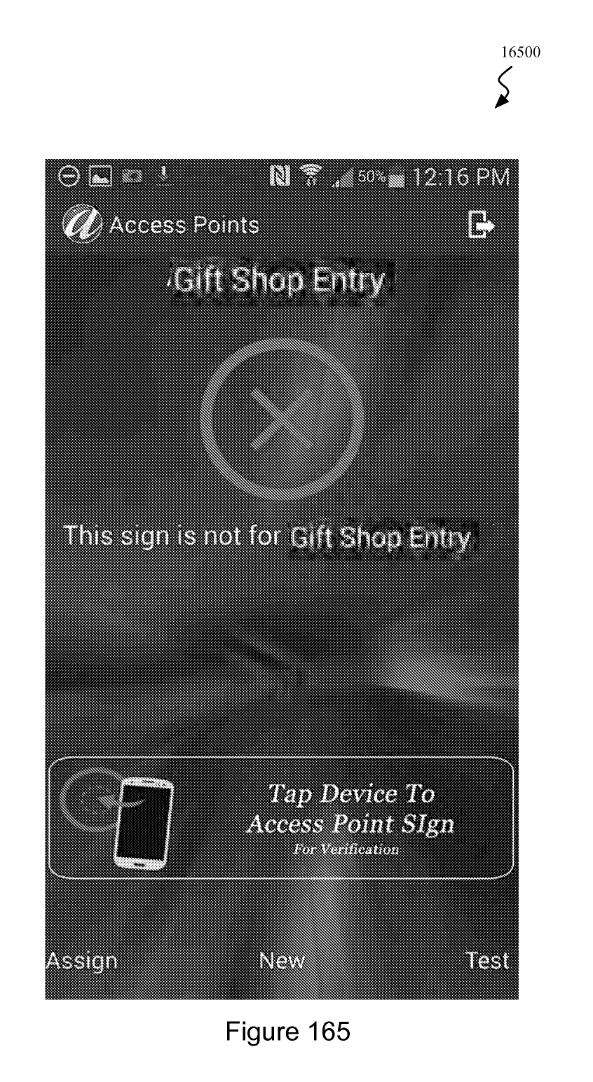

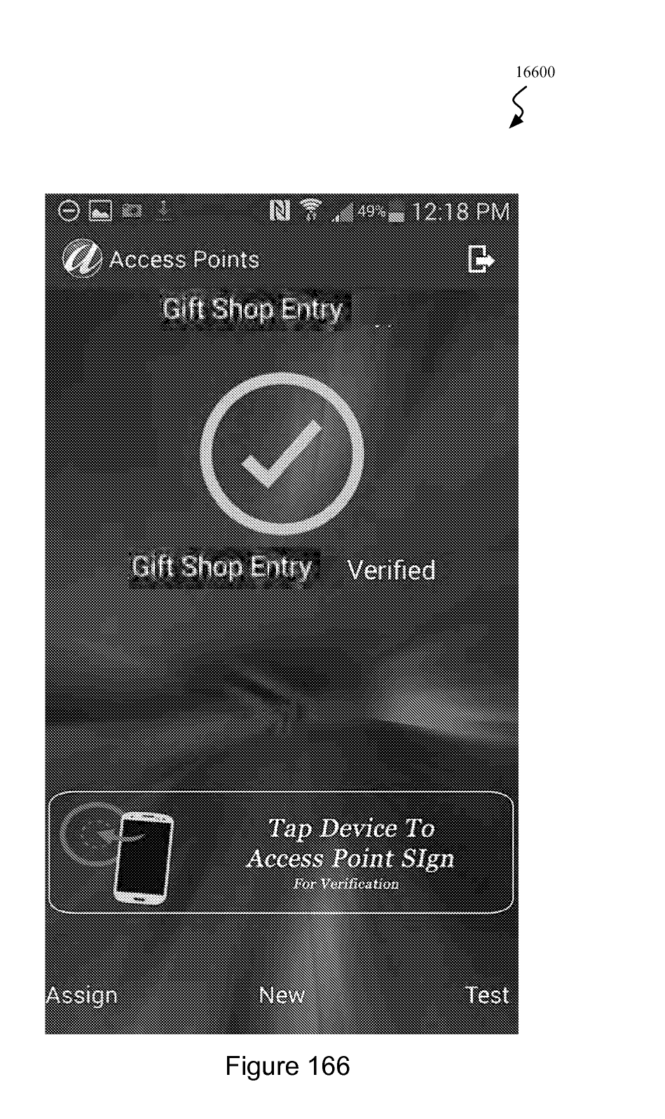

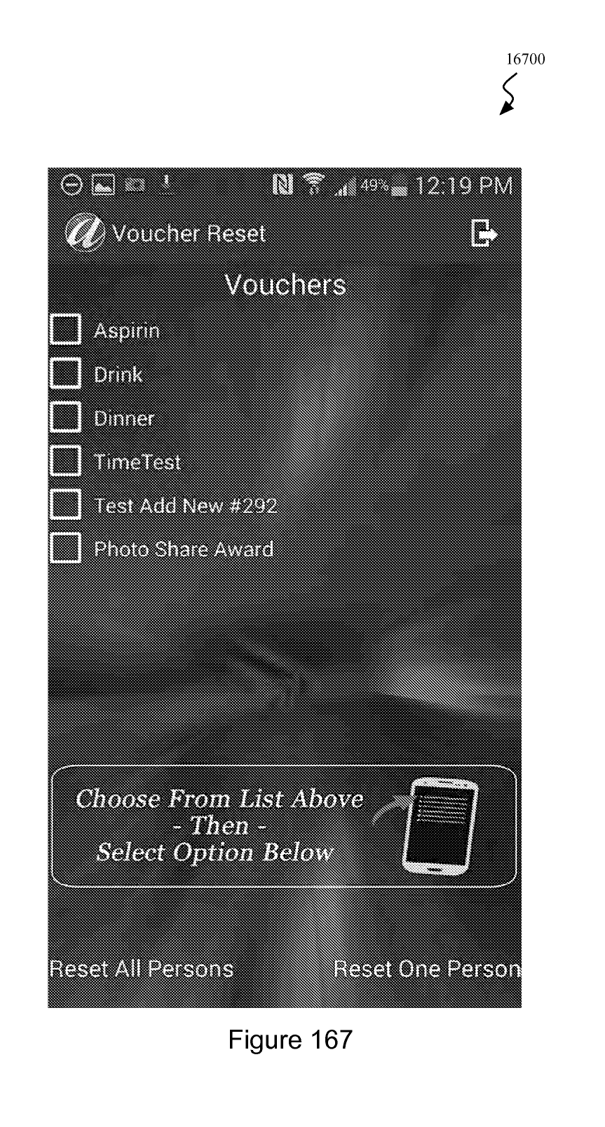

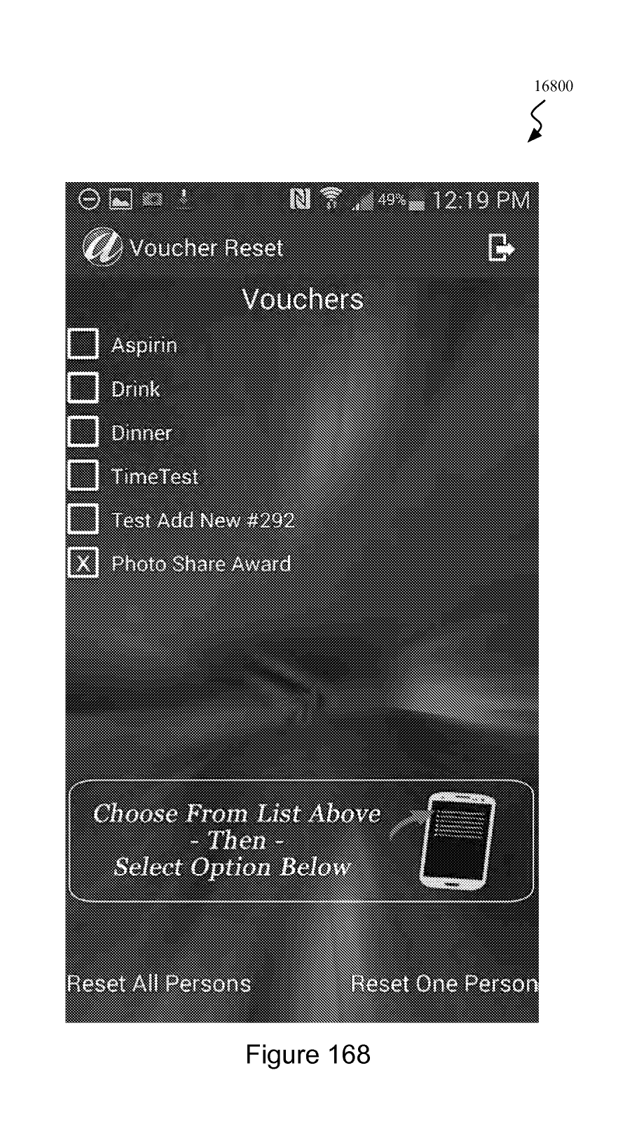

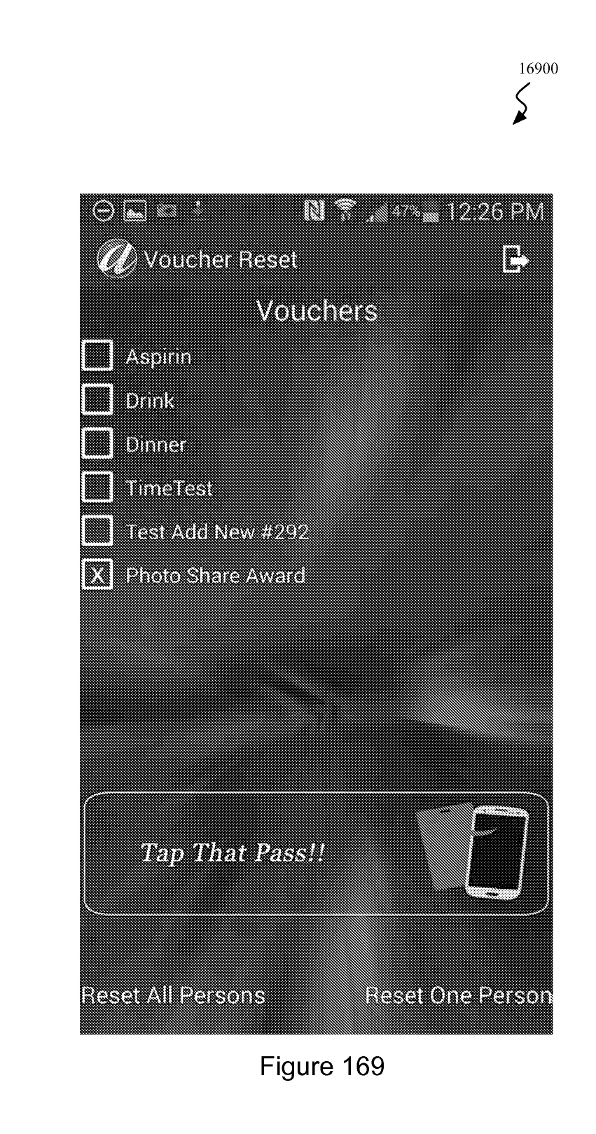

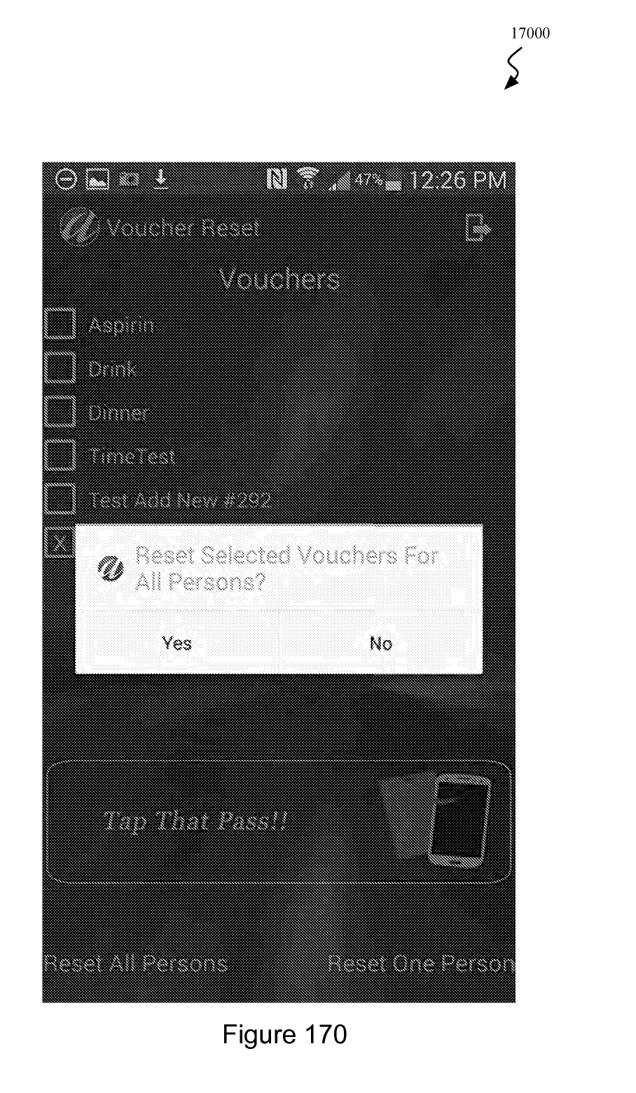

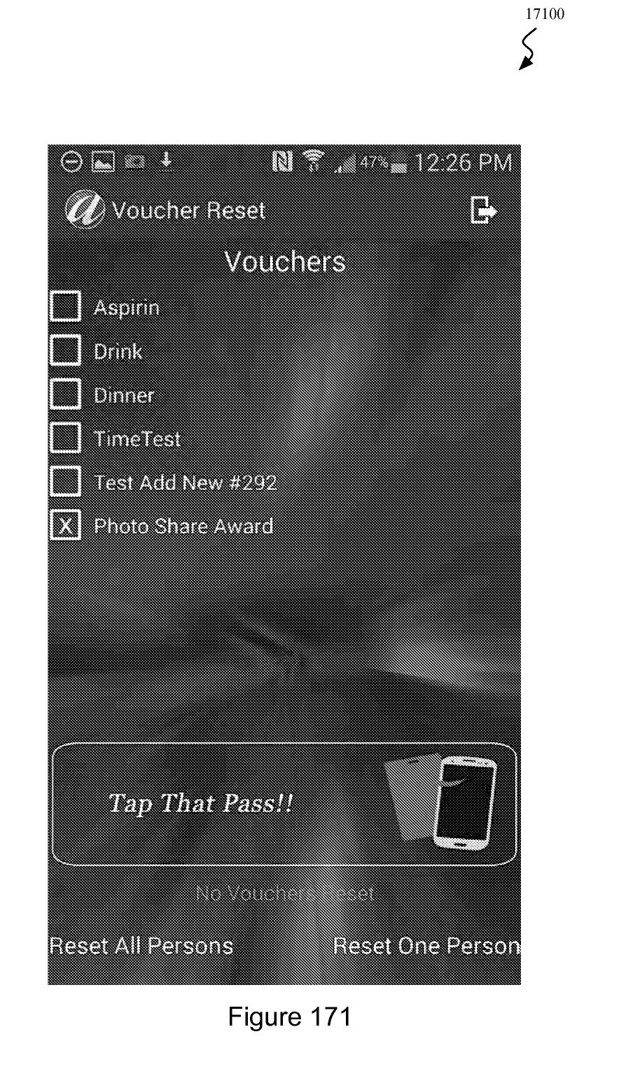

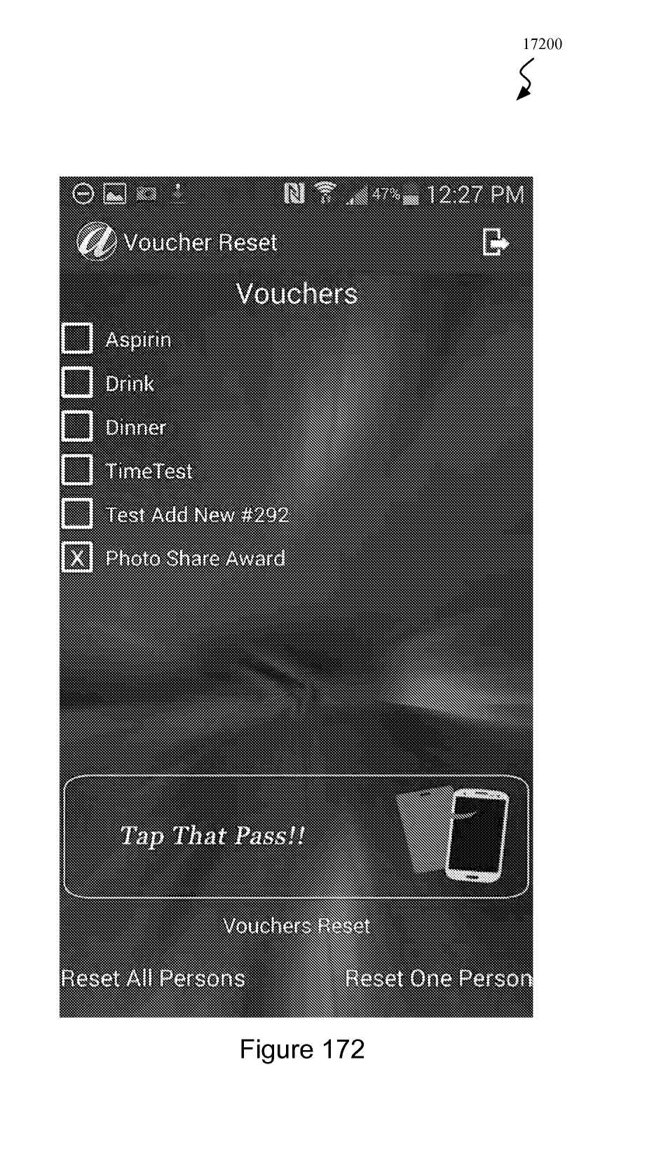

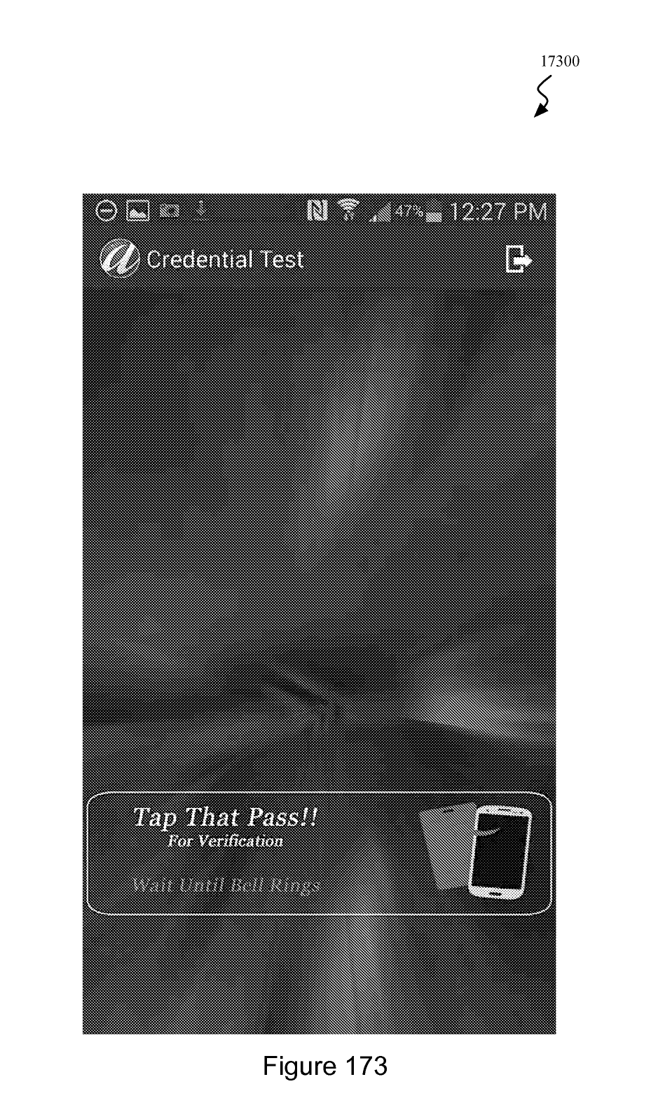

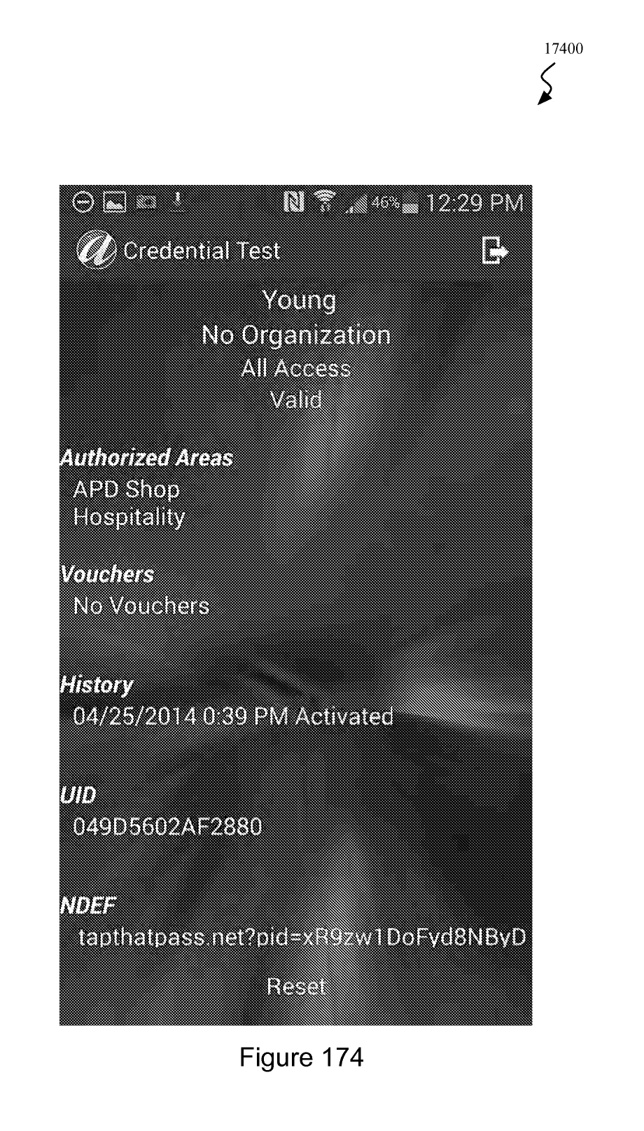

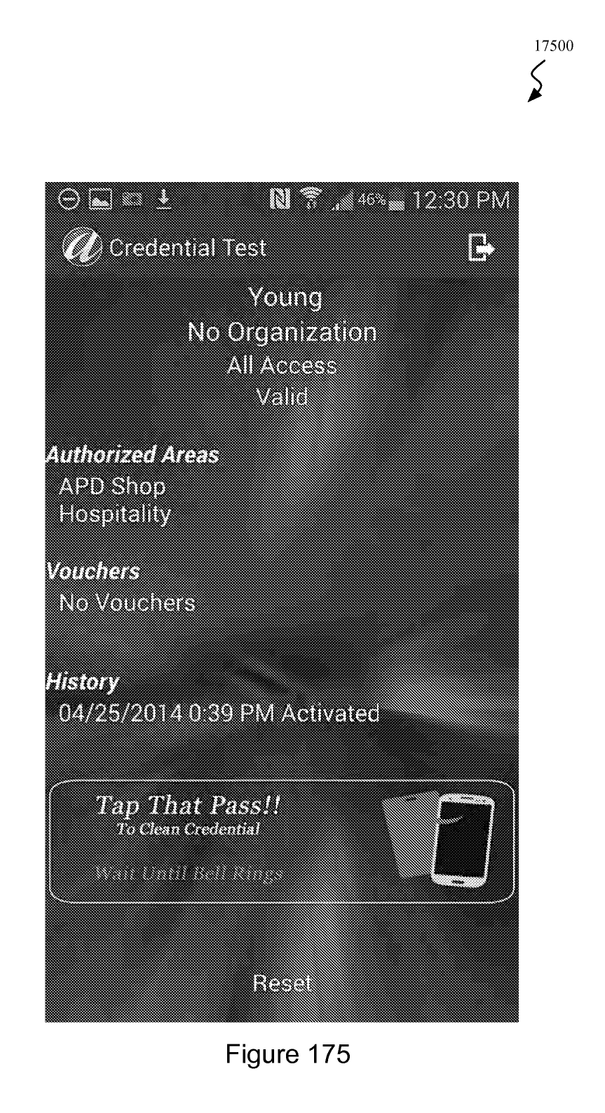

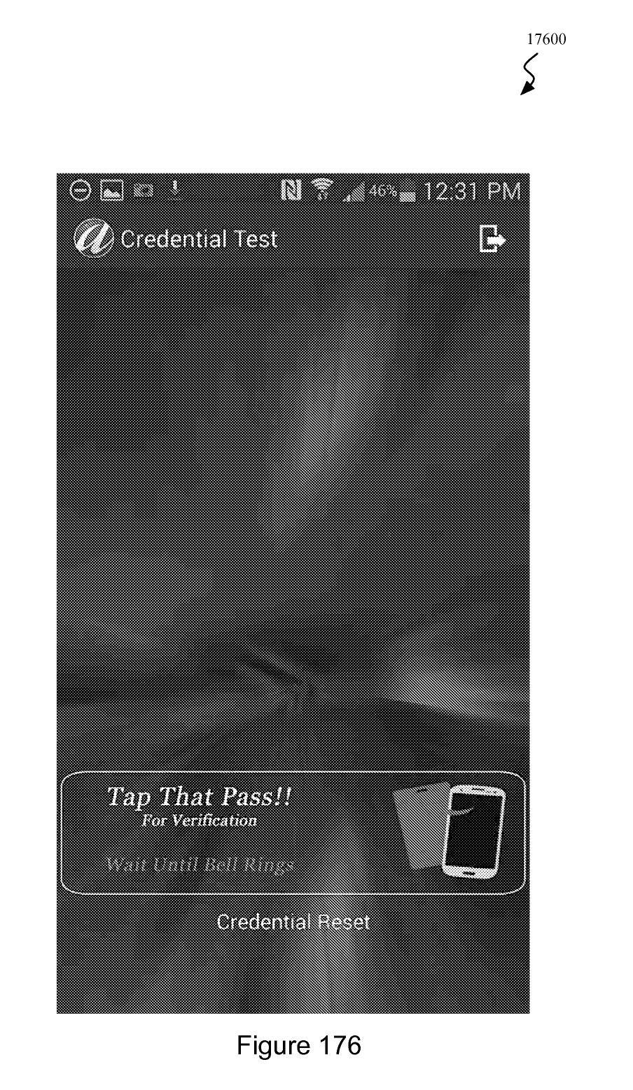

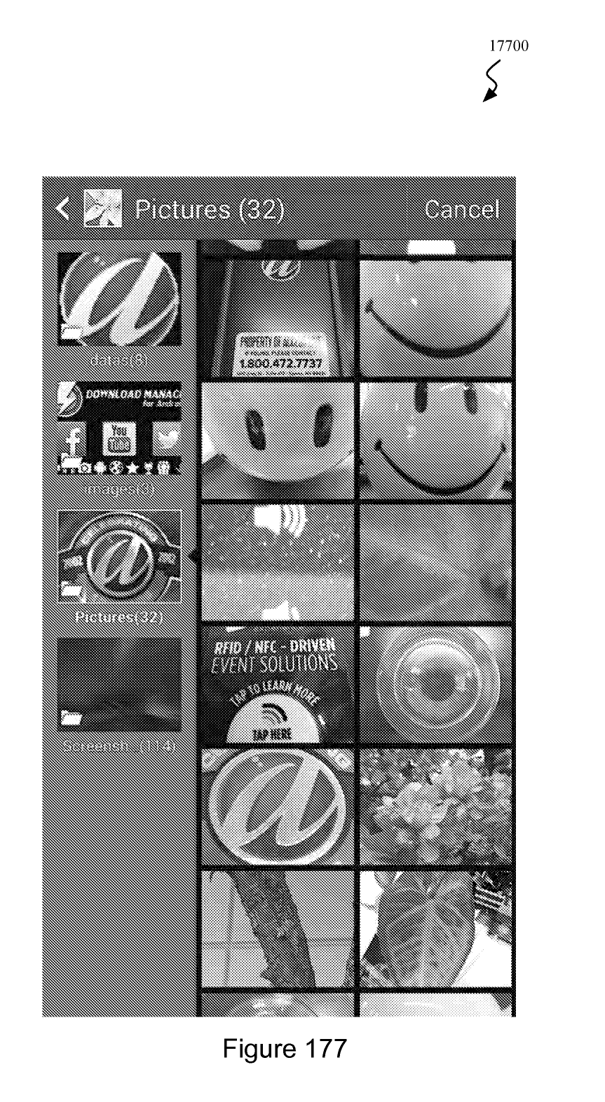

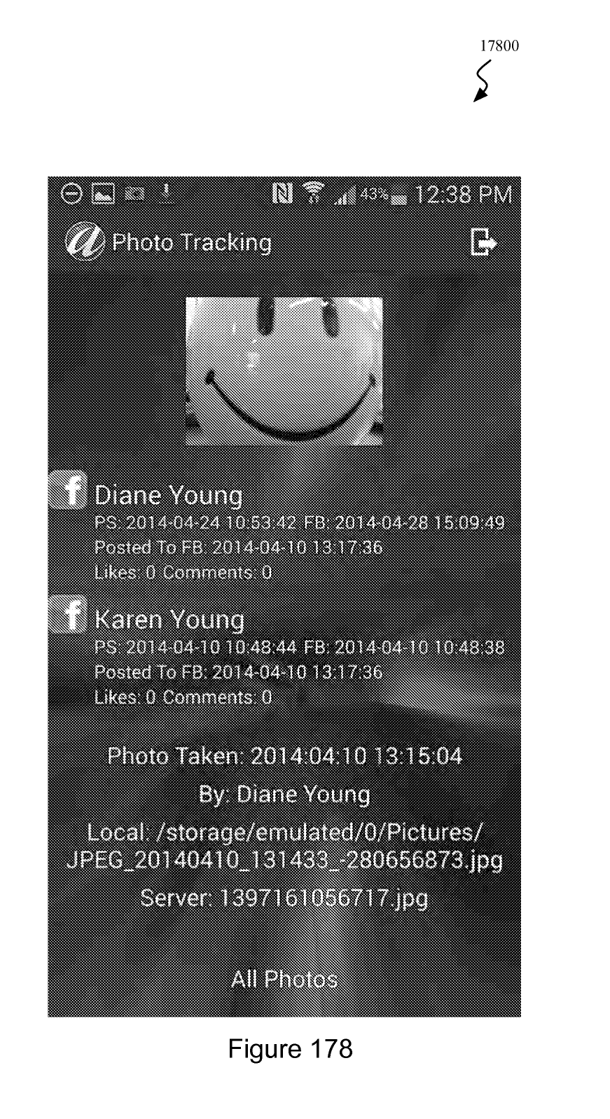

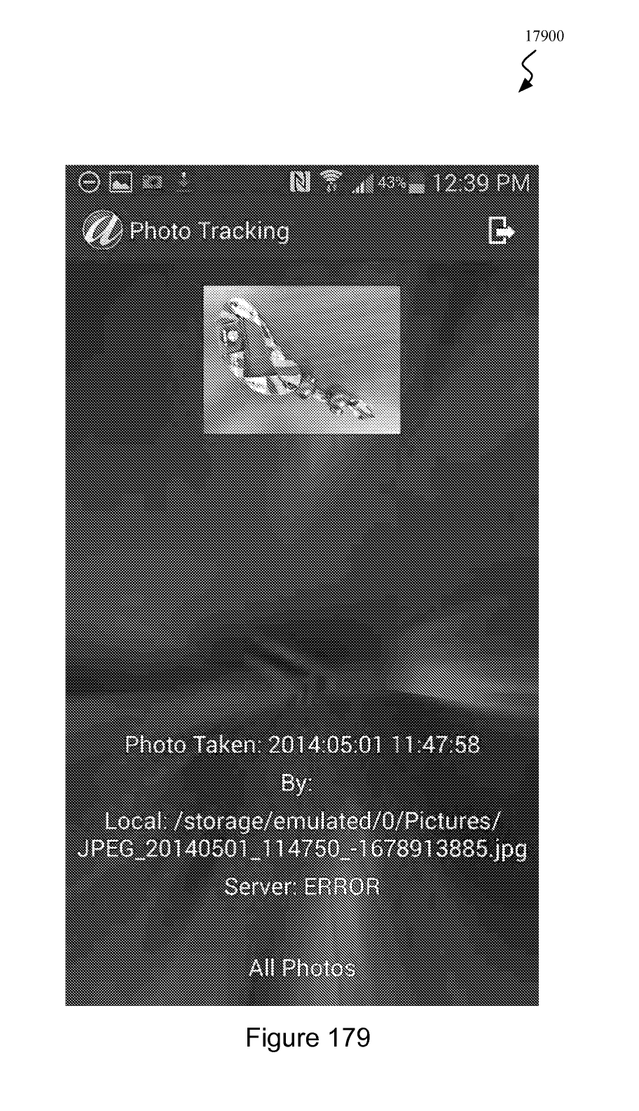

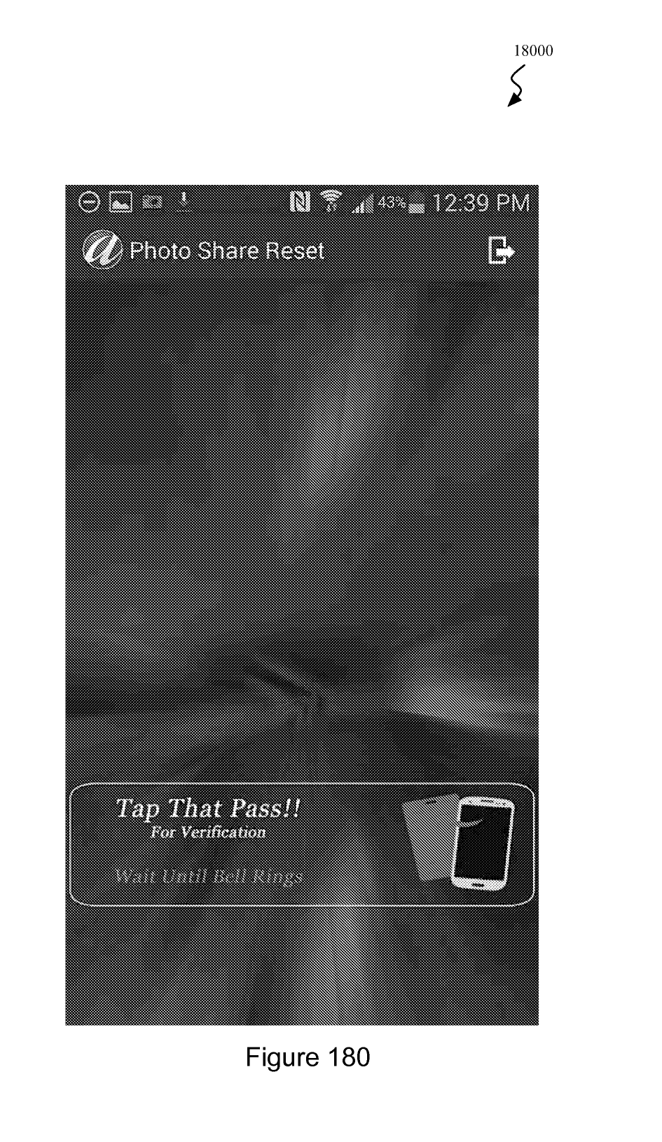

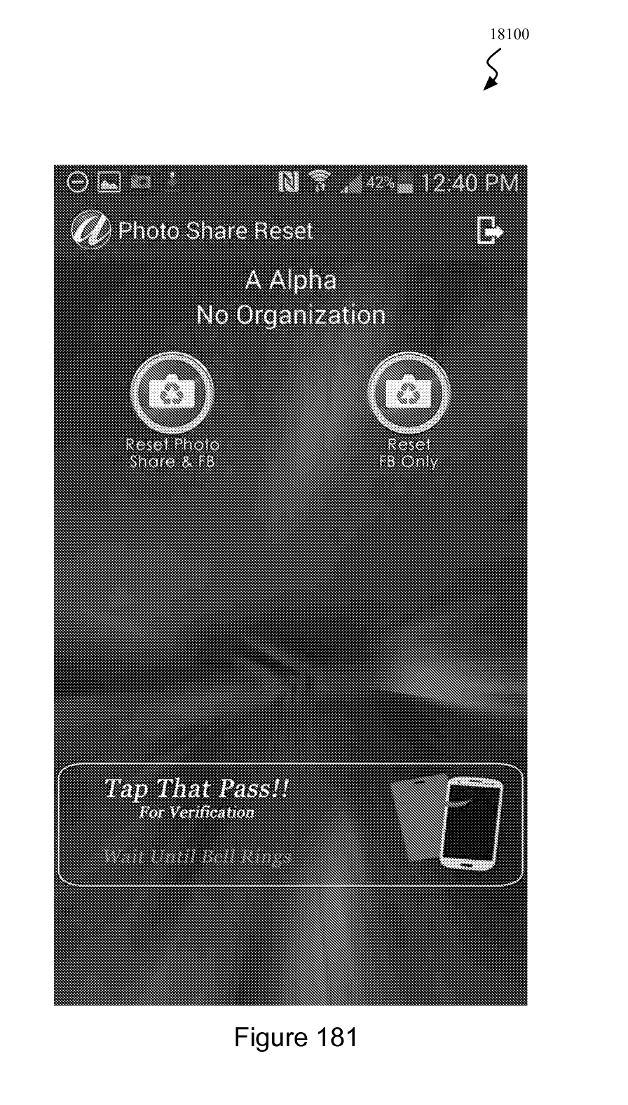

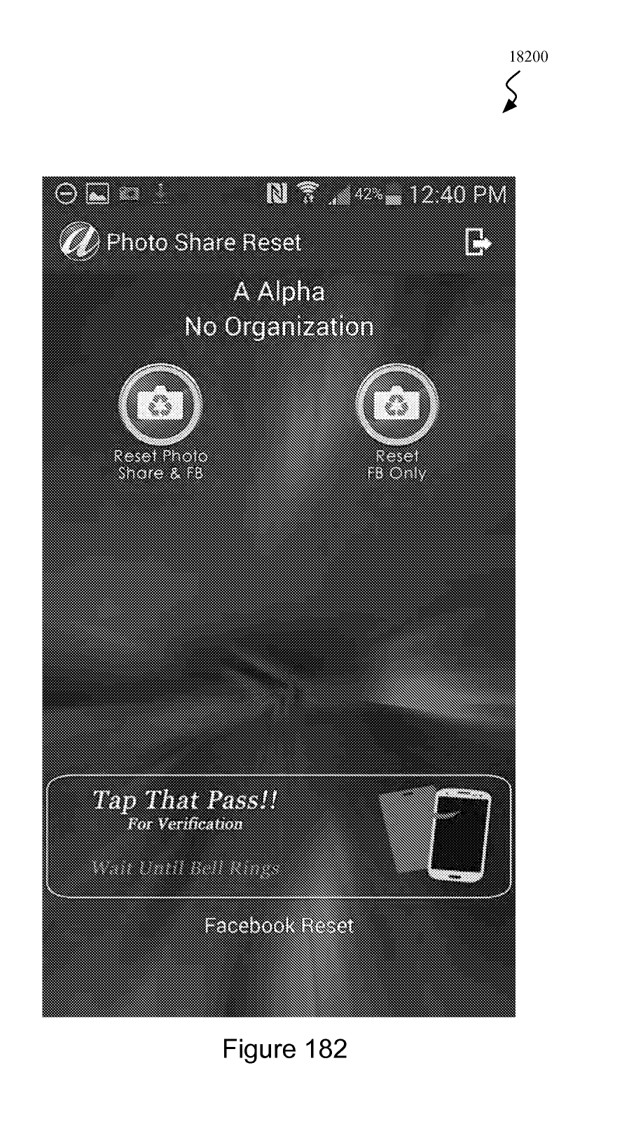

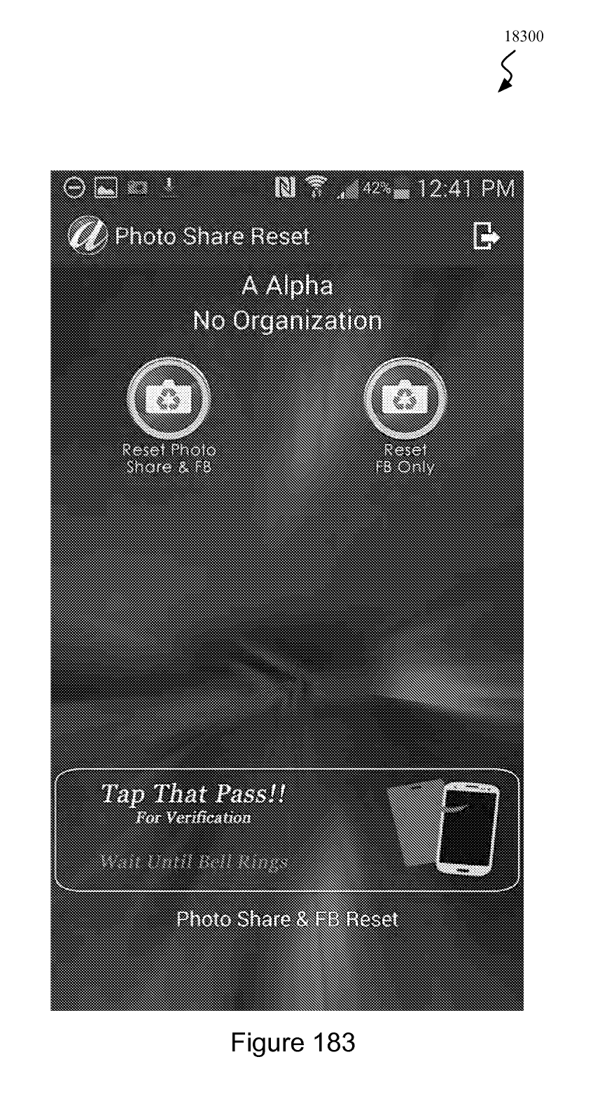

Referring now to FIG. 159 through FIG. 183, various utility views are included. Upon detection of the selection event associated with the utilities icon on the home view 6800, the utility home view 15900 is displayed. Upon detection of the selection event associated with the access points icon on the utilities home view 15900, the access control module 714 displays the access points selection view 16000. Upon detecting the selection event associated with an available access point selection, the access control module 714 displays the access point site view 16100 that includes the name of the access point and one or more menu options, such as assign an access point and new access point.

Upon detection of the selection event associated with the assign menu item, the access control module displays the access points tap sign view 16400, prompting the operator of the device to tap the device to the placard, also known as a sign. If the selected access point is already assigned, the access control module 714 displays the access points overwrite view in advance, prompting the operator to confirm they wish to overwrite the current assignment. Upon detection of the sign tap event, the access control module 714 determines if the tag associated with the sign is valid for the selected access point. If it is not, the access control module will display the access points invalid sign view 165000. If it is valid, the access control module will display the access points sign registration confirmation view 166000.

Upon detection of the selection event associated with the vouchers reset icon on the utilities home view 15900, the voucher module 728 displays the voucher reset selection view 167000. Upon detecting the selection event associated with a voucher 16800 and the selection event associated with a menu item, such as reset all person 16900, the voucher module 728 displays the voucher reset tap credential view 16900. If the user opts not to confirm the reset, no vouchers are reset and the voucher module 728 displays the voucher not reset confirmation view 17100. If instead, the user opts to confirm the reset, vouchers are reset and the voucher module 728 displays the voucher reset confirmation view 17200.

Upon detection of the selection event associated with the credential test icon on the utilities home view 15900, the credential audit module 736 generates a credential test start view 17300 prompting for the tapping of the credential to the site device. Upon tapping the credential, information can be displayed including, for example, access level, the activation status, authorized areas, vouchers, credential history, a UID value, an NDEF value, and the like 17400. Menu options provided can include resetting the credential. Upon detection of the selection event associated with the reset menu item, the credential audit module 736 displays the credential reset tap credential view 17500, prompting for the credential to be tapped to the device. Upon detection of the tapping of the credential, the credential is reset and the credential reset confirmation message view 17600 is displayed.

Upon detection of the selection event associated with the photo tracker icon on the utilities home view 15900, the photo share module 716 generates a photo tracker gallery view 17700, providing a gallery of photos, images, or videos for selection. Upon detecting the selection event associated with a displayed photo, the photo share module 716 generates a photo tracker view 17800, 17900 that can include information such as, for example, social media publishing destinations and related historical data and meta data, photo history and meta data, the local storage location, and the server storage location, if such server location is available.

Upon detection of the selection event associated with the photo share reset icon on the utilities home view 15900, the photo share module 716 generates a photo share reset tap credential view 18000, prompting for the tapping of a credential. Upon detecting the credential tap event, the photo share reset module 716 generates a photo share reset selection view 18100 that can include menu selection such as, for example, reset photo share and social medie (e.g. FB), and reset social media (e.g. FB) only. Upon detection of the selection of a reset option and the tapping of a credential, the appropriate reset is performed and the appropriate reset confirmation message is generated 18200, 18300.

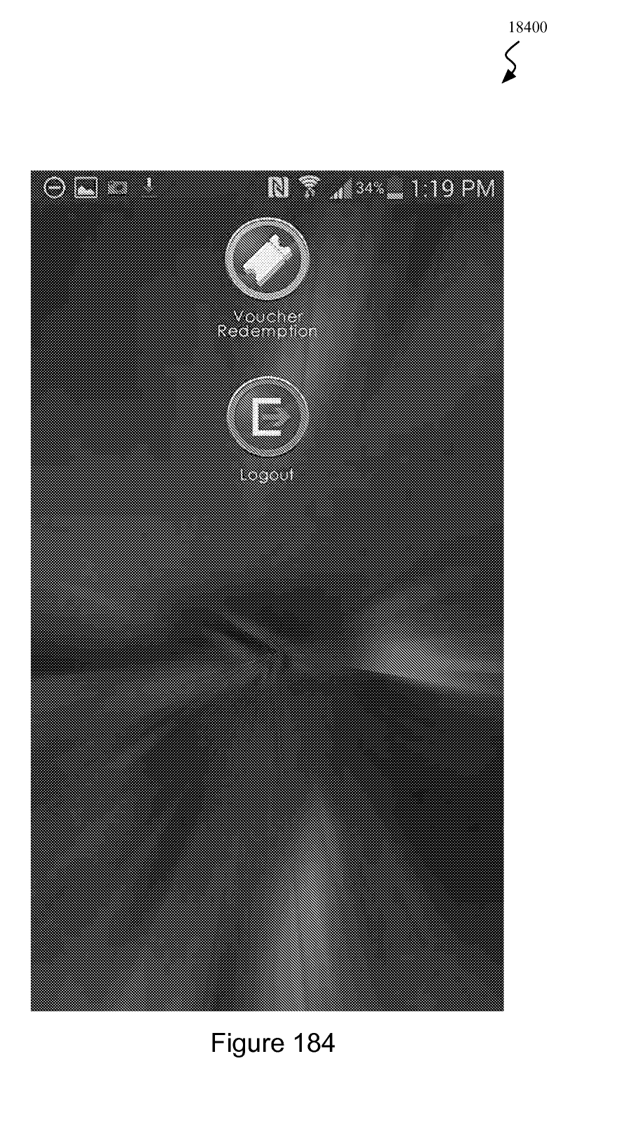

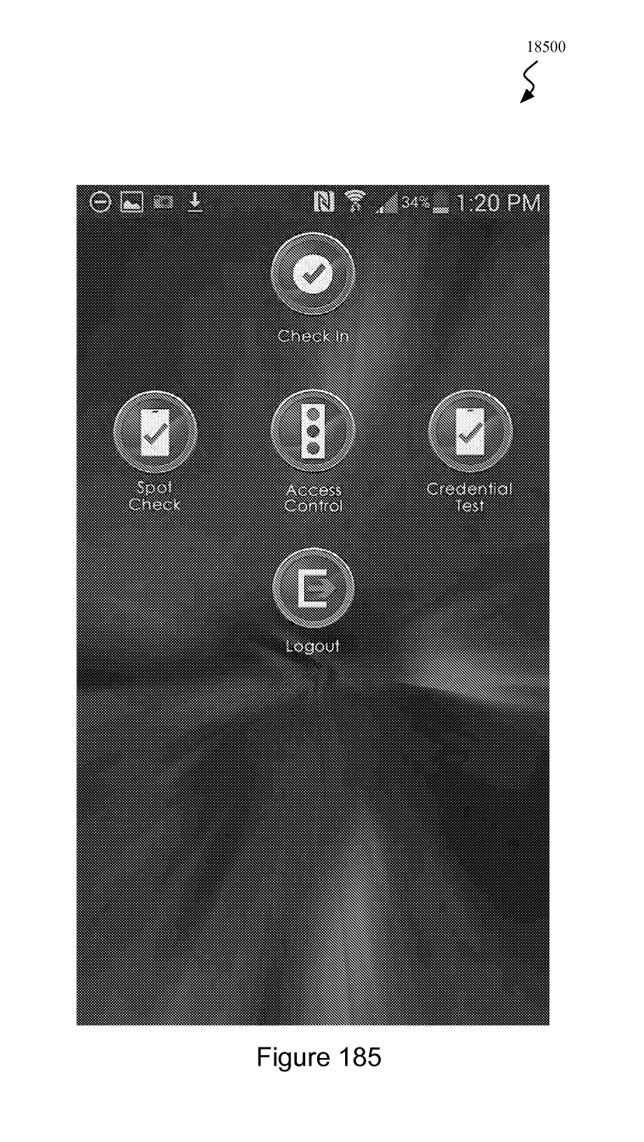

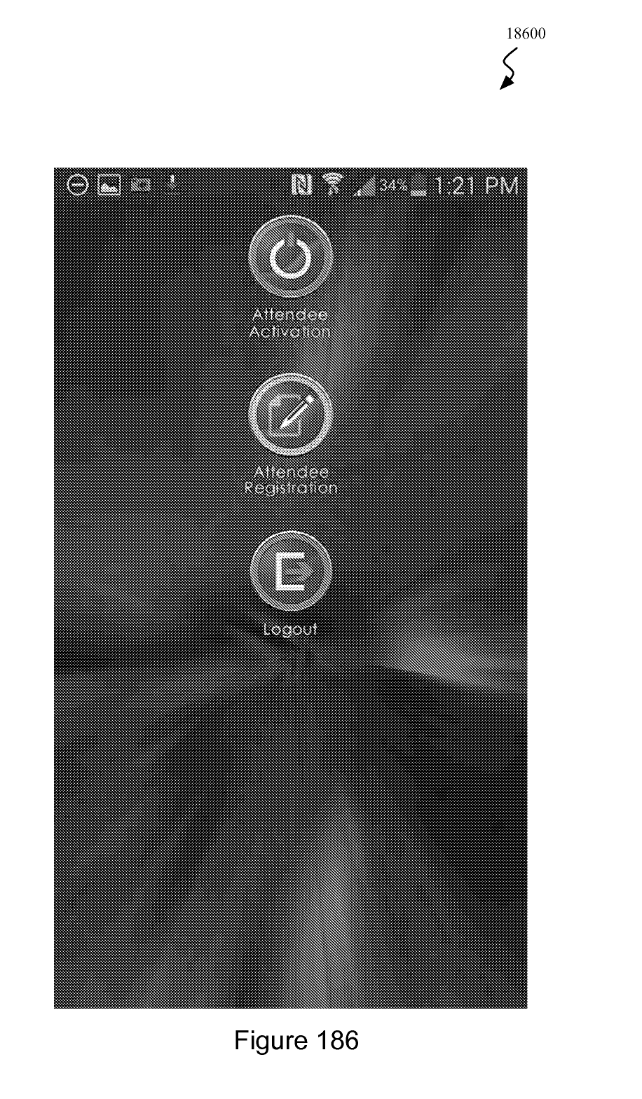

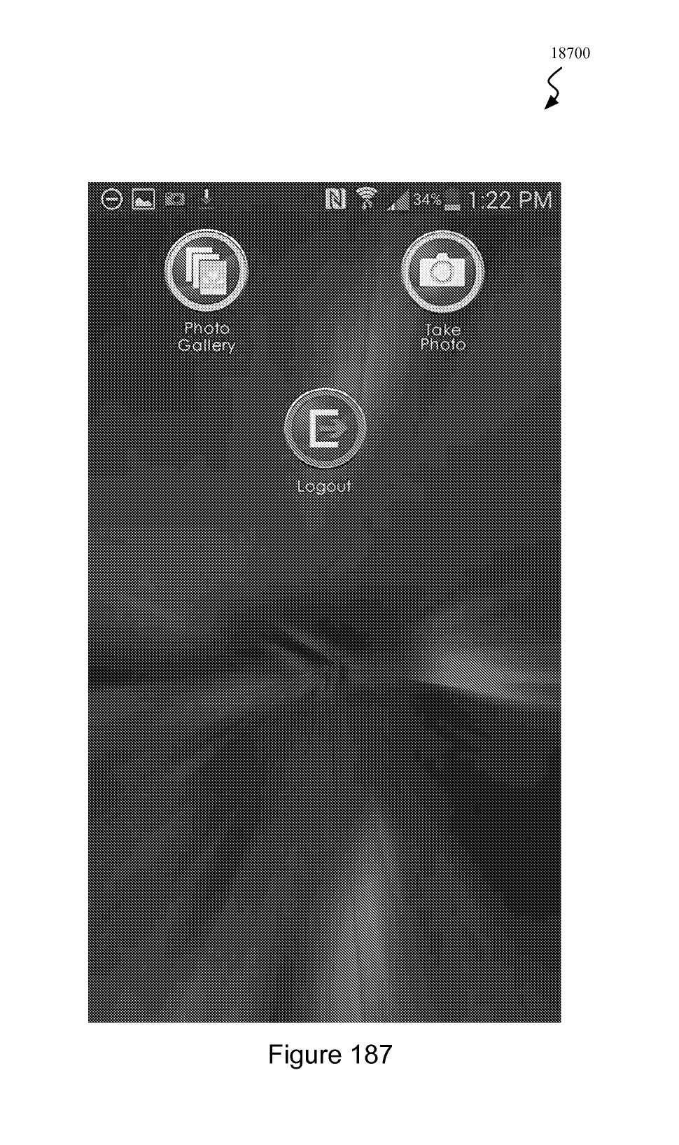

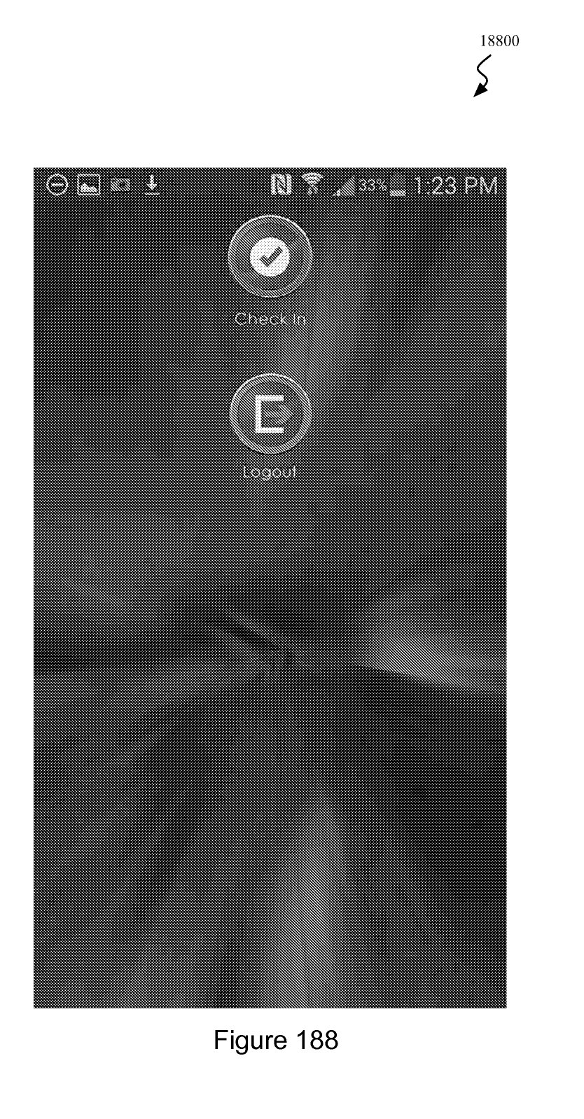

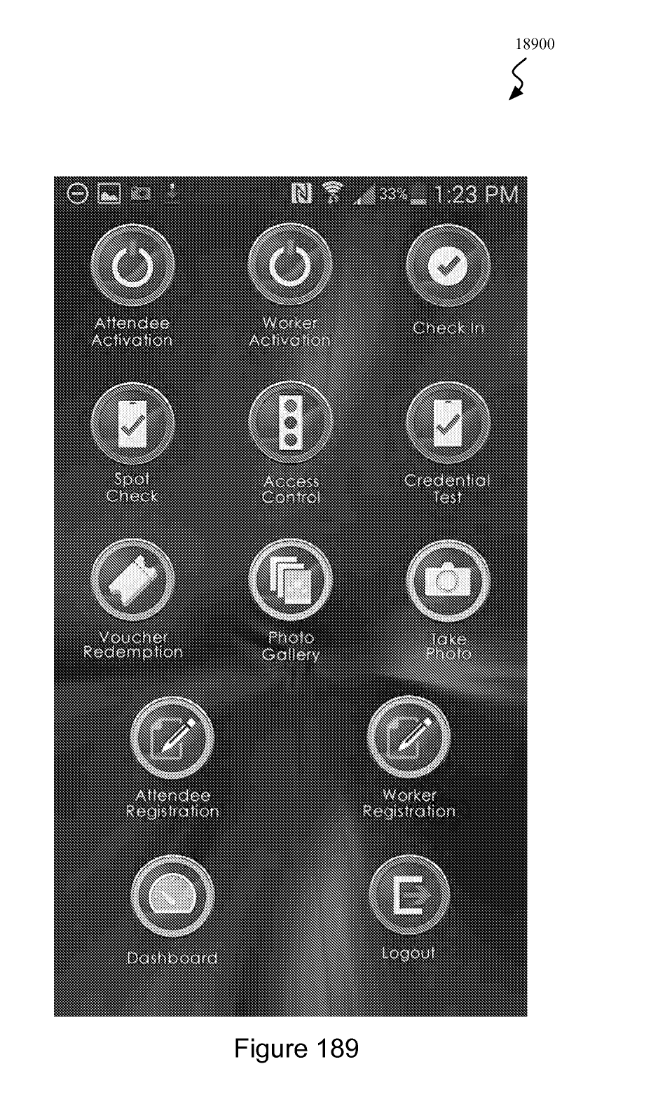

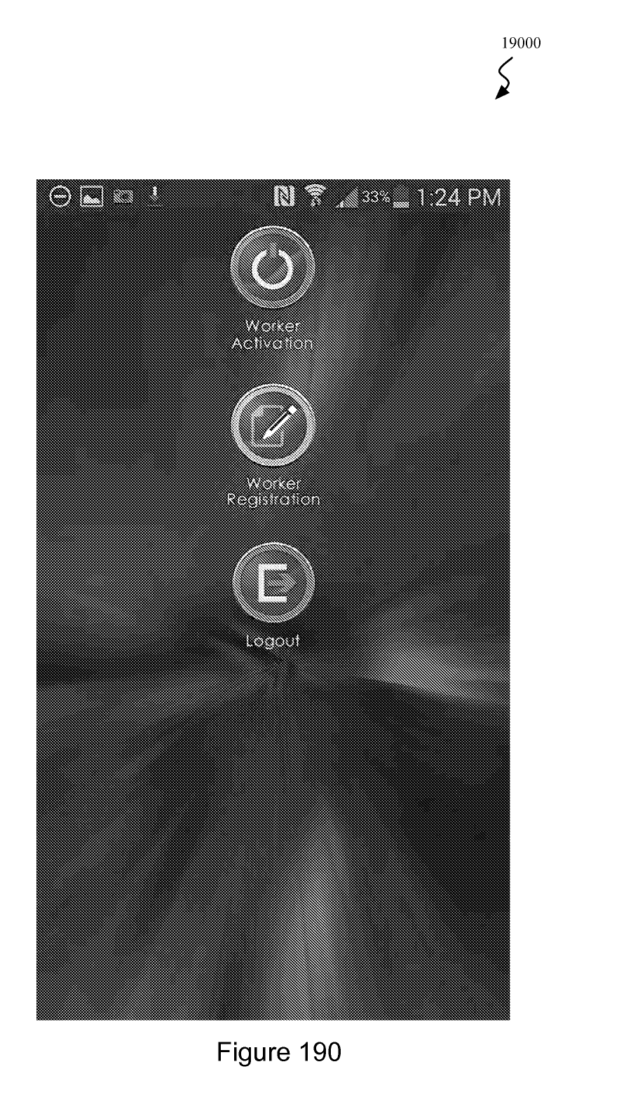

Referring now to FIG. 184 through FIG. 191, various function-limited home pages are included. In some embodiments, the functions accessible from a site device home view are determined, at least in part, by the intersection of the functions associated with the privileges assigned to the authenticated user of the device, and the area in which the device is being operated. For example, referring now to FIG. 184, only voucher redemption is available. This could result from one of two conditions. The first condition could be a situation where the area where the device is being operated is an all functions area, but the authenticated user is only authorized to perform voucher redemptions. The second condition could be a situation where the authenticated user is authorized to perform voucher redemption, but the area where the device is being operated does not allow voucher redemption. It is the intersection of the two sets of authorized functions that determines, at least in part, what is displayed on the site device home view at any given time.

A site device can function as an interest collection device at exhibitor/sponsor booth and can have multiple sections across multiple pages of a display, such as, for example:
A Branding Section
Branded for exhibitor/sponsor. Branding items can include, for example:
   Company name
   Logo
   Message(s):
      Company slogan
      Company address/location
      Booth number/location at venue
      Specials/incentives available during event
      Link to “more information” section/page
      Etc.
Layout
   Layouts may be provided in, and selected from, a template gallery
   Custom layouts may be designed and deployed in advance
   Branding assets can be external to layout and reused in one or more portals
“Products” section
Assets, such as icons, can be deployed representing items or categories in of interest to a credential holder
“Credential Holder” section
Initial state—Prompt inviting the credential holder to perform an engagement action, such as tapping the credential to an associated credential reader. In some instances, the prompt may include an incentive for preforming an engagement action, e.g. “ . . . in order to gain points”, “in order to be added to the drawing for . . . ”, etc.
Once the credential hodler engages their tech-enabled credential with the associated reader device, information displayed in this section can include:
   Welcome message including credential holder's name
   Number of points/vouchers or other incentive gained by engaging with device
   How close the credential holder is to winning a prize
   Name of booth attendant interacting with the credential holder
   Message inviting the credential holder to identify items/categories of interest to them (from the “Products” section)
   Selection and display of items/categories are selected/identified
   Interface to specify evel of interest in each item/category
   When selected, display of additional details of the item/category
“More information” section
Information about the exhibitor/sponsor's, such as the exhibitor/sponsor's schedule at the event
   Date, time, and location of sponsored presentations/activities
   Start and end date, time, and location of specials, contests, etc.
   Date, time, and location of prize drawings

In some instances an event portal for exhibitors/sponsors is generated by the portal service 545. The portal interface can include:
Pre-event configuration section
Upload assets interface for the “branding” section of the display
Upload assets interface for the “products” section of the display
Upload/configure “more information” content, such as schedule of activities at event, e.g.
   Date, time, and location of sponsored presentations at event
   Date, time, and location of sponsored activities at the event Timeline/Checklist section
Timeline and checklist of what the exhibitor/sponsor needs to do/provide prior to the event
Post event information section
List of credential holders who visited booth including their
   Name
   Title
   Phone number
   Company name
   Company location
   Time engaged in the booth
   Items of interest and level of interest
   Name of booth attendant who interacted with them
Summary reports of the event

In some instances, a portal for speakers/educators is generated by the portal service 545. The portal interface can include:
Pre-event configuration section
Upload/data entry interface for the speaker biography
Upload/data entry interface for topic/course summary
Upload/data entry interface for the date, time, and location of presentation(s)/course(s)
Upload interface for collateral, papers, slide decks, and the like
List of workers/attendees who attended presentation
Name
Title
Company name
Company location
Survey results

In some implementations, summary data for multiple events may be available in a cross-event portal interface. Event producers can compare the results of their event to similar events.

In some instances, a portal for credential holders is generated by the portal service 545. The portal interface can include:

### Summary Data for Multiple Events

Event and Activities section displaying a summary of activities and interests by event

Event section that includes activities and interest specific to an event. Producers and vendors can advertise up-coming events which may be seen not only by those who have attended their events in the past, but to others.

For the below discussion, RFID is used as the example of input. The interest collection and tracking system can have multiple points of input which may be RFID, but also can include, but are not limited to, other sources such as NFC, QR codes, bar codes, GeoMeta data, personal mobile devices and other modes of input.
1) RFID Access Control
   a. Use of RFID wristbands, cards, or devices with proprietary access point kiosks and mobile handheld readers in real-time with reporting.
2) Cashless Payment
a. Use of RFID interface to make purchases within a location.
3) Reporting
   a. Generation of analytics and data capture based on how a user accesses a site including locations, time at a location, purchases, and other metrics.
4) Access Control
   a. RFID device deployment for site access control, VIP access credentials, guest access control, photo identification, RFID handheld management, RFID turnstiles and kiosks, real-time registration and leveled access.
5) Social Media a. Support for a standard API with an abstraction layer allowing the ability to interface with current and future social media applications.
   b. This can include
      i. Facebook: “Likes,” posts of pictures, location and comments directly onto a Facebook users timeline/wall.
      ii. Twitter: The ability to “tweet” in real-time with support for all Twitter functions.
   c. Mobile support for the new Android Facebook Home application.
6) Zone Control
   a. Zone control includes the basics such as site access as well as VIP, back-stage and other restricted areas.
   b. Interaction with social media component to include check in zones, reward zones and other specialized promotional tools.
7) User Profiling
   a. Vendor tools that profile detailed survey data related to users.
   b. Support for refined marketing campaigns, loyalty discounts, reward programs, usage tracking, personalized promotions and incentives.
8) Brand Ambassador
   a. Allows vendors and their brands to make permanent digital connection with audience members on-site through “check in zones.”
9) Mobile Applications for Staff
   a. Ready-to-use tablets or tablet applications to event staff that can be used to collect consumer data, digital content delivery, interaction with social media, and other application-only functions. The applications may be customized per venue or per environment.
10) Mobile Applications for Users
   a. Applications for user devices can allow for specific features when on-site at a venue as well as promotional tools.
11) Staff Management
   a. Provide different levels of backstage area control, faster response times to emergency situations, greater staff efficiency, real-time staff monitoring, Photo ID incorporation on hand-held readers, time restrictions on staff passes.
The interest collection and tracking system includes the collection of data from event locations, and the analysis and processing of the data in both real time and subsequent to an event.

Data sources may be varied. However, for the purpose of this description, sources may include RFID, HF and UHF systems. Supported data acquisition techniques may also include NFC, QR codes, bar codes, geo-location information from smart phones and related devices as well as other defined methods of input. Multiple methods can be used to collect the user information for credentials. Methods include, for example:
On-line using an interest collection and tracking portal via at least one of a PC, a tablet device, or a smart phone.
Off-line using a tablet device or smart phone.
Automated entry from an online ticketing system such as, for example, Ticket Master.

The data entry point, whether from a PC, mobile device or smart phone, can include an encrypted interface. An industry standard security technology for establishing an encrypted link between a web server and a client, such as Secure Socket Layer (SSL) can be implemented between the data entry point and the interest collection and tracking server. This method can take the secure encrypted data from the point of entry and maintain security as it is sent to the server. In some embodiments, all data is stored compliant with the Advanced Encryption Standard (AES) protocol per FIPS 197.

In some embodiments, RFID location data is delivered to the database in a anonymous format. The RFID identification can use User Datagram Protocol (UDP) for transmission and the number may not cross-reference until interaction with the private database. This can provide improved efficiency on the use of on-site bandwidth.

Access to data stored in the interest collection and tracking system may be limited based on one or more of authentication, type of user, user role, or type of device.

On or more servers will reside on a DMZ server that contacts one or more secure servers, where such secure servers are behind a firewall, storing data in and/or retrieving data from the secure server. Along with the use of SSL by the server, port knocking can be implemented, and/or with local-only access to the database.

Staff, vendors, speakers, educators, attendees, and the like can update some portion of the interest collection and tracking system data at the time of an event. In some embodiments, a web-based Content Management System (CMS) can provide search and revision features with access control.

One or more kiosks can be implemented at one or more locations a venue site. These kiosks can allow users to scan their credentials and view credential-associated information.

Third party API access can provide the ability to use existing RFID hardware and access to cashless payment systems as well as third-party reporting systems. Social media integration can be implemented as abstraction layer interfacing with the API's of social media sites such as, for example, Facebook and Twitter. This can allow for the implementation of future social media platforms and updates to current ones without rewriting core software components.

Specific integrated social media functionality can include, but are not limited to, “like” posts, photo uploads, and/or tagging. On-site features can include points for check-in or attendance of specific features (digital reward areas), competition zones, geo-location, and backend tracking.

The server services portion of the interest collection and tracking system can allow for publication to mobile clients as well as to authorized “opt-in” email and notification destinations. The interest collection and tracking system can produce various reports and documents. Basic reporting functions will be directly available through the interest collection and tracking system and analytical reports may be available through a vendor-supplied API.

Marketing promotions can be run, including limited offers, discounts, etc., to enhance business or bring in new customers. The interest collection and tracking system can support the creation of such promotions, including mailing lists, and storage of promotional documents and reports on the performance of marketing promotions. Redundant cloud storage can be implemented that supports replication, backup, on-line access and security.

The detailed description set forth above in connection with the appended drawings describes examples and does not represent the only examples that may be implemented or that are within the scope of the claims. The term “example,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a module is described as containing components A, B, and/or C, the module can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for interest collection, comprising:
receiving, at a reader device, one or more indications of interest in a subject from a wireless interest indication device;
recording the one or more indications of interest in the subject; and
providing a uniform resource locator for access to the recorded one or more indications of interest.

2. The method of claim 1, wherein the one or more indications comprise one or more indications of user interest in a particular location, activity, or physical asset.

3. The method of claim 1, wherein the wireless interest indication device comprises a radio frequency identification (RFID) device, a near field communication (NFC) device, or a Bluetooth-enabled device.

4. The method of claim 1, wherein the reader device comprises a near field communication (NFC) reader kiosk, an NFC-enabled mobile device, an RFID tag reader, or a Bluetooth-enabled reader.

5. The method of claim 1, wherein the receiving the one or more indications of interest comprises receiving an indication of a degree on interest at the reader device.

6. The method of claim 5, the indication of the degree of interest is based on one or more of a tap of the wireless interest indication device at or near the reader device, a number of taps of the wireless interest indication device at or near the reader device, an amount of time the wireless interest indication device is within proximity of the reader device, or receipt of a subsequent selection through an interface associated with the reader device.

7. The method of claim 1, wherein providing the record comprises providing a record at a personal portal associated with a user of the wireless interest indication device.

8. The method of claim 7, further comprising:
tracking access to the personal portal by the user of the wireless interest indication device; and
generating an activity report based at least in part of the tracking.

9. The method of claim 8, further comprising:
providing the activity report to a vendor or activity provider associated with the subject.

10. The method of claim 8, wherein the personal portal provides one or more of real-time event information, historical event information, or interest indication information.

11. The method of claim 8, further comprising:
presenting the personal portal to the user of the wireless interest indication device based on the receiving one or more indications of interest.

12. The method of claim 11, wherein the wireless interest indication device is a network connected mobile device having a graphical user interface, and wherein the personal portal is presented using a browser instance or a device application on the mobile device.

13. The method of claim 1, further comprising:
receiving a request to access the recorded one or more indications of interest;
determining credentials associated with the request to access; and
providing access to the recorded one or more indications of interest based on the credentials associated with the request to access.

14. The method of claim 13, further comprising:
receiving, from a user of the wireless interest indication device, a designation of a level of access to the recorded one or more indications of interest; and
wherein the providing access to the recorded one or more indications of interest is further based on the level of access of the credentials associated with the request to access.

15. The method of claim 1, wherein the receiving, recording, and providing are associated with a first user, and further comprising
secondly receiving, subsequent to the receiving, recording, and providing, one or more subsequent indications of interest in a same subject or a different subject from the first user; and
linking together the recorded one or more indications of interest and the one or more subsequent indications of interest.

16. The method of claim 1, further comprising:
identifying an incentive associated with the one or more indications of interest;
providing the incentive to a user of the wireless interest indication device when a predetermined criteria for providing the incentive is met.

17. The method of claim 16, wherein the predetermined criteria is based on one or more of a number of points accumulated by the user of the wireless interest device, a number of purchases associated with the one or more indications of interest, or a level of access to the recorded one or more indications of interest provided by the user of the wireless interest device.

18. The method of claim 1, wherein the reader device is associated with an access point to an event, and wherein the recording the one or more indications of interest in the subject comprises recording an indication of attendance of a user of the wireless interest device at the event.

19. The method of claim 18, further comprising:
receiving, at the reader device, an indication of entrance and exit events of the user of the wireless interest device; and
determining attendance of the user of the wireless interest device at the event based on the entrance and exit events.

20. The method of claim 1, further comprising:
initiating a purchase of an event passport based at least in part on receiving the one or more indications of interest at the reader device;
initiating communication of an activation link to a user of the wireless interest device;
receiving an indication of a click event associated with the activation link; and
activating the event passport based at least in part on the indication of the click event.

21. The method of claim 1, further comprising:
determining credentials of a user of the wireless interest indication device; and
dynamically altering available features and access associated with the user based at least in part on one or more of the credentials of the user, a location of the reader device, or a time of day.

22. An apparatus for interest collection, comprising:
means for receiving one or more indications of interest in a subject from a wireless interest indication device;
means for recording the one or more indications of interest in the subject; and
means for providing a uniform resource locator for access to the recorded one or more indications of interest.
